(19) United States
(12) Patent Application Publication
(10) Pub. No.: US 2023/0385742 A1
(43) Pub. Date: Nov. 30, 2023

(54) EMPLOYEE NET PROMOTER SCORE GENERATOR

(71) Applicant: Degree, Inc., San Francisco, CA (US)

(72) Inventors: William Michael Dybas, San Francisco, CA (US); Ryan Hinshaw, San Francisco, CA (US); Michael John Neth, Wichita, KS (US); Jack Hanford, San Francisco, CA (US); Megan McGowan, Albany, CA (US)

(21) Appl. No.: 18/323,806

(22) Filed: May 25, 2023

Related U.S. Application Data
(60) Provisional application No. 63/365,325, filed on May 25, 2022.

(51) Int. Cl. G06Q 10/0639

(52) U.S. Cl. CPC G06Q 10/06393

(57) ABSTRACT

A method of improving an employee Net Promoter Score (eNPS) for an entity is disclosed. Based on an enablement of an eNPS feature in an administrative user interface, an eNPS survey question is added to one or more question banks associated with one or more surveys. Anonymous answers to the eNPS survey question are collected from a plurality of employees of an entity. An eNPS score for the entity is calculated. The calculating of the eNPS score includes subtracting a percentage of detractors from a percentage of promoters. Based on the eNPS score, one or more suggested actions are generated for improving the eNPS score for the entity. User interface elements pertaining to the one or more suggested actions are caused to be surfaced in the administrative user interface to allow one or more users to signal one or more intentions to implement the one or more suggested actions.

### CROSS-REFERENCE TO RELATED APPLICATIONS

This application claims the benefit of U.S. Provisional Application No. 63/365,325, filed May 25, 2022, entitled “EMPLOYEE NET PROMOTER SCORE GENERATOR,” which is hereby incorporated by reference herein in its entirety.

### TECHNICAL FIELD

The present application relates generally to the technical field of data analytics and, in one specific example, to collecting and analyzing survey data pertaining to sentiments of employees or other individuals toward an entity and facilitating implementation of actionable suggestions for improving those sentiments.

### BACKGROUND

An entity, such as a private or public corporation, may benefit from a better understanding of how individuals associated with the entity, such as employees of the entity (and/or other parties, such as contractors or third-party service providers associated with the entity), feel about the entity itself or one or more particular practices of the entity.

For example, the entity may seek to improve its understanding of user sentiments such that the entity can adapt its practices or policies to improve its levels of success with respect to various metrics, such as employee satisfaction, efficiency, and/or retention, that are deemed important by stakeholders of the entity.

To improve its understanding, the entity may seek to actively engage such individuals by, for example, encouraging participation in online surveys and/or other online electronic communication systems provided or managed by the entity.

However, because of various technological limitations of these systems, such as relying on stale data or failing to offer present options to stakeholders for improving sentiments as soon as the options are identified, these systems fall short of their full potential.

### BRIEF DESCRIPTION OF THE DRAWINGS

Some embodiments are illustrated by way of example and not limitation in the figures of the accompanying drawings.

FIG. 1 is a network diagram depicting a cloud-based SaaS system within which various example embodiments may be deployed.

FIG. 2 is a block diagram illustrating example modules of the engagement service(s) of FIG. 1.

FIG. 3 illustrates an example grouping of respondents.

FIG. 4 is an example user interface in which employee Net Promoter Score (eNPS) data for an entity is surfaced.

FIG. 5 is a screenshot of an example interactive user interface in which follow-up engagement themes are surfaced in a pop-up window based on an interaction with a graph of underlying pulse survey data.

FIG. 6 is a screenshot of an example interactive user interface in which interaction with eNPS data presented in a bar graph causes information regarding promoters, passives, and detractors to be surfaced in a pop-up window.

FIG. 7 is a screenshot of an example interactive user interface in which attributes associated with an individual (e.g., an employee) are surfaced in a pop-up window upon activation of a user interface element on an engagement survey results page. Such attributes may include customer obsession, effort, empathy, growth, and/or leadership.

FIG. 8 is a screenshot of an example user interface for specifying pulse survey admins.

FIG. 9 is a screenshot of an example user interface for specifying administrators of a pulse survey.

FIG. 10 is a screenshot of an example user interface for viewing existing surveys and creating new surveys.

FIG. 11 is a screenshot of an example user interface for configuring a survey.

FIG. 12 is a screenshot of an example user interface for specifying survey questions and/or selecting questions from a survey bank to include in a survey.

FIG. 13 is a screenshot of an example user interface for specifying participants for a survey.

FIG. 14 is a screenshot of an example user interface for specifying default attributes and/or a data check for a survey.

FIG. 15 is a screenshot of an example user interface for verifying a survey configuration.

FIG. 16 is a screenshot of an example user interface for adding questions to a survey.

FIG. 17 is a screenshot of an example user interface for adding a theme to a survey.

FIG. 18 is a screenshot of an example user interface for inputting a question for a survey.

FIG. 19 is a screenshot of an example user interface for selecting a type for the question.

FIG. 20 is a screenshot of an example user interface for duplicating an engagement survey.

FIG. 21 is a screenshot of an example user interface for enabling eNPS for a survey.

FIG. 22 is a screenshot of an example user interface for configuring a survey question.

FIG. 23 is a screenshot of an example user interface for viewing a survey question as it will appear to survey respondents.

FIG. 24 is a screenshot of an example user interface for viewing results of a survey question.

FIG. 25 is a screenshot of an example user interface for viewing an eNPS breakdown for responses to a survey question.

FIG. 26 is a screenshot of an example user interface for an engagement survey welcome screen.

FIG. 27 is a screenshot of an example user interface for an engagement survey including an anonymous indicator.

FIG. 28 is a screenshot of an example user interface for setting up a survey, including an anonymity threshold.

FIG. 29 is a screenshot of an example user interface for selecting an anonymity threshold.

FIG. 30 is a screenshot of an example user interface for managing user attributes, including active and archived attributes.

FIG. 31 is a screenshot of an example user interface creating a custom attribute, including specifying available valid options for the custom attribute.

FIG. 32 is a screenshot of an example user interface for managing employee profiles.

FIG. 33 is a screenshot of an example user interface for managing employees, including a user interface element for adding employees.

FIG. 34 is a screenshot of an example user interface for specifying employees in a spreadsheet (e.g., .csv) form.

FIG. 35 is a screenshot of an example user interface for adding employees in bulk (e.g., from a spreadsheet).

FIG. 36 is a screenshot of an example user interface for managing survey groups.

FIG. 37 is a screenshot of an example user interface for creating a new survey (e.g., from scratch or from a template).

FIG. 38 is a screenshot of an example user interface for performing a next action with respect to each of a list of surveys, such as tracking progress, enabling action planning, or finishing setup.

FIG. 39 is a screenshot of an example user interface for previewing a survey.

FIG. 40 is a screenshot of an example user interface for correcting data with respect to default or custom attributers of a survey.

FIG. 41 is a screenshot of an example user interface for correcting data with respect to a survey, such as assigning a manager to employees who do not have a manager assigned.

FIG. 42 is a screenshot of an example user interface for managing an employee profile (e.g., by adding the name of a manager assigned to the employee).

FIG. 43 is a screenshot of an example user interface for supplying missing values for one or more user attributes in order to separate survey results.

FIG. 44 is a screenshot of an example user interface for accessing profile pages of users to which no manager is assigned.

FIG. 45 is a screenshot of an example user interface for specifying a manager for a user to which new user is specified.

FIG. 46 is a screenshot of an example user interface for managing surveys, including an option to track progress or view participation associated with a survey.

FIG. 47 is a screenshot of an example user interface for sending a reminder notification for a survey.

FIG. 48 is a screenshot of an example user interface for writing a reminder for a survey.

FIG. 49 is a screenshot of an example user interface for changing a management hub.

FIG. 50 is a screenshot of an example user interface for accessing quick sheets for engagement surveys.

FIG. 51 is a screenshot of an example user interface for managing templates for surveys.

FIG. 52 is a screenshot of an example user interface for filtering a view by a department (e.g., R & D).

FIG. 53 is a screenshot of an example user interface for examining results by question or by theme, in either a list format or heatmap view.

FIG. 54 is a screenshot of an example user interface for filtering a result (e.g., by tenure of 2-4 years).

FIG. 55 is a screenshot of an example user interface for interactively accessing comment responses associated with a survey question.

FIG. 56 is a screenshot of an example user interface for viewing a heatmap (e.g., for filtered results (e.g., by gender and/or department)).

FIG. 57 is a screenshot of an example user interface for comparing results of an overlapping question across multiple surveys.

FIG. 58 is a screenshot of an example user interface for exporting survey participation.

FIG. 59 is a screenshot of an example user interface for viewing user attributes at survey launch.

FIG. 60 is a screenshot of an example user interface for exporting survey results (e.g., as .CSV).

FIG. 61 is a screenshot of an example user interface for accessing overall sentiment (e.g., generated from free-text comments, such as through application of natural language processing or other machine-learning algorithm).

FIG. 62 is a screenshot of an example user interface for accessing sentiment associated with each theme, question and/or comment associated with a survey.

FIG. 63 is a screenshot of an example user interface for assessing sentiments and/or responses to a survey.

FIG. 64 is a screenshot of an example user interface for filtering by attribute and/or score.

FIG. 65 is a screenshot of an example user interface for grouping and/or rating themes and/or questions by scored attributes.

FIG. 66 is a screenshot of an example user interface for filtering results by review cycles and/or response types.

FIG. 67 is a screenshot of an example user interface for filtering results by themes.

FIG. 68 is a screenshot of an example user interface for grouping themes and/or questions by rating questions and/or scored attributes.

FIG. 69 is a screenshot of an example user interface for saving a view in a storage for later access or distribution to one or more users (e.g., users having one or more specified roles, such as managers, administrators, executives, and so on).

FIG. 70 is a screenshot of an example user interface for sharing a subset of data with particular users or users having particular roles.

FIG. 71 is a screenshot of an example user interface for specifying a group to share results with.

FIG. 72 is a screenshot of an example user interface for saving role-based views.

FIG. 73 is a screenshot of an example user interface for specifying settings for manager views, including whether to enable filtering and/or show comments.

FIG. 74 is a screenshot of an example user interface for previewing, managing access, and selecting a sharing group for saved views (e.g., for a manager).

FIG. 75 is a screenshot of an example user interface for managing saved view access.

FIG. 76 is a screenshot of an example user interface for adding filters (e.g., office location) for a custom view to share.

FIG. 77 is a screenshot of an example user interface for enabling comments from survey respondents to be visible to users with access to a saved view.

FIG. 78 is a screenshot of an example user interface for presenting a custom view when comments are turned off.

FIG. 79 is a screenshot of an example user interface for managing a saved view, including users it is shared with.

FIG. 80 is a screenshot of an example user interface for unsharing a view (e.g., from users with a “department head” role).

FIG. 81 is a screenshot of an example user interface for unsharing a view from a particular user.

FIG. 82 is a screenshot of an example user interface for editing a view.

FIG. 83 is a screenshot of an example user interface for deleting a view.

FIG. 84 is a screenshot of an example user interface for viewing action plans associated with a user (e.g., an employee).

FIG. 85 is a screenshot of an example user interface for accessing action plans associated with engagement for a user.

FIG. 86 is a screenshot of an example user interface for accessing results of engagement with a user.

FIG. 87 is a screenshot of an example user interface for viewing action plans associated with specific surveys.

FIG. 88 is a screenshot of an example user interface for exporting a heat map associated with survey results.

FIG. 89 is a screenshot of an example user interface for viewing an exported heat map in a spreadsheet.

FIG. 90 is a screenshot of an example user interface for exporting heatmaps for one or more of themes and questions associated with a survey.

FIG. 91 is a screenshot of an example user interface for accessing a statistical accuracy of a survey.

FIG. 92 is a screenshot of an example user interface for viewing a delta across multiple survey results.

FIG. 93 is a screenshot of an example user interface for accessing an overall distribution of responses relative to a benchmark.

FIG. 94 is a screenshot of an additional example user interface for accessing an overall distribution of responses relative to a benchmark.

FIG. 95 is a screenshot of an example user interface for accessing action plans from a user profile.

FIG. 96 is a screenshot of an example user interface for accessing action plans from surveys shared with a user on a goals page associated with the user.

FIG. 97 is a screenshot of an example user interface for accessing action plans from a specialized secondary user interface window docked to a main window.

FIG. 98 is a screenshot of an example user interface for managing actions and/or updates for a focus area identified from a survey.

FIG. 99 is a screenshot of an example user interface for selecting a baseline question for a survey.

FIG. 100 is a screenshot of an example user interface for accessing questions that have a high impact.

FIG. 101 is a screenshot of an example user interface for flagging a question to add to an action plan.

FIG. 102 is a screenshot of an example user interface for enabling company focus and/or manager focus action plans.

FIG. 103 is a screenshot of an example user interface for creating a focus area to include in a company and/or manager's action plan.

FIG. 104 is a screenshot of an example user interface for specifying settings for a focus for an action plan.

FIG. 105 is a screenshot of an example user interface for publishing an action plan.

FIG. 106 is a screenshot of an example user interface for accessing a published access plan.

FIG. 107 is a screenshot of an example user interface for unpublishing an action plan.

FIG. 108 is a screenshot of an example user interface for changing action plan settings, including due date, visibility, and/or owner(s).

FIG. 109 is a screenshot of an example user interface for specifying survey questions to focus on.

FIG. 110 is a screenshot of an example user interface for creating a focus area for a survey question.

FIG. 111 is a screenshot of an example user interface for publishing an action plan.

FIG. 112 is a screenshot of an example user interface for a notification of a publishing of a company action plan.

FIG. 113 is a screenshot of an example user interface for a notification of a publishing of a manager action plan.

FIG. 114 is a screenshot of an example user interface for a notification of an update to a published action plan.

FIG. 115 is a screenshot of an example user interface for configuring notifications, including whether each of multiple types of notifications are sent via one or more particular channels (e.g., Slack or email).

FIG. 116 is a screenshot of an example user interface for a notification of a launch of an engagement survey.

FIG. 117 is a screenshot of an additional example user interface for a notification of a launch of an engagement survey.

FIG. 118 is a screenshot of an example user interface for a notification of a reminder to complete a survey.

FIG. 119 is a screenshot of an additional example user interface for a notification of a reminder to complete a survey.

FIG. 120 is a screenshot of an example user interface for a notification for admins to manage a survey.

FIG. 121 is a screenshot of an example user interface for a notification of a notification that a report has been shared.

FIG. 122 is a screenshot of an example user interface for a notification for an action plan being published.

FIG. 123 is a screenshot of an example user interface for a notification for an action plan being updated.

FIG. 124 is a screenshot of an example user interface for responding to a survey via a tasks list.

FIG. 125 is a screenshot of an example user interface for a welcome screen for a survey.

FIG. 126 is a screenshot of an example user interface for setting a cadence for a survey, such as a frequency and/or a question limit.

FIG. 127 is a screenshot of an example user interface for adding an eNPS question to a survey (e.g., a pulse survey).

FIG. 128 is a screenshot of an example user interface for presenting an eNPS survey question to a user.

FIG. 129 is a screenshot of an example user interface for accessing eNPS reporting.

FIG. 130A-130B are screenshots of example user interfaces for accessing scores over a time period.

FIG. 131 is a screenshot of an example user interface for specifying a number of pulse survey questions from a recommended range (e.g., 3-5).

FIG. 132 is a screenshot of an example user interface for accessing a pulse survey setup screen.

FIG. 133 is a screenshot of an example user interface for specifying a Cadence for a pulse survey during a setup flow.

FIG. 134 is a screenshot of an example user interface for verifying configurations and/or setting a launch date for a pulse survey.

FIG. 135 is a screenshot of an example user interface for changing configuration settings for and/or pausing a pulse survey.

FIG. 136 is a screenshot of an example user interface for specifying one or more participants or groups of participants for a survey.

FIG. 137 is a screenshot of an example user interface for specifying one or more specific users (e.g., employees) as participants for a survey.

FIG. 138 is a screenshot of an example user interface for confirming and/or launching a pulse survey.

FIG. 139 is a screenshot of an example user interface for accessing participation and/or response rates for a survey.

FIG. 140 is a screenshot of an example user interface for accessing different options for response and/or participation rates for a survey.

FIG. 141 is a screenshot of an example user interface for viewing participation and/or response rates under a specific view (e.g., a manager view).

FIG. 142 is a screenshot of an example user interface for viewing and filtering pulse survey data (e.g., for administrators).

FIG. 143 is a screenshot of an example user interface for accessing results of a pulse survey.

FIG. 144 is a screenshot of an example user interface for accessing participation and/or response rates for a pulse survey.

FIG. 145 is a screenshot of an additional example user interface for accessing participation and/or response rates for a pulse survey.

FIG. 146 is a screenshot of an example user interface for accessing an overall score for a pulse survey.

FIG. 147 is a screenshot of an example user interface for accessing theme scores for a pulse survey.

FIG. 148 is a screenshot of an example user interface for accessing theme scores over a specified time period.

FIG. 149 is a screenshot of an example user interface for selecting one or more filter options and/or selecting one or more custom attributes.

FIG. 150 is a screenshot of an example user interface for uncovering one or more data insights in search results.

FIG. 151 is a screenshot of an example user interface for accessing a time range bar.

FIG. 152 is a screenshot of an example user interface for selecting and/or applying a desired time range.

FIG. 153 is a screenshot of an example user interface for comparing pulse results for a specific time range to a previous time range.

FIG. 154 is a screenshot of an example user interface for saving a view.

FIG. 155 is a screenshot of an example user interface for sharing a view with one or more groups of users and/or one or more individual users.

FIG. 156 is a screenshot of an example user interface for managing users with whom to share a view.

FIG. 157 is a screenshot of an example user interface for managing one or more saved views for a survey.

FIG. 158 is a screenshot of an example user interface for deleting a view, sharing a view, or removing access to a view.

FIG. 159 is a screenshot of an example user interface for exporting a view for access by an external tool (e.g., to a file, such a CSV file, for access by a spreadsheet program).

FIG. 160 is a screenshot of an example user interface for generating a heatmap export.

FIG. 161 is a screenshot of an example user interface for accessing a heatmap export in an external tool, such as a spreadsheet program (e.g., Excel).

FIG. 162 is a screenshot of an example user interface for exporting heatmaps for themes and/or questions.

FIG. 163 is a screenshot of an example user interface for sharing survey results from a user profile page (e.g., a user having admin role with respect to the survey).

FIG. 164 is a screenshot of an example user interface for sharing survey results from a people page.

FIG. 165 is a screenshot of an example user interface for presenting a notification that a report has been shared with a user.

FIG. 166 is a screenshot of an example user interface for pausing a pulse survey.

FIG. 167 is a screenshot of an example user interface for confirming that a pulse survey is to be paused.

FIG. 168 is a screenshot of an example user interface for changing configuration settings for a pulse survey.

FIG. 169 is a screenshot of an example user interface for pausing or removing a question from a pulse survey.

FIG. 170 is a screenshot of an example user interface for saving changes to questions for a pulse survey.

FIG. 171 is a screenshot of an example user interface for configuring notifications associated with pulse surveys.

FIG. 172 is a screenshot of an example user interface for a notification for launching of a pulse survey.

FIG. 173 is a screenshot of an additional example user interface for launching of a pulse survey.

FIG. 174 is a screenshot of an example user interface for a presenting a reminder to complete a pulse survey.

FIG. 175 is a screenshot of an additional example user interface for presenting a reminder to complete a pulse survey.

FIG. 176 is a screenshot of an example user interface for presenting a notification that an administrator has replied to a comment.

FIG. 177 is a screenshot of an example user interface for presenting a notification that an anonymous comment has been assigned to a user for handling.

FIG. 178 is a screenshot of an example user interface for presenting a pulse update.

FIG. 179 is a screenshot of an example user interface for starting a pulse survey.

FIG. 180 is a screenshot of an example user interface for accessing new pulse survey from a profile page of a user.

FIG. 181 is a screenshot of an example user interface for selecting to create a survey that incorporates an eNPS question.

FIG. 182 is a screenshot of an example user interface for selecting questions for a survey (e.g., from a question bank).

FIG. 183 is a screenshot of an example user interface for selecting a cadence for a survey and/or for an eNPS question within the survey.

FIG. 184 is a screenshot of an example user interface for verifying a pulse survey configuration.

FIG. 185 is a screenshot of an example user interface for presenting an eNPS question within a pulse survey to a user.

FIG. 186 is a screenshot of an example user interface for presenting results of an Engagement and/or pulse survey.

FIG. 187 is a screenshot of an example user interface for presenting eNPS results corresponding to a survey.

FIG. 188 is a screenshot of an example user interface for an administration tab for a pulse survey.

FIG. 189 is a screenshot of an example user interface for displaying a distribution of scores corresponding to eNPS question over a configurable time period.

FIG. 190 is a screenshot of an example user interface for unlocking real-time insights about people.

FIG. 191 is a block diagram of example operations for incorporating eNPS into a survey generation workflow.

FIG. 192 is a block diagram of additional example operations for incorporating eNPS into a survey generation workflow.

FIG. 193 is a block diagram of additional example operations for incorporating eNPS into a survey generation workflow.

FIG. 194 is a screenshot of an example user interface for presenting an eNPS question to a user and for collecting an explanation for the selected answer.

FIG. 195 is a screenshot of an example user interface for specifying a question in a survey.

FIG. 196 is a screenshot of an example user interface for specifying that an eNPS question is to be added to a survey.

FIG. 197 is a screenshot of an example user interface for recording an answer to an eNPS question.

FIG. 198 is a screenshot of an example user interface for accessing survey results based on themes.

FIG. 199 is a screenshot of an example user interface for accessing survey results based on questions.

FIG. 200 is a screenshot of an example user interface for interacting with a result in a user interface in order to view a distribution of promoters, passives, and detractors with respect to an eNPS question.

FIG. 201 is a screenshot of an additional example user interface for interacting with a result in a user interface in order to view a distribution of promoters, passives, and detractors with respect to an eNPS question.

FIG. 202 is a screenshot of an example user interface for viewing eNPS scores over a configurable period of time, including by theme.

FIG. 203 is a screenshot of an example user interface for viewing eNPS distributions over a configurable period of time.

FIG. 204 is a screenshot of an example user interface for accessing survey results for multiple surveys and optionally comparing one or more of the multiple surveys.

FIG. 205 is a screenshot of an example user interface for viewing results of an eNPS survey question and/or one or more results of other survey questions.

FIG. 206 is a screenshot of an example user interface for interactively drilling down into a specific survey result included in a graph of scores over a configurable period of time.

FIG. 207 is a screenshot of an additional example user interface for interactively drilling down into a specific survey result.

FIG. 208 is a screenshot of an example user interface for starting generation of a survey.

FIG. 209 is a screenshot of an example user interface for adding a eNPS question to a survey and/or toggling the eNPS question on or off.

FIG. 210 is a screenshot of an example user interface for adding and/or removing one or more survey questions to a survey.

FIG. 211 is a screenshot of an example user interface for specifying a cadence for a survey.

FIG. 212 is a screenshot of an example user interface for viewing eNPS results corresponding to a survey.

FIG. 213 is a screenshot of an example user interface for optionally adding one or more questions to a survey from a question bank.

FIG. 214 is a screenshot of an example user interface for viewing survey results over a configurable period of time.

FIG. 215 is a screenshot of an example user interface for viewing eNPS survey question results, including distributions, over a configurable period of time.

FIG. 216 is a screenshot of an example user interface for specifying a type of a question as well as possible answers to the question for including in a survey.

FIG. 217 is a screenshot of an example user interface for specifying a theme in order to filter questions in the question bank for optional selection.

FIG. 218 is a screenshot of an example user interface for presenting an eNPS question to a user.

FIG. 219 is a screenshot of an example user interface for managing views associated with survey results by question.

FIG. 220 is a screenshot of an example user interface for managing views associated with survey results by theme.

FIG. 221 is a screenshot of an example user interface for presenting detailed view of eNPS results.

FIG. 222 is a block diagram illustrating a mobile device, according to an example embodiment.

FIG. 223 is a block diagram of a machine in the example form of a computer system within which instructions for causing the machine to perform any one or more of the methodologies discussed herein may be executed.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

A method of improving an eNPS score for an entity is disclosed. Based on an enablement of an eNPS feature in an administrative user interface, an eNPS survey question is added to one or more question banks associated with one or more surveys. Anonymous answers to the eNPS survey question are collected from a plurality of employees of an entity. An eNPS score for the entity is calculated. The calculating of the eNPS score includes subtracting a percentage of detractors from a percentage of promoters. Based on the eNPS score, one or more suggested actions are generated for improving the eNPS score for the entity. User interface elements pertaining to the one or more suggested actions are caused to be surfaced in the administrative user interface to allow one or more users to signal one or more intentions to implement the one or more suggested actions.

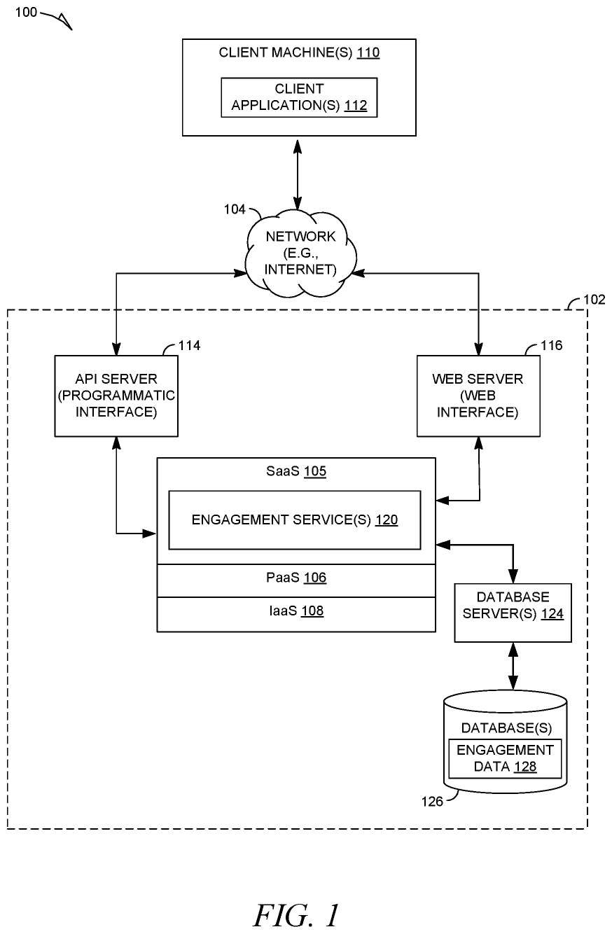

FIG. 1 is a network diagram depicting a system 100 within which various example embodiments may be deployed.

A networked system 102, in the example form of a cloud computing service, such as Microsoft Azure or other cloud service, provides server-side functionality, via a network 104 (e.g., the Internet or Wide Area Network (WAN)) to one or more endpoints (e.g., client machines 110). The networked system 102 is also referred to herein as “Lattice” or “the system.” FIG. 1 illustrates client application(s) 112 on the client machines 110. Examples of client application(s) 112 may include a web browser application, such as the Internet Explorer browser developed by Microsoft Corporation of Redmond, Washington, or other applications supported by an operating system of the device, such as applications supported by Windows, iOS or Android operating systems. Examples of such applications include e-mail client applications executing natively on the device, such as an Apple Mail client application executing on an iOS device, a Microsoft Outlook client application executing on a Microsoft Windows device, or a Gmail client application executing on an Android device. Examples of other such applications may include calendar applications and file sharing applications. Each of the client application(s) 112 may include a software application module (e.g., a plug-in, add-in, or macro) that adds a specific service or feature to the application.

An API server 114 and a web server 116 are coupled to, and provide programmatic and web interfaces respectively to, one or more software services, which may be hosted on a software-as-a-service (SaaS) layer or platform 105. The SaaS platform may be part of a service-oriented architecture, being stacked upon a platform-as-a-service (PaaS) layer 106 which, may be, in turn, stacked upon a infrastructure-as-a-service (IaaS) layer 108 (e.g., in accordance with standards defined by the National Institute of Standards and Technology (NIST)).

While the applications (e.g., engagement service(s)) or application(s) 120 are shown in FIG. 1 to form part of the networked system 102, in alternative embodiments, the applications 120 may form part of a service that is separate and distinct from the networked system 102.

Further, while the system 100 shown in FIG. 1 employs a cloud-based architecture, various embodiments are, of course, not limited to such an architecture, and could equally well find application in a client-server, distributed, or peer-to-peer system, for example. The various server applications 120 could also be implemented as standalone software programs. Additionally, although FIG. 1 depicts machines 110 as being coupled to a single networked system 102, it will be readily apparent to one skilled in the art that client machines 110, as well as client applications 112, may be coupled to multiple networked systems, such as payment applications associated with multiple payment processors or acquiring banks (e.g., PayPal, Visa, MasterCard, and American Express).

Web applications executing on the client machine(s) 110 may access the various applications 120 via the web interface supported by the web server 116. Similarly, native applications executing on the client machine(s) 110 may accesses the various services and functions provided by the applications 120 via the programmatic interface provided by the API server 114. For example, the third-party applications may, utilizing information retrieved from the networked system 102, support one or more features or functions on a website hosted by the third party. The third-party website may, for example, provide one or more promotional, marketplace or payment functions that are integrated into or supported by relevant applications of the networked system 102.

The server applications 120 may be hosted on dedicated or shared server machines (not shown) that are communicatively coupled to enable communications between server machines. The server applications 120 themselves are communicatively coupled (e.g., via appropriate interfaces) to each other and to various data sources, so as to allow information to be passed between the server applications 120 and so as to allow the server applications 120 to share and access common data. The server applications 120 may furthermore access one or more databases 126 via the database servers 124. In example embodiments, various data items are stored in the database(s) 126, such as engagement data 128. In example embodiments, the engagement data includes one or more anonymous comment replies and associated metadata, as described herein.

Navigation of the networked system 102 may be facilitated by one or more navigation applications. For example, a search application (as an example of a navigation application) may enable keyword searches of data items included in the one or more database(s) 126 associated with the networked system 102. Various other navigation applications may be provided to supplement the search and browsing applications.

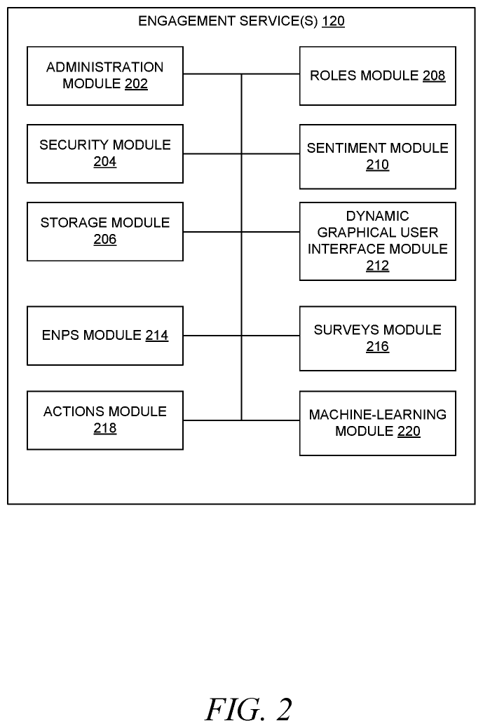

FIG. 2 is a block diagram illustrating example modules of the engagement service(s) 120.

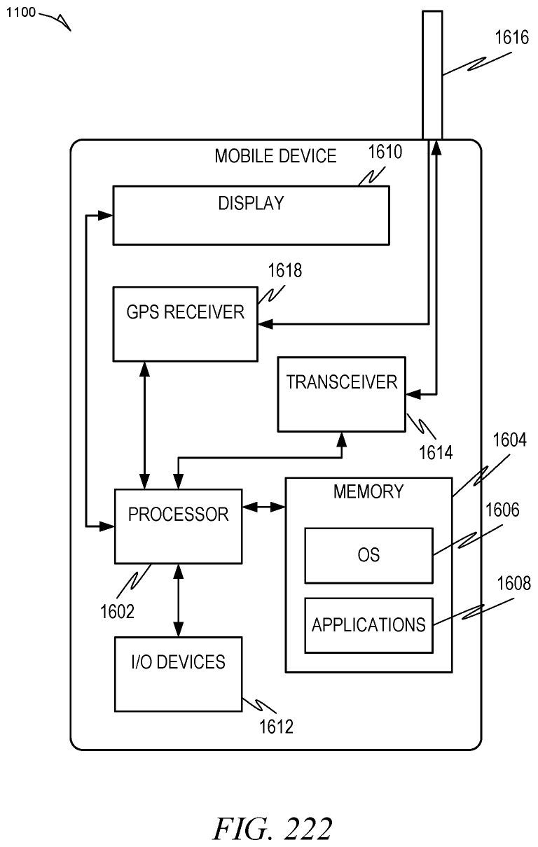

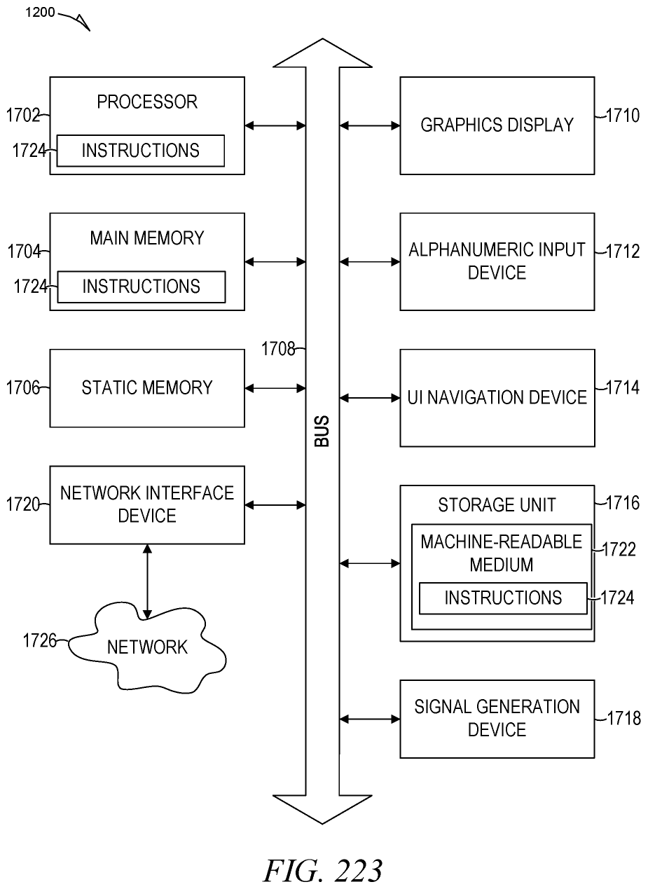

An administration module 202 is configured to enable administration of the various engagement services 120 (e.g., via one or more specialized user interfaces), as described in more detail herein. A security module 204 is configured to implement security measures associated with collecting data, including protecting the anonymity of users, as described in more detail herein. A storage module 206 is configured to store collected data in a secure fashion, as described in more detail herein. A roles module 208 is configured to manage roles for users for purposes of controlling access to and/or managing survey data, including eNPS data. A sentiment module 210 is configured to provide a sentiment of users with respect to an entity or one or more business practices of the entity based at least in part on the collected survey data. A dynamic graphical user interface (GUI) module 212 is configured to provide one or more specialized graphical user interfaces, as described herein, to, for example, allow users to integrate eNPS into surveys, including engagement surveys and pulse surveys, as described herein. In example embodiments, the one or more specialized user interfaces or elements included in the one or more specialized user interfaces, or combinations thereof, are asserted to be unconventional. Additionally, the one or more specialized user interfaces described include one or more features that specially adapt the one or more specialized user interfaces for devices with small screens, such as mobile phones or other mobile devices, as shown herein (e.g., see mobile device 1100 of FIG. 222, which may correspond to one or more client machine(s) 110 of FIG. 2, and client application(s) 112, which may present one or more user interfaces described herein, such as user interfaces of one or more mobile applications (e.g., Lattice App). An eNPS module 214 is configured to calculate an eNPS score for an entity, as described herein. A surveys module 216 is configured to conduct surveys, including engagement surveys and pulse surveys, as described herein. An actions module 218 is configured to recommend one or more actions for users of the system to perform based on the eNPS score for an entity or other survey results. A machine-learning module 220 is configured to train one or more machine-learned models or algorithms and apply those one or more machine learning algorithms for various purposes, as described herein.

“How likely are you to recommend this business to a friend?” An entity (e.g., a company or other organization) may use that question and/or the Net Promoter Score (NPS) methodology to measure satisfaction (e.g., of a customer, employee, user, and so on) toward just about anything, from software to burritos.

With engaging and retaining top performers top of mind for most entities, the disclosed system brings the concept of NPS to the workplace and/or other environments. The resulting metric, employee Net Promoter Score (eNPS), may take its rightful place in importance alongside standbys, like turnover and retention.

Calculating eNPS

When asked if they'd recommend an entity to a friend, respondents may respond using a scale of, for example, zero (not at all likely) to 10 (extremely likely). While that sounds intuitive enough, calculating eNPS isn't a matter of averaging scores. Based on their feedback, respondents are grouped into one of three categories: promoters, detractors, and “passives.”

### Promoters, Detractors, and Passives

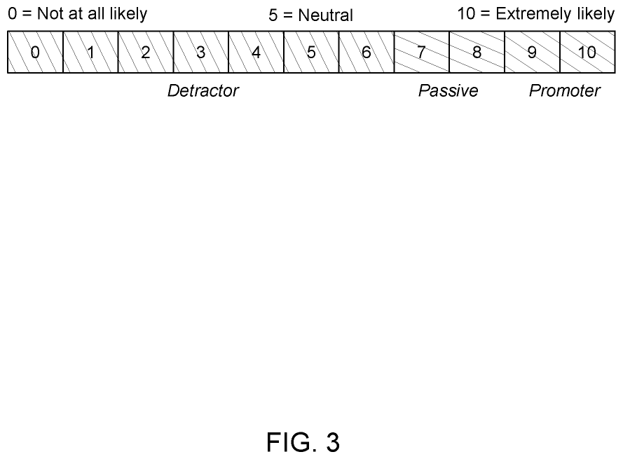

FIG. 3 illustrates an example grouping of respondents.

Promoters, or employees who score high (e.g., at above a promoter threshold value, such as 9-10), may be an entity's biggest advocates. They may be a major asset to the entity's brand and/or recruiting efforts. These individuals may be more likely to share job postings on job boards (e.g., LinkedIn) and/or within their network—they may be the entity's brand ambassadors.

Detractors aren't just apathetic about the company's prospects for success, they could hurt an entity's brand in the long term. These individuals are unhappy enough to “gripe to friends, relatives, acquaintances—anyone who will listen.” Detractors may score anywhere at or below a configurable detractor threshold value, such as below 6. Thus, in example embodiments, they may account for over half of the rubric.

Lastly, passive respondents are neutral. They might like working with or for an entity, but not enough to actively refer friends to it. If their feelings could be summed up as a social networking (e.g., LinkedIn) status, they're “open to opportunities,” but not actively looking. Scores in the upper middle range (e.g., above a configurable detractor threshold value and below the configurable promote threshold value, such as from 7-8) are considered passive and, in some embodiments, won't factor into the system's final calculation. There may be a lot of value in understanding feedback from this group to discover what can be done to move them into the promoter category.

In example embodiments, the threshold values and the scale may be configurable via an administrative user interface. In example embodiments, machine-learning may be applied to set the threshold values and/or the scale (e.g., to optimize the matching of the categories to the attributes of the users associated with the categories). For example, training data may include attributes and/or behaviors of employees (e.g., anonymously extracted from system data) and the machine-learned model may be configured to output optimized threshold values and/or scales for categorizing the users more accurately over time.

In example embodiments, one or more artificial intelligence agents, such as one or more machine-learned algorithms or models and/or a neural network of one or more machine-learned algorithms or models, may be trained iteratively (e.g., in a plurality of stages) using a plurality of sets of input data. For example, a first set of input data may be used to train one or more of the artificial agents. Then, the first set of input data may be transformed into a second set of input data for retraining the one or more artificial intelligence agents (e.g., to reduce false positives or otherwise improve accuracy with respect to one or more outputs). The continuously updated and retrained artificial intelligence agents may then be applied to subsequent novel input data to generate one or more of the outputs described herein.

### Calculating Employee NPS

Once the system has collected survey responses (e.g., from employees), the system may subtract a percentage of detractors from a percentage of promoters. This calculation will yield an entity's eNPS. Keep in mind that an eNPS can be as high as a configurable maximum value (e.g., +100 (the absolute best)) or as low as a configurable minimum value (e.g., −100 (the absolute worst)). Intuitively, anything below zero may be cause for concern. Note that while the system is subtracting a percentage from another percentage, the NPS score may not be read as a percentage.

eNPS Formula

Employee Net Promoter Score=% Promoters−% Detractors

In example embodiments, passive respondents do not factor into this calculation.

### What a “Good” Score Looks Like

In example embodiments, 100 and −100 are the best and worst eNPS scores that can be generated, respectively. But entities may seldom approach anything near those scores, making them unrealistic benchmarks for the vast majority of entities.

Another question that may be asked is, what's a good score given an entity's current situation? For example, employees' likelihood to recommend an entity as a great place to work may be influenced by a multitude of factors, including some beyond the entity's control. For example, eNPS survey scores may vary significantly between cultural groups (e.g., Protestant Europe vs. Catholic Europe), absent other factors, like geography, industry, or profitability. Other factors to consider may include:
The regional and global economic climate;
Being a private versus public company;
Whether you're in the middle of a leadership overhaul; and/or
Slow versus rapid growth.

Knowing how an entity's scores compare across different departments or quarters, for example, will give a more actionable understanding of an engagement baseline and where an entity can improve.

### Surveying for Employee NPS

In example embodiments, if an eNPS question is bundled into a broader survey (e.g., an employee engagement survey), the system may make it the first question employees see. In this way, the system may maximize the chances of generating not only an accurate read on how employees feel, but potentially also detailed comments. Employee comments may be important for diagnosing company culture issues, and may be surfaced by the system in a user interface so that HR leaders and managers are able to pay particularly close attention to them.

Survey fatigue is real. If the system puts an eNPS question at the end of a survey, an individual may be less likely to provide the richness the system can collect in the form of employee feedback and comments. Additionally, getting the question out of the way early may help to mitigate the chance that other survey questions might influence how employees respond.

If you conduct pulse surveys, the system provides options for weaving eNPS into them as well. These pulse short surveys consist of a small number of questions (e.g., one to five) and can be administered as often as they are configured to be administered—e.g., month over month, bi-weekly, or even every week. While annual engagement surveys can sometimes take up to minutes to complete, these pulse surveys take just seconds, giving a consistent insight into progress.

Employee NPS Vs. Engagement

Management thinkers may seek “silver bullet” approaches to work and measuring customer loyalty. But while an eNPS score a useful tool for measuring employee satisfaction and loyalty, the system may warn against using it solely to get a read on employee engagement. After all, it's a measure of faith in the entity, not individual happiness or productivity. In that respect, it's a great metric for recruiters to track as they look to roll out or update referral programs.

eNPS may be used as a “temperature check” on employees or other individuals associated with an entity. But the system may be configured to go a step further by complementing it with more pointed questions. In this way, the system facilitates diving deeper into the issues to find the root causes. While eNPS an important metric to track, it may not tell the whole story. Thus, in example embodiments, the system may follow up eNPS questions by asking respondents to explain their scores.

Employee satisfaction may consist of one or more factors, like relationships with colleagues, quality of management, challenging and motivating projects, and/or culture. While eNPS tells companies which way the wind blows, it represents just one facet of the employee experience.

### A Holistic Approach to Surveying

In example embodiments, eNPS is provided as part of a broader employee survey strategy. For example, an eNPS survey question may be combined with questions relating to belonging, work-life balance, and/or other HR focuses.

It's hard to sum up everything the system does into just one question. The system is applicable in engagement, career development, performance management, goal setting, and/or everything else that's part of that employee lifecycle. Two questions the system may add are, “Do you believe in our CEO's vision and mission?” and “Do you believe in the direction of the company?” Questions like these go further than satisfaction and speak to employees' intrinsic motivation for coming into work.

Rather than look at eNPS as a catch-all survey question, it may be thought of as a North Star. It won't reveal all of the obstacles or treacherous seas an entity may need to overcome, but it will give insight into the general state of things. This makes it a great complement, but not a replacement, to other questions that measure employee engagement.

In addition to experimenting with different questions, the system is configured to allow administrators to test out different survey cadences. Depending on a company's needs, that may mean trying Pulse surveys, monthly questionnaires, or something completely different. In example embodiments, the system may be configured to hold engagement surveys with different topics on a quarterly basis, but it can be changed up to make sure that it is accurately capturing sentiment.

It's important to remember that this extra survey data doesn't replace eNPS. Rather, it actually empowers stakeholders to improve an entity's scores. That's a useful distinction to make when a leadership team has its heart set on measuring eNPS.

Using questions around communication, trust, and fulfillment, the system may be configured to backtrack to where employees or others think a company is falling short. The pain points the system may be configured to focus on are those that are mentioned by the passive group in the NPS breakdown. The system may be configured to isolate areas of improvement that could raise these employees' scores to that of a promoter.

### Using Technology to Track Employee NPS

The system empowers entities to run engagement surveys, collect feedback, and/or build people-first cultures. In addition to the system's customizable survey templates, the system enables measurement of eNPS.

eNPS packs a ton of insight into one question so an entity can instantly gain an understanding of its culture and/or entire employee experience. And an entity can start getting those insights immediately because implementing eNPS in a survey takes just one click via a user interface. After creating an employee survey, a user (e.g., an administrator) can simply click the toggle button on the bottom of a “questions page” to enable eNPS.

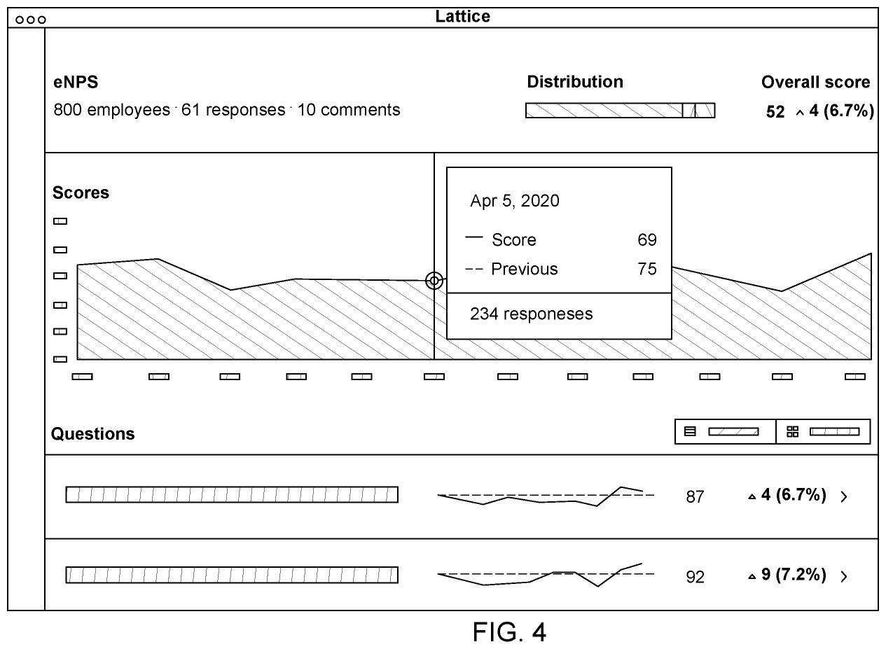

FIG. 4 is an example user interface in which employee Net Promoter Score (eNPS) data for an entity is surfaced.

Once the system begins tracking eNPS, users are able to filter the system's results by department, manager, demographics, and/or other custom attributes—giving a more comprehensive view of engagement levels and satisfaction. Users can also weave eNPS into ongoing pulse surveys, giving an up-to-date view of promoters, detractors, and/or passives. The system automatically handles the calculations and reporting based on configuration inputs.

Get to the heart of an entity's employee experience with one question. eNPS surveys may help users identify an entity's biggest promoters and/or experience detractors.

Turn every employee into a promoter. eNPS surveys may be incorporated as a part of an entity's people strategy program to understand employee advocates.

Uncover every detail about what impacts your employee experience. Learn what has the greatest impact on an entity's eNPS with detailed follow-up engagement themes.

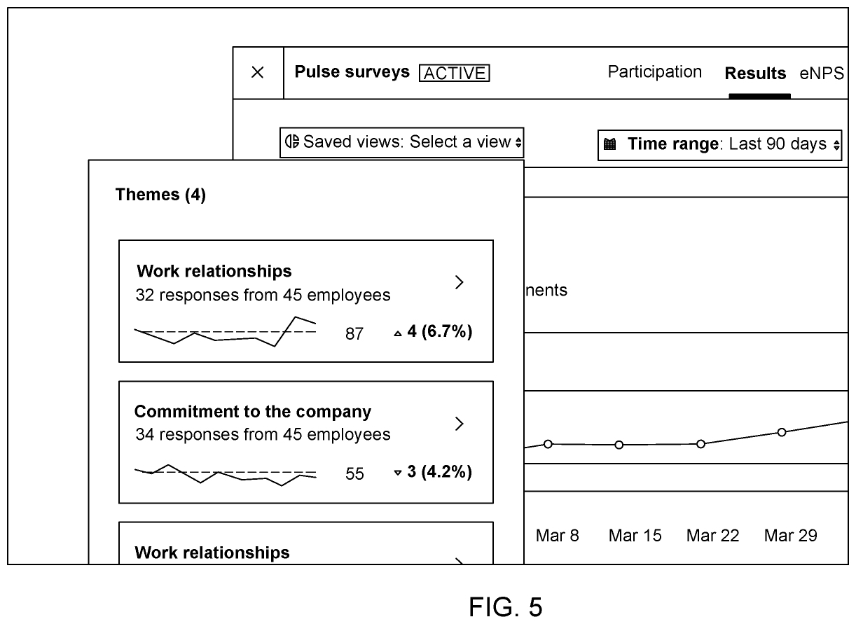

FIG. 5 is a screenshot of an example interactive user interface in which follow-up engagement themes are surfaced in a pop-up window based on an interaction with a graph of underlying pulse survey data.

Predict the future of your org. Are an entity's top performers flight risks? Is an entity's next generation of leaders detracting from the entity?

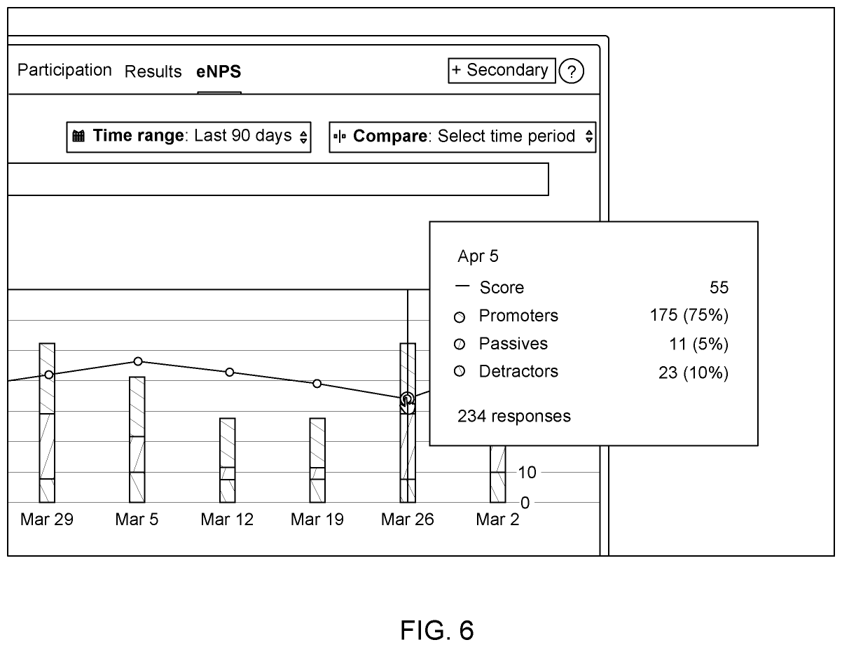

FIG. 6 is a screenshot of an example interactive user interface in which interaction with eNPS data presented in a bar graph causes information regarding promoters, passives, and detractors to be surfaced in a pop-up window

Turn employees into advocates. Use engagement survey results to identify how the employee experience can be improved to turn all your employees into promoters

eNPS, explained: Employee Net Promoter Score is a way to measure an entity's employee experience based on the concept of Net Promoter Score, which measures customer experience and loyalty.

Promoters (e.g., 9-10). These are an entity's most enthusiastic and loyal employees. They are ambassadors for the entity's brand, love their role, see a clear future with the entity, and/or likely refer strong candidates from their network to open roles.

Passives (e.g., 7-8). These employees are generally satisfied with their experience at work, but they aren't as excited about or enamored with an entity as promoters. There may be a lot of value in understanding feedback from this group to discover what can be done to move them into the Promoter category.

Detractors (e.g., 0-6). These employees are often dissatisfied and can do damage to an entity and/or brand through disengagement, apathy, and/or negativity about their roles.

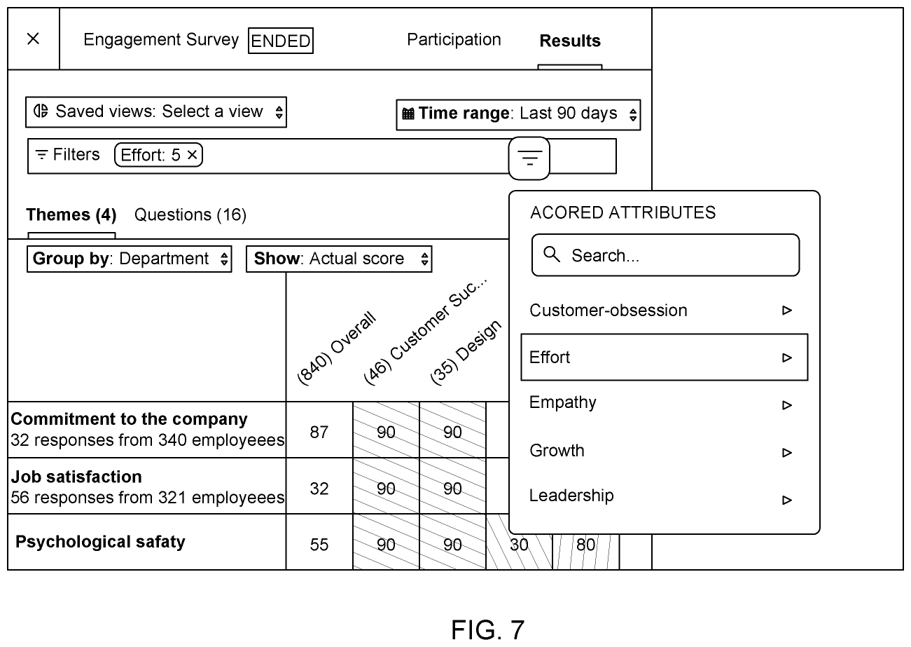

FIG. 7 is a screenshot of an example interactive user interface in which attributes associated with an individual (e.g., an employee) are surfaced in a pop-up window upon activation of a user interface element on an engagement survey results page. Such attributes may include customer obsession, effort, empathy, growth, and/or leadership.

### How to Configure Your Survey Before You Launch

To get the most out of an engagement survey and/or make the process as smooth as possible, a few things can be done before launching a survey in the system.

Determine when to Launch

Timing may be important when it comes to launching the engagement survey. As a user (e.g., a survey admin), it may be important to determine the survey launch date and duration to ensure that enough time is being given to get valuable insights from a team or one or more groups of individuals (e.g., employees).

Here are some questions to ask before creating the survey:
Will the entity do annual or quarterly surveys?
Which day of the week will the survey launch?
How long will the survey stay open?

### Set Up Employee Data

To get the most out of a company engagement survey, employee data should be kept up to date.

The default user attributes that are used in survey analytics may include:
Manager;
Department;
Start date (used to calculate tenure);
Birthdate (used to calculate age); and/or
Gender (male, female, or non-binary)

In addition to the default attributes that the system offers, users can also create custom attributes to capture information that the system does not already store. For example, if a user knows that they want to analyze survey data by office or level, the user can create some custom user attributes for that information.

Note: in example embodiments, selecting (e.g., via a user interface) to include “All employees” as participants of a survey will include all active, invited, and created state users. This means that a survey can be launched, and any users who are either invited or created will be prompted to fill out the survey when they activate their system account. Invited users will receive a launch notification, but created users will not receive the launch notification.

An additional step of the engagement survey process is deciding which questions to ask.

To that end, the system offers a question bank. The questions included in the question bank are proven to work well for any entity looking to run a general engagement survey. Users can also add their own custom questions to the survey if you wish.

In example embodiments, the questions written should fit the Likert scale response format (e.g., strongly disagree, disagree, neutral, agree, strongly agree) or be open-ended. Here are a few tips to keep in mind when creating questions:
Use direct, simple questions that are neutral and unambiguous. And remember, it's important to frame questions positively, for example, “I am happy to come to work every day.”
When choosing which questions to ask, ask only about topics an entity is prepared to act on. If asking about things that can't actually be changed or improved upon, an entity end up with some very disappointed employees should the results show strong opinions on those questions.
For rating questions, it's also important to write the questions so that responding with “strongly agree” is a positive response to match the system's analytics format.

### Communications

Ensure that you have a communications plan for why the entity is running the survey and the plan of action for the survey results.

Draft an email communication that addresses.
Why the entity is running the engagement survey
When responses need to be in by
How the data is being analyzed
When the results will be shared
What action will be taken from the results

### Engagement Survey Permissions

In example embodiments, all superuser accounts of the system have access to a surveys tool. Administrators have complete control over any survey they create. Administrators can customize the settings, launch the survey, manage and end the survey, and view all results.

However, in example embodiments, admins won't have access to surveys that that they didn't create (e.g., unless this default is overridden). For example, despite a first admin having super admin permissions, if a second admin creates a survey, the second admin's survey won't be visible to the first admin in the administrative user interface.

In example embodiments, to give other users admin access to a survey, admins need to add them as a survey admin while they are configuring the survey questions. Admins can add any user as a survey admin. If an admin makes a non-super admin a survey admin, it only gives them the ability to see and manage that one specific survey. It doesn't provide them with access to any other admin-only features.

Note: In example embodiments, managers and employees do not have access to survey results or participation. To share results with a manager, admins may create a survey shared view.

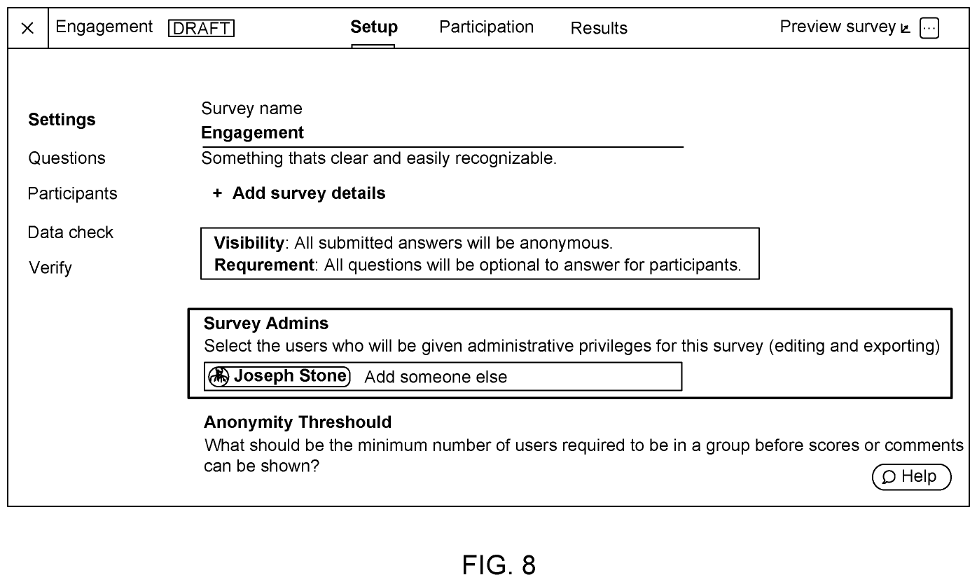

FIG. 8 is a screenshot of an example user interface for specifying pulse survey admin.

### Pulse Survey Permissions

In example embodiments, unlike engagement surveys, all super admins have full access to pulse. You do not need to be a pulse admin to help manage pulse or view your pulse results if you're a super admin. You can add any user as a pulse admin. If you make a non-super admin a pulse admin, it only gives them the ability to see and manage pulse. It doesn't provide them with access to any surveys or other admin-only features.

Note: Managers and employees do not have access to pulse survey results or participation. To share results with a manager, you may create a pulse shared view.

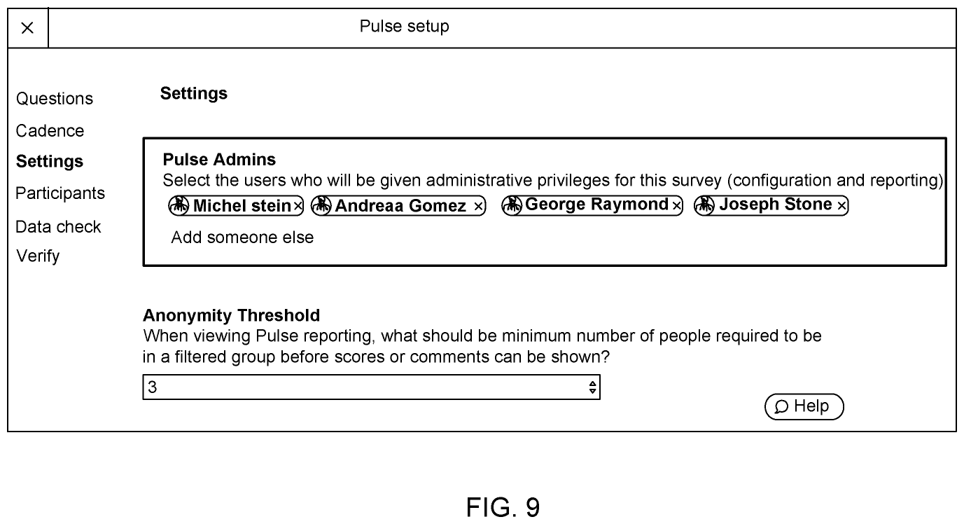

FIG. 9 is a screenshot of an example user interface for specifying administrators of a pulse survey.

### Creating a Survey

To start setting up your first survey, navigate to an admin page from a discovery navigation tool within the user interface, and then click on a user interface element (e.g., “Surveys” from the left secondary navigation). From there, click a user interface element (e.g., “Create new survey” button) to create the survey.

### Designing Your Survey

### Settings

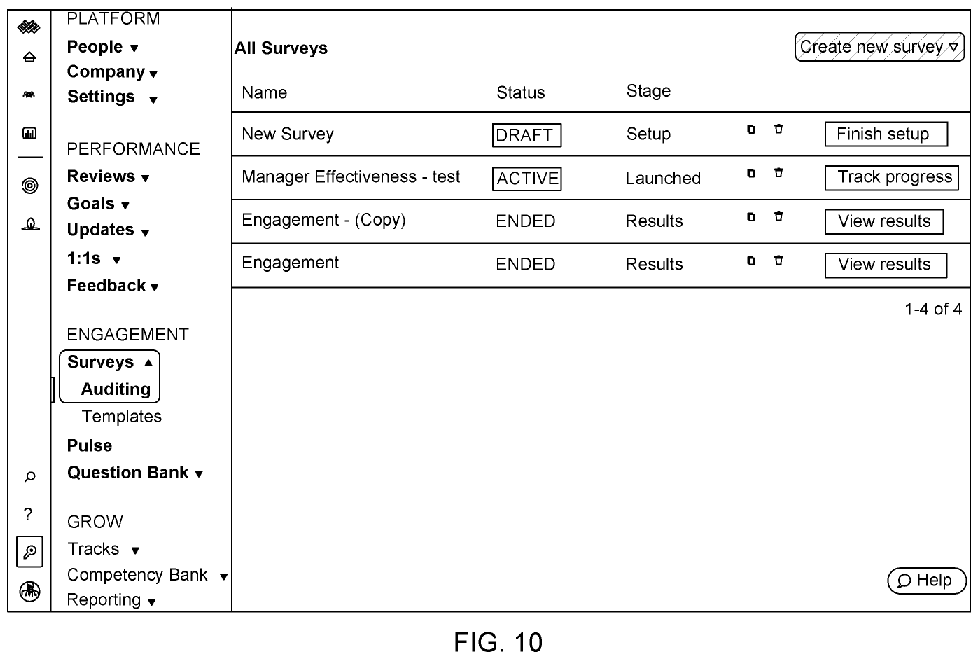

FIG. 10 is a screenshot of an example user interface for viewing existing surveys and creating new surveys.

When creating your survey, there are just a few settings to configure:

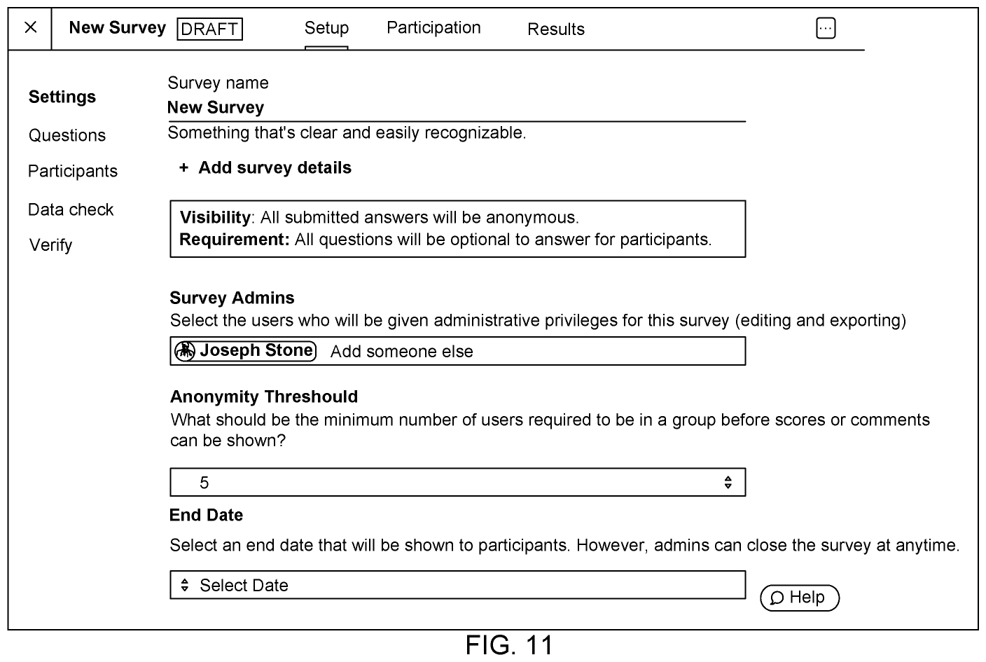

FIG. 11 is a screenshot of an example user interface for configuring a survey.

### Name

Give your survey a name that's specific so that down the line, you can easily find it again. We recommend having the type of survey and the date in the name, for example, “Employee Engagement, July 2018”.

### Survey Details

Survey details help provide employees a brief description or instructions to help them respond to the survey. For example, you can link to outside resources that give participants a better understanding of their expectations. You can also use the description to clarify language, such as a callout to keep their direct supervisor in mind whenever a question references the word “manager”. Remember to keep it brief; longer descriptions have the potential of increasing bias. Survey details will be shown to all participants before starting the survey and are accessible throughout.

### Survey Admins

Employees that are survey admins can configure survey settings and have full access to the anonymized results. You can set admins on a per survey basis. This means that any employee can be an admin of a survey without having administrative access to other parts of the system (reviews, private feedback, etc.), including other engagement surveys. You can come back to this step even after your survey has launched to add or remove any survey admins.

### Anonymity Threshold

This threshold sets the minimum number of responders needed to view the scores for a question or theme. The threshold protects all responders by providing an additional layer of anonymity.

### End Date

This is the date communicated to survey participants regarding when the survey will end. In example embodiments, the survey will not automatically be closed on this date; a survey admin will need to manually end the engagement survey. Both admins and survey participants who have not submitted their survey will be sent a reminder (e.g., two days before this end date). We recommend setting an end date a couple of days before when you want the survey to end. You can also come back and change this date after your survey launches.

The first step (and one of the most important steps) of the engagement survey process is deciding which questions you're going to ask.

The surveys come with a question bank. The questions in the question bank were selected through careful study to work well in any organization looking to run a general engagement survey. If you wish, you can also add your own custom questions to the survey.

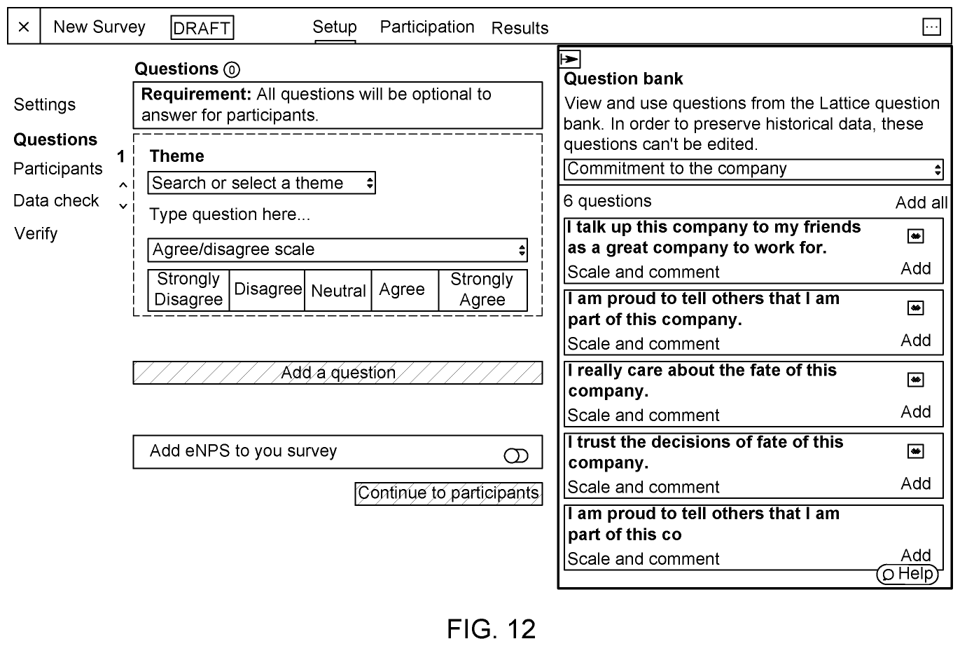

FIG. 12 is a screenshot of an example user interface for specifying survey questions and/or selecting questions from a survey bank to include in a survey.

### Participants

Choose who you want to fill out your survey. We recommend selecting everyone in your company, but you can also select a specific subset of employees to participate. By clicking “Specific Employees,” you can use the filter to select/bulk select and add participants of departments, reporting relationships, or custom attributes. Alternatively, you can also upload a CSV with participants.

Note: Selecting “All employees” as participants of a survey will include all active, invited, and created state users. This means that you can launch a survey, and any users who are either invited or created will be prompted to fill out the survey when they activate their system account Invited users will receive a launch notification, but created users will not receive the launch notification.

### Data Check

User attributes are used to separate your survey results, which are based on employee data as it exists at the time of launch. It is important to double-check your data to get the most accurate insights.

For deactivated users: If employees were active at the time of creation (not publishing) and then were deactivated, they will continue to appear in the data check if they originally were missing attributes. However, the archived employees will not be sent a survey.

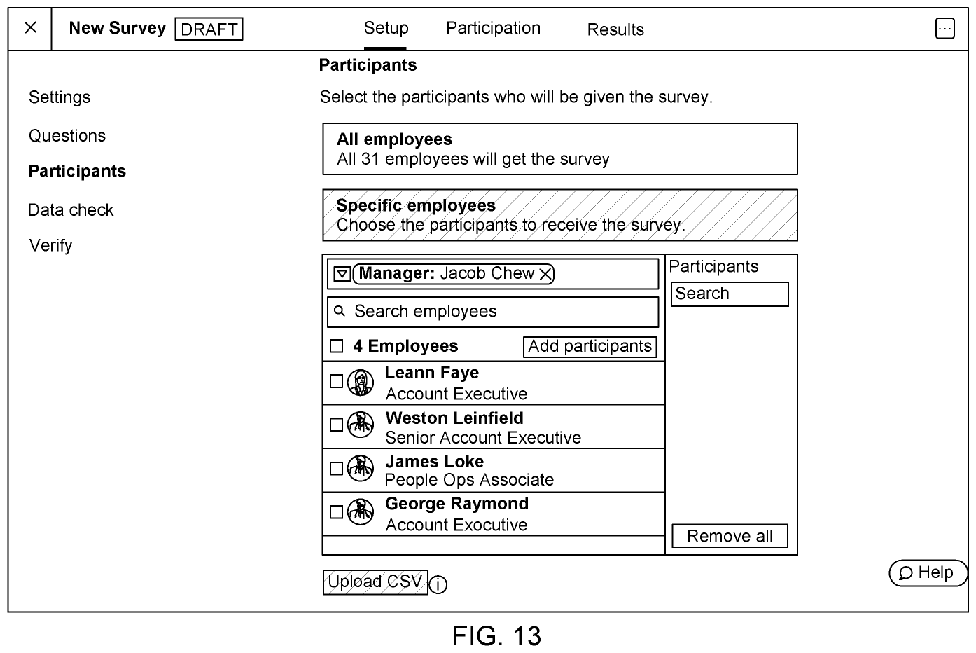

FIG. 13 is a screenshot of an example user interface for specifying participants for a survey.

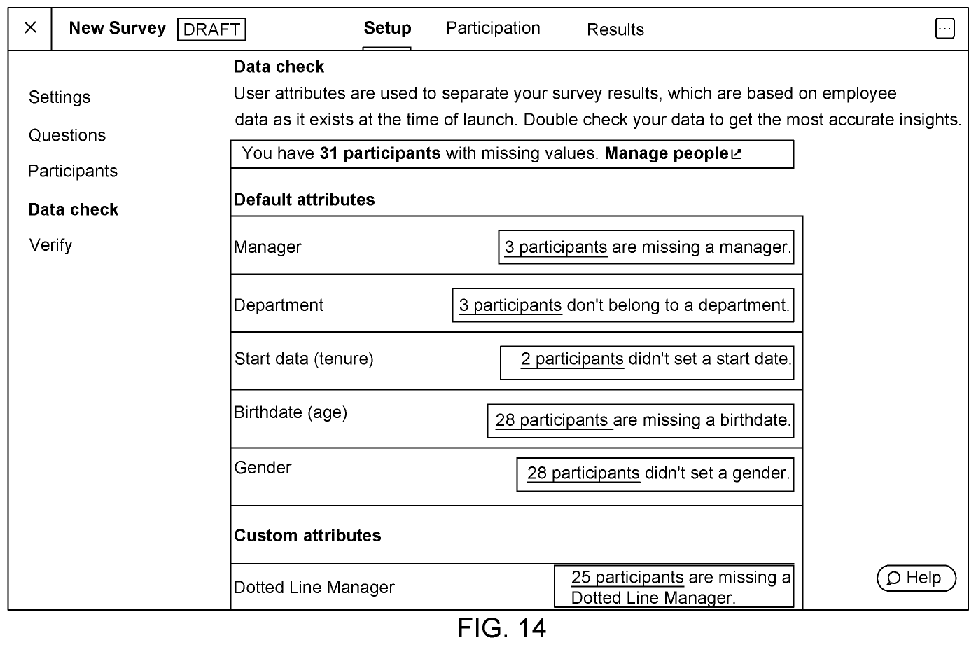

FIG. 14 is a screenshot of an example user interface for specifying default attributes and/or a data check for a survey.

### Verify

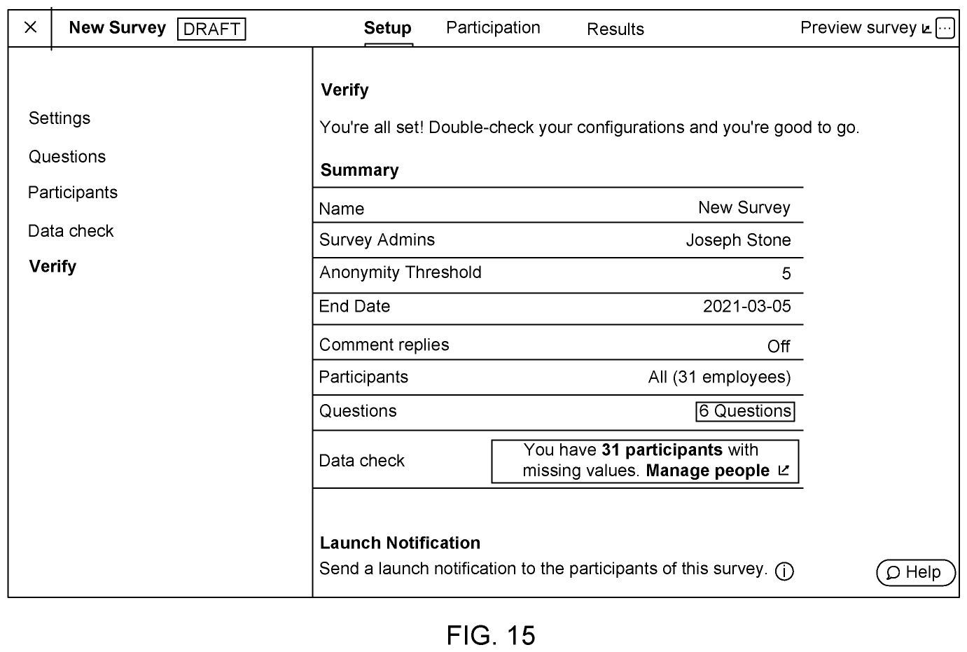

Verify that your settings are correct. Here you will have the opportunity to draft an email communication that addresses:
Why you're running the engagement survey
When responses need to be in by
How the data is being analyzed
What action will be taken from the results
   FIG. 15 is a screenshot of an example user interface for verifying a survey configuration.

### Launching Your Survey

After you launch a survey, the survey may substantially immediately start collecting responses. If you choose to send a launch email through the system, it may also include a link to all responders to the survey form and create a task for them on the user's homepage. If you choose to skip sending the email through the system, users will still get a task in the system linking them to the survey.

If you are running a survey in the system, you may want to create your own questions that are more specific to your own company. Questions are created during the survey creation flow.

Step 1: When creating your survey, in the questions part of the setup flow, click “Add Question.”

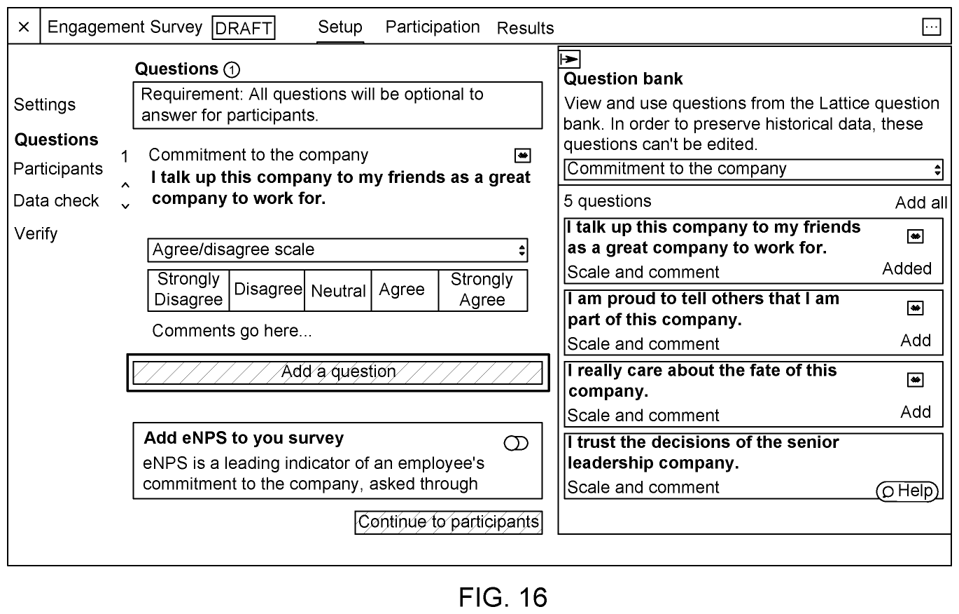

FIG. 16 is a screenshot of an example user interface for adding questions to a survey.

Step 2: Add a theme to your question, and it will automatically be added to your survey.

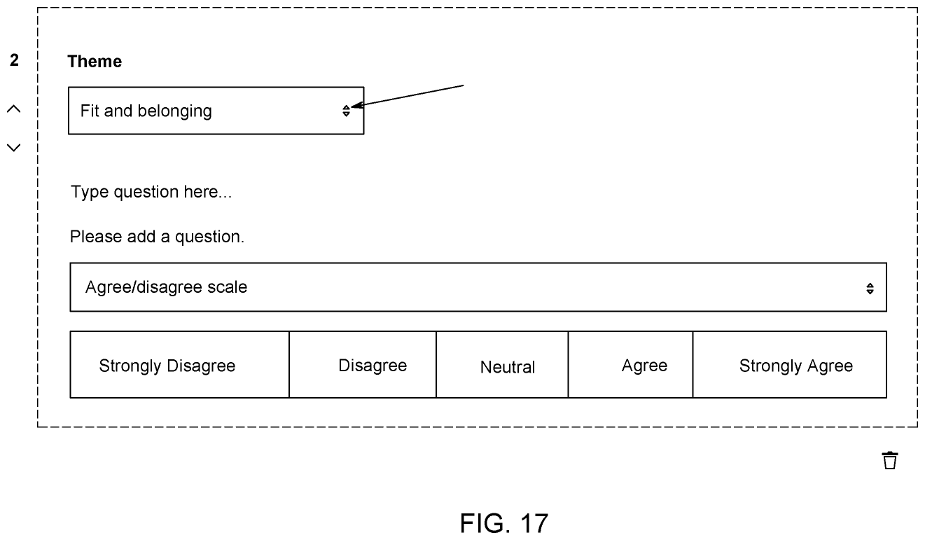

FIG. 17 is a screenshot of an example user interface for adding a theme to a survey.

Step 3: Type in your question.

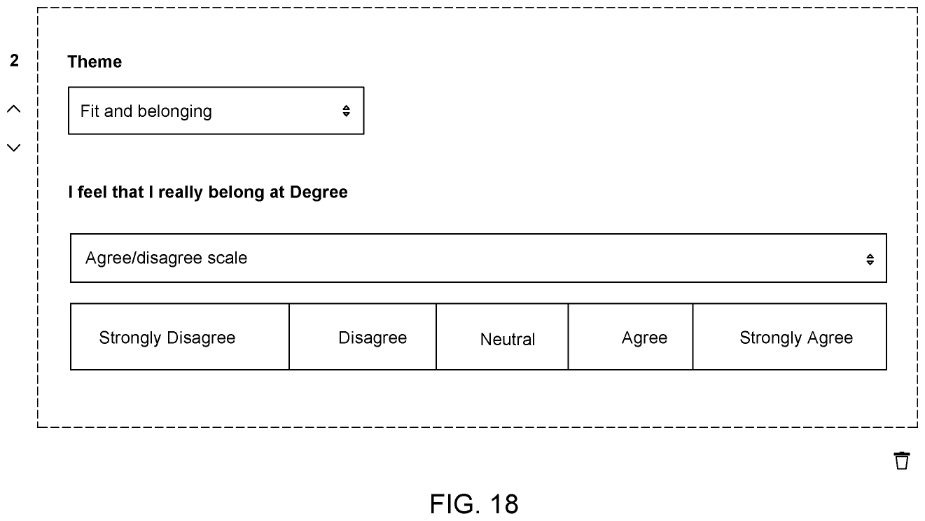

FIG. 18 is a screenshot of an example user interface for inputting a question for a survey.

Step 4: Select the type of question you would like to create.

Currently, when creating your own questions, you can choose between three options:
Agree/disagree scale
Comment
Agree/disagree scale and comment

Please note: If using the agree/disagree scale to measure employee responses properly, your questions should be phrased as a positive statement.

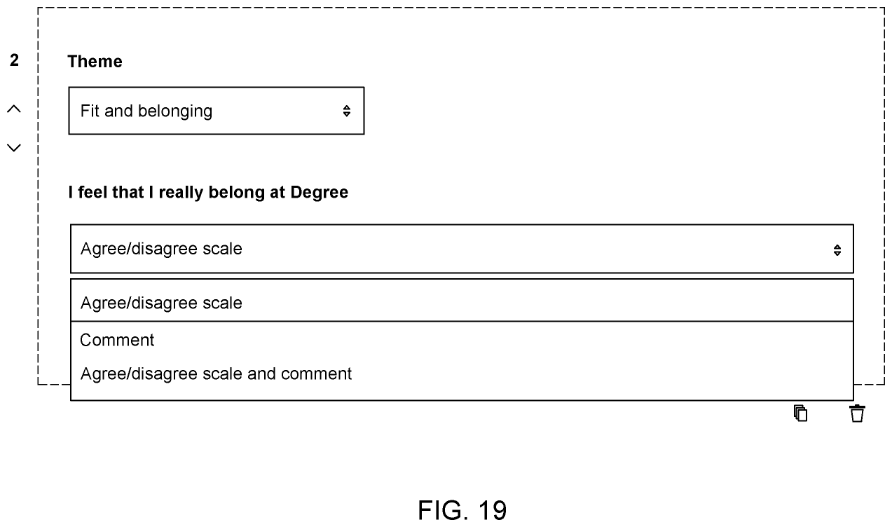

FIG. 19 is a screenshot of an example user interface for selecting a type for the question.

Admins can duplicate a previous engagement survey to make setting up a new survey simple.

Duplicated surveys duplicate the following setup customizations from the previous survey:
Survey name
Survey admins
Questions

### Duplicate an Engagement Survey

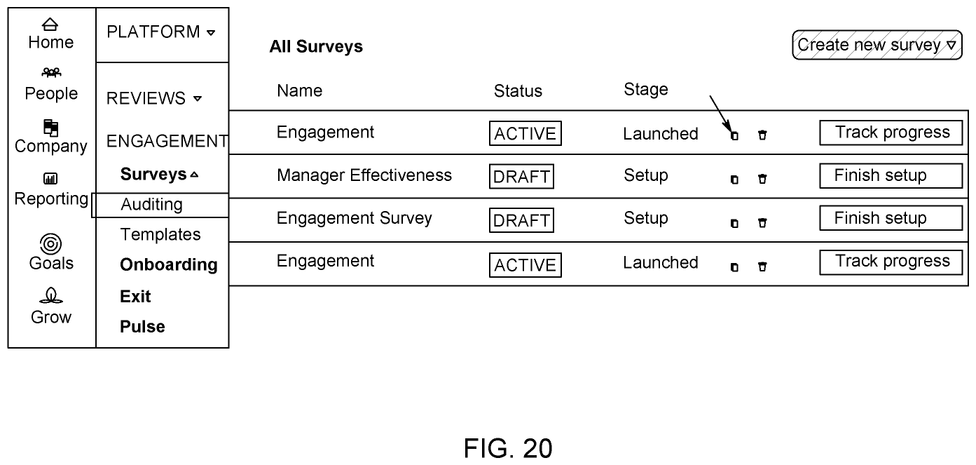

1. Navigate to Admin>Engagement>Surveys>Auditing.
2. Select the duplicate icon next to the desired survey to duplicate.
3. Customize the survey with the desired setup.
   FIG. 20 is a screenshot of an example user interface for duplicating an engagement survey.

### Measuring Engagement Through Employee Net Promoter Score

eNPS (employee Net Promoter Score) may be one of the simplest and fastest ways for companies to measure employee loyalty and predict the future of their company. This metric acts as a leading indicator for employee outcomes like productivity and retention and helps HR teams uncover the most actionable steps to improve their employee experience.

eNPS packs a ton of insight into one question so you can instantly gain an understanding of your culture and entire employee experience. You can start getting those insights immediately because implementing eNPS in your next survey takes just one click.

Adding eNPS to Your Survey

After creating a survey, click the toggle button on the bottom of the Questions page to enable eNPS.

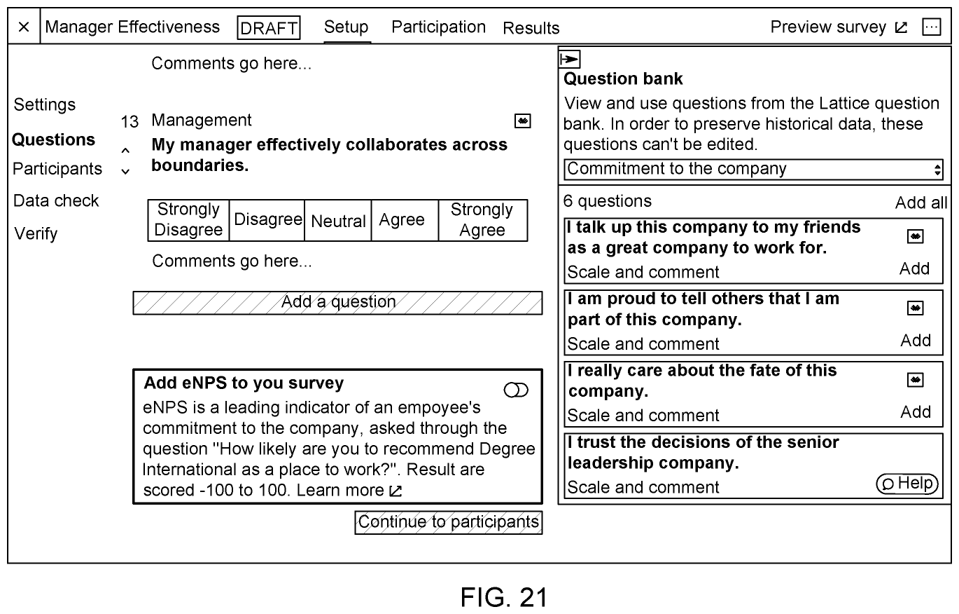

FIG. 21 is a screenshot of an example user interface for enabling eNPS for a survey.

After clicking the toggle button, the system will add an eNPS question (e.g., “How likely are you to recommend [Company Name] as a place to work?”) to your survey. This question may be measured on a scale of 0 (Not very likely) to 10 (Very likely) and may include an optional open-ended comment box.

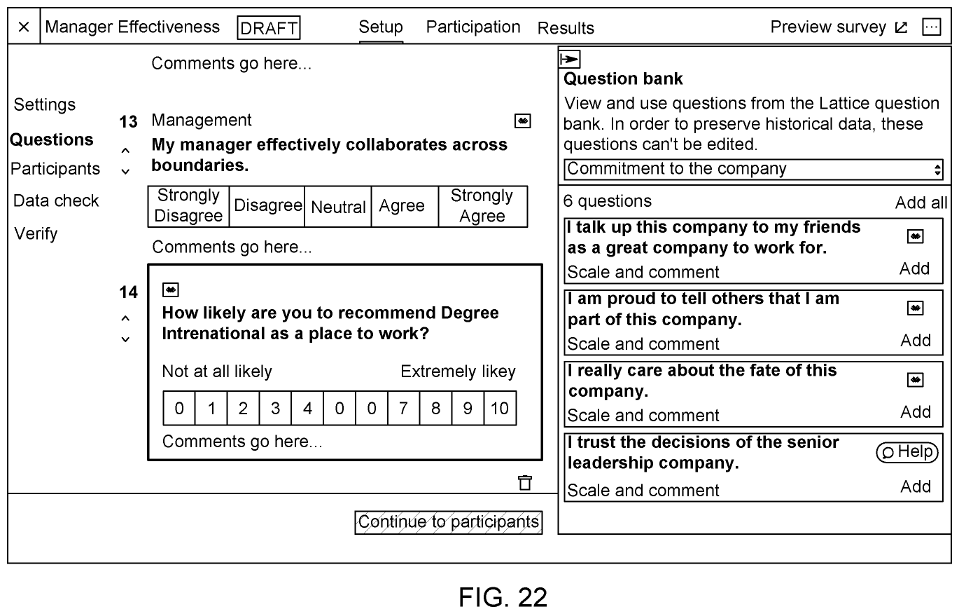

FIG. 22 is a screenshot of an example user interface for configuring a survey question

How this Appears to Survey Respondents

When filling out an eNPS survey, system users will see the question “How likely are you to recommend [Company] as a place to work?” with a 1-10 scale.

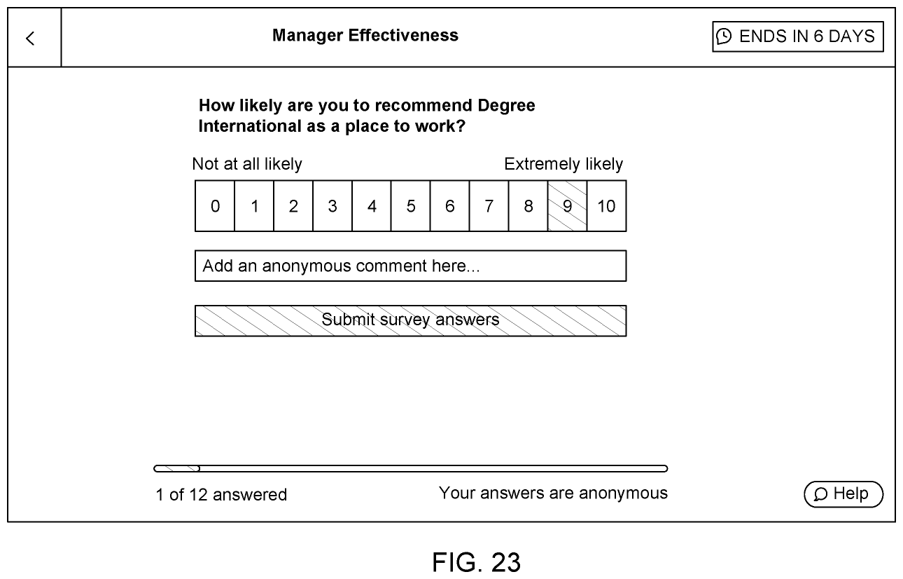

FIG. 23 is a screenshot of an example user interface for viewing a survey question as it will appear to survey respondents.

### Viewing Survey Results

When viewing your survey results, the eNPS question may appear at the top of both the question and theme lists separate from the rest of your themes and questions.

Click into the eNPS question to see the breakdown of promoters, passives, detractors, and any comments.
Promoters are response scores 9-10.
Passives are response scores 7-8.
Detractors are response scores 0-6.

To calculate eNPS, we take the percentage of your employees who are promoters and subtract the percentage of employees who are detractors.

Your result is measured on a scale from −100 to 100.

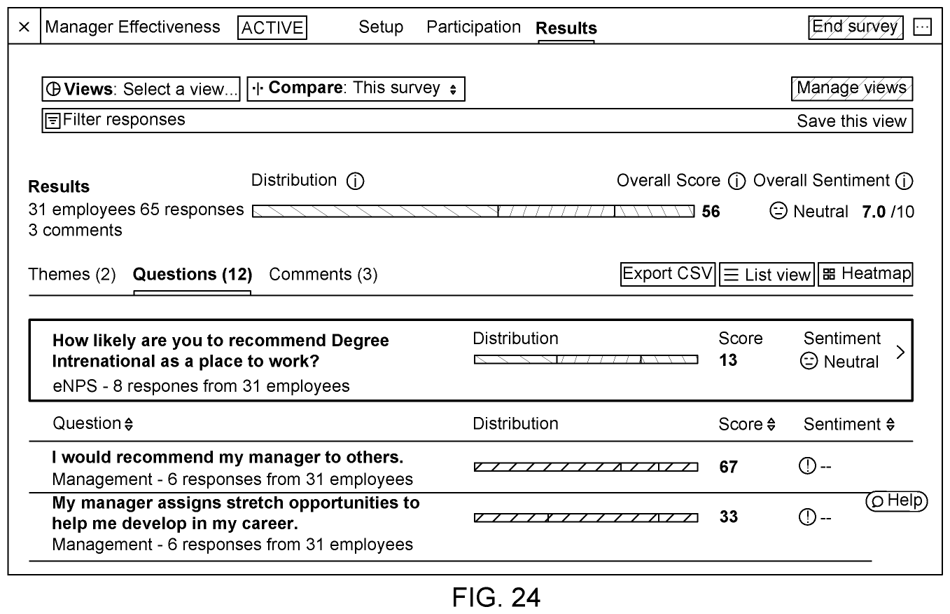

FIG. 24 is a screenshot of an example user interface for viewing results of a survey question.

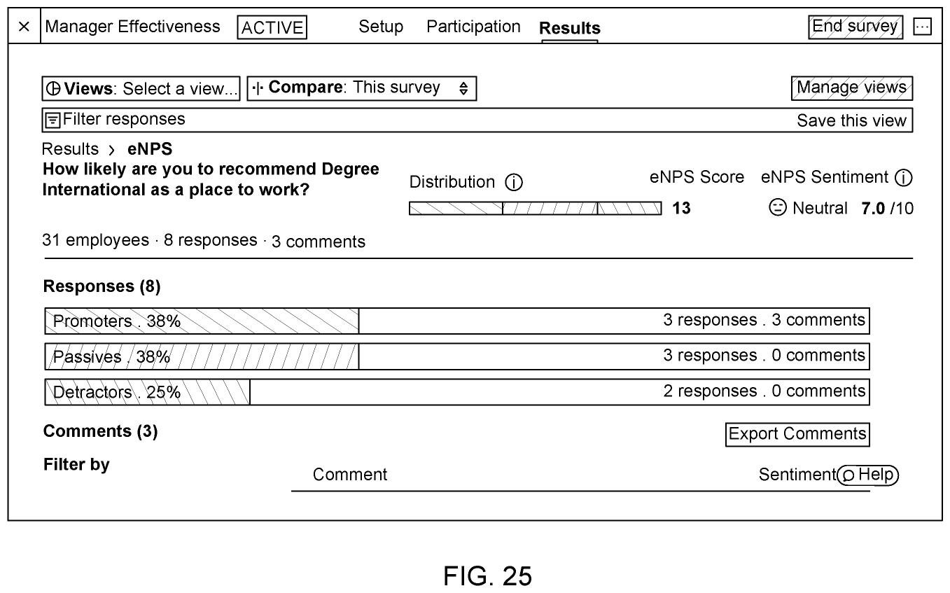

FIG. 25 is a screenshot of an example user interface for viewing an eNPS breakdown for responses to a survey question.

### Are My Responses to Surveys & Pulses Really Anonymous?

As a participant in a survey or pulse, your answers will be completely anonymous. The system may remind each participant of this at the start of the survey and the bottom of the survey, and at the top of the pulse question.

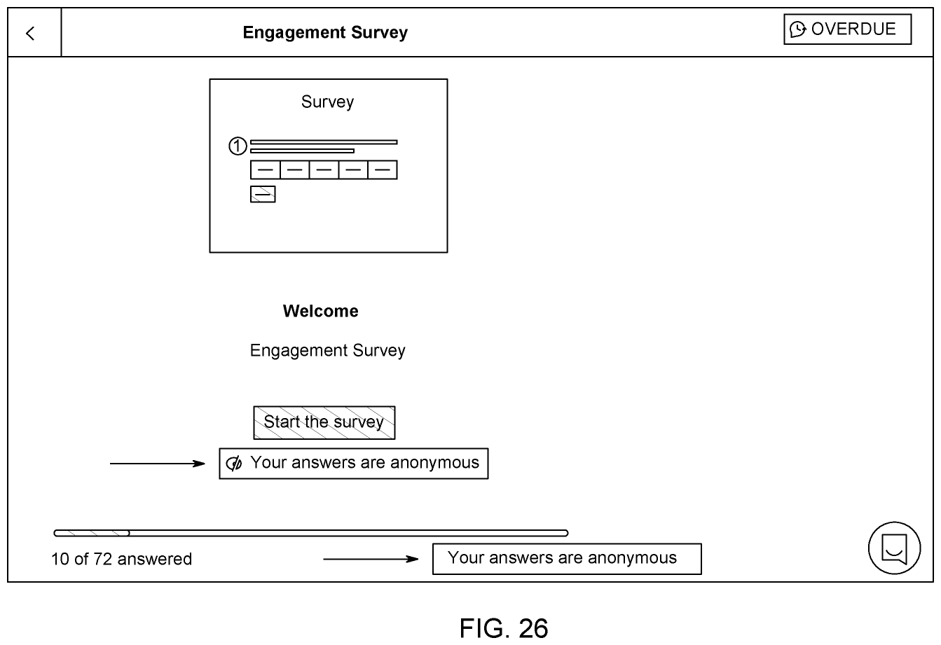

FIG. 26 is a screenshot of an example user interface for an engagement survey welcome screen.

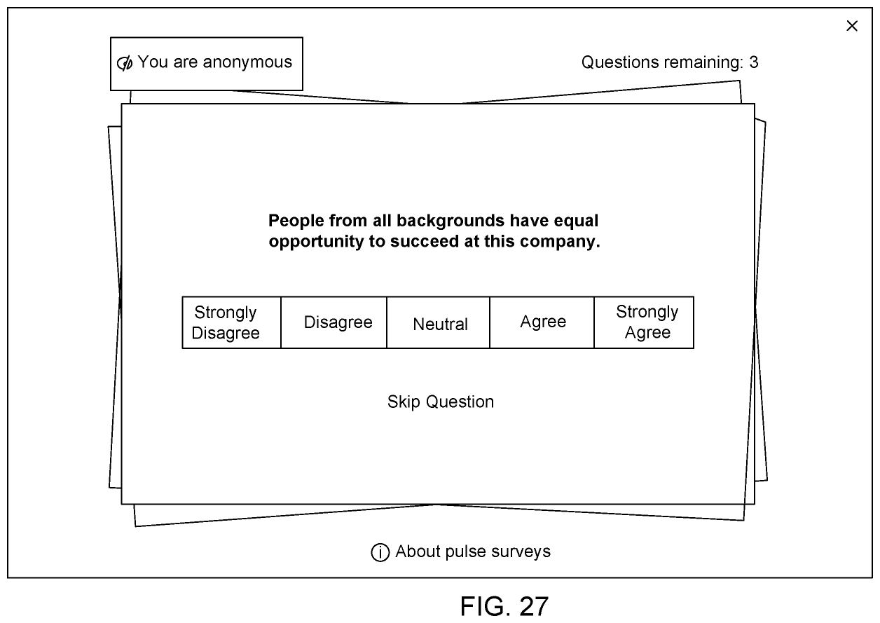

FIG. 27 is a screenshot of an example user interface for an engagement survey including an anonymous indicator.

### How do I Know My Responses are Anonymous?

The system may be configured to care deeply about survey respondent users' privacy, confidence, and anonymity. Due to this, individual survey responses may never be available in reporting—only aggregate scores may be viewable. This means that scores and comments may be abstracted from the survey record and cannot be identified back to an individual response or the person who submitted it.

Additionally, to ensure participants' anonymity, a minimum number of employees (e.g., three employees) must answer a question for results to be revealed to the admin. Admins will have the option to raise the anonymity threshold for their organization; however, it can never be lower than this minimum number.

### Setting the Anonymity Threshold in Engagement Surveys

When setting up your survey, you will be able to adjust the anonymity threshold. This threshold sets the minimum number of responders needed in order to view the scores for a question or theme.

When adjusting this threshold, it is important to take the demographic makeup of your organization and the privacy of the participants into account. While setting a lower anonymity threshold (e.g., 3 or 4) may help you view data for smaller groups, it may make participants feel vulnerable and keep them from answering the survey honestly. However, if you are trying to view data for a team that only has 3 members, having a lower threshold will allow you to more easily view the team data.

Surveys in the system default the anonymity threshold to 5. To adjust this threshold, follow these steps:

Step 1: When creating the survey, click on “Settings” on the left.

Step 2: Under “Anonymity Threshold” click on the drop-down arrow.

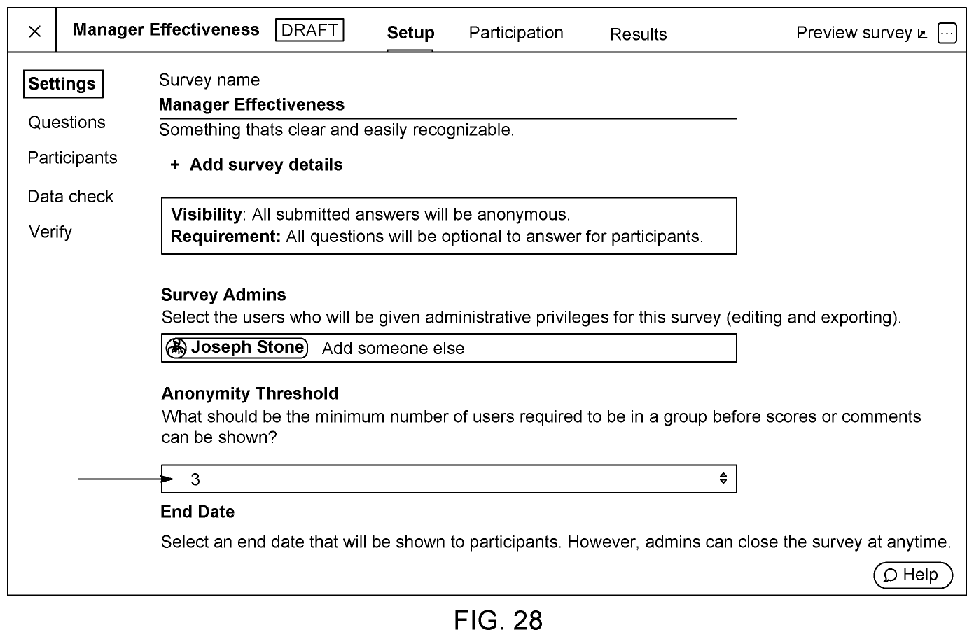

FIG. 28 is a screenshot of an example user interface for setting up a survey, including an anonymity threshold.

Step 3: From the drop-down, choose the minimum number of users required in a group before scores/comments are shown. You can choose a minimum of 3 and a maximum of 10.

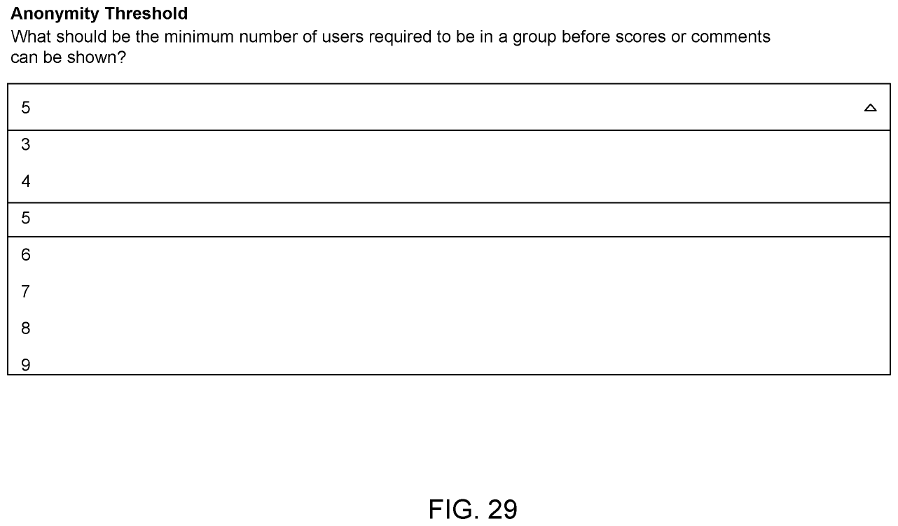

FIG. 29 is a screenshot of an example user interface for selecting an anonymity threshold.

Note: You can edit the threshold at any point, even while the survey is active or after it has ended.

### Setting up Custom Survey Groups

For anonymity purposes, to see survey results of a group of employees, you'll need at least the minimum number of people. However, let's say you want to see survey results for a specific group, and there aren't enough employees in that group to do so. The system allows you to create custom attributes to help combine different groups that may be too small individually to meet this threshold.

For example, let's say the Sales and Marketing departments each have 2 employees. You might want to group those departments together, so you're able to see the new group's survey results.

Please note: Survey groups need to be created before a survey is launchedfor the attribute to be pulled into results.

### How to Create a Survey Group

Step 1: Navigate to the admin page found at the bottom of the discovery navigation.

Step 2: Enter the “People” section in the secondary navigation and select “User attributes.”

Step 3: Click “Create custom attribute.”

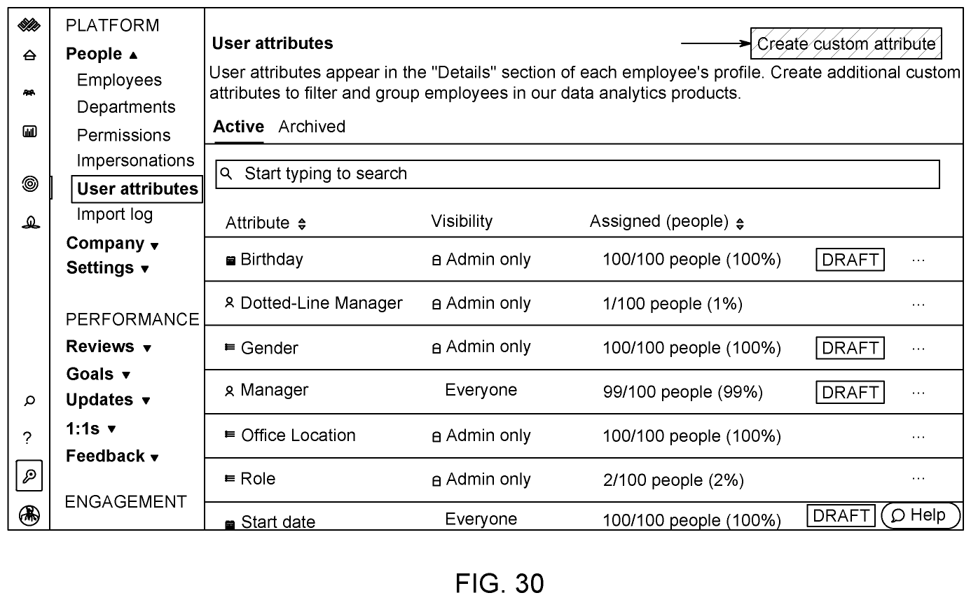

FIG. 30 is a screenshot of an example user interface for managing user attributes, including active and archived attributes.

Step 4: Fill out the “Create new custom attribute” pop-out.

Choose “Multiple Choice”>Name the custom user attribute >Select the visibility>Enter the survey group names under “Options,” e.g., “Sales and Marketing”>Repeat for other survey groups >Click the “Add attribute” button.

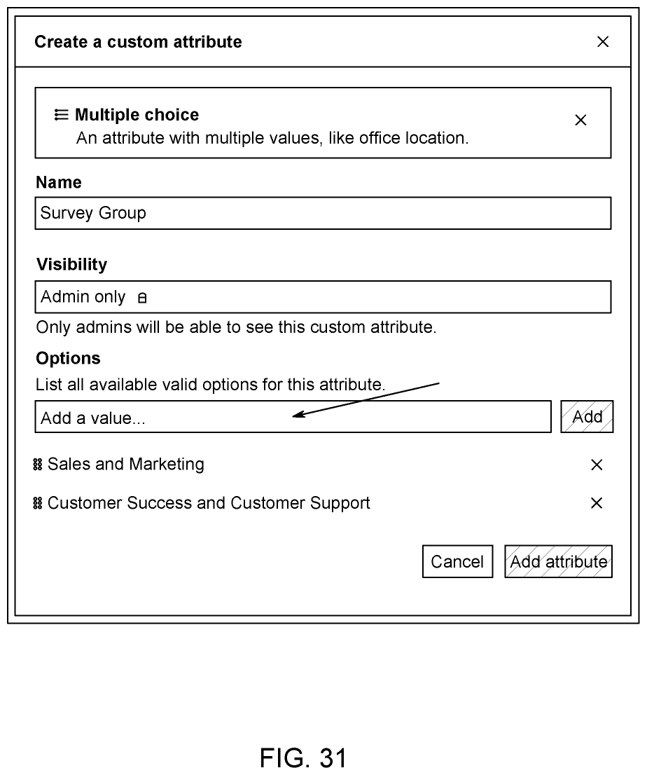

FIG. 31 is a screenshot of an example user interface creating a custom attribute, including specifying available valid options for the custom attribute.

Step 5: Put employees into your new custom attribute in the employees' profiles or CSV upload.

Go into the employee's profile and choose the survey group from the “Survey Group” dropdown.

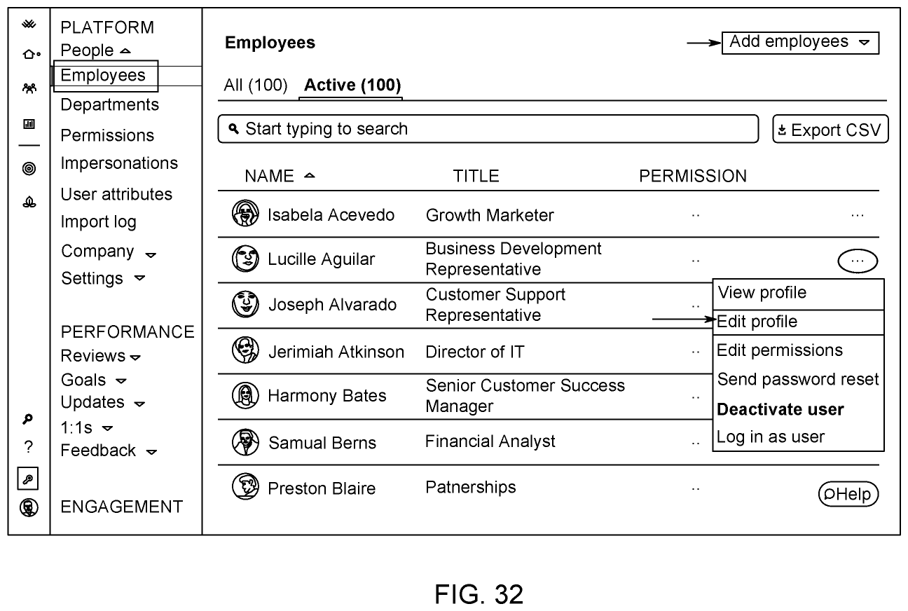

FIG. 32 is a screenshot of an example user interface for managing employee profiles.

Or you can download your company CSV to fill out the new attribute and then re-upload.

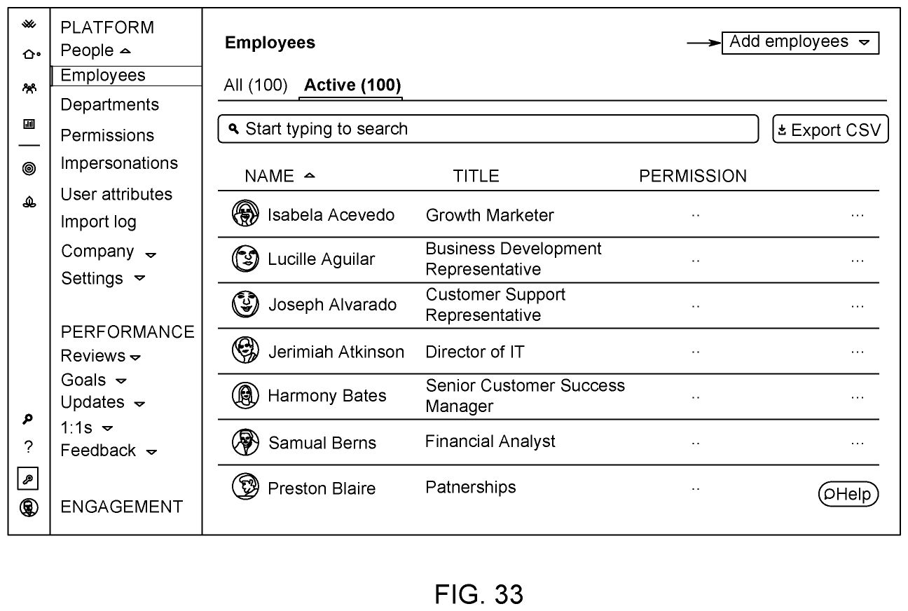

FIG. 33 is a screenshot of an example user interface for managing employees, including a user interface element for adding employees.

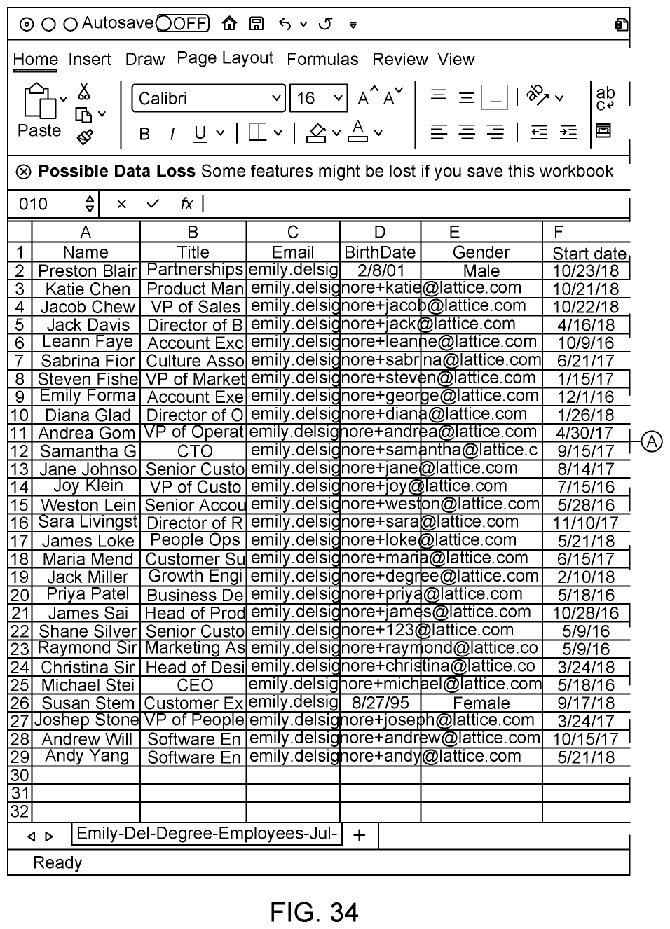

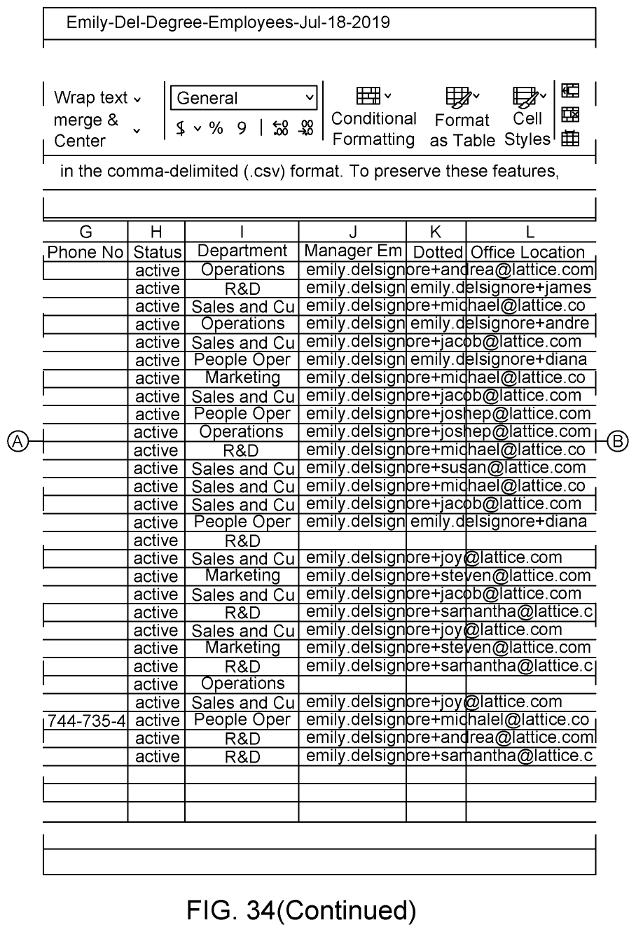

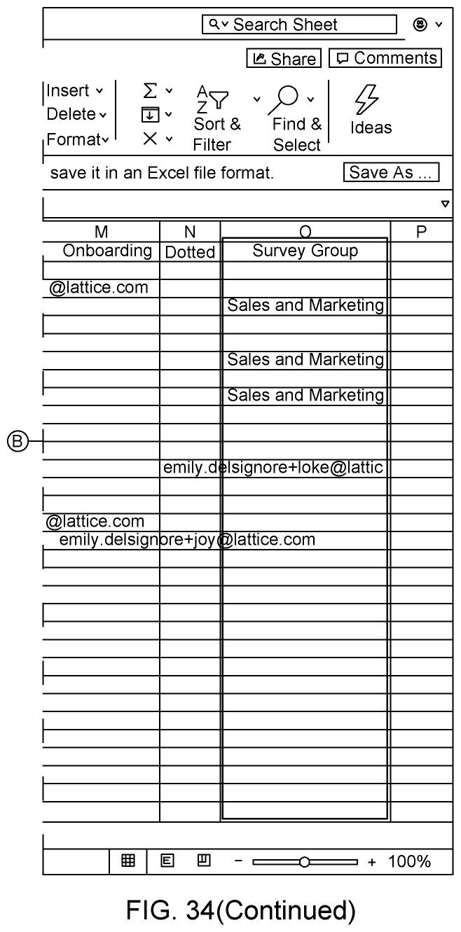

FIG. 34 is a screenshot of an example user interface for specifying employees in a spreadsheet (e.g., .csv) form.

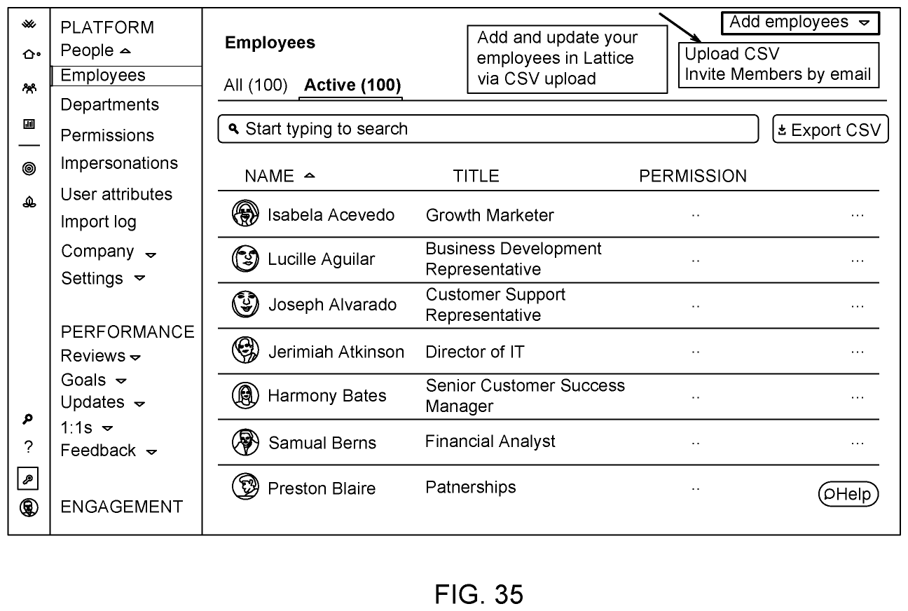

FIG. 35 is a screenshot of an example user interface for adding employees in bulk (e.g., from a spreadsheet).

Step 4: Run your survey and then group results by your custom attribute.

In this example, we will use the custom attribute of “Survey Groups” to group results for the Sales & Marketing and Customer Success & Customer Support.

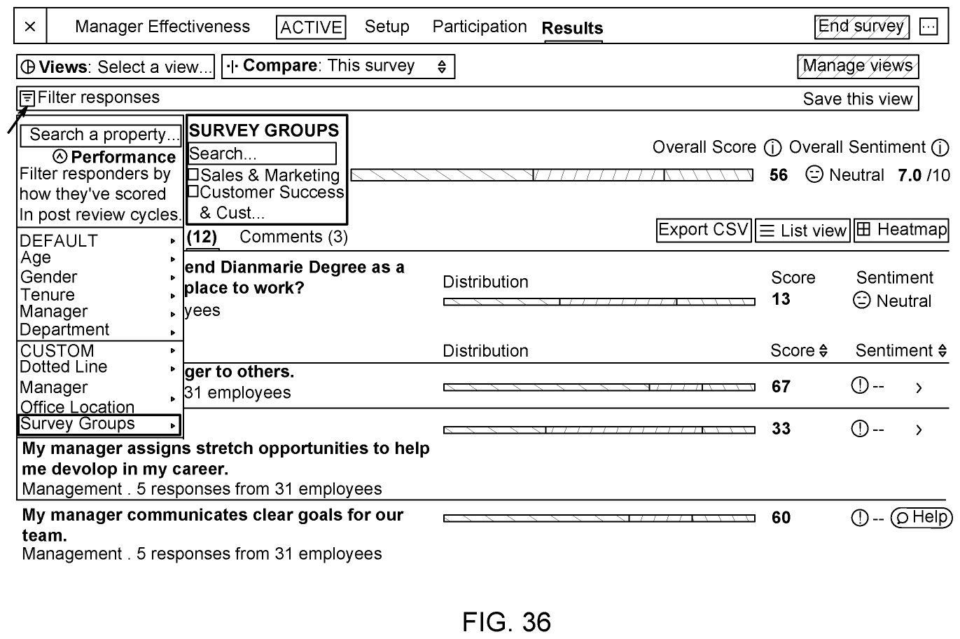

FIG. 36 is a screenshot of an example user interface for managing survey groups.

### Overview of Pre-made Survey Templates: Engagement, Team Effectiveness, Diversity and Inclusion, and Manager Effectiveness

The system may offer survey templates you can use when setting up your survey. In example embodiments, the questions in these templates are developed in partnership with the one or more academic institutions. In example embodiments, each of the questions are rated on a Likert scale (strongly disagree, disagree, neutral, agree, and strongly agree) unless otherwise noted.

### How to Create a Survey Using System Templates

To use any of the system survey templates, navigate to Surveys from the admin panel, and click on “Create a new survey.” From the drop-down menu, you will be able to view all of the templates the system offers. You will also be able to create your own survey.

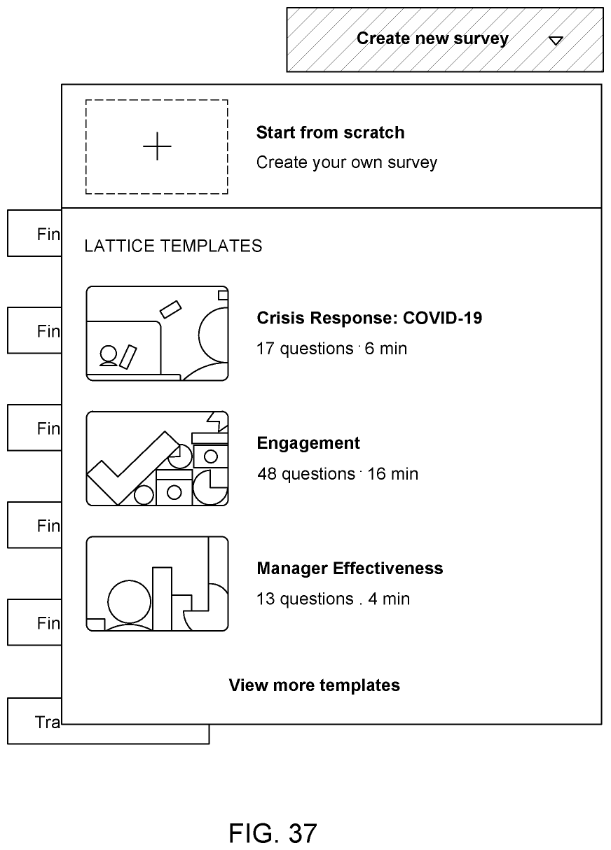

FIG. 37 is a screenshot of an example user interface for creating a new survey (e.g., from scratch or from a template).

### What Templates do we Offer?

Each of the templates focuses on a specific theme and measures certain attributes: e.g., engagement, team effectiveness, diversity and inclusion, and/or manager effectiveness.

### Engagement

This survey is designed to give companies a broad understanding of the factors that drive employee engagement.

What does this engagement survey measure? Examples include the following:
Management
Engagement
Work relationships
Feeling valued
Team culture
Open-ended
Self-efficacy
Fit and belonging
Job satisfaction
Commitment to the company
Psychological safety

### Team Effectiveness

As more work is done by teams, it's important to make sure that teams within your organization are performing at their best. This survey is designed to assess how safe people feel taking risks on a team, as well as how effectively the team learns and improves as a whole.

What does this team effectiveness survey measure? Examples include the following:
Psychological safety
Team learning

### Diversity and Inclusion

Having a diverse and inclusive culture is critical for companies that want to grow and thrive in the modem business environment. This survey is designed to give companies a sense of how people feel around the diversity level of an organization but also takes it a step further to probe how included people feel within the environment.

What does this diversity and inclusion survey measure? Examples include the following:
Diversity climate
Feeling valued
Fit and belonging
Psychological safety
Fairness
Open-ended

### Manager Effectiveness

Managers have a massive impact on the engagement and retention of their direct reports. This survey does a check on how people are feeling about their managers across all fronts.

What does this manager effectiveness survey measure? Examples include the following:
Management

### Crisis Response Survey

During uncertain times, it is important to continue to gauge how your employees are feeling. This survey allows you to quickly gather feedback and act on that information.

What does this crisis response survey measure? Examples include the following:
Enablement
Well-being
Communication
Manager support
Leadership
Work relationships
Motivation
Commitment to the Company

As an admin, you may want to preview a survey before it is launched. To do so, follow the steps below:

Step 1: Navigate to the admin page found at the bottom of the discovery navigation. Under “Engagement”, click into “Surveys”>“Auditing.”

Step 2: Select the survey that you wish to preview.

Please Note: You can only preview a survey if the survey is a draft. Once the survey is active, you can no longer preview it.

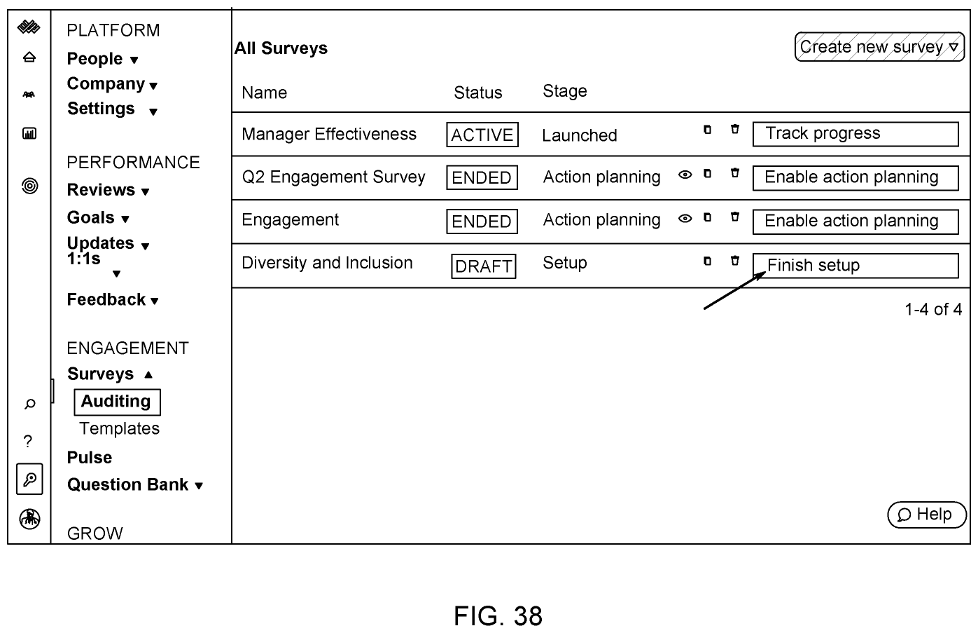

FIG. 38 is a screenshot of an example user interface for performing a next action with respect to each of a list of surveys, such as tracking progress, enabling action planning, or finishing setup.

Step 3: On the right-hand side of the page choose “Preview survey.”

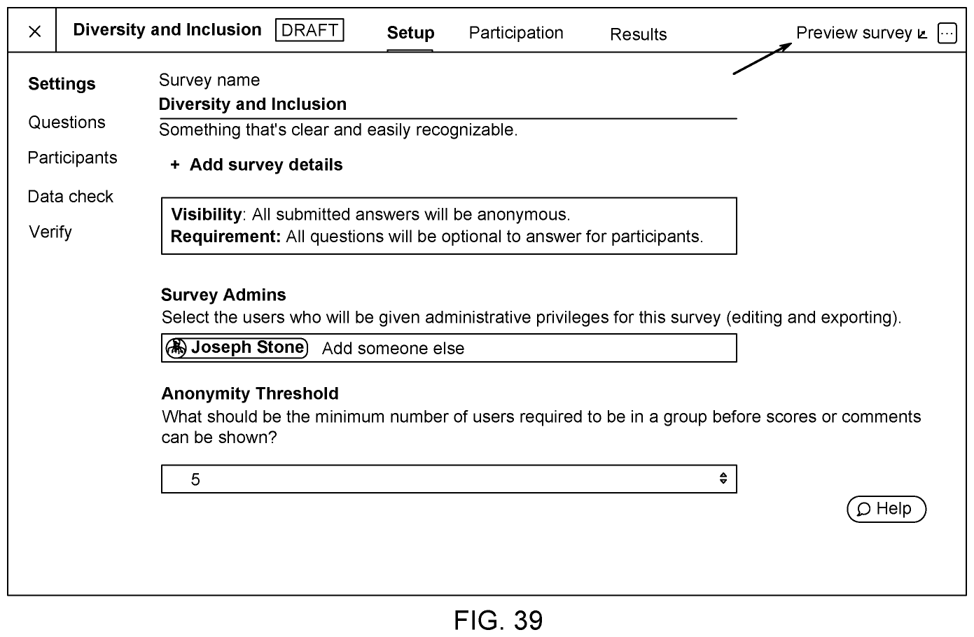

FIG. 39 is a screenshot of an example user interface for previewing a survey.

Step 4: You will then be redirected to a new page with a preview of your survey. Before you launch a survey, the system may ask you to complete a data check to ensure that you are receiving the most accurate survey results and not missing any crucial data. User attributes are used to separate your survey results based on employee data as it exists at the time of launch. The data check notifies you of any missing user attributes.

For deactivated users: If employees were active at the time of survey creation (not publishing) and then were deactivated, they will continue to appear in the data check if they originally were missing attributes. However, the archived employees will not be sent a survey.

### Using the Survey Data Check

Step 1: After you've set up your survey, but before you verify and launch your survey, you will be brought to the data check step.

Attributes that are not complete will be highlighted for the user to go back and fix before launching the survey. Please note you do not need to fix an attribute before launching your survey. This is only to remind you that a certain attribute is missing.

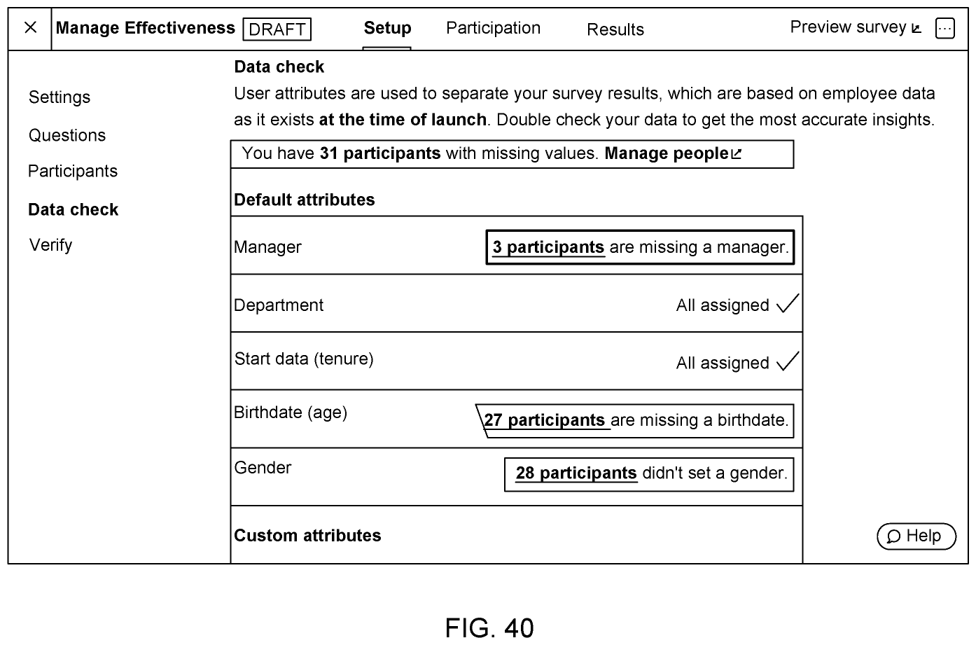

FIG. 40 is a screenshot of an example user interface for correcting data with respect to default or custom attributers of a survey.

Step 2: Click into each of the attributes that is missing a value and click Manage People.

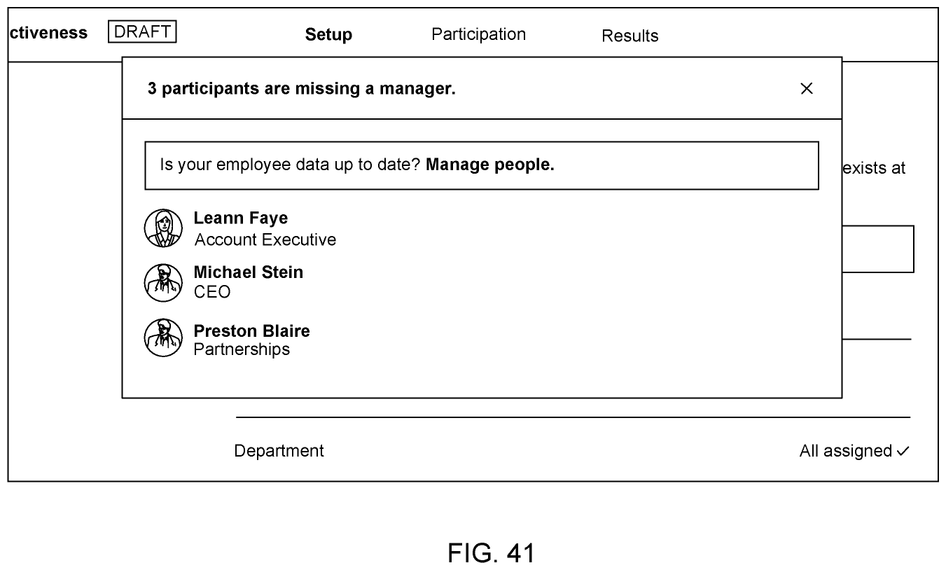

FIG. 41 is a screenshot of an example user interface for correcting data with respect to a survey, such as assigning a manager to employees who do not have a manager assigned.

Step 3: From your employee list, click into the employee's profile that contains the error and enter the attribute that is missing. Alternatively, you can mass export a CSV and complete the missing information in bulk.

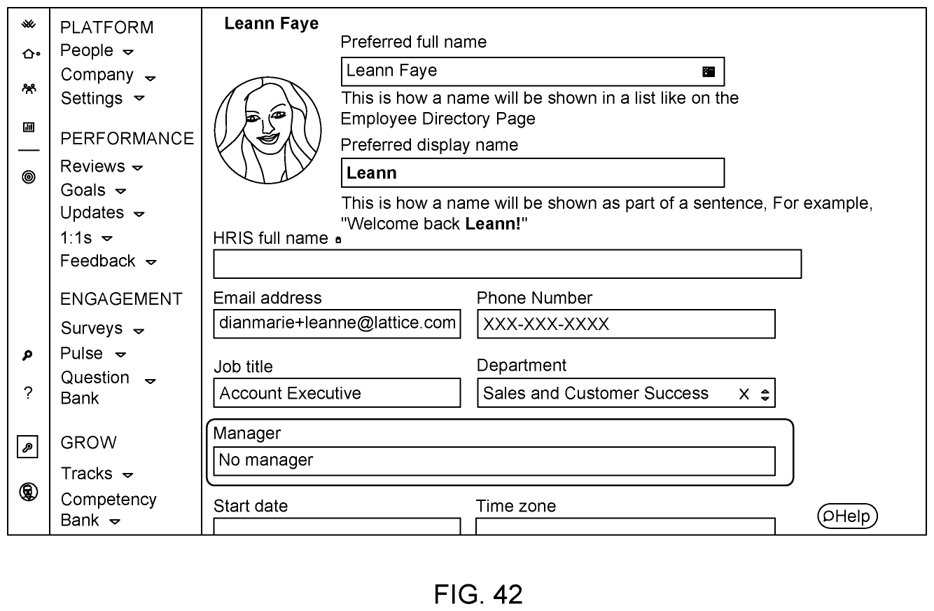

FIG. 42 is a screenshot of an example user interface for managing an employee profile (e.g., by adding the name of a manager assigned to the employee).

Step 4: Go back to the survey, confirm that all user attributes are complete, and then verify and launch your survey.

Before you launch a survey, the system may ask you to complete a data check to ensure that you are receiving the most accurate survey results and not missing any crucial data. User attributes are used to separate your survey results based on employee data as it exists at the time of launch. The data check notifies you of any missing user attributes.

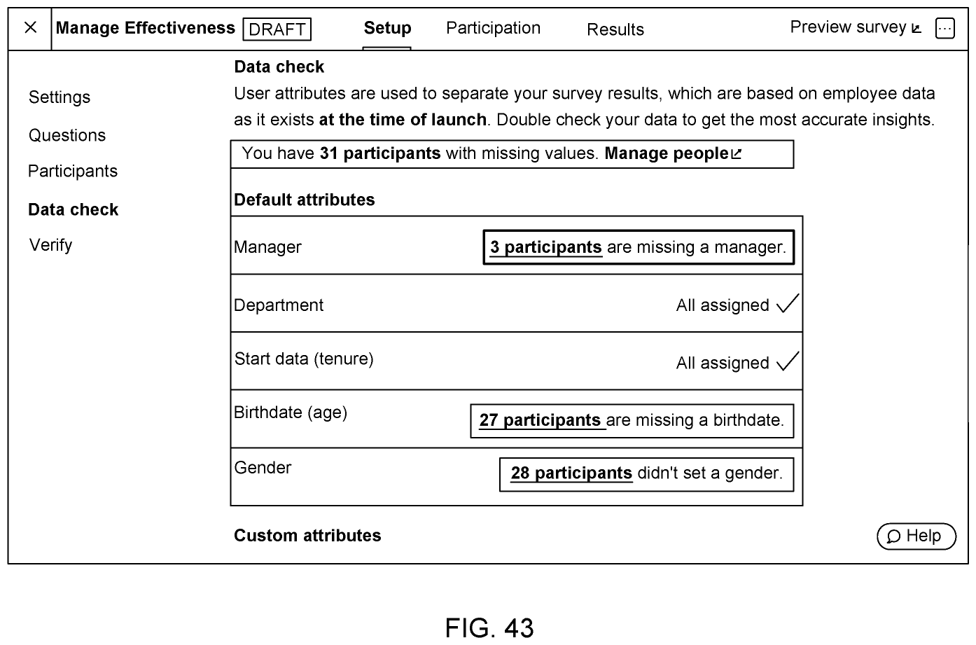

FIG. 43 is a screenshot of an example user interface for supplying missing values for one or more user attributes in order to separate survey results.

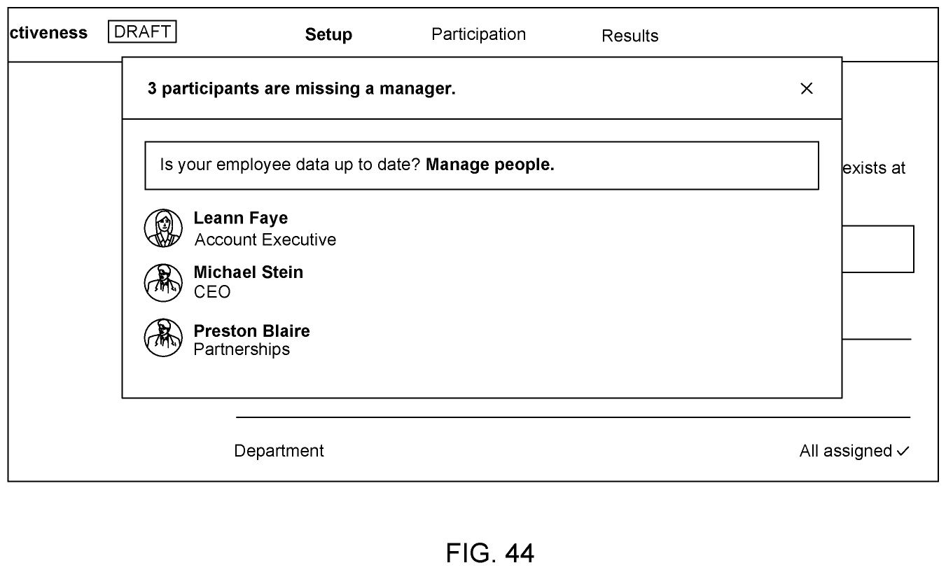

FIG. 44 is a screenshot of an example user interface for accessing profile pages of users to which no manager is assigned.

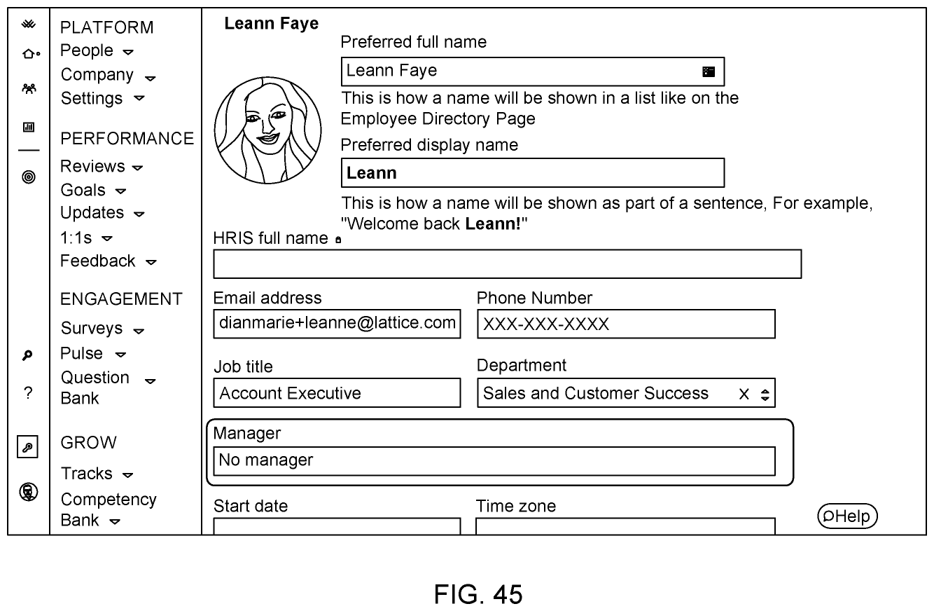

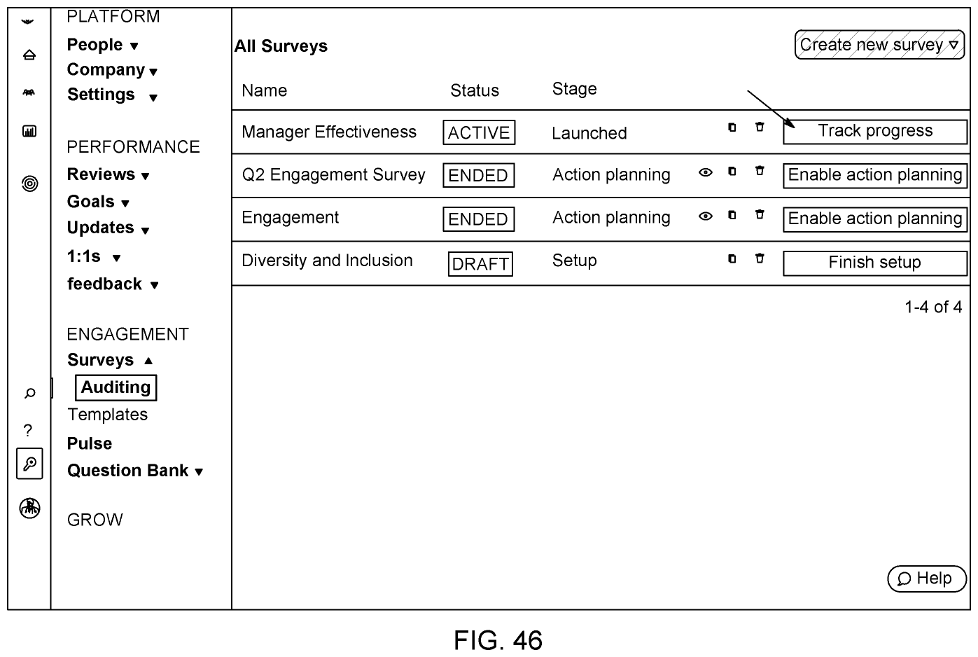

FIG. 45 is a screenshot of an example user interface for specifying a manager for a user to which new user is specified.

### Reminding Employees to Complete Surveys

At some point, you may need to remind employees to complete their surveys. As an admin, you can do so by following the steps below:

Step 1: Navigate to the admin page found at the bottom of the discovery navigation. Click into “Surveys” and “Auditing.”

FIG. 46 is a screenshot of an example user interface for managing surveys, including an option to track progress or view participation associated with a survey.

Step 2: Select “Participation.” This tab will show how all survey participants are progressing thus far. You can view this information by department and by manager. Select “Write a reminder” in the top right-hand corner.

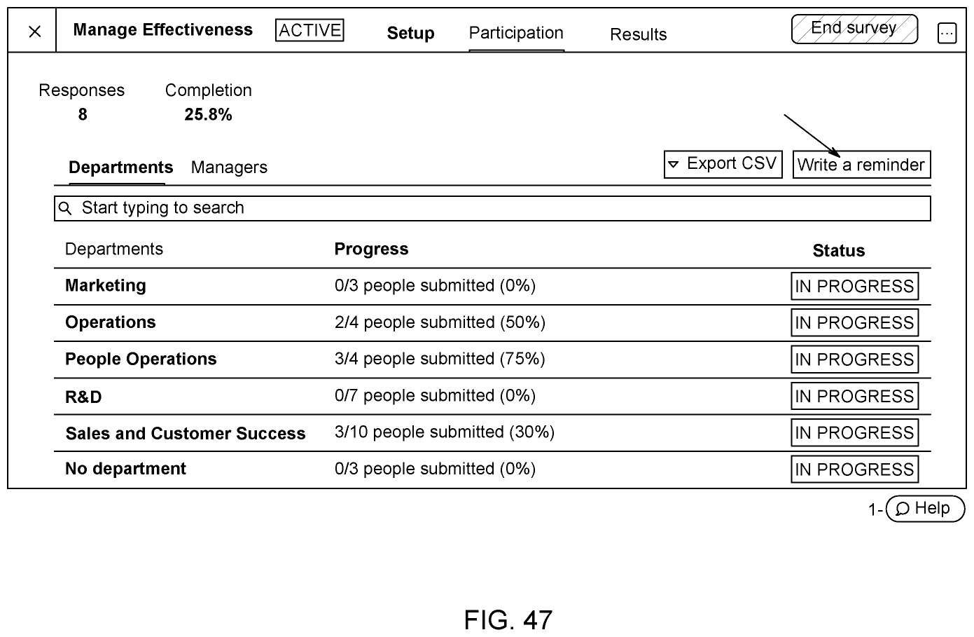

FIG. 47 is a screenshot of an example user interface for sending a reminder notification for a survey

Step 3: From here, you will be prompted to write a reminder email to everyone whose status is not “Completed.”

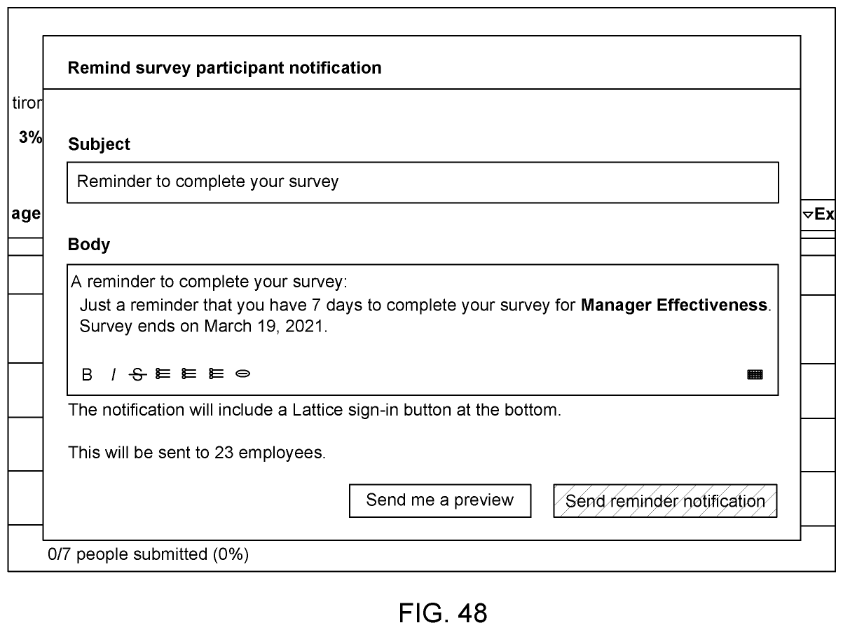

FIG. 48 is a screenshot of an example user interface for writing a reminder for a survey.

Please Note: This reminder will only be sent to individuals who have NOT completed their survey.

### The Benefits of the Likert Scale

The survey tool may be intentionally designed to measure engagement using the Likert scale (strongly agree to strongly disagree scale). Likert scale questions are among the most widely used tools in researching opinions by using psychometric testing to measure beliefs and attitudes. The system is configured to partner with academic institutions to create questions for our question bank that emphasize reducing bias.

Using Likert scale questions for engagement ensures that you measure “apples to apples” in your analytics; the scores for each question and theme are only meaningful if every question is asked on the same scale. Lastly, using a standard scale gives you access to benchmarking data across hundreds of other system customers utilizing our survey functionality.

### Ease of Analysis

While open text fields or multiple-choice questions give you specificity, they don't lend themselves well to analysis. Using the Likert scale makes it easier to collect, analyze, and subsequently act on employee feedback.

### Open-Ended Responses

The Likert scale sets guardrails that make employee surveys easier to complete and analyze.

While Likert-scale questions identify what your key problem areas are, open-ended questions help clarify the why behind them.

### What Questions Are Asked in the System's Engagement Survey Template?

The questions in this engagement survey were developed in partnership with academic institutions. All questions are rated on a Likert scale (strongly disagree, disagree, neutral, agree, and strongly agree) unless otherwise noted.

What does the Engagement Template Measure?

Examples include the following:
Management
Engagement
Work relationships
Feeling valued
Team culture
Open-ended
Self-efficacy
Fit and belonging
Job satisfaction
Commitment to the company
Psychological safety

### Questions

For a list of questions found within an engagement survey template:

Step 1: On the left-hand discovery navigation, select Help Center.

Step 2: Select Change Management Hub from the dropdown menu.

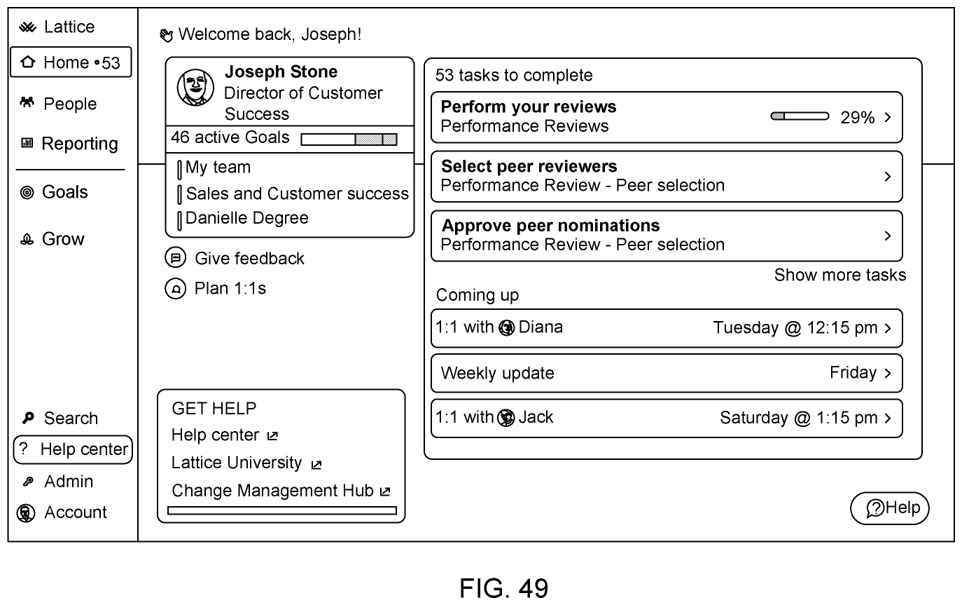

FIG. 49 is a screenshot of an example user interface for changing a management hub.

Step 3: Select Quick Sheets>Engagement.

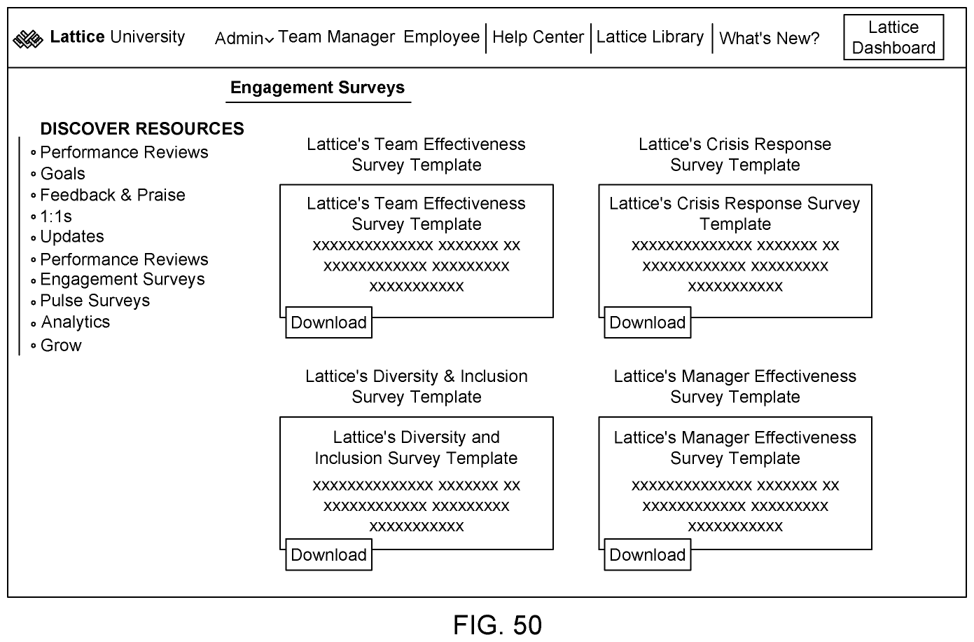

FIG. 50 is a screenshot of an example user interface for accessing quick sheets for engagement surveys.

### What Questions are Asked in the System's Return-to-Work Survey Template?

In example embodiments, the questions in this return-to-work survey are developed in partnership with one or more academic institutions. Questions are rated on a Likert scale (strongly disagree, disagree, neutral, agree, and strongly agree) unless otherwise noted.

What does the Return to Work Survey Measure?

Examples include the following:
Employee Buy-In
Health and Safety
Hybrid and Remote Work
Manager support
Collaboration and Productivity
Communication
Personal Flexibility
Travel
Open-ended

### Collecting Actionable Feedback in the Midst of Uncertainty

An unprecedented crisis can throw a wrench into any organization's operations. We know companies are doing all they can to not only survive but thrive during these uncertain times.

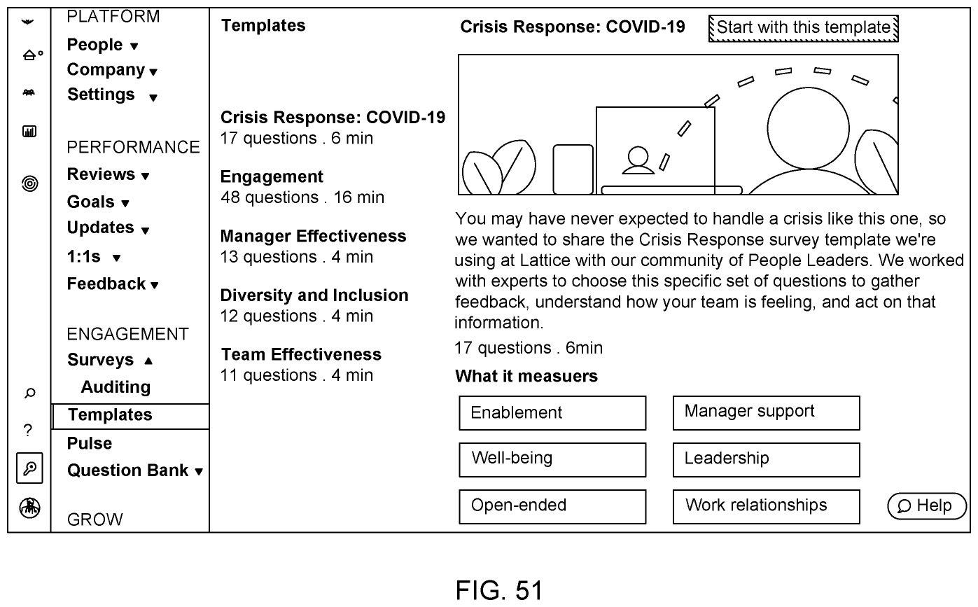

FIG. 51 is a screenshot of an example user interface for managing templates for surveys

What does the Crisis Response Survey Measure?

Examples include the following:
Enablement
Well-being
Communication
Manager support
Leadership
Work relationships
Motivation
Commitment to the Company

### What Questions are Asked in the System's Team Effectiveness Survey Template?

In example embodiments, the questions in this team effectiveness survey have been developed in partnership with one or more academic institutions. Questions are rated on a Likert scale (strongly disagree, disagree, neutral, agree, and strongly agree) unless otherwise noted.

What does the Team Effectiveness Survey Measure?

Examples include the following:
Psychological safety
Team learning

### Commitment to the Company

Organizational commitment has been shown to predict motivation at work (especially motivation to do more than the minimum), and turnover, amongst other things. Standard scales may be used. In example embodiments, a configurable number (e.g., 3) relevant statements are pulled from a main scale used in over one hundred studies and based on seminal work, such as, for example:
I am proud to tell others that I am part of this company.
I talk up this company to my friends as a great company to work for.
I really care about the fate of this company.

In example embodiments, an additional statement that matches one of the three dimensions of organizational commitment-a strong belief and acceptance of an organization's goals—is added, such as, for example:
I trust the decisions of the senior leadership in the company

### Engagement

Engagement is perhaps one of the most well-known predictors of job performance. Engaged employees are expected to be more productive, better at their jobs, and often more satisfied. Most constructs of work engagement attempt to capture three constructs: vigor, dedication, and absorption. If the concepts sound foreign, it is because they are used globally and have been translated many times, but make more sense when defined:

Vigor: “high levels of energy and mental resilience while working, the willingness to invest effort in one's work, and persistence even in the face of difficulties”

Dedication: “feelings of a sense of significance, enthusiasm, inspiration, pride, and challenge”

Absorption: “being fully concentrated and deeply engrossed in one's work, whereby time passes quickly and one has difficulties with detaching oneself”

While engagement scores are usually created with surveys having a configurable larger number of questions (e.g., a 9-question or 17-question survey), a shorter 3-question version may capture the three main constructs and may be validated across multiple countries.

In example embodiments, the system uses three (adjusted) questions to capture the same concepts:
Vigor: At work I feel very energetic
Dedication. I am enthusiastic about my job
Absorption: Time flies when I'm working

A sister concept of engagement is burnout. It is a strong predictor of mistakes but importantly also predicts sick leave and turnover. Example questions may include the following:
When I get up in the morning, I look forward to going to work.
After work, I have energy for my leisure activities, friends and family

### Feeling Valued at Work

Although feeling valued at work is described in various different ways in the literature, there is no question that it is a central component of the work experience. In some studies, feeling respected at work is ranked as more important than career opportunities or even income. Feeling psychologically safe to speak up and be heard in an organization has been shown to improve team learning and innovation in organizations. Similarly, receiving recognition or praise-regularly-increases employee engagement. As such, to create this category, the system may combine questions in unconventional ways. Here are some examples:
At work, my unique skills and talents are valued and utilized.
People notice when I go the extra mile at work.

### Fit and Belonging

Perceptions of person-organization fit have been shown to be one of the strongest predictors of applicant attraction to a job, amongst other things. Similarly, especially for underrepresented groups, belonging uncertainty—or feeling like you may not belong—has been shown to reduce performance.

“Fit” often captures two constructs: complementary fit, or feeling that the company's style/values/approach matches your own, and supplementary fit, feeling like the company meets your psychological needs, including feeling like you belong.

Example questions to cover complementary fit may include the following:
I find that my values and the company's values are similar.
My work style matches the work style of the company.

Example questions to target feelings of belonging may include the following:
I can be myself at work.
I feel like I belong in this company.

### Job Satisfaction

There is a strong positive correlation between job satisfaction and job performance.

The measures below are example summary measures of job satisfaction. Job satisfaction captures many of the other concepts in this survey and may mean something different for each employee. As such, these questions aim to capture overall satisfaction with each of the key components of a job, as well as the job as a whole.
All in all, I'm very satisfied with my job.
All in all, I'm very satisfied with my coworkers.
All in all, I'm very satisfied with the supervision I receive.
All in all, I'm very satisfied with the work that I do.

### Management

In example embodiments, the system draws on actionable measures of what makes a good manager in this survey, rather than the broader academic concept of “leadership.”

Some example questions are below:
If I could choose, I would continue working with my manager.
My manager communicates clear goals for our team
My manager gives me actionable feedback on a regular basis.
My manager regularly shares relevant information from their manager and senior leadership.
My manager has the technical expertise required to effectively manage me.
My manager makes tough decisions effectively.
My manager wants to see me succeed.

### Self-Efficacy

Feeling like you have the capacity to do your work is not only about underlying ability, or job demands, but also about a company culture that makes you feel like you have the resources to succeed within a company. Feelings of self-efficacy have been linked to burnout as well as overall job satisfaction and intent to leave. Indeed, the job demands-job resources model suggests that it is not the difficulty of a job that leads to burnout but the feeling of not having the resources available to you to meet the demands of the job. Burnout is often conceptualized as the opposite of engagement, so many of the questions below also are used in engagement surveys or burnout surveys.

The system's questions aim to capture a broad range of feelings of self-efficacy, including those that are linked to seeing a future in the company (a measure correlated with intent to leave). Example questions include the following:
I can see myself growing and developing my career in this company.
I am proud of the work that I do.
I find my work to be a positive challenge.

### Team Culture & Psychological Safety,

One of the key components of a well-functioning company is a well-functioning team. The example questions below aim to capture components of an effective team. First, these include feeling psychologically safe within a team, something that is highly correlated with team learning and innovation.
It is safe to take a risk on this team.
Members of this team are able to bring up problems and tough issues.

To measure team learning directly, the system picks one of the questions correlated with innovation, such as the following question:
We regularly take time to figure out ways to improve our team's work processes.

The system may also list a series of questions about coworkers that mirror questions on ability and organizational commitment that the system has asked about the individual employee. In so doing, the system can capture any discrepancies between how an individual views their own role in the company and whether they see similar levels of commitment and ability in their teammates. Here are some examples:
I learn a lot from my coworkers.
My coworkers have the skills and expertise to do their jobs well.

### Work Relationships

Work relationships play an integral role in psychological well-being at work, which in turn predicts everything from job satisfaction to performance.

The system may include questions that correlate with engagement that have been validated before and then include slightly more actionable questions that aim to capture components of well-being and feeling supported. Examples include the following:
If I'm struggling, I know who to turn to for help
My coworkers want to see me succeed.

And as they relate indirectly to work-life balance:
People at work know about what's going on in my life.

As soon as people start submitting their responses to a survey, survey admins will immediately (e.g., in real time) be able to see analytics around the responses (e.g., once the number of responses satisfies the anonymity threshold). Several views are offered to help users discover insights about their people and organization.

### Filtering Through an Attribute

The filter bar at the top of the Results page allows results to be filtered by any user attribute that has been uploaded to the system. This includes both default fields like gender, age, department, etc., custom fields that the client has uploaded into the system, or by various performance metrics.

Filters can be stacked for different fields on top of each other to get to the exact cut of data that is desired. For example, stacking Gender=>Female and Department=>Engineering will show responses from all the women in the engineering department.

Within one field, selecting multiple options (like selecting both R&D and Marketing from the Department field) will show people who are in R&D or Marketing.

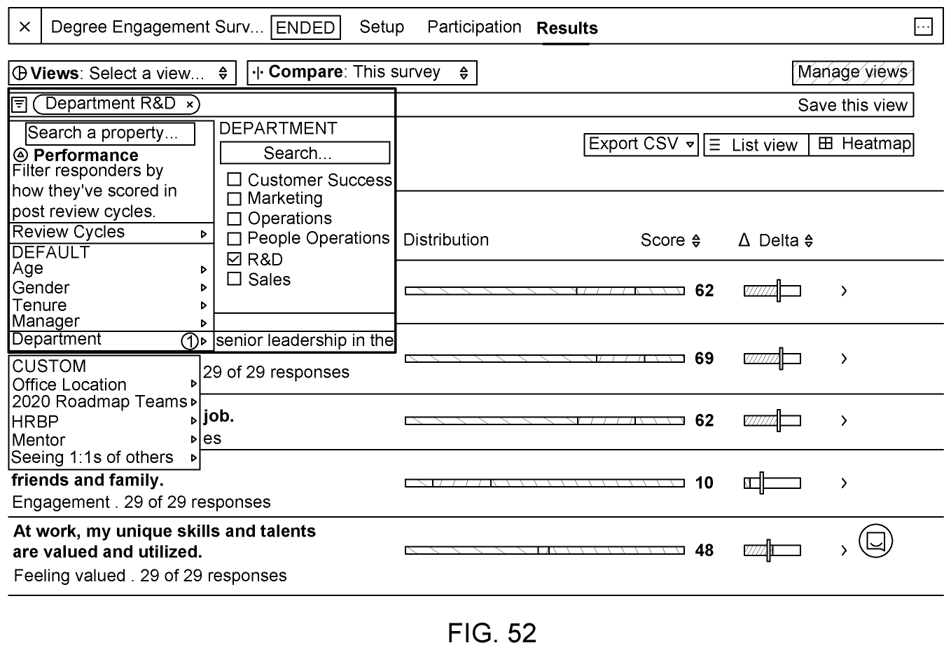

FIG. 52 is a screenshot of an example user interface for filtering a view by a department (e.g., R & D).

Once a filter is applied, the delta column/toggle is visible, which shows how the filtered group of responses compares to how the entire survey scored overall.

### Filtering Through Performance Metrics

Similar to filtering by a department, you can drill down into multiple different directions to unlock insights into how employee performance connects to employee engagement. By filtering through rating questions and scored attributes from a specific review cycle, you answer questions such as:
Are employees who rate their managers highly actually more engaged?
Are employees who are rated highly by peers more engaged or not?
Does a performance gap between the manager and reviewee (manager rated the employee lower than what the reviewee thought they were) have an impact on engagement? To start uncovering these data insights select “Review Cycles” and the desired performance metrics.

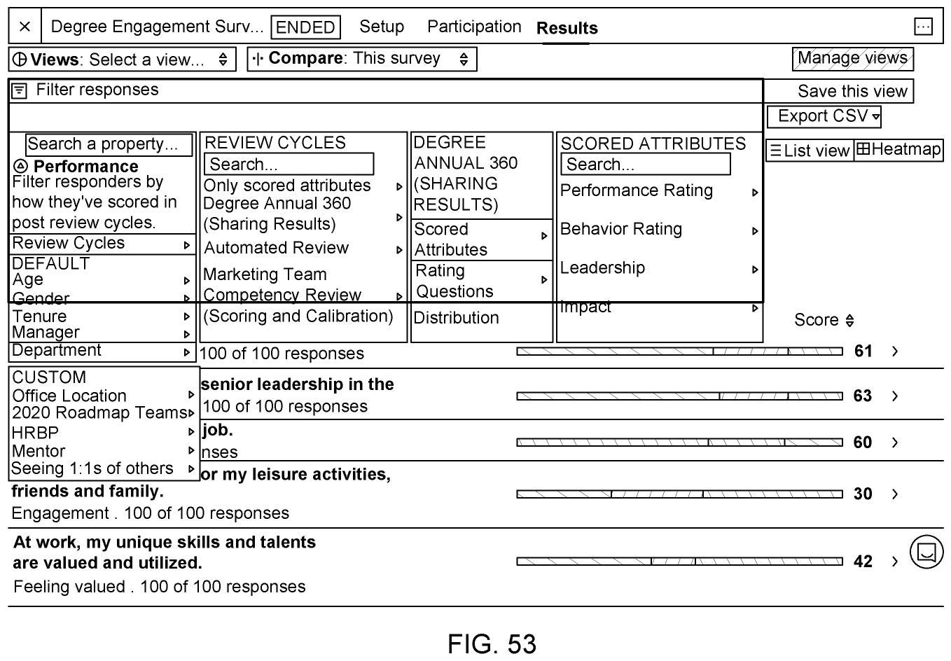

FIG. 53 is a screenshot of an example user interface for examining results by question or by theme, in either a list format or heatmap view.

### List View

The list view for both questions and metrics gives you a quick way to see how a group of responders is doing across all themes or questions. The colors in the horizontal bar next to each item show the breakdown of positive, neutral, and negative responses (e.g., in green, grey, and red respectively). To see a count of how many responders fell into each bucket, hover over a particular color in the bar to see the count.

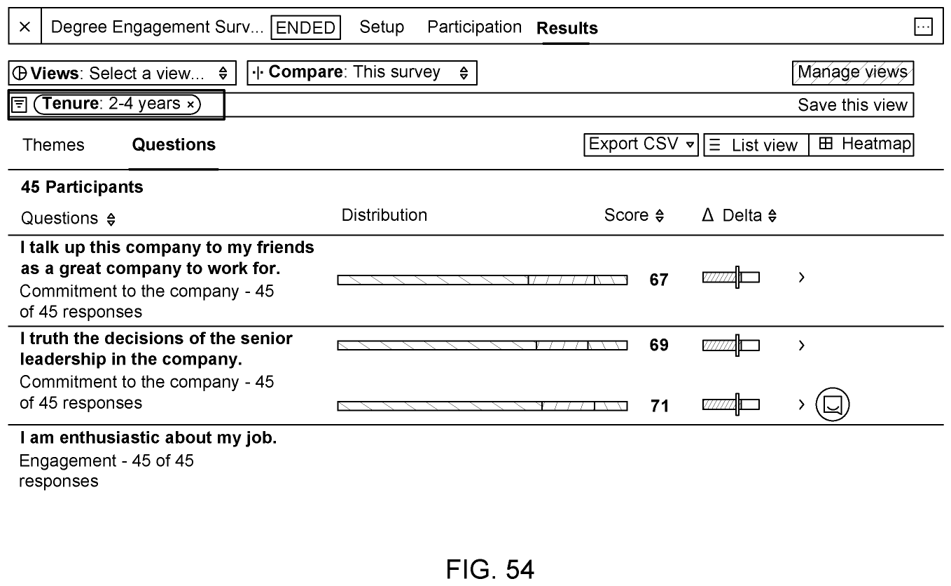

FIG. 54 is a screenshot of an example user interface for filtering a result (e.g., by tenure of 2-4 years).

Scores can be sorted in descending or ascending order by clicking on the Scores column label to quickly see which areas need the most attention. If a filter has been applied, the questions or themes can also be ordered by how much the score differs from the overall aggregate score.

To drill into a particular question or theme to see the exact breakdown, click on the question or theme body, which will then take you to a view showing the exact breakdown of responses for that particular question or theme.

For questions that have comment responses, there is an associated color based on the rating selected (positive responses=green, negative responses=red, neutral responses=yellow). Comments have a continuous scroll that allows you to view all the comments that were written on the same page.

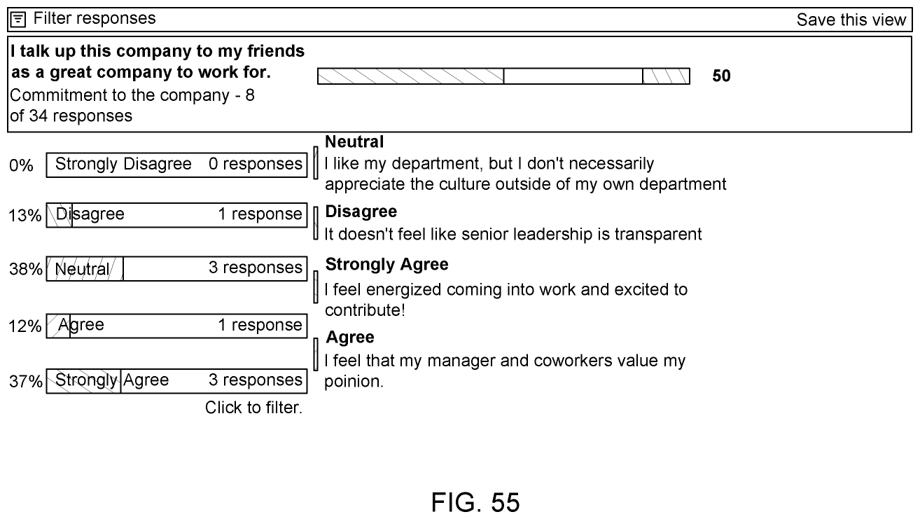

FIG. 55 is a screenshot of an example user interface for interactively accessing comment responses associated with a survey question.

### Heatmap View

The heatmap view is best for comparing different groups of responders against each other across questions or themes.

### Dropdowns: Group by

For example, if you wanted to compare every department against each other, navigate to the heatmap view and on the “Group by” dropdown, select “Department”.

While you're looking at a heatmap, you can still apply filters to cut your data even further. For example, after group by department, if you want to see how women in each of your departments feel, you could filter on Gender=Female in the filter bar. The heatmap then shows just responses to the questions from women across each department.

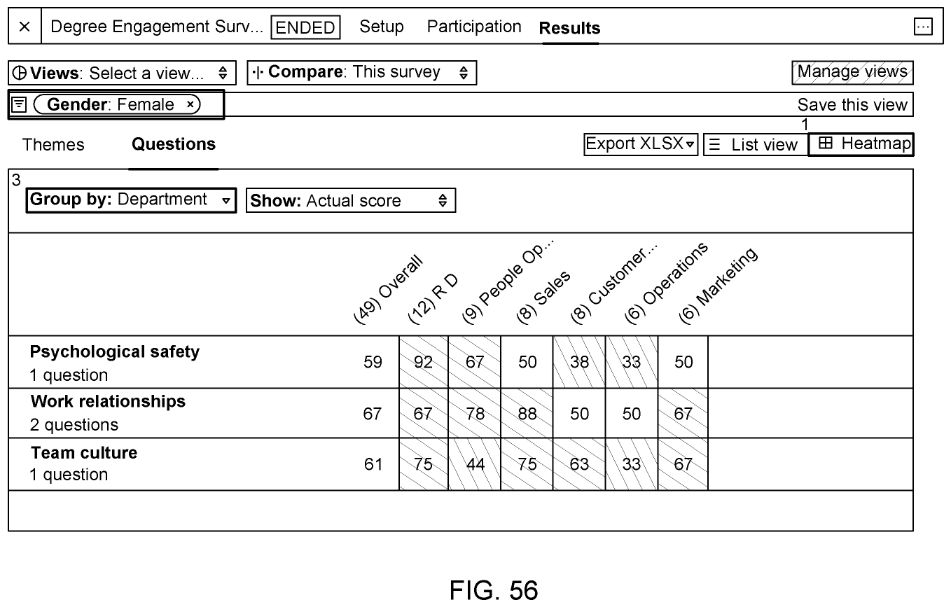

FIG. 56 is a screenshot of an example user interface for viewing a heatmap (e.g., for filtered results (e.g., by gender and/or department)).

One thing to note is that you cannot filter on the field that you are currently comparing on. For example, if you are comparing across departments, you then cannot apply a department=Engineering filter.

### Dropdowns: Show

The “Show” drop down allows you to show the actual score for a group. This score is the true score for each grouping based on the filters selected.

If you are comparing a survey against itself, the delta score is the comparison of the scores calculated from the people that match the “group by” or selected filters compared to all survey responders. For example, a delta score of −3 for a group indicates that their actual score is 3 points lower than the score for all survey responders.

A Note about Tenure and Age

When grouping by tenure or age (based on the start date and birthday default user attributes), the low range is inclusive, and the high range is exclusive.

For example, tenure is grouped by 3-6 months, 6-12 months, 1-2 years, and so on. The 3-6 months range includes 3 months but not 6 months, whereas the 6-12 months range includes 6 months but not 12 months.

If Sarah hits her 1-year tenure on Nov. 24, 2020, we will bucket Sarah to be in the ‘Tenure=1-2 years’ based on today's date (Dec. 2, 2020). Since on December 2nd she is in the 1-2 year bucket, she's attached to that until she passes her 2 years on Nov. 25, 2021. On Nov. 25, 2021, if the HR admin views the filter results, any of Sarah's responses will now only be shown now if the ‘Tenure=2-4 years’ filter is selected.

If you are comparing a survey against itself, the delta score shown once a filter is applied is the comparison of the scores calculated from the people that match the filter compared to all survey responders.

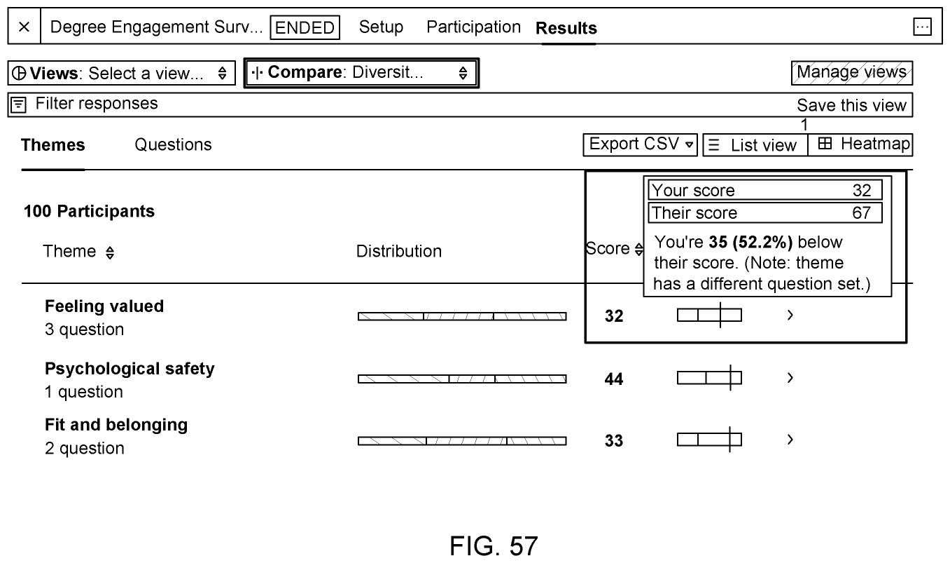

FIG. 57 is a screenshot of an example user interface for comparing results of an overlapping question across multiple surveys.

If you've run other surveys with overlapping questions, you can toggle the “Compare” dropdown and choose to compare instead of a previous survey that you've run.

As an admin, you may want to export the participation for both departments and managers as a way to measure levels of participation. The system offers survey participation (e.g., CSV) export to make it easier for orgs to track survey participation progress.

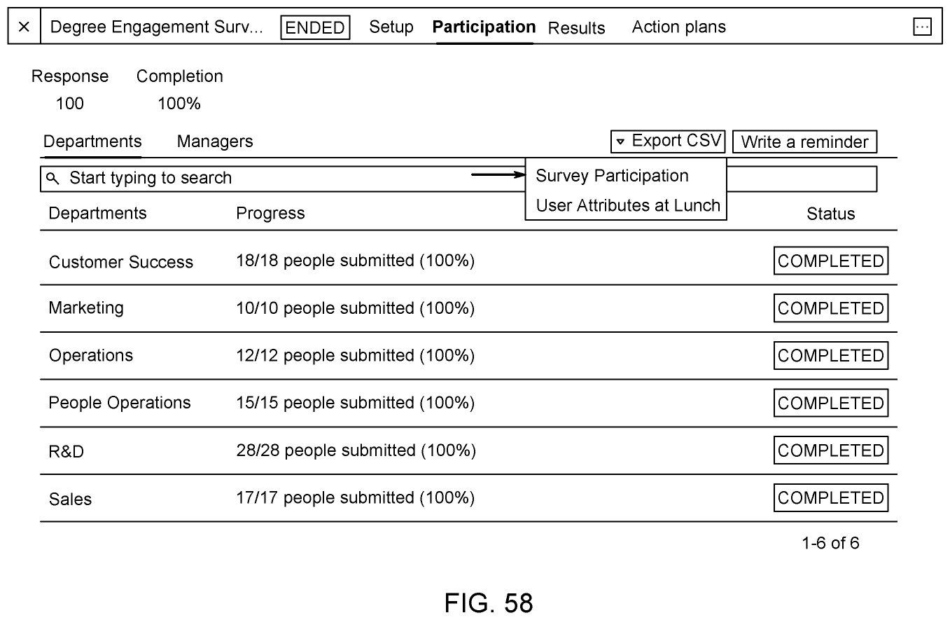

FIG. 58 is a screenshot of an example user interface for exporting survey participation.

### User Attributes at Launch

User attributes at launch allow admins to see the user attributes that were set at the time of launching the engagement survey. This is important to admins when looking back to historical surveys and being able to compare those results with current information.

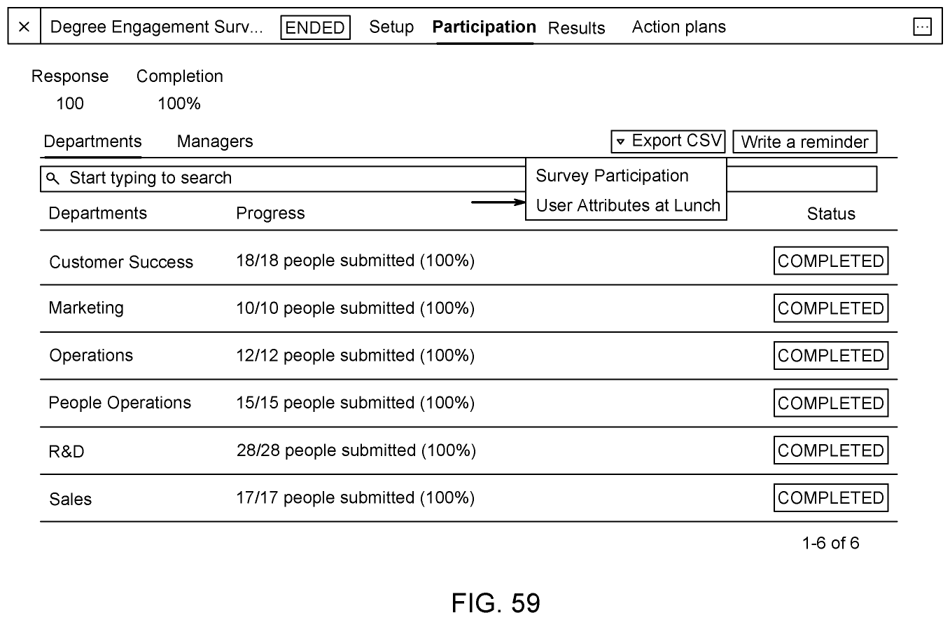

FIG. 59 is a screenshot of an example user interface for viewing user attributes at survey launch.

### Results

Survey results can also be exported as a CSV. Results include the score and sentiment, including a breakdown of strongly agree, agree, neutral, disagree, and strongly disagree counts.

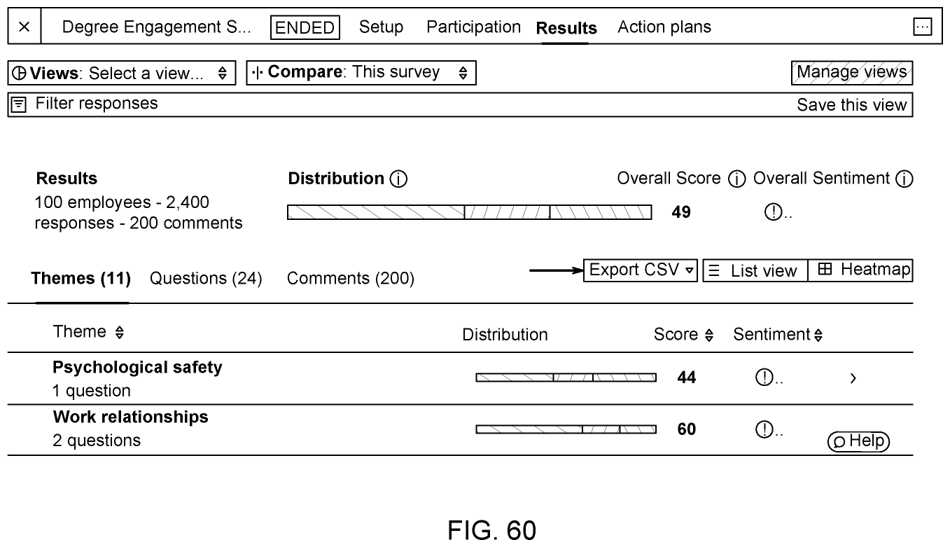

FIG. 60 is a screenshot of an example user interface for exporting survey results (e.g., as .CSV).

### Score Calculation

For a question that uses the 5 point agree/disagree scale, scores are calculated in the following way:
“Agree” or “Strongly Agree”=Positive Responses
“Disagree” or “Strongly Disagree”=Negative Responses
“Neutral”=Neutral Response

A question's score is the number of responders who gave positive responses out of the number of total responders for that question.

### For Example:

You've sent out a survey to all of your 150 employees. For a particular question, 100 people in total responded (the other 50 people either skipped it or didn't get around to it). The response breakdown is as follows:
Strongly agree: 30 people
Agree: 20 people
Neutral: 10 people
Disagree: 25 people
Strong disagree: 15 people
No response: 50 people

For this question then, the positive score would be (30+20)/100, which calculates out to 50%.

### For Themes

The score of a theme that contains multiple questions IS NOT the average score of all the questions within the theme.

Instead, to calculate the score of a theme, we take all of the users that have responded to at least one question associated with the theme. For each user in that group, we take all of their responses to the questions associated with the theme and calculate an average (on the scale of strongly disagree=1 and strongly agree=5) score for that user. If the average is 3.5 or greater, then that user is marked as having a positive response to that theme. After doing this for every user in the group, we count the number of users who qualify as having a positive response to that theme and divide by the total number of users to calculate that theme's score.

We use this methodology so that the score for a theme does not over-weigh the responses from people who have answered all the questions within the theme vs. those who only answered one.

### For Overall Score

Overall scores are calculated as an average of all question scores for questions included in that survey. As aforementioned, question scores are measured as a percentile of their positive responses.

For example, in a survey that had 3 questions with question scores of
Question 1: 50
Question 2: 60
Question 3: 70
The overall score would be 60 [(50+60+70)/3].
   Questions or Themes without Scores

A question or theme won't have a score associated with it for two possible reasons:

First, the question could have been set as solely a “comment” question, meaning that responders were prompted for a free text response rather than a scale rating. In this case, there is no score to show. The same applies if a theme consists only of questions that are comment questions.

The second reason for this is that there aren't enough responses to a question or theme to show the score. Currently, the system has set an “anonymity threshold” of at least 3, meaning that if you are looking at a view of a question or theme with fewer than five responders, no score will be shown to protect the anonymity of the responders.

### Unsubmitted Surveys

Responses that have not been submitted by the time the survey is ended will not be pulled into survey analytics.

### Survey Sentiments

Survey sentiments help admins assess key takeaways from survey comments throughout questions and themes.

With engagement survey sentiments, system admins can quickly gain a high-level understanding of whether survey comments are positive, neutral, or negative. This can help reduce the amount of time spent identifying focus areas to improve employee engagement.

Once employees have completed a survey and the anonymity threshold has been met, admins can access results and reference overall survey sentiment gained from the free-text comments.

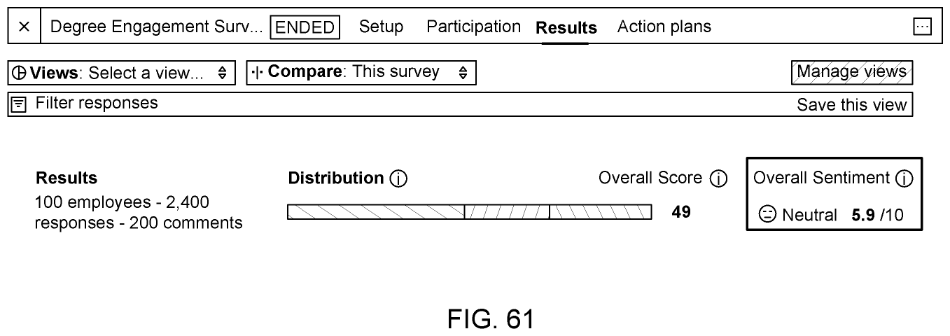

FIG. 61 is a screenshot of an example user interface for accessing overall sentiment (e.g., generated from free-text comments, such as through application of natural language processing or other machine-learning algorithm).

Additionally, in the list view of results, a sentiment will be associated with each theme, question, and comment.

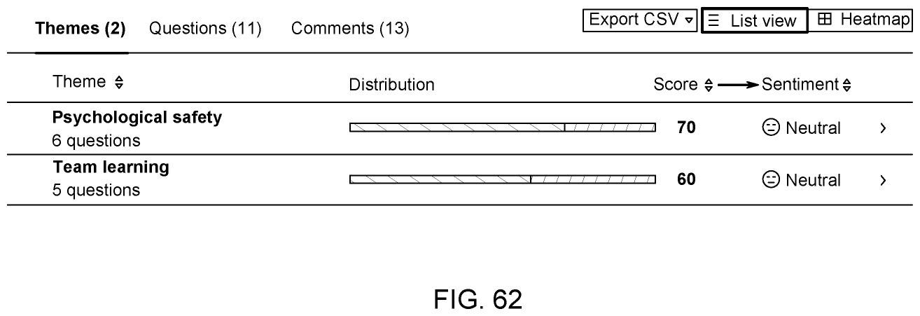

FIG. 62 is a screenshot of an example user interface for accessing sentiment associated with each theme, question and/or comment associated with a survey.

The system's natural language processing engine leverages leading artificial intelligence and machine learning technology to provide the most accurate and rapid sentiment tagging possible from free-text responses.

Scores Vs. Sentiments

Please note: The engagement score and sentiment score are unrelated. Engagement scores are based on the question responses (strongly disagree to strongly agree) while sentiment scores are based on language provided in the free-text comments.

### Filtering Survey Comments by Sentiment

Admins have the ability to filter comments by sentiment (positive, neutral or negative) or response (agree, neutral, disagree, etc.).

To filter responses:

Step 1: Navigate to your survey results panel.

Step 2: Toggle to the “Comments” tab, and under “Filter by”, select the sentiments or responses that you want to assess.

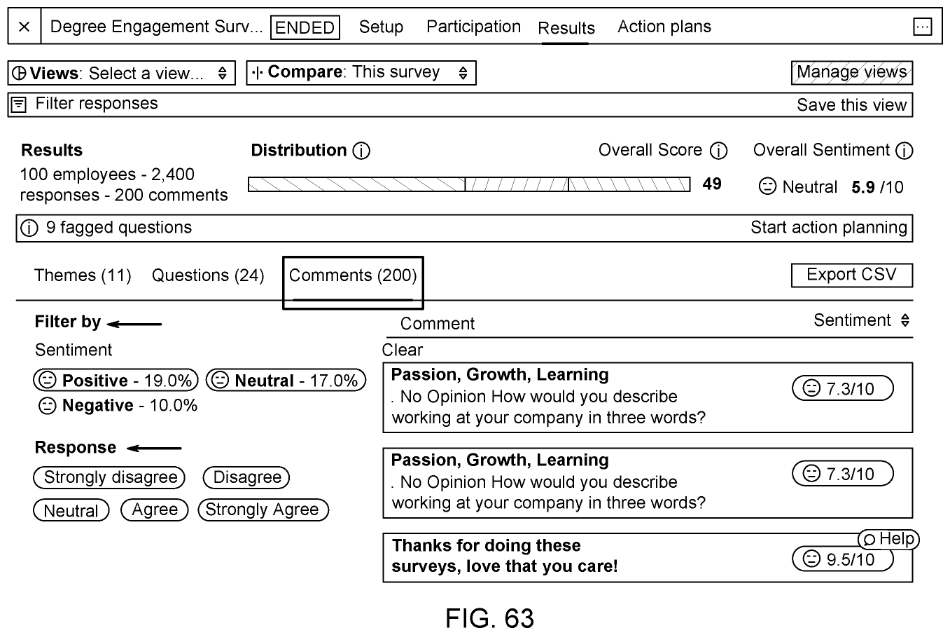

FIG. 63 is a screenshot of an example user interface for assessing sentiments and/or responses to a survey.

You can also leverage the “Export CSV” button to share any insights with leadership from the filters you have selected.

Drawing Actionable Insight from Engagement Surveys by Scored Attribute Review Results

If your company is grading employees on scored attributes during your review cycles, you can analyze your engagement survey results by their scores. The system will automatically use the scores from your most recently completed review cycle.

### Filtering by Scored Attributes

In either the list view or heatmap, you can apply scored attribute filters to your survey results. We allow you to filter by attribute and score by clicking into the filter bar and then on “Performance” in the drop-down menu as shown below.

Follow these steps to filter results through scored attributes:
Step 1: Navigate to the Results tab of the survey
Step 2: Click on the filter icon
Step 3: Under Performance, select “Review Cycles”
Step 4: Click on desired review cycle and “scored attributes”
Step 5: Click the desired scored attribute

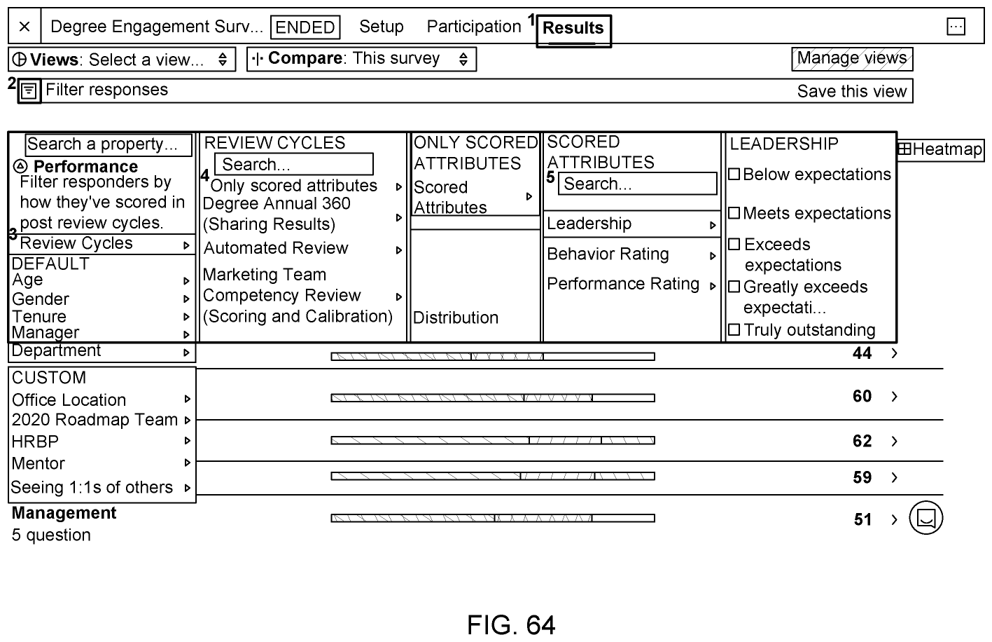

FIG. 64 is a screenshot of an example user interface for filtering by attribute and/or score.

### Grouping by Scored Attributes

In the survey results heatmap, you can group themes and questions by scored attributes. In the results heatmap, you can group themes and questions by rating questions. Follow these steps:
Step 1: Select “Heatmap” view
Step 2: Click on “Group by”
Step 3: Under Performance, select “Review Cycles” or “Only scored attributes”
Step 4: Click on desired review cycle and select desired scored attribute.

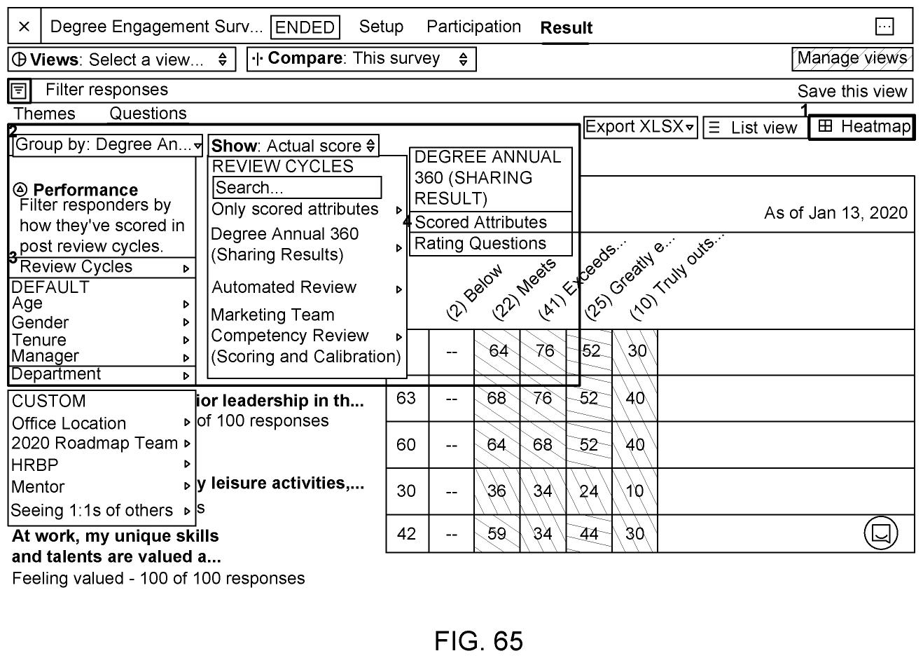

FIG. 65 is a screenshot of an example user interface for grouping and/or rating themes and/or questions by scored attributes.

Once you select a scored attribute, you'll be able to see how employees responded to your survey questions by score. In the user interface, a number inside the parentheses is the number of responders with that score. So in the first column indicated by the red arrow, 3 participants with a behavior score of “Below expectations” have an average score of 100 for the question, “I talk up this company to my friends as a great company to work for.”

If you're using rating questions in your review templates, you can use them to analyze your engagement survey results You can choose any rating question from any review cycle that you'd like.

In either the list view or heatmap, you can apply rating question filters to your survey results. Follow these steps to filter results through rating questions:
Step 1: Navigate to the Results tab of the survey
Step 2: Click on the filter icon
Step 3: Under Performance, select “Review Cycles”
Step 4: Click on the desired review cycle and select “Rating Questions”
Step 5: Click the desired question

After selecting the rating question, you can pick which review direction and response types you want to filter by.

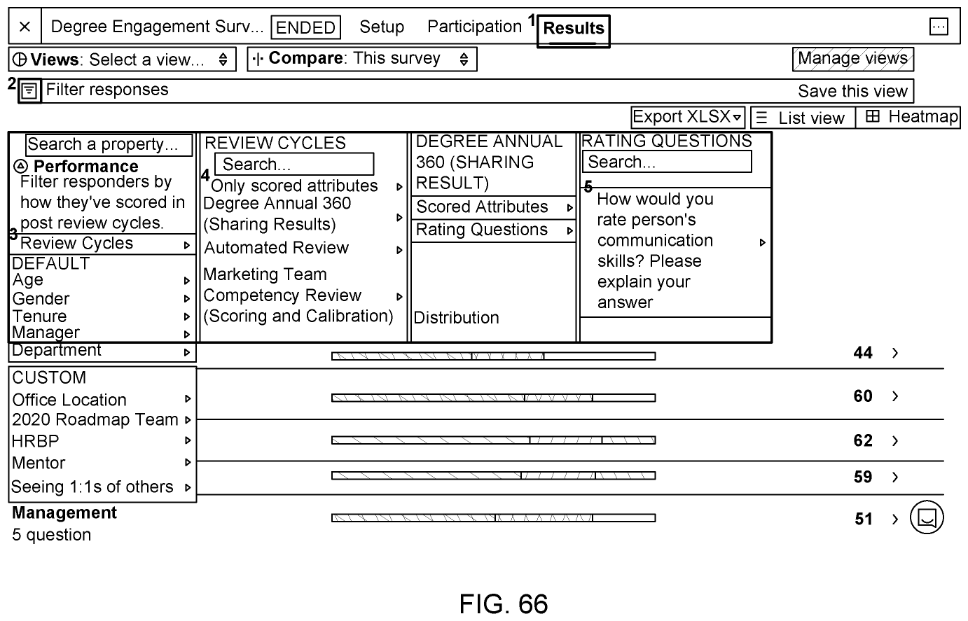

FIG. 66 is a screenshot of an example user interface for filtering results by review cycles and/or response types.

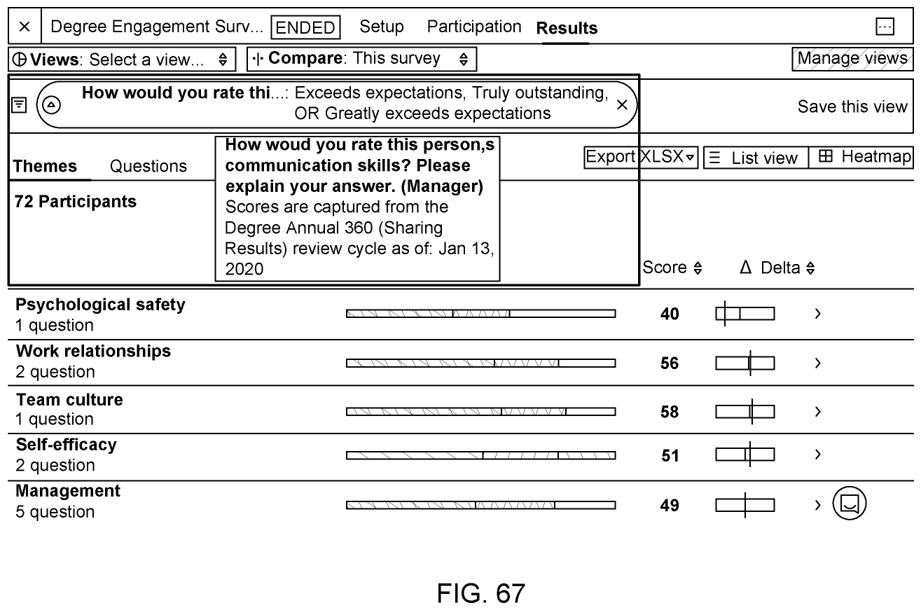

FIG. 67 is a screenshot of an example user interface for filtering results by themes.

In the survey results, heatmap, you can group themes and questions by rating questions. Follow these steps:
Step 1: Select “Heatmap” view
Step 2: Click on the “Group by”
Step 3: Under Performance, select “Review Cycles”
Step 4: Click on the desired review cycle and select the desired rating question

You can choose between rating questions or scored attributes (if applicable).

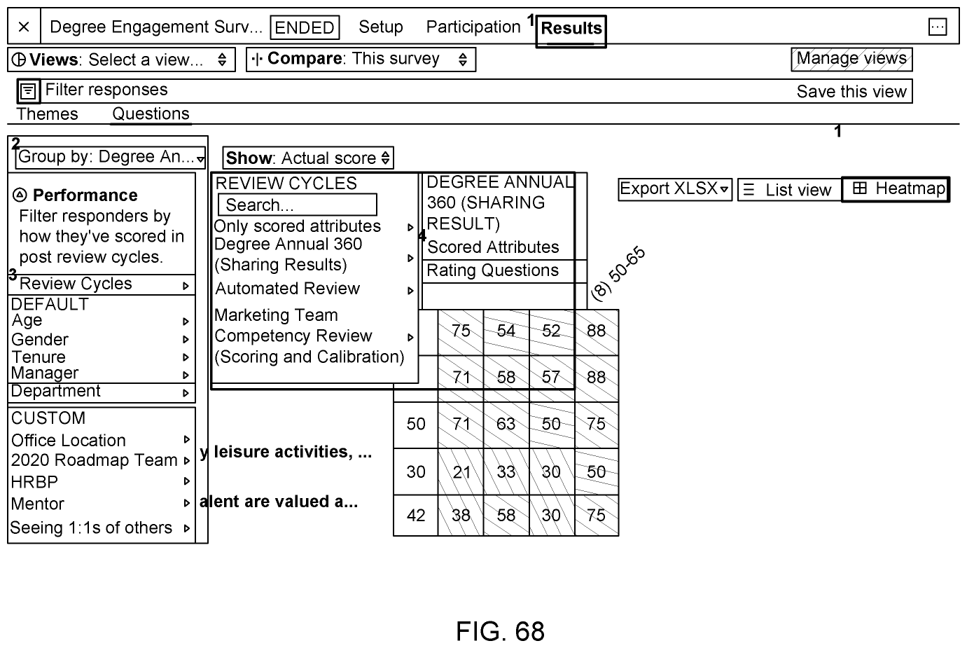

FIG. 68 is a screenshot of an example user interface for grouping themes and/or questions by rating questions and/or scored attributes.

After selecting your rating question, you can click into the box indicated by the red arrow above to select a different question.

You'll see each review direction that contained the rating question. If you want to isolate your survey responses in a particular direction, check on the direct reports (upward), self, peer, or manager (downward) buttons to include them in your grouping.

### Sharing Survey Results

### Sending a Specific View of Survey Results to Anyone at Your Company

All survey admins can share survey results with others at the company. Survey results can either be shared in full or as a filtered set of data. Either way, the system makes it easy to share the relevant data with the relevant people.

You might want to share the full survey results with the exec team. To do so, navigate to the Results tab of the survey, and with no filters applied, click on “Save this view.”

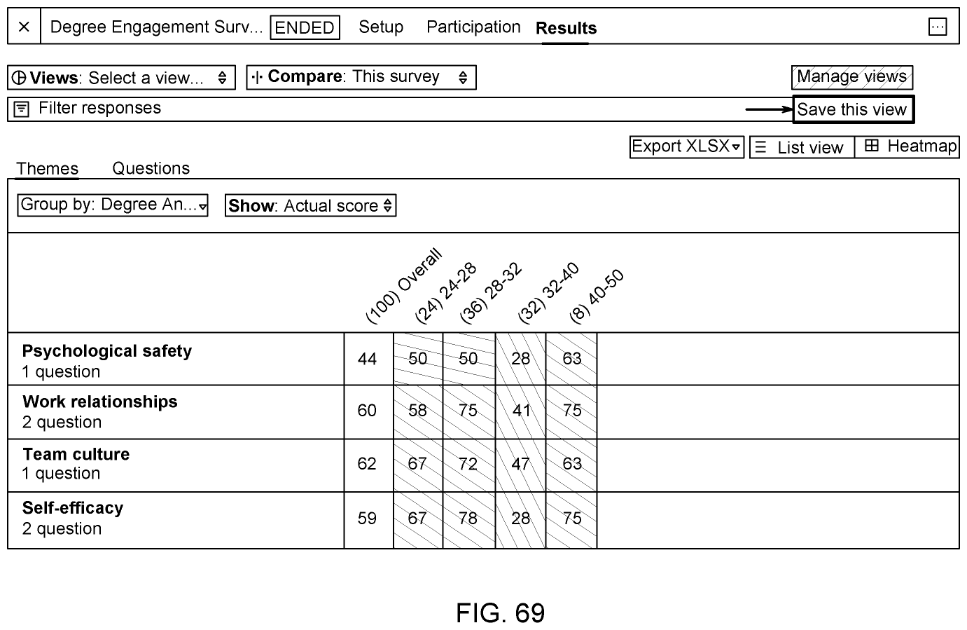

FIG. 69 is a screenshot of an example user interface for saving a view in a storage for later access or distribution to one or more users (e.g., users having one or more specified roles, such as managers, administrators, executives, and so on).

This will open up the saved views sidebar and prompt you to view and name the users you want to share this view with. You can share the survey results with many people at once.

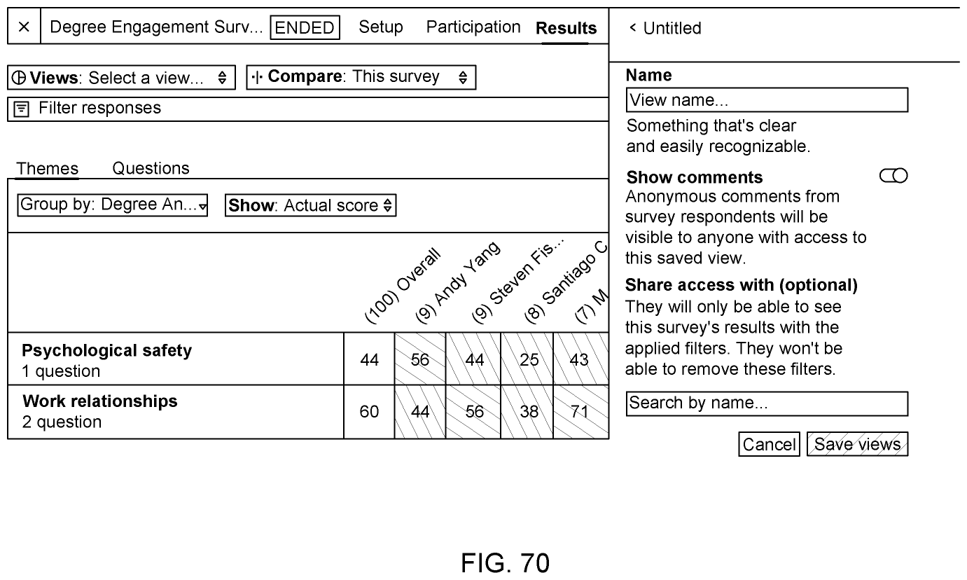

FIG. 70 is a screenshot of an example user interface for sharing a subset of data with particular users or users having particular roles.

For people outside of the executive team, you might only want to share a subset of the data with them, like sharing the engineering department's results with just the head of the department, or only share results from a manager's team with that manager.

### Role-Based Sharing

Surveys automatically create specific views for managers, department heads, and mangers of managers. To access, navigate to the Results tab of the survey, and select “Manage Views.”

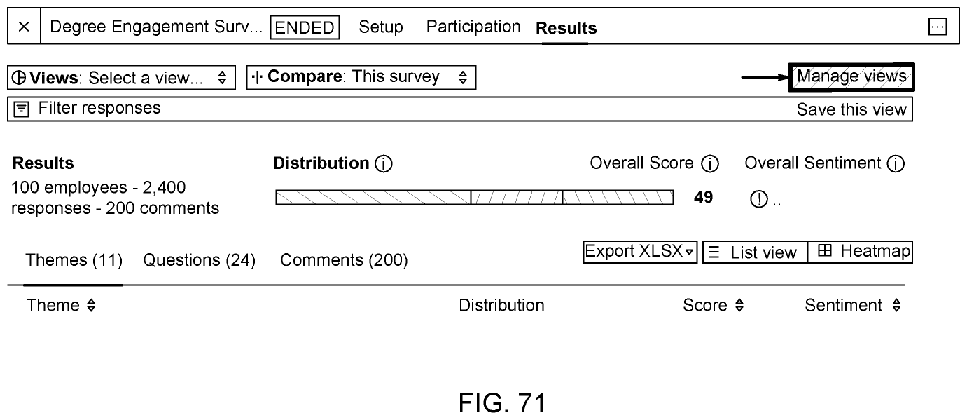

FIG. 71 is a screenshot of an example user interface for specifying a group to share results with.

From here, select the group you would like to share results for:
Department heads will see survey results from members of their own department
Managers will see survey results from their direct reports
Managers of managers will see survey results from their indirect reports
   Please note: Saved views will not be shared if the anonymity threshold is not met.

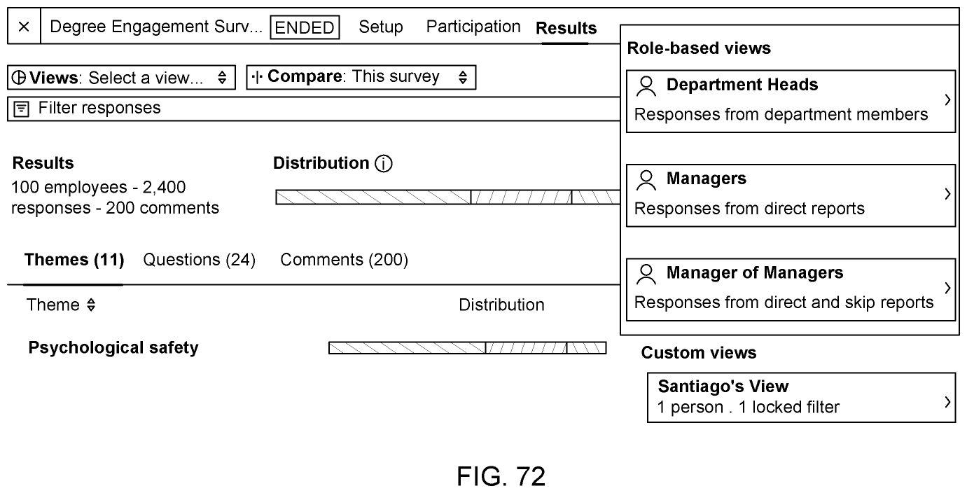

FIG. 72 is a screenshot of an example user interface for saving role-based views.

Once you select your view, you will have the opportunity to adjust the view settings to determine if the group will have access to the following:
Enable filtering: Allow the group to filter results when viewing responses and heatmaps. Please note, department heads, managers, and managers of managers will never have visibility into results that are not within their organization. Filtering capabilities are limited to custom user attributes that are visible to everyone; non-admins are unable to filter by admin, admin+manager-only user attributes in shared views. This feature only allows the group to add additional filters to the results they have access to. If toggled off, the top filter bar and heatmap analysis will be disabled.
Show comments: Allow the group to view anonymous comments from survey responders. If toggled off, the Comments tab will not be visible within the view Please note, if you have set the survey to allow managers or managers of managers to reply to anonymous comments, you will need to disable their access to replies before you can toggle off comments within the saved view.

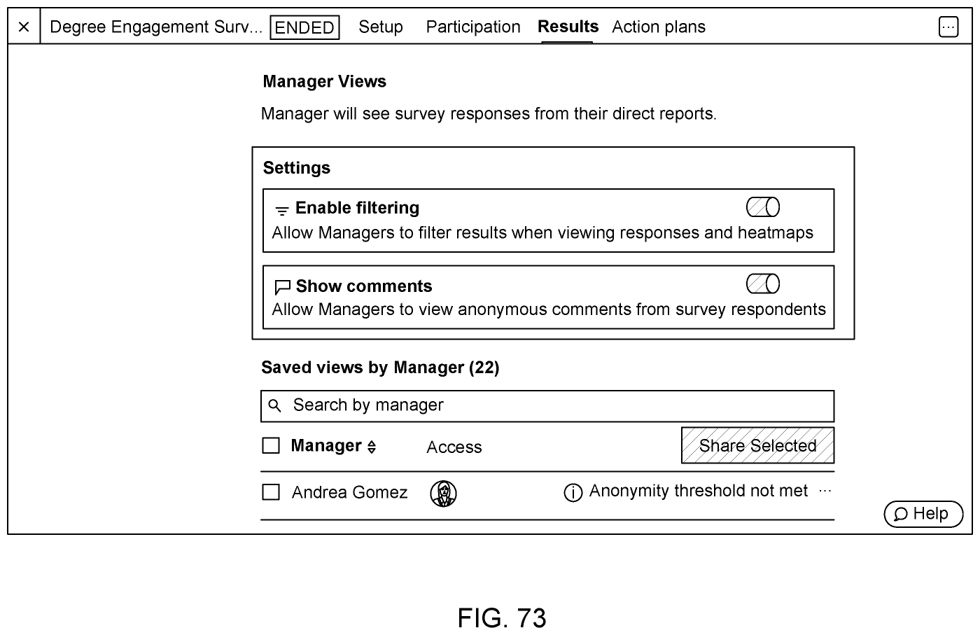

FIG. 73 is a screenshot of an example user interface for specifying settings for manager views, including whether to enable filtering and/or show comments.

After choosing your settings, you will have the opportunity to (1) preview the view they will see, (2) manage access by adding or removing employees from the visibility group, and finally (3) share with the selected group.

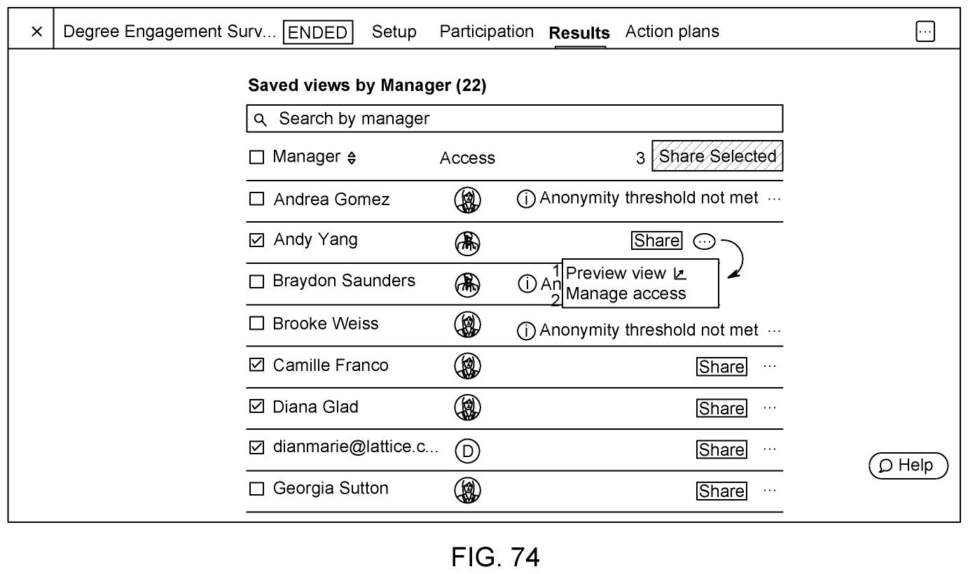

FIG. 74 is a screenshot of an example user interface for previewing, managing access, and selecting a sharing group for saved views (e.g., for a manager).

### Manage Access

As the admin, you have the opportunity to customize the view even further by managing access. You can add or remove any user to the role group to give or remove their visibility.

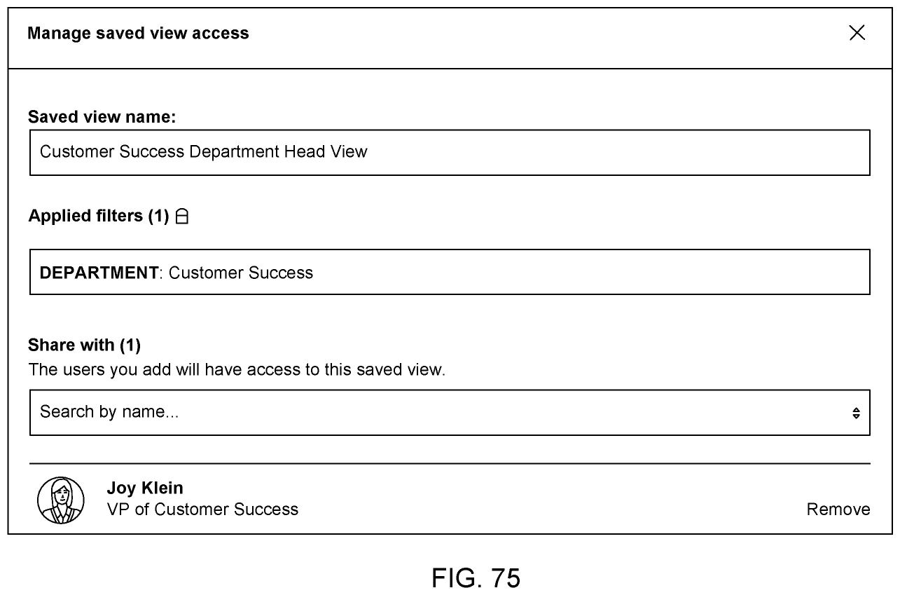

FIG. 75 is a screenshot of an example user interface for managing saved view access.

The employees with whom the survey is being shared will get an email with a link to the Results tab, including all its functionality, with the preset filters locked in. They will not remove the preset filters, but they can add additional filters when exploring the data.

### Custom Views

Sometimes you may want to create a view that does not necessarily fall into a specific department or a team. In these cases, a custom view may be a better choice.

To set up a custom view, you will need to add the filters you want to share. For example, you may want to filter by office location. Once the filter is set, click on “Save this view” to give it a name and share it with an employee. Note that now the “Office Location: NY” filter is locked in.

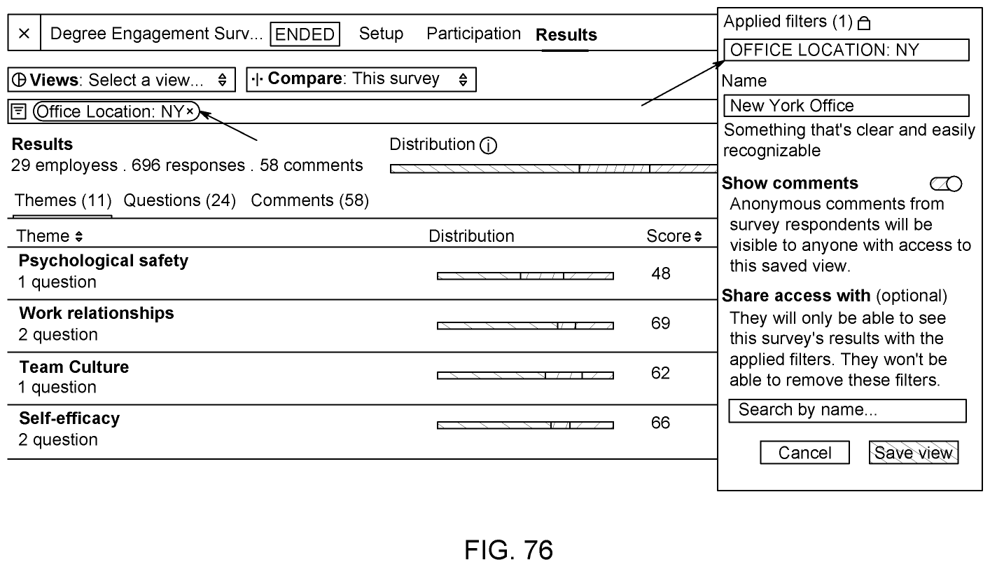

FIG. 76 is a screenshot of an example user interface for adding filters (e.g., office location) for a custom view to share.

When creating a saved view, you will have the option to toggle on/off sharing comments. To share comments, make sure to toggle on the “Show comments” setting:

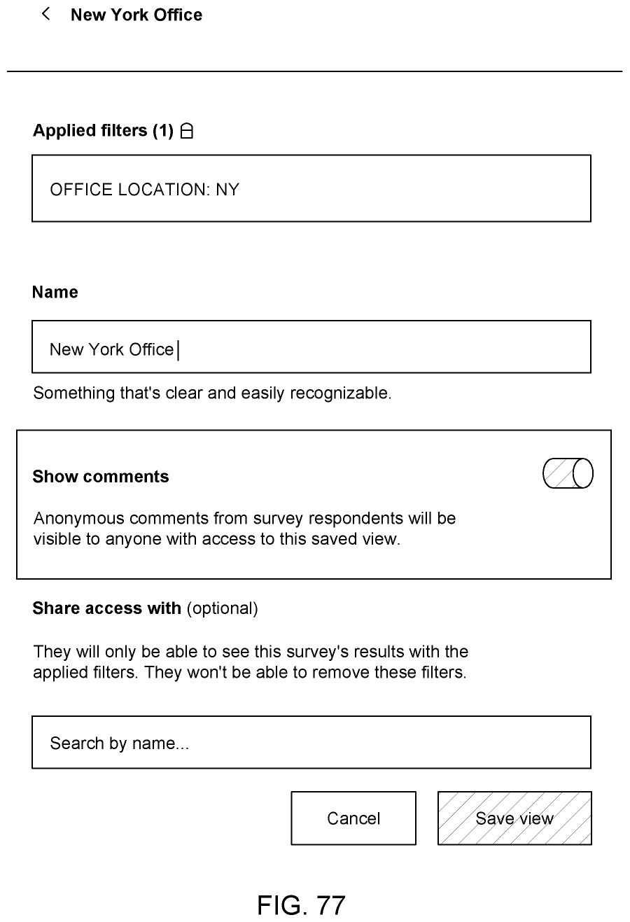

FIG. 77 is a screenshot of an example user interface for enabling comments from survey respondents to be visible to users with access to a saved view.

To hide comments, turn off the toggle. Those who have access to the view won't see the comments when this is turned off. Please note: the share/hide comments feature is only available for custom views.

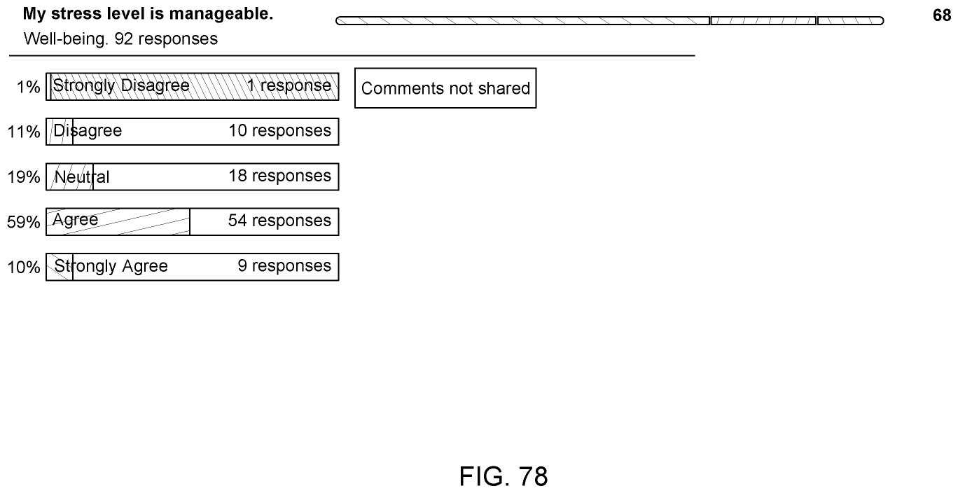

FIG. 78 is a screenshot of an example user interface for presenting a custom view when comments are turned off.

### Managing Shared Surveys

If you want to manage your saved views and who you've shared them with, click on the “Manage views” button to open up the view sidebar.

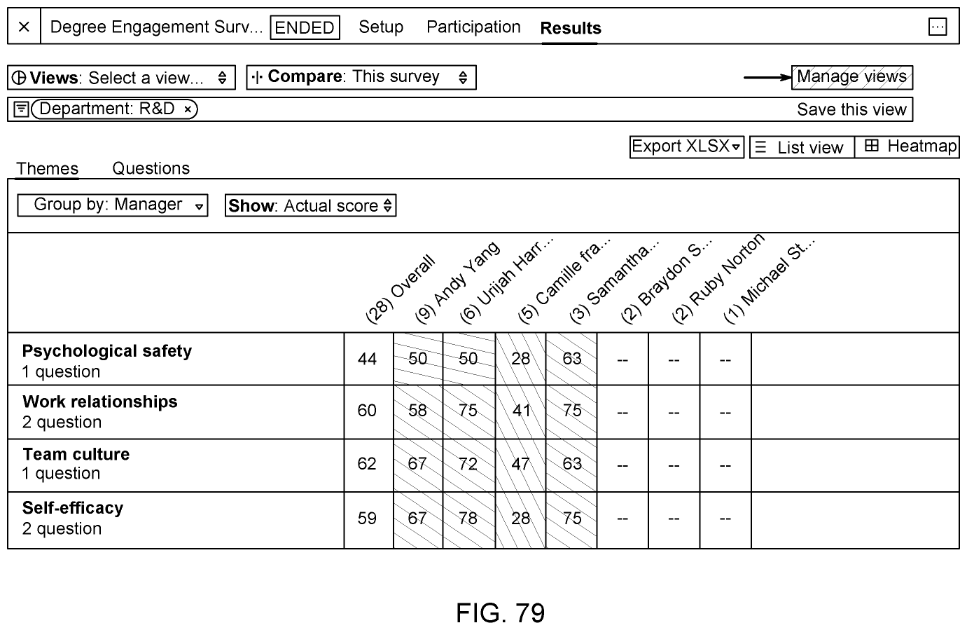

FIG. 79 is a screenshot of an example user interface for managing a saved view, including users it is shared with.

From here, you can delete the views you've created, share existing views with more people, or remove access to views.

Unshare reviews by clicking into the associated view and removing the user.

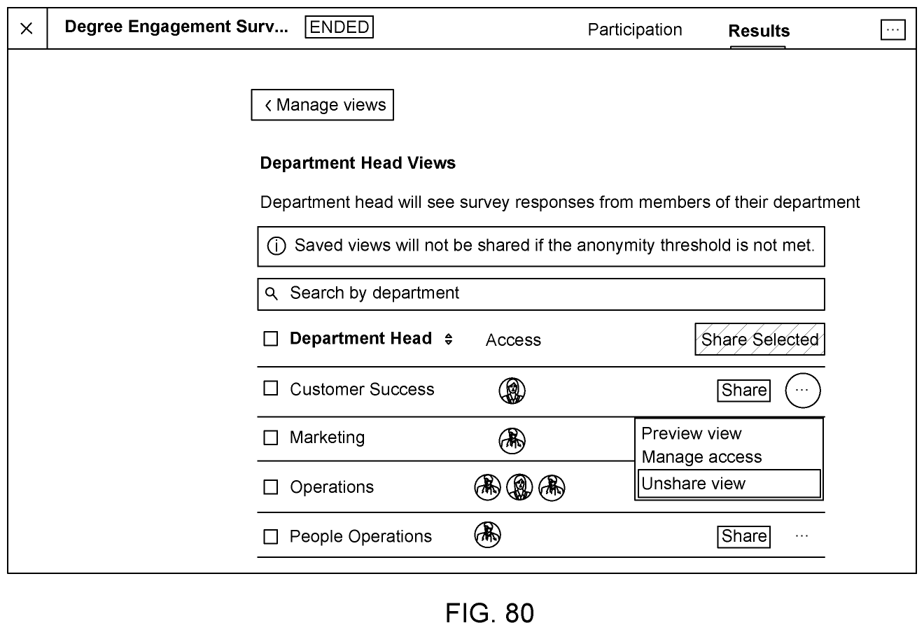

FIG. 80 is a screenshot of an example user interface for unsharing a view (e.g., from users with a “department head” role).

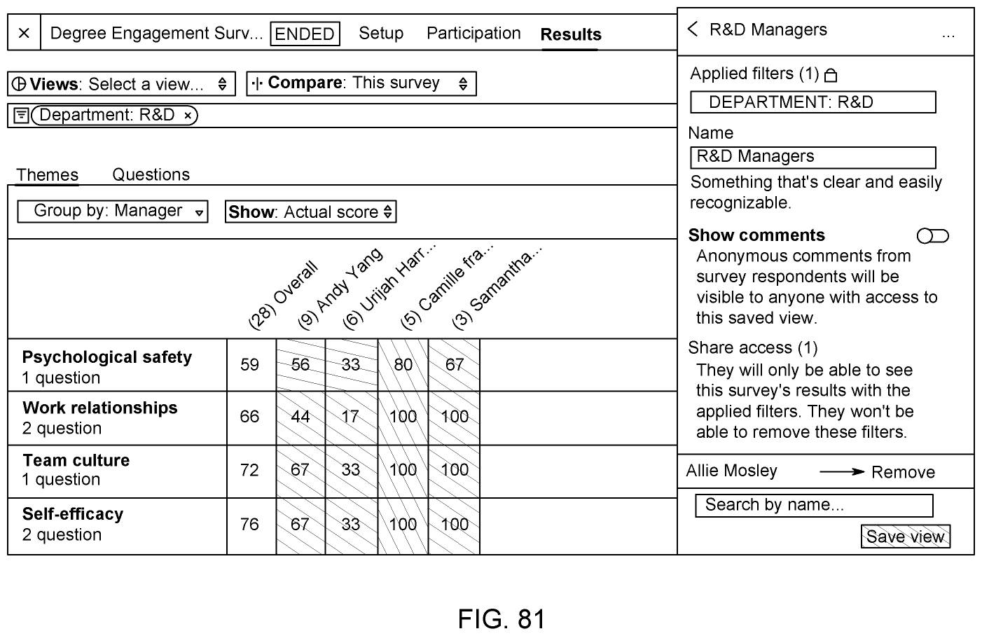

FIG. 81 is a screenshot of an example user interface for unsharing a view from a particular user.

### Edit/Delete Saved Views

Once you have created a custom view for your engagement survey, you may find that the view is no longer relevant the way it currently exists. The system allows you to edit or delete saved views to keep the filters that are the most pertinent to you.

Note: Only the survey admin who created the view can delete it.

### Edit a View

Step 1: Navigate to Admin>Engagement>Auditing.

Step 2: Click on the desired survey.

Step 3: Click on the Results tab.

Step 4: Select Manage views and enter the desired view.

Step 5: Make your changes and select Save view.

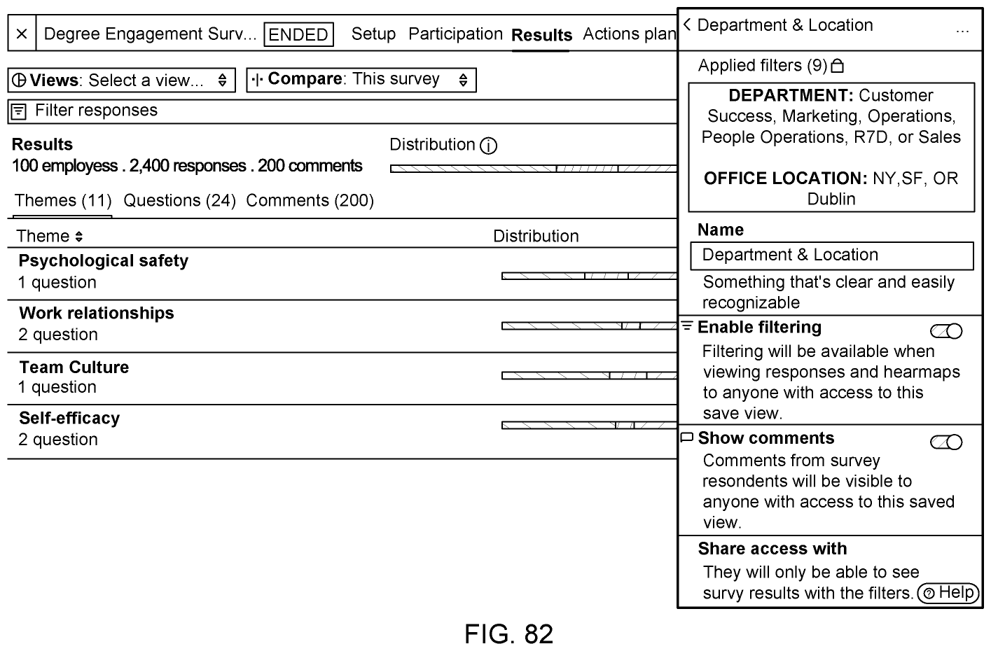

FIG. 82 is a screenshot of an example user interface for editing a view.

### Delete a View

Step 1: Navigate to Admin>Engagement>Auditing.

Step 2: Click on the desired survey.

Step 3: Click on the Results tab.

Step 4: Select Manage views and select the desired view.

Step 5: Select ellipsis>Delete view next to the view title.

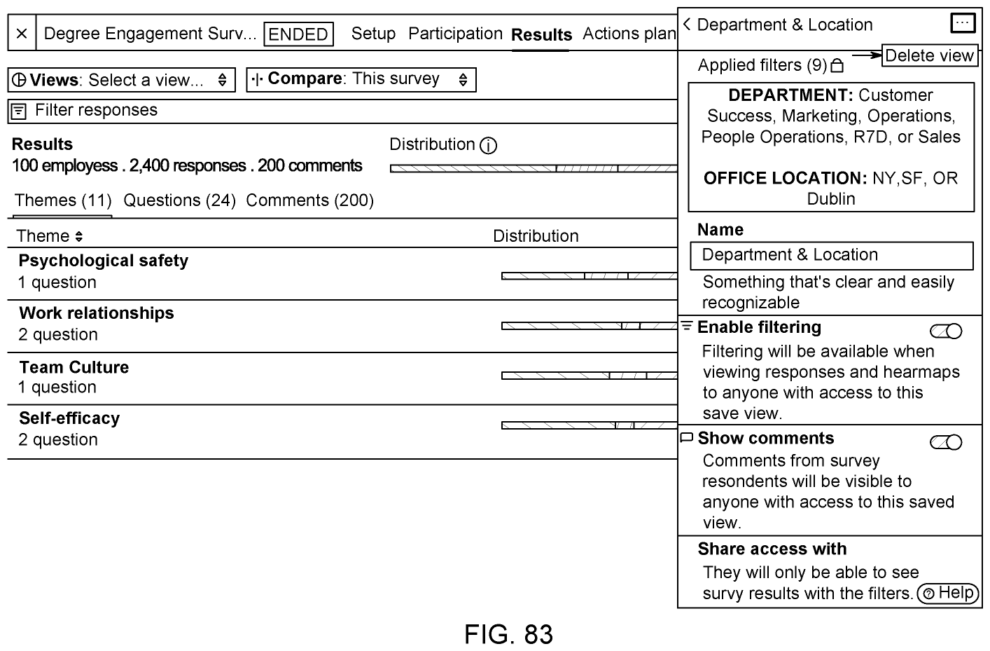

FIG. 83 is a screenshot of an example user interface for deleting a view.

Any users who have had a saved view shared with them can access their survey view on their home or people page.

Note: If multiple saved views have been shared for the same survey, there will only be one link.

If you are a survey admin, learn how to create a saved view of your pulse survey results with anyone at your company.

### Option 1: From Your Home Page

Step 1: On your home page, click on View results from your profile card. Please note: Depending on whether or not your survey admin has created an action plan for this survey, you may see the View action plans button instead.

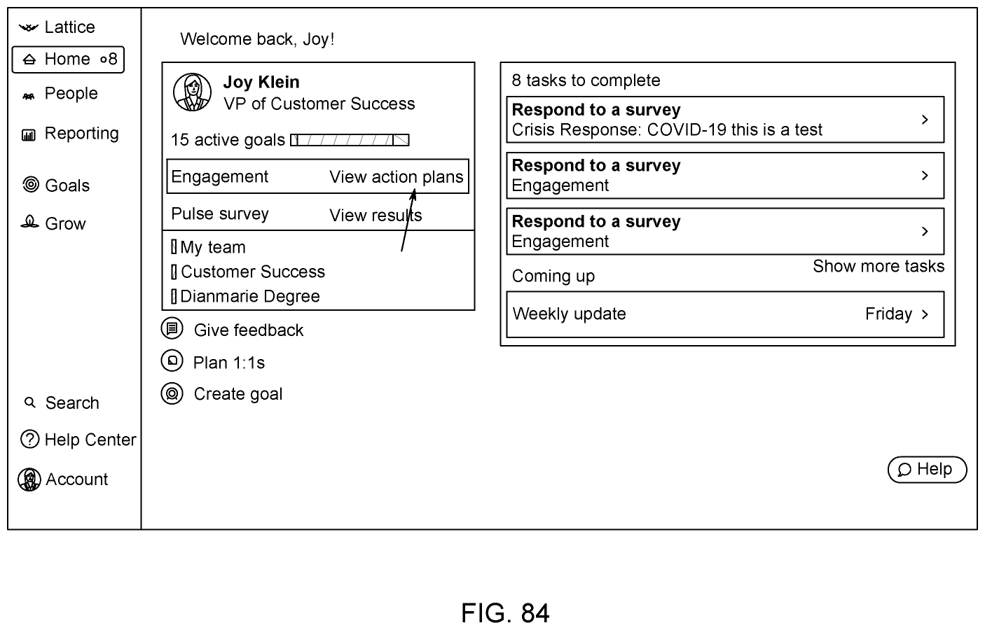

FIG. 84 is a screenshot of an example user interface for viewing action plans associated with a user (e.g., an employee).

Option 2: From your People page
Step 1: Click on the People page.
Step 2: Select your own profile page.
Step 3: Click View results next to the engagement survey.
   Please note: Depending on whether or not your survey admin has created an action plan for this survey, you may see the View action plans button instead.

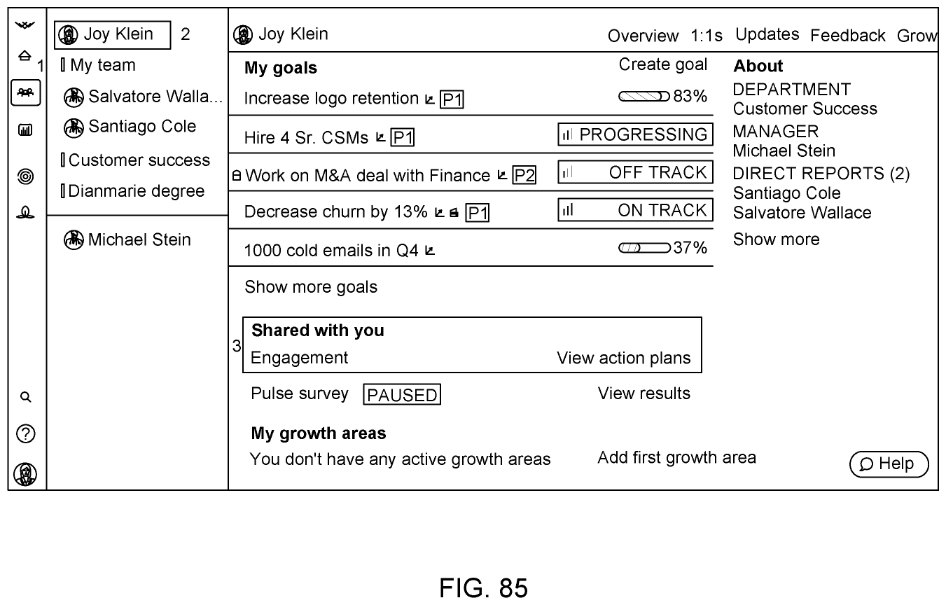

FIG. 85 is a screenshot of an example user interface for accessing action plans associated with engagement for a user.

Saved views can also be accessed from your initial email notification. Select View your report to be directly taken to your saved view in the system.

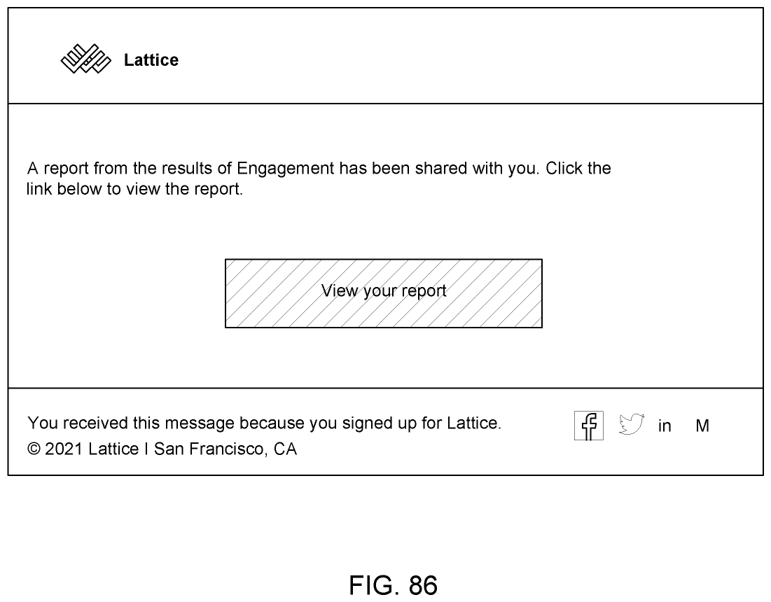

FIG. 86 is a screenshot of an example user interface for accessing results of engagement with a user.

### Exporting a Survey Heatmap

While you can directly share the survey results with other team members within the product, admins might want to export just the survey heatmap to include in presentations or to send a specific view of the data to others directly.

Survey admins can view and export the heatmap at any time after the survey is launched, as soon as the anonymity threshold has been reached for your questions or themes.

Currently, we allow exporting the heatmap to an Excel file. To do so:

Step 1: Navigate to the admin page found at the bottom of the discovery navigation.

Step 2: Click on “Surveys”>“Auditing” under the Engagement section in the secondary navigation.

Step 3: Find the survey you would like to see results for and click on it.

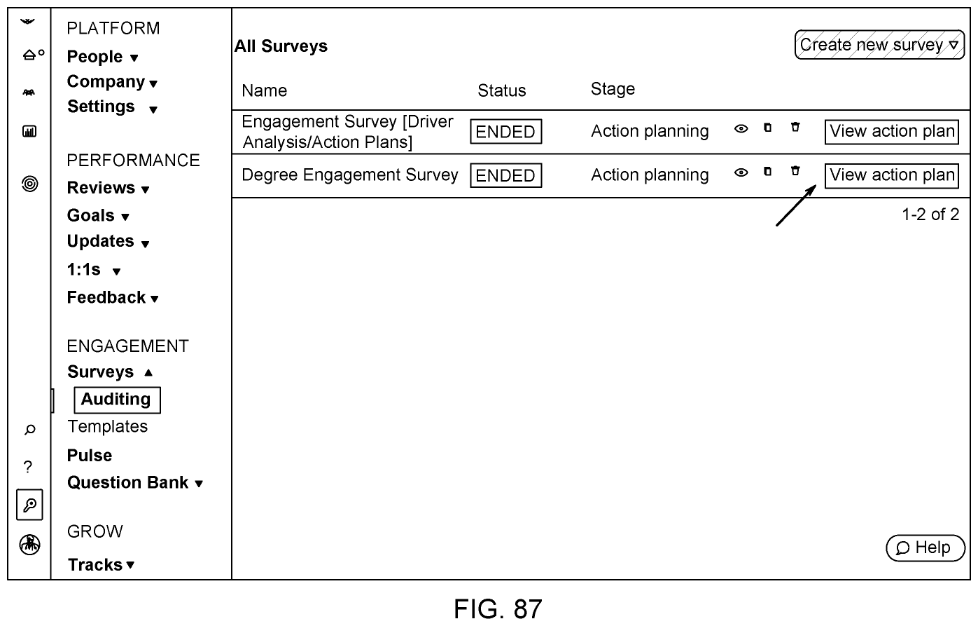

FIG. 87 is a screenshot of an example user interface for viewing action plans associated with specific surveys.

Step 4: Toggle to whether you want to view your data by theme or by a question, and then toggle to the “Heatmap” view. Then choose what you want to group by (gender, department, etc.), filters that you might want to be applied, and whether you want to see absolute scores or deltas.

Step 5: Click “Export XLSX” and then select “Export Heatmap.”

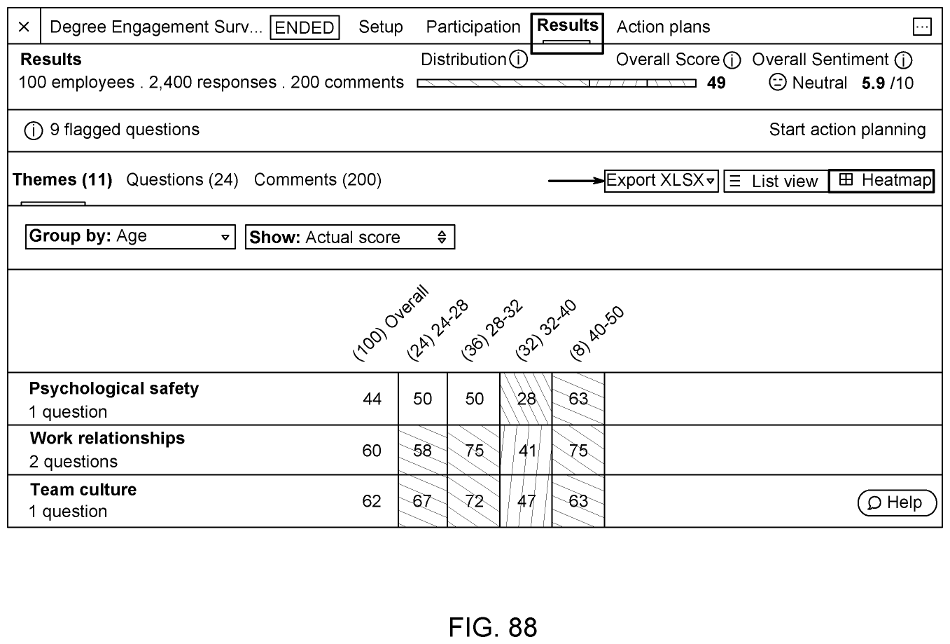

FIG. 88 is a screenshot of an example user interface for exporting a heat map associated with survey results.

This will export the heatmap as you see it in the system to a spreadsheet (e.g., an Excel) file.

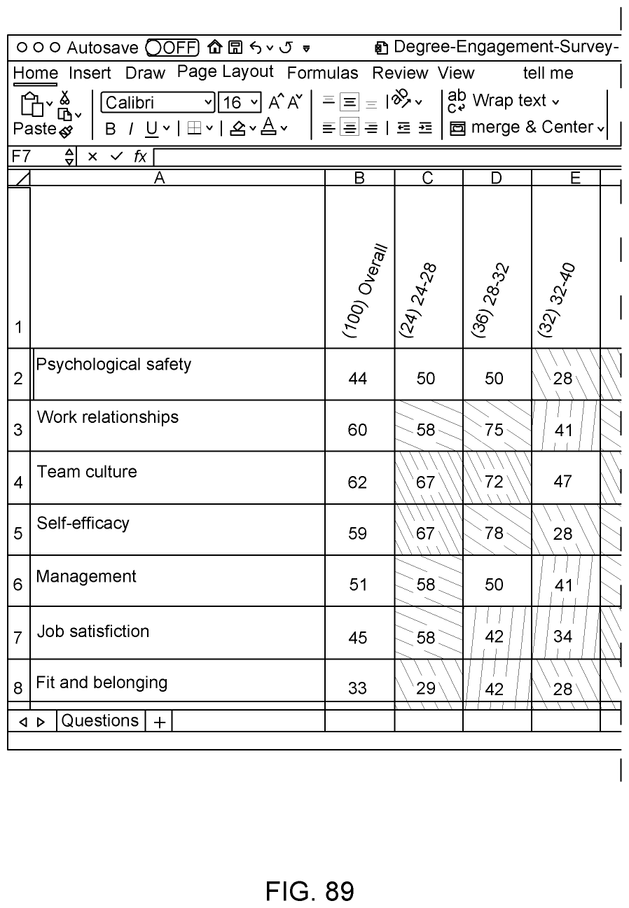

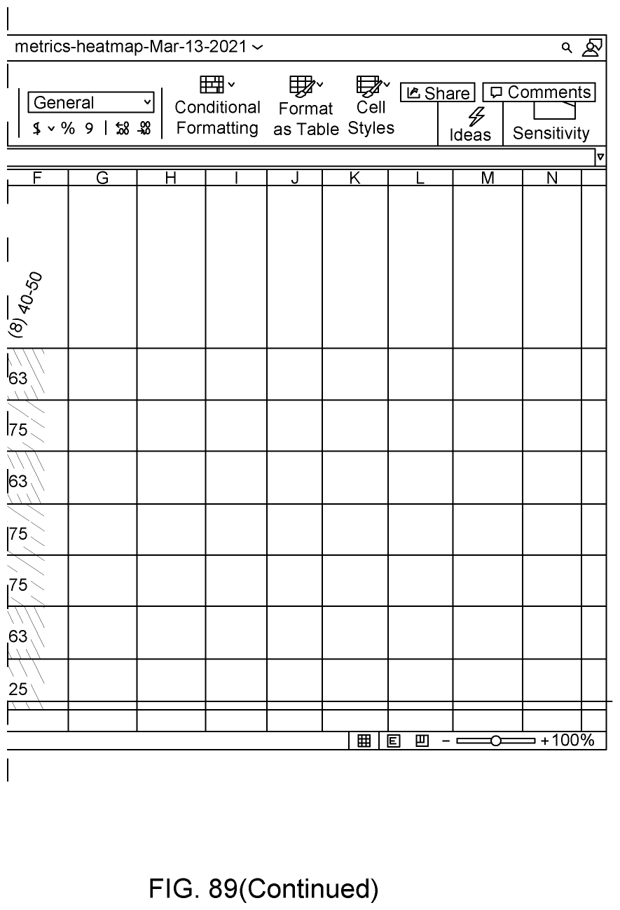

FIG. 89 is a screenshot of an example user interface for viewing an exported heat map in a spreadsheet.

You can export heatmaps for both themes and questions by toggling on the lefthand side and then clicking on “Export XLSX” on the right.

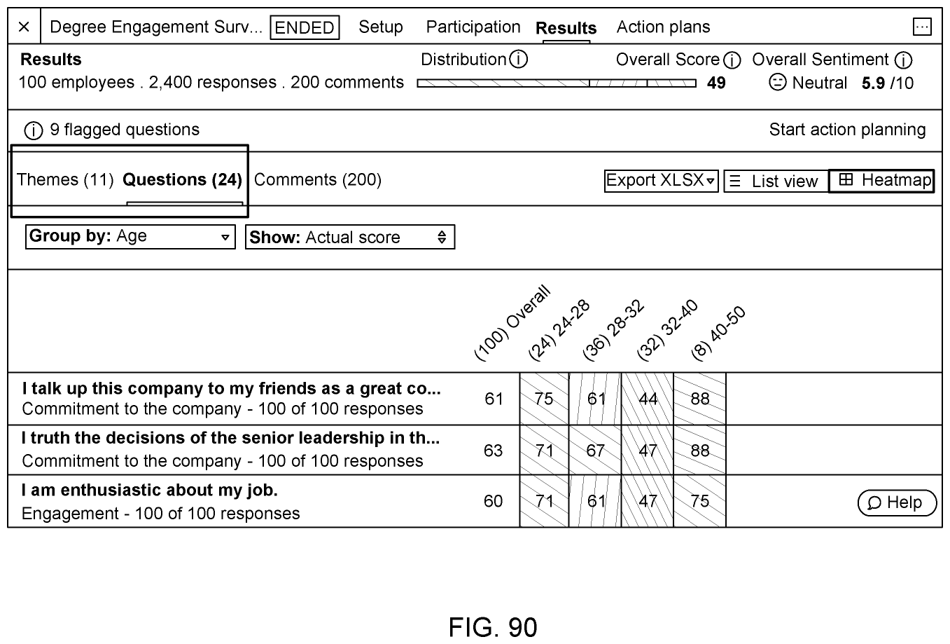

FIG. 90 is a screenshot of an example user interface for exporting heatmaps for one or more of themes and questions associated with a survey.

Why would I want to Export My Heatmap?

After exporting your heatmap to Excel, you can edit the Excel file in any way you choose, deleting unwanted columns or rows. Then, it's easy to select the data that you want to present and copy the cells into a PowerPoint presentation for an all-hands meeting or a leadership meeting.

Statistical significance is an important concept for analyzing pulse and engagement survey scores over time. This is also particularly important to consider when comparing results from different populations and attributes within your data.

The certainty (%) is the confidence in the accuracy of your survey results. In this case, the confidence level of 95% certainty allows us to say that we are 95% sure that this sample of employees is representative of the population. To break it down further, we can say that if we run this survey 100 times, we'd expect results to match what we're seeing now f margin of error at least 95 times.

The margin of error (MOE) is a statistic that predicts the amount of the random sampling error in survey results. To calculate the MOE, multiply the % by the scale. For example, if the average for a given question is 4 and your MOE is ±10%, then there's a 95% chance that the full population's average is between 3.5 and 4.5.

As an admin, you may be wondering how many responses you need to receive for there to be value in distinguishing the scores. After you launch your survey, you can take a look at a graph to see what your margin of error is. The graph shows the relationship between the size of the population and what % of that population needs to respond in order to have a given margin of error.

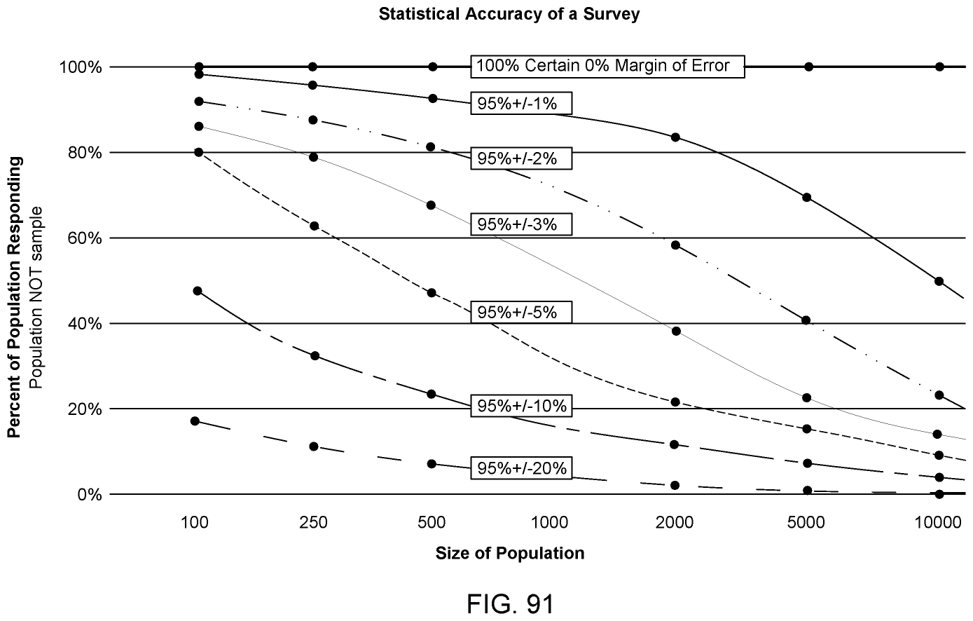

FIG. 91 is a screenshot of an example user interface for accessing a statistical accuracy of a survey.

As an example, let's say 75% of people have filled out your engagement survey. You can use the graph above to see what your margin of error is (based on the population of employees at your company). In this example, we'll use a company of 100 employees. If your employee population is 100 and you want to have a margin of error of ±5%, you'd need to have 80 people respond to the survey (light blue line above). If 50%¹ of people filled out the survey, then the margin of error is ±10% (yellow line above).

### A Few More Things to Note Here:

This does not mean that if you have fewer responses, you won't have usable results—the margin of error will just go up! The margin of error is particularly important when looking at results over time.

The number of times a question is asked is less important than the number of people who respond to it, and what that latter number represents as a percent of the total employee population.

It's also important to note that if you are planning to do any slicing on the data, e.g., gender, department, etc., that will have an impact on the statistical significance for that subset of employees. For example, if your company has 200 employees split evenly between men and women, then you'll be looking at a population of 100 of each (for this attribute). This will then change the margin of error due to the decreased population size

### Looking for Ways to Increase Survey Participation?

As an admin, you can write a reminder to employees to submit their surveys. The reminder will only go to employees who have not yet submitted their surveys.

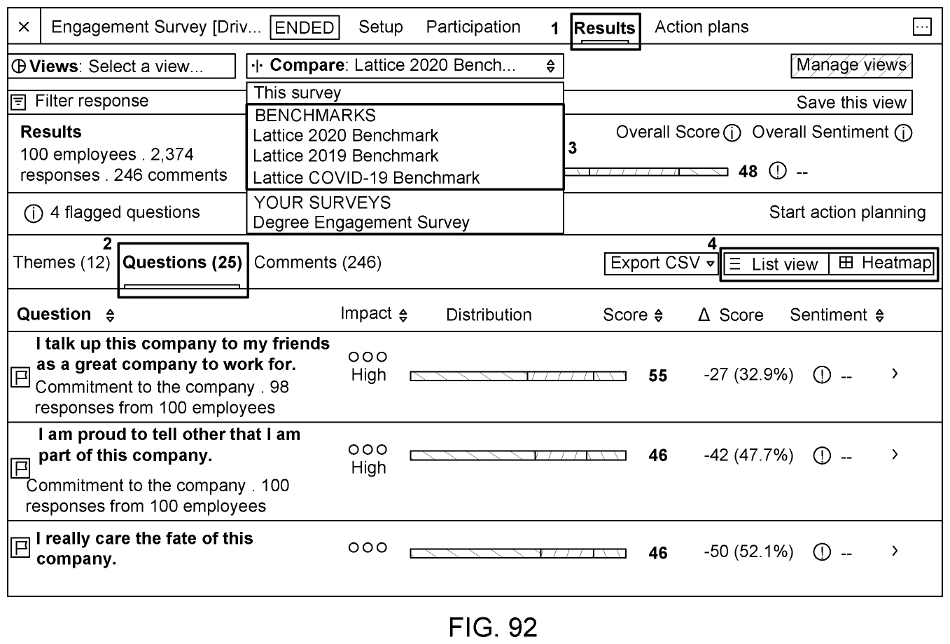

FIG. 92 is a screenshot of an example user interface for viewing a delta across multiple survey results.

### Lattice Benchmark for Engagement

The Lattice benchmark for engagement lets you know how your company compares to other Lattice customers using real survey data taken from our recommended Lattice question bank. It is an easy-to-understand score, showing how your organization is doing compared to other organizations that are asking the same engagement questions.

The following benchmarks are available in Lattice:
Lattice 2019: Overall
Lattice 2020: Overall
Lattice 2020: COVID-19
Lattice 2021. Overall
Lattice 2021: Top Decile
Lattice 2021: Top Quartile
Lattice 2021: Employees: 0-250
Lattice 2021: Employees: 250-1k
Lattice 2021. Software & IT
Lattice 2021: Prof & Biz Svcs
Lattice 2021: North America
Lattice 2021: Europe

### Enabling a Lattice Benchmark

To enable a Lattice benchmark, you will need to utilize the preloaded set of curated engagement questions. To see the Lattice benchmark in engagement survey results, follow these steps:

Step 1: Navigate to the Results tab of the survey.

Step 2: Select Questions.

Step 3: Select List View.

Step 4: Click on Compare and select your desired benchmark option, e.g., Lattice Benchmark 2020, Lattice Benchmark 2019, Lattice Benchmark COVID-19, and more.

Step 5: Click on a Delta to get more insight into any specific question.

### Understanding Lattice Benchmark

The Lattice benchmark will allow you to compare the company average score for a specific question against a representative set of Lattice customer benchmarks. The benchmark will stack your company, giving your organization a ranking where you stand compared to other companies. It will also provide a percentage of how above or far your organization is from the Lattice Benchmark.

1. For the question, “I have a best friend at work,” this is an area where this company is doing well. The overall distribution of responses is positive, resulting in a company's score of 54, which is above the Lattice benchmark (45). Therefore, the company is 9 points above the Lattice benchmark. Another way to see this is that this organization scored 20% better than the Lattice benchmark.

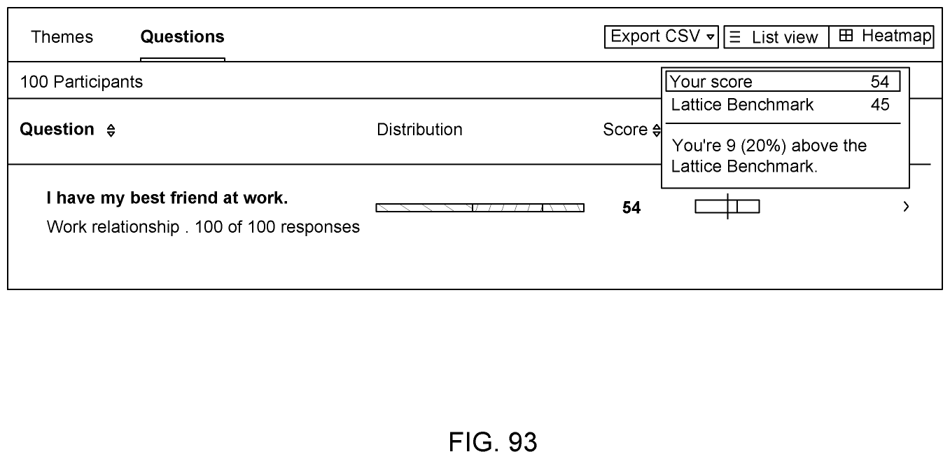

FIG. 93 is a screenshot of an example user interface for accessing an overall distribution of responses relative to a benchmark.

2. For the question, “I find that my values and company's values are similar,” this is a potential area of improvement as. The overall distribution of responses leans on the negative side, resulting in a company's score of 32, which is below the Lattice benchmark (81). Therefore, the company is 49 points below the Lattice benchmark. Another way to see this is that this organization scored 60.5% worse than the Lattice benchmark.

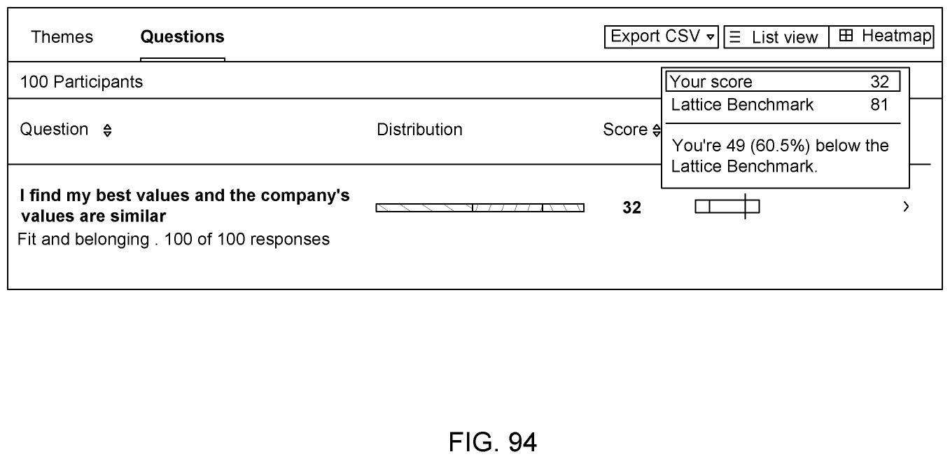

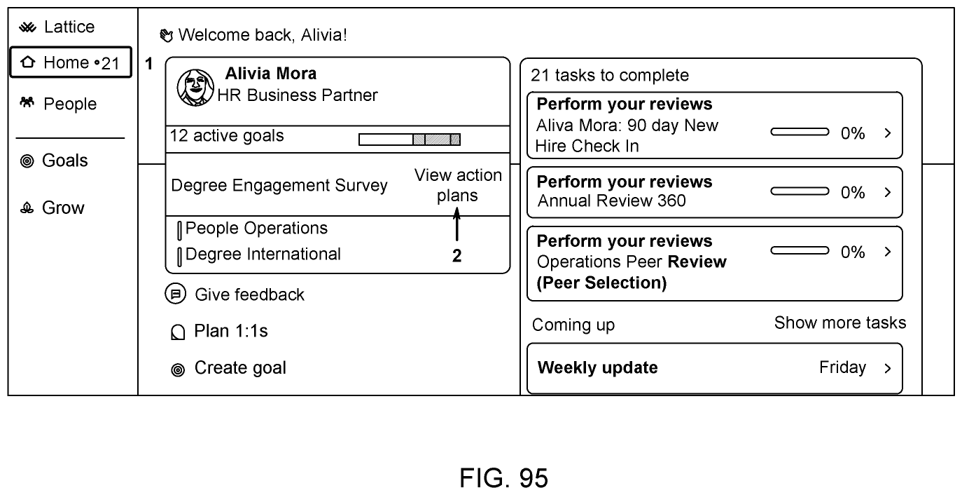

FIG. 94 is a screenshot of an additional example user interface for accessing an overall distribution of responses relative to a benchmark.

### Why Use the Lattice Benchmark?

Through the use of a Lattice benchmark, you will be able to get further insights into how your company is doing compared to other Lattice customers. By being able to compare your company with other organizations:
You will be confident that your conclusions and actions are informed by data from real companies facing the same challenges and focusing on the same initiatives as your organization.
With data and comparative benchmarks that contextualize your results against a representative set of other companies, you can learn exactly what the themes are that make your culture click.
The data the Lattice benchmark provides can help identify the areas that your team can most meaningfully improve to ensure the moments that matter in the employee experience are prioritized to be impactful.

### Action Plans

Action plans help your company and team organize and tackle opportunities to improve employee engagement and happiness. Action plans help create initiatives based on specific focus areas based on the results of your engagement survey. There are two kinds of action plan:
Company action plans: Initiatives that impact all employees
Manager action plans: Initiatives that impact your direct peers and team.

Only action plan owners can update an action plan. You will receive a notification for each update made to the Manager action plan.

### Updating an Action Plan

### Navigate to Action Plans

Step 1: Navigate to the Home page.

Step 2: Within your profile card, next to the desired survey, select View action plans.

FIG. 95 is a screenshot of an example user interface for accessing action plans from a user profile.

### OR

Step 1: Navigate to People>My profile>Shared with you.

Step 2: Next to the desired survey, select View action plans.

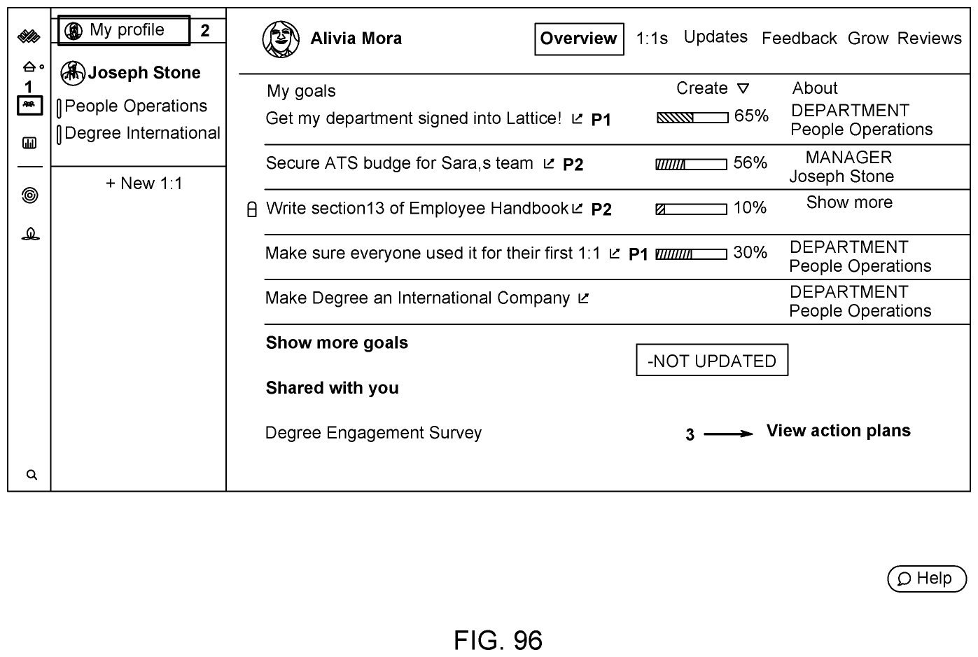

FIG. 96 is a screenshot of an example user interface for accessing action plans from surveys shared with a user on a goals page associated with the user.

### Viewing Action Plans

If the company and manager action plans are visible to you, you will be able to see each section on the left-hand side.

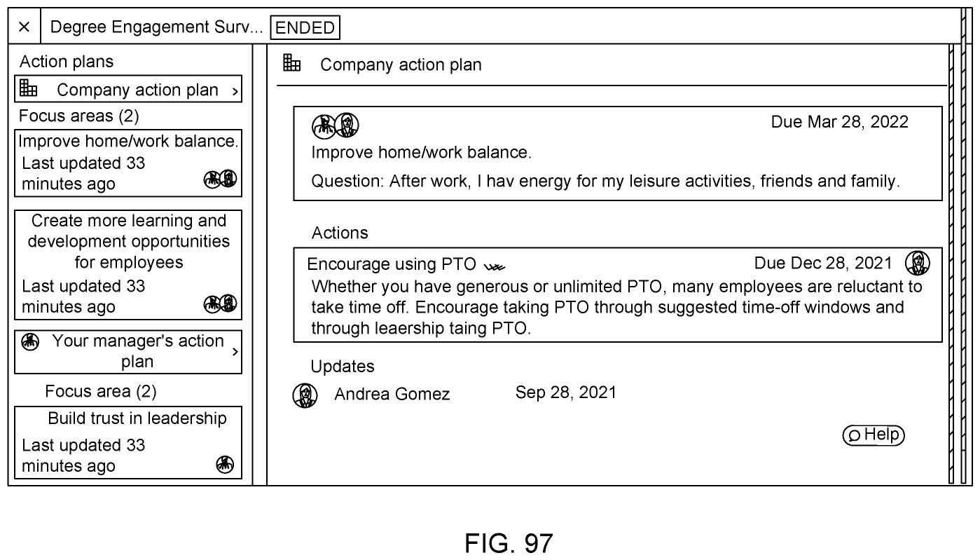

FIG. 97 is a screenshot of an example user interface for accessing action plans from a specialized secondary user interface window docked to a main window.

Each plan will include a focus area based on a question asked in the engagement survey. These focus areas are areas that your company or manager wishes to improve.

Next, you will see specific actions owners are taking to improve on each focus area. Updates made to the area are found below.

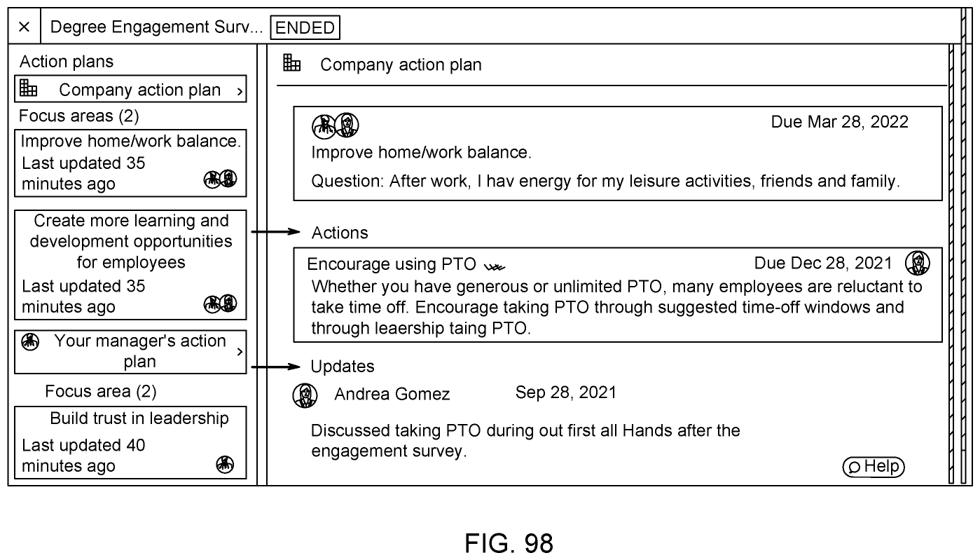

FIG. 98 is a screenshot of an example user interface for managing actions and/or updates for a focus area identified from a survey.

Lattice has developed a method to identify questions that have a high impact on engagement. We call this driver analysis, and we run this analysis using a set of baseline questions.

### What is a Baseline Question?

Baseline questions are the questions that typically drive overall engagement. For this purpose, we default to use our engagement-themed questions from the Lattice question bank for driver analysis.

For driver analysis, Lattice will look at employees who answered high on questions that “drive engagement” and then identify which other questions they are more positive on than other employees. Lattice then looks at those who answered low on “drive engagement” questions and sees what questions they are less positive about than others. Questions with high impact tend to drive engagement, and focusing on improvement in these areas is likely to improve engagement.

### How to Select Default Engagement Theme Questions

When setting up your engagement survey, you can select Lattice's default engagement theme questions to be your baseline questions.

Step 1: Under the “Questions” tab, select the engagement theme from the question bank context panel.

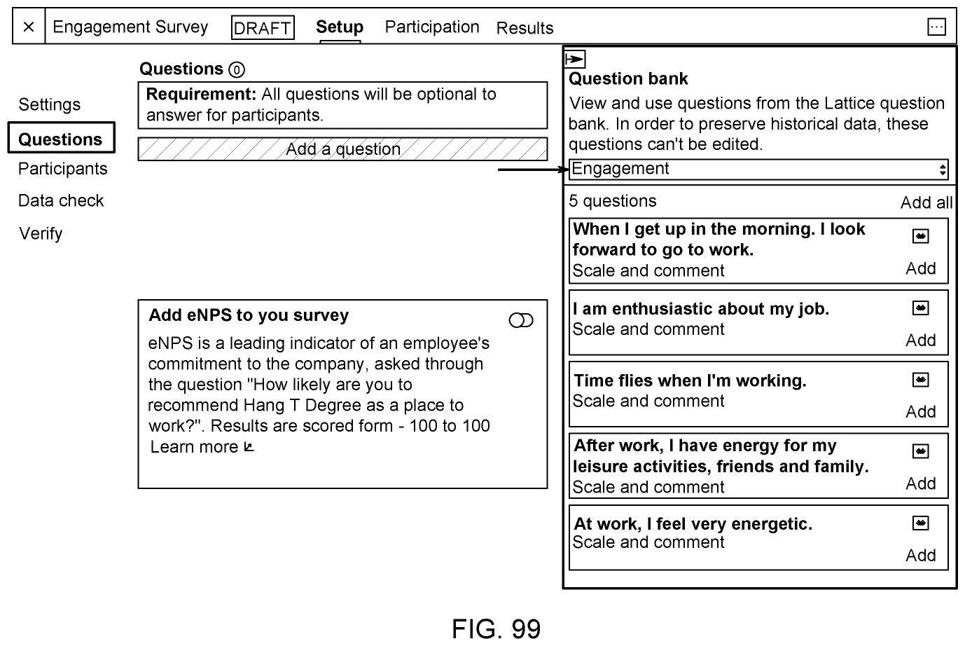

FIG. 99 is a screenshot of an example user interface for selecting a baseline question for a survey.

Please note, you don't need to select all five engagement theme questions to run driver analysis.

Below are Lattice's five default engagement theme questions:
1. When I get up in the morning, I look forward to going to work.
2. I am enthusiastic about my job.
3. Time flies when I'm working.
4. After work, I have energy for my leisure activities, friends, and family.
5. At work, I feel very energetic.

If you would like to create your own engagement theme questions, please reach out to Customer Care or your CSM.

Once the engagement survey has ended, you will see which questions have a high impact based on the engagement theme questions. Here, high impact may be an impact transgressing a configurable threshold value, and the impact of each question may be measured through configurable rules and/or application of a machine-learning algorithm.

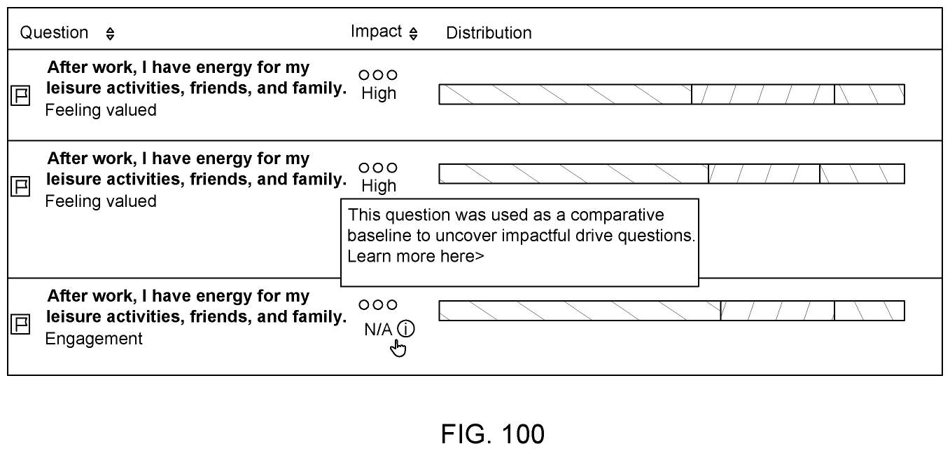

FIG. 100 is a screenshot of an example user interface for accessing questions that have a high impact.

Please note, if a question has an impact score of “N/A,” this means that question is either a baseline question, an open-ended question, or that the question didn't hit the anonymity threshold yet.

### What is an Impact Score?

The impact score is a way to choose which questions to focus on to improve engagement.

A survey question that has a high impact on engagement shows employees who respond more favorably to that question are also more engaged. A survey question that has a low impact shows no relationship between how employees respond to that question and how engaged they are.

Questions with high impact tend to drive engagement, and focusing on improvement in these areas is likely to improve engagement. It is important to remember that impact and favorability are not the same. A question with low favorability could have a high or low impact.

Please note, a question with low favorability may have a low impact on engagement if all employees gave a low response, regardless of their level of engagement. Simultaneously, another question with low favorability could have a high impact on engagement if the few people who gave positive responses were also the most engaged.

Driver analysis runs both at the company and manager levels. Once results are shared, managers can view impact based on their own data subset, which may be different than the company level.

### Next Step: Action Plans

After your survey has ended and after determining which questions to focus on based on your driver analysis, you are able to create action plans based on your highest impact questions in order to improve engagement scores.

### What are Suggested Actions?

A curated list of suggested actions may be presented to admins and managers. An original list of suggested actions may be mapped actions from real client use cases or recommendations made to clients as to the questions and themes within the engagement survey question bank. The list of suggested actions is then refined to ensure these actions reflect best-in-class product usage. In example embodiments, machine-learning models are trained and applied to create the curated list.

Each question may have between 2-5 suggested actions associated with it, and the suggestions are tailored to reflect the admin or manager persona. Please note, these Suggested Actions will only appear for specific individual questions and not for focus areas around themes.

### How to a Flag a Question to Add to an Action Plan

Step 1: From the “Results” tab select “Questions”.

Step 2: Click on the flag icon on the left side of the question to flag a question you would like to focus on.

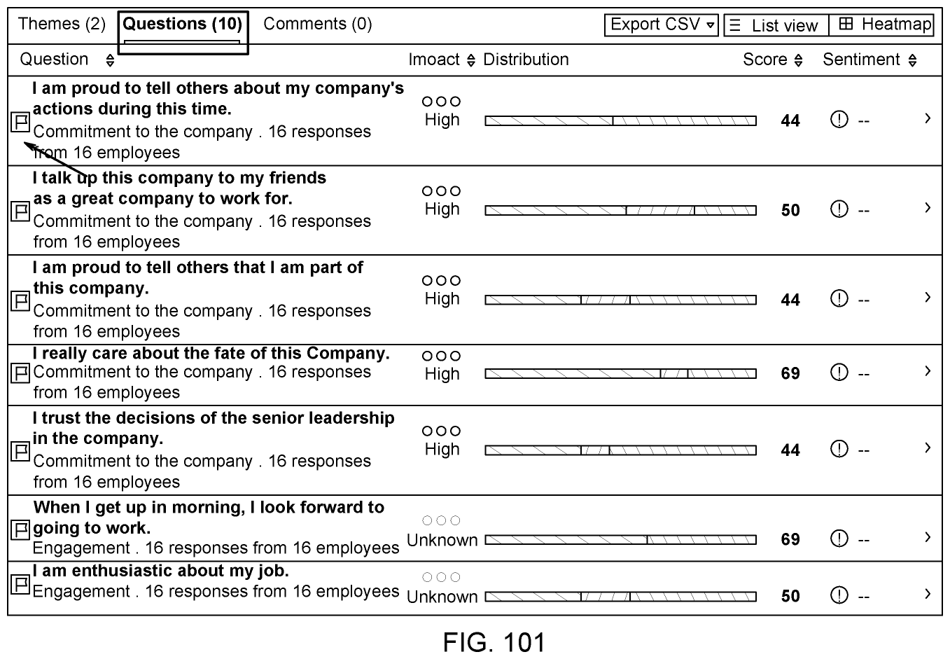

FIG. 101 is a screenshot of an example user interface for flagging a question to add to an action plan.

Once you have flagged your questions, you are able to create company focus action plans or manager focus action plans.

Step 3: Click on the “Action plans” tab to enable company and manager action plans.

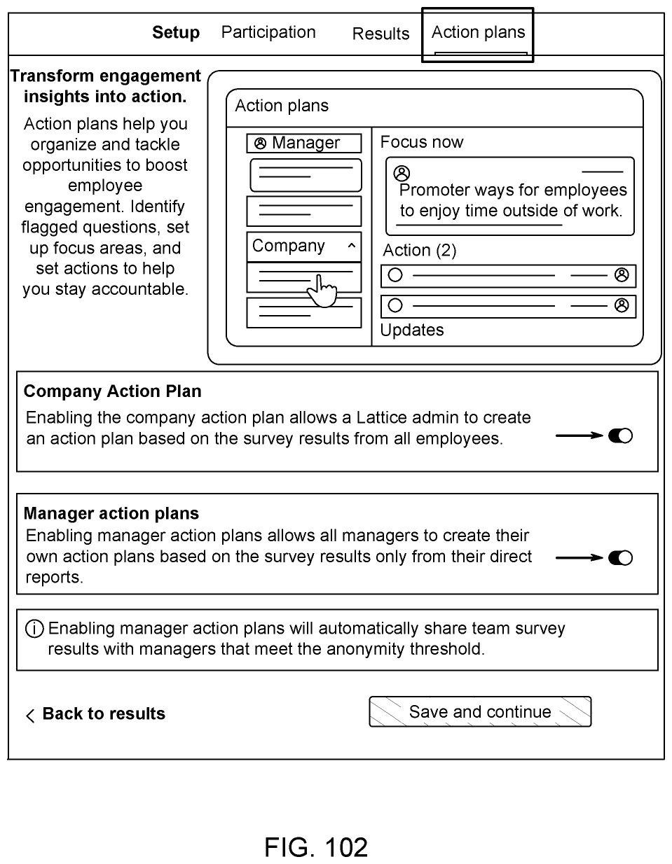

FIG. 102 is a screenshot of an example user interface for enabling company focus and/or manager focus action plans.

Please also note that when a manager is viewing their team's results, we will recalculate the impact scores for their team. This allows the manager to choose hyper specialized actions that are more centered towards their team.

### How Auto-Flagging Works

After your survey has ended, Lattice will automatically flag questions for you to focus on, so you can have a starting place for your action plan. The auto-flagging feature focuses on the “actionability” of questions, which is assessed using both how low a question score is and how high an impact score is. Questions with a score greater than a certain configurable number (e.g., 95) will never be auto-flagged—that high of a score indicates that engagement is already high and you might want to focus your efforts on other areas.

Lattice will select a top number (e.g., 2) of the most actionable questions from each theme, and from that set, a top number (e.g., 5) will be flagged In this example, Lattice will auto-flag at most 5 questions, with no more than 2 from every theme. However, there may be no limit on what users can manually flag to bring to their action plan. Users can also deselect a question that has been auto-flagged by simply clicking on the highlighted flag. In example embodiments, themes will also be auto-flagged based on the questions that were chosen. In example embodiments, users cannot flag themes manually.

### How to Create an Action Plan

Step 1: Click on “Create focus area” next to the question you'd like included in your company or manager's action plan.

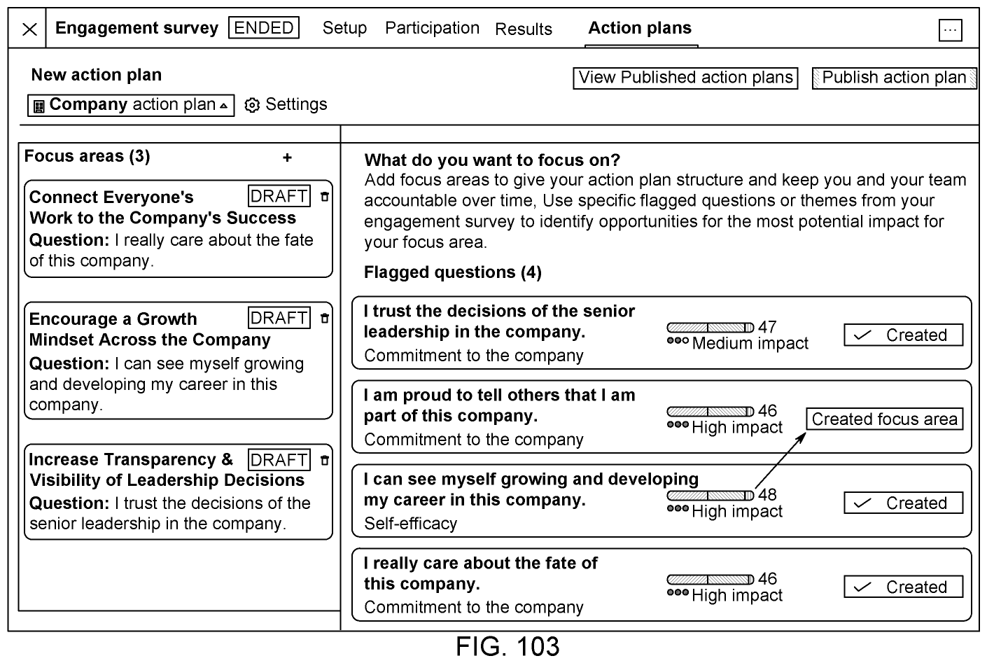

FIG. 103 is a screenshot of an example user interface for creating a focus area to include in a company and/or manager's action plan.

Step 2: Give your focus area a title and select the settings. Once complete, click “Save.”

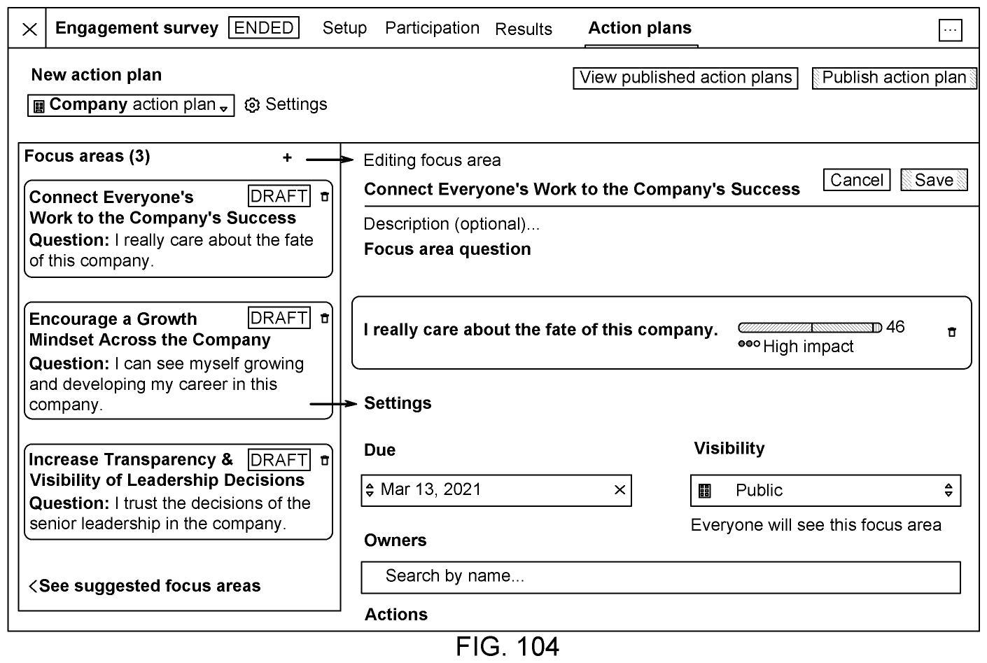

FIG. 104 is a screenshot of an example user interface for specifying settings for a focus for an action plan.

Step 3: Once you are ready to publish your action plan, click on “Publish action plan,” then select “Publish”.

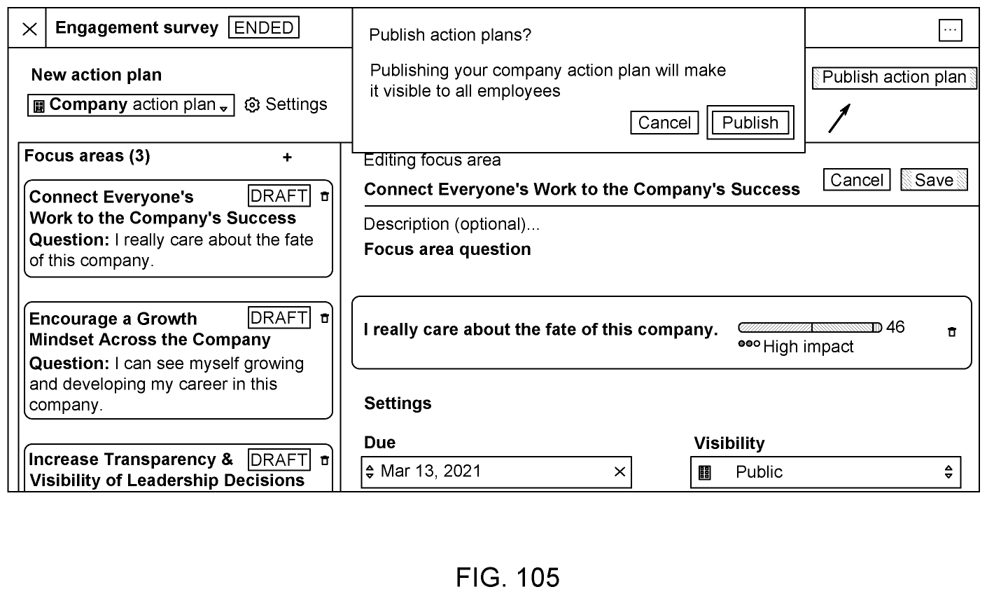

FIG. 105 is a screenshot of an example user interface for publishing an action plan.

Once published, your action plans will be listed under the “Action plans” tab.

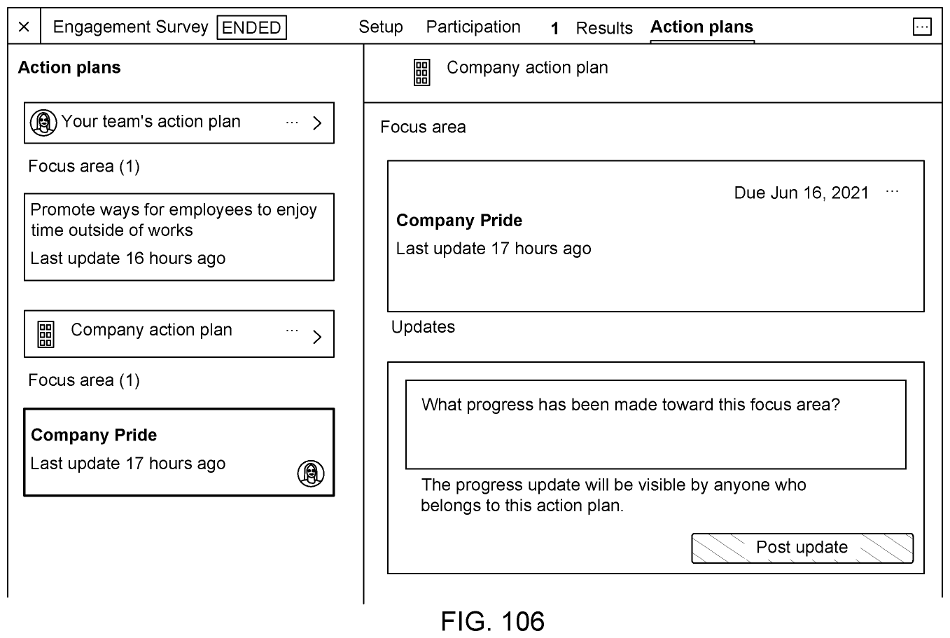

FIG. 106 is a screenshot of an example user interface for accessing a published access plan.

When you publish an action plan, you can no longer add additional focus areas or edit your actions until you unpublish.

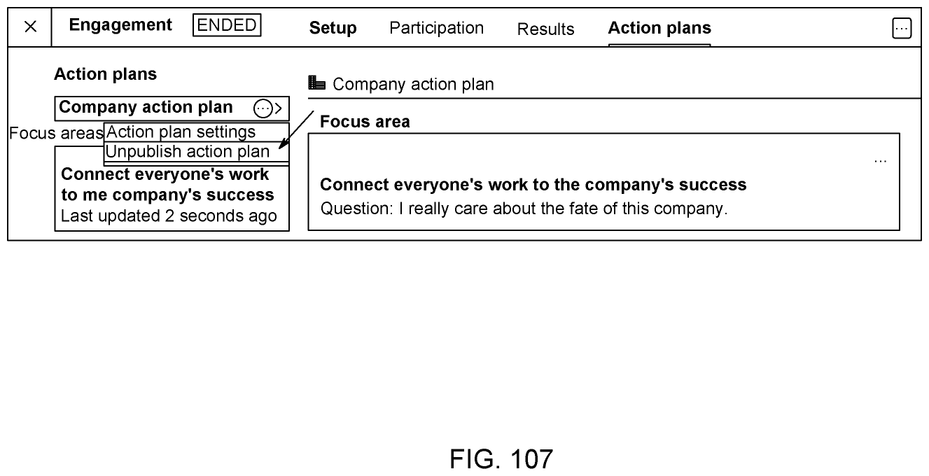

FIG. 107 is a screenshot of an example user interface for unpublishing an action plan.

Please note, depending on the risibility of your action plan (public or private), different groups of people will have visibility of the action plan this is called out in the ‘visibility’ drop-down in your action plan.

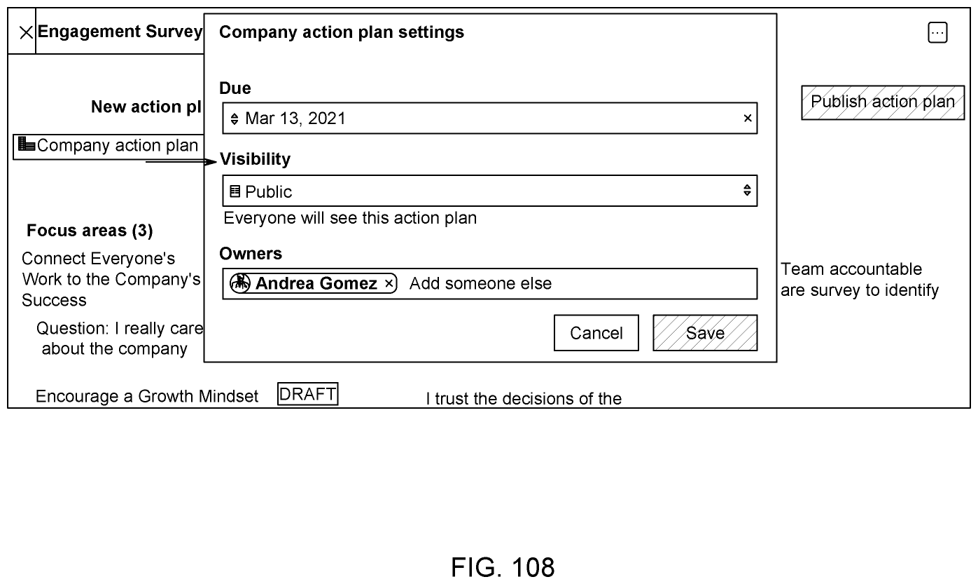

FIG. 108 is a screenshot of an example user interface for changing action plan settings, including due date, visibility, and/or owner(s).

Once manager action plans have been enabled and results have been shared, managers can create their own action plans based on the survey results only from their direct reports.

Step 1: Navigate to the Engagement page within the discovery navigation bar.

Step 2: Select Start action planning next to the desired survey.

Step 3: Enter Results>Questions.

Step 4: Select the flag icon next to the questions you would like to focus on.

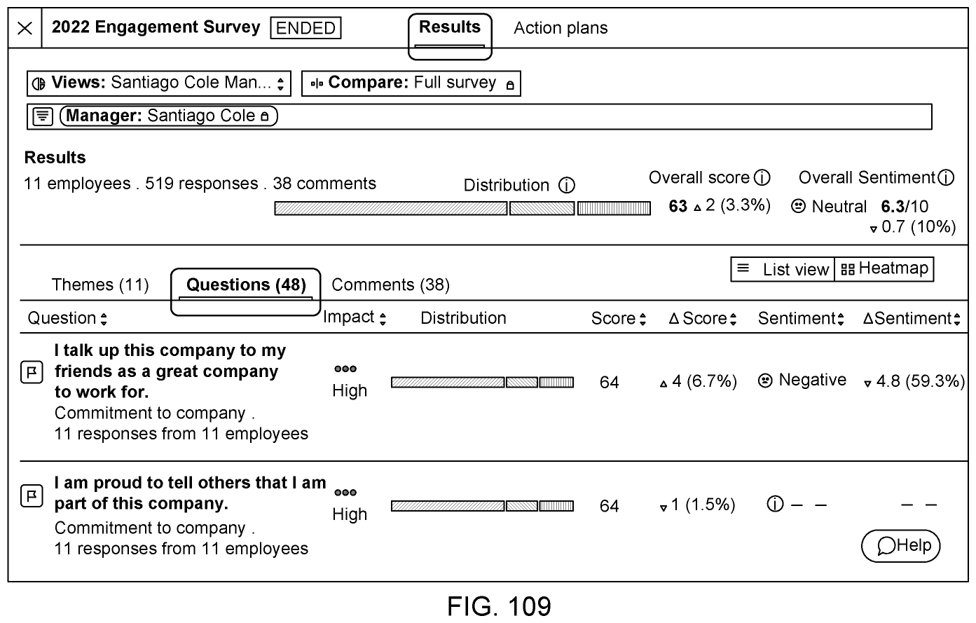

FIG. 109 is a screenshot of an example user interface for specifying survey questions to focus on.

Step 5: Once you have flagged your questions, enter the Action plans tab.

Step 6: Select Edit action plan here to see all flagged questions within the action plan.

Step 7: Click Create a focus area to add questions you flagged to your action plan.

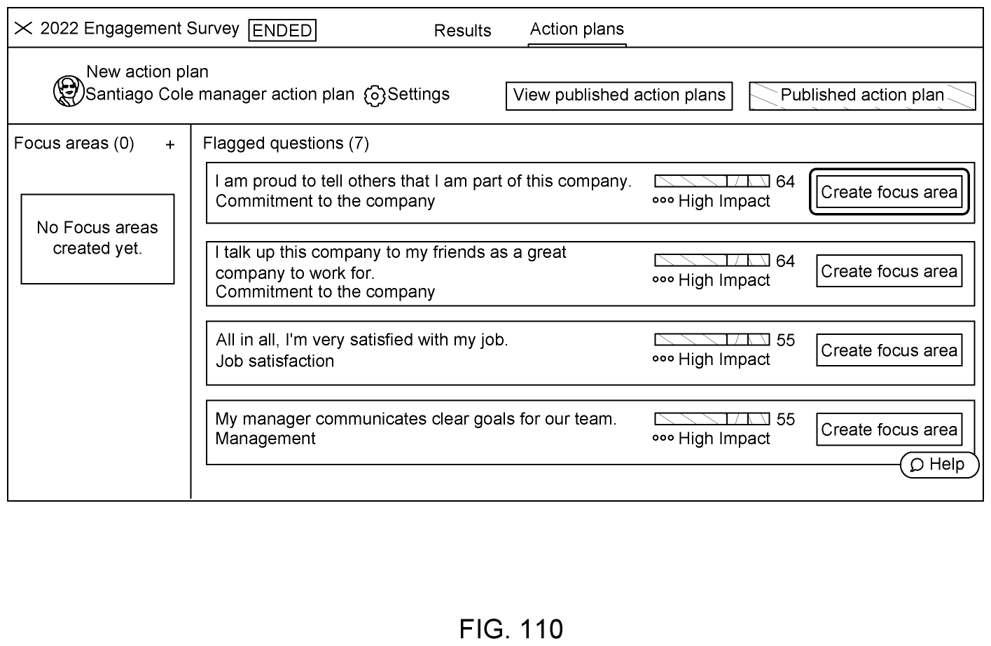

FIG. 110 is a screenshot of an example user interface for creating a focus area for a survey question.

Step 8: Add a title, an optional description, and select action plan settings:
Due date
Visibility*
Owners
   You can select the option for either public or private visibility. Public visibility will give survey admins, your reports, your manager, and owners of this action plan visibility. Private visibility will give survey admin, your manager, and owners of this action plan visibility.

Step 9: Select Create a new action to create an action that will help the team meet the expectations of the focus area. Depending on the specific individual question you have flagged, suggested actions will be listed to include as an action in your action plan.

Step 10: Select Publish action plan>Publish.

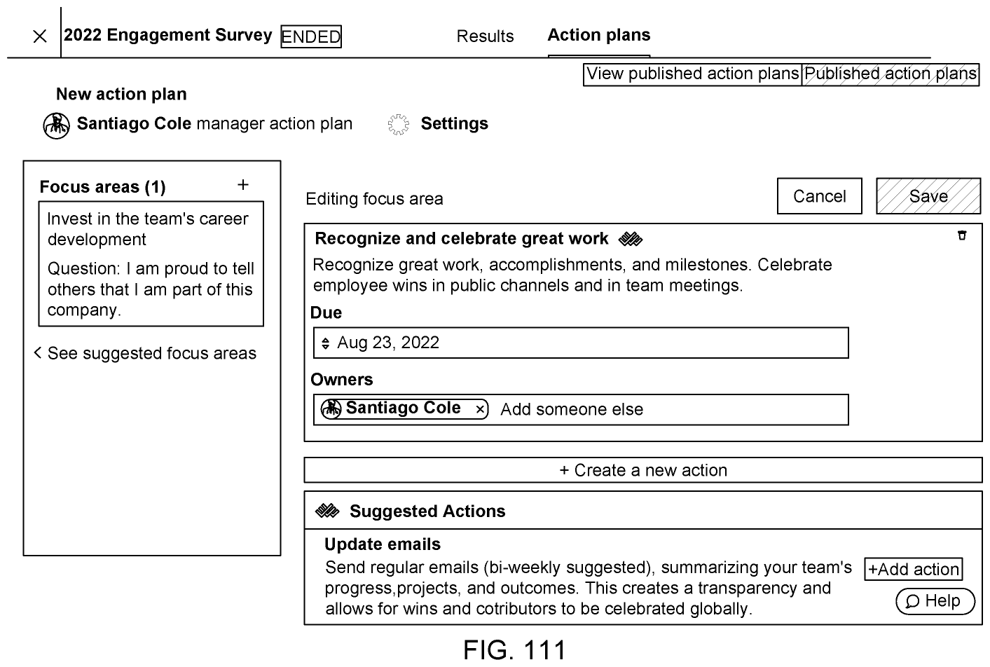

FIG. 111 is a screenshot of an example user interface for publishing an action plan.

These suggested actions help the admins build company action plans. Below is a list of all suggest actions grouped by themes.

### Commitment to the Company

Recognize great work, accomplishments, and milestones. Encourage managers to celebrate employee wins in public channels and in all-hands meetings.
Ask leaders and managers to send regular emails (bi-weekly suggested), summarizing their teams' progress, projects, and outcomes. This creates a sense of transparency and allows for wins and contributors to be celebrated globally.
Invest in initiatives that help improve company culture, including team-building exercises, offsite meetings, and shared celebrations.
Present on the state of the business and company goals, and give the audience a chance to ask questions. Employees want to know where things stand. All-hands meetings give them that clarity.
Consider implementing benefits that vest over time. To care about the company, employees need to see that the company cares about them. Offering employees equity and 401(k) matching, for example, or establishing a learning stipend, helps promote loyalty over the long term.
Ensure that your company's mission and values are representative, widely known, and lived by leadership. Company mission statements and values can help employees find meaning in their work.
Implement reverse mentorships, where employees advise leaders on how their actions are perceived by others. Employees can sometimes view leadership as out of touch.
Make leadership available for questions. Instituting office hours and lunches give employees the opportunity for face time and to ask questions.
Invest in greater transparency. All-hands meetings are a great venue for leaders to communicate the thinking behind company initiatives and business decisions.

### Engagement

Help give a sense of purpose by creating a program that enables frontline employees to share customer success stories and that ties them back to how each team positively impacts customers.
Create a celebratory spirit by creating public spaces to share praise for employee wins, like public praise via a praise channel or praise wall.
Create an SME (subject matter expert) program to ensure that employees have leadership opportunities that let them shine outside of their day-to-day jobs.
Use company-wide recurring talking points in one-on-ones to encourage managers to dig into whether their team members are feeling under-supported in some way or disconnected from the company mission, and address those issues individually.
Promote work-life balance by communicating (and having leadership exemplify) a culture where people don't work (send emails, messages, etc.) after hours and on weekends.
Set a “no meeting” day or days to allow employees time for deep focus and better opportunity for time management.
Whether you have generous or unlimited PTO, many employees are reluctant to take time off. Encourage taking PTO through suggested time-off windows and through leadership taking PTO.
Encourage mental health breaks during the day-to-day activities like a workout or meditation in order to help prevent burnout.
Promote a strong commitment to health and wellness as a part of company culture by providing health and wellness options as part of your benefits package.

### Feeling Valued

Implement a program where managers give their reports the opportunity to pursue one independent project per quarter. These assignments give employees the chance to leverage their unique skills and learn new ones.
Establish an expectation that all employees have growth plans consisting of the skills and talents they want to develop. Ensure managers are actively tracking and that employees are updating progress.
Implement competency frameworks and have managers discuss role expectations with individual employees, both when they start a new role and periodically as work changes.
Ask employees to provide managers with a weekly update on what they've accomplished and what they're working on. They can share these updates with teammates, too. Not every role has a highly visible output.
Create a norm whereby employees use Lattice's feedback tool weekly to help their coworkers develop. Managers should lead by example.
Consider offering incentives ad hoc or on a recurring basis. Rewards, incentives, and gifts are a great way to recognize and motivate employees.
Have managers encourage their teams to share what's on their mind in writing, verbally, or otherwise Not all employees feel comfortable speaking up in meetings.
After creating your action plans, communicate them to the organization and connect them back to survey results so that employees know they are being heard.
Consider a no-interruption rule to ensure every employee has an opportunity to share their thoughts.
Ask leaders and managers to send regular emails (bi-weekly suggested), summarizing their teams' progress, projects, and outcomes. This creates a sense of transparency and allows for wins and contributors to be celebrated globally.
Praise from peers helps empower belonging. Managers should challenge their reports to recognize at least one peer a week, be it in writing or in person.
Create a celebratory spirit by creating public spaces to share praise for employee wins, like public praise via a praise channel or praise wall.

### Fit and Belonging

Openly discuss and embrace diversity in working styles, including introducing work style and strengths assessments such as MBTI, StrengthsFinder, or similar. Encourage teams to review each member's preferences and identities, and create opportunities to take advantage of those differences.
Help underrepresented employees (e.g., culturally diverse, women, LGBTQ+, parents, etc.) feel supported by creating Employee Resource Groups (ERGs). Encourage employees to lead the ERGs and leaders to sponsor them. A low score on the fit and belonging question often means you need to pay closer attention to diversity and inclusion initiatives.
Celebrate nonstandard holidays and events (such as Black History Month, Equal Pay Day, Pride Month, etc.) by bringing in speakers, setting aside time in all-hands meetings, or hosting a social event with your ERGs.
Ensure that company values are included in the recruiting and onboarding process such that new employees are well steeped in the company culture
If they're not already well-formulated, create or update company values with input from a cross-section of leaders and employees. Ensure that the company embodies these values by tying feedback to them, including them in company communications, and linking activities and rewards to them.
Create an employee-led diversity, equity & inclusion task force that is representative of the employee base. Task them with collecting feedback about employees' values, and then sharing ideas, learnings, and concerns with the executive team.
Help give a sense of purpose by creating a program that enables frontline employees to share customer success stories and that ties them back to how each team positively impacts customers.
Recognize great work, accomplishments, and milestones. Encourage managers to celebrate employee wins in public channels and in all-hands meetings.
Run a manager training on understanding different working styles, and create a work style framework that managers can use with current and new employees.
Have each team member create an “operating manual” on how to work with them—what their preferences are on communication, cadence, timing, tools, etc. Have each team member present their manual to the rest of the team and keep all manuals updated and accessible.
Lead internal meetings by asking team members to share a personal check-in teams can go around the room, while large teams can divide into groups of 3-4 to give everyone a chance to share.

### Job Satisfaction

Recognize great work, accomplishments, and milestones. Encourage managers to celebrate employee wins in public channels and in all-hands meetings.
Establish an expectation that all employees have growth plans consisting of the skills and talents they want to develop. Ensure managers are actively tracking and that employees are updating progress.
Hold weekly one-on-one meetings to give managers a way to diagnose and address engagement issues. They should regularly check on how employees are doing.
If a deep dive into comments reveals a problem with communication, openly discuss and embrace diversity in working styles, including introducing work style and strengths assessments such as MBTI, StrengthsFinder, or similar. Encourage teams to review each member's preferences and identities, and create opportunities to take advantage of those differences.
If a deep dive into comments reveals a lack of collaboration, consider running a company and team goals alignment exercise that helps employees recognize their shared direction and plan how to achieve their goals together.
If a deep dive into comments reveals a lack of personal connection, foster deeper bonds by bringing peers together outside of work Field days, dinners, and team outings can help build relationships.
One of the most critical aspects of management is to set expectations around roles, responsibilities, and individual and team goals. Equip managers with a framework to ensure they are setting these expectations with their teams.
Use updates to capture roadblocks that team members are facing. Encourage managers to respond to those roadblocks directly, and bring them up in their next one-on-one.

### Management

Create a norm whereby employees use Lattice's feedback tool weekly to help their coworkers develop. Managers should lead by example.
Establish an expectation that all employees have growth plans consisting of the skills and talents they want to develop. Ensure managers are actively tracking and that employees are updating progress.
Review development progress and growth plans in weekly one-on-one meetings. Managers should regularly check on how employees are doing.
Employee expectations are shifting to more frequent feedback and reviews. If you don't already have a semiannual performance review cycle, consider adding a lighter-weight review between the annual cycle that currently exists.
Feedback is only useful if it's delivered often, and managers need to follow up to track progress. Use Lattice's feedback tools, and nudge managers into giving more frequent feedback.
Form monthly manager working groups to connect high-performing managers with new or lower-performing managers In groups of 4 or 5, each can share challenges they face and work together to come up with ideas and solutions. If a group session isn't available to you, consider simply pairing managers with different strengths together in order to share with and learn from one another.
Hire a coach or consultant to conduct a 360-degree assessment for managers that scored low, and to work with them on identifying and addressing areas of concern for their teams, peers, and leaders.
Establish and roll out a goal-setting methodology company-wide from the beginning of your objectives and key results (OKR) process, and set office hours in case managers need help with that methodology and how it applies to their teams. Managers may not be setting team goals if they're at a loss for how to set goals properly.
Examine how your teams are tracking and communicating goals. Host regular training sessions to ensure managers and employees know all about the resources and tools available to them—and, of course, make sure that includes Lattice.
Once team OKRs are set, encourage managers to share them out to every team member, to put them into Lattice, and make them part of one-on-one meetings going forward. If OKRs and goals are front and center to the team's success, they'll be more clearly visible to everyone on the team.
Help give managers structure and guidance on doing one-on-ones well by providing company-wide one-on-one talking points so managers are reminded to talk about what the company considers key topics. Managers should see one-on-ones as the most important meetings of the week.
Ask leaders to send regular emails (bi-weekly suggested), summarizing their departments' progress, projects, and outcomes. This establishes visibility into the progress and updates of the senior leaders in the company.
Make leadership available for questions. Instituting office hours and lunches give employees the opportunity for face-time and to ask questions.
Conduct manager training sessions to help your leaders learn how to communicate effectively with their teams, and identify when their teams need more visibility.
Establish competency frameworks so managers understand the technical expectations of their roles and can create growth plans to address the gaps in their knowledge.
Openly discuss and embrace diversity in technical abilities. Conduct skill mapping exercises to identify which managers spike in specific technical areas, and match those managers with employees who need support via mentorships or office hours.
Conduct manager training sessions to bridge the gap between expected technical experience, and current manager expertise.
Consider offering coaching to managers through an on-demand coaching platform or by encouraging them to use their development budget (if they have one) on an independent coach.
Conduct manager training sessions focused on decision-making and prioritization.
Conduct manager training sessions to help your leaders learn best practices around coaching and feedback as well as work with a trainer on common management problems. And encourage these managers to solicit feedback from reports on where they can improve.
One of the best ways to support your team is to provide them with thoughtful feedback. Commit to giving your team members feedback on a regular basis (start with once per week for each individual) to show them you're invested in their development.
Hire a coach or consultant to conduct a 360-degree assessment for managers that scored low, and to work with them on identifying and addressing areas of concern for their teams, peers, and leaders.
Expressions of vulnerability can help bring people closer together. Train leaders (people managers and informal leaders) on how to positively express vulnerability publicly to build trust with their team.
Offer a stipend to pursue learning and development opportunities. Make sure managers actively encourage their reports to use it.
Have employees set at least one “stretch” goal per quarter that's aspirational in nature. This goal should ideally tie to the part of their job they are most enthusiastic about.
Train managers to check in with employees regarding their roles and responsibilities at least once a quarter, to identify how to best align their work with their strengths and desired areas of development.
One of the most critical aspects of management is to set expectations around roles, responsibilities, and individual and team goals. Equip managers with a consistent framework to ensure they are setting these expectations with their teams.
Growth comes from feedback. Encourage or train managers to provide their team constructive feedback in one-on-ones and ad-hoc Employees can also request feedback from their peers.
Set a “no meeting” day or days to allow employees time for deep focus and better opportunity for time management.
One of the most critical aspects of management is to set expectations around roles, responsibilities, and individual and team goals. Equip managers with a consistent framework to ensure they are setting these expectations with their teams.
Performance reviews are designed to facilitate productive career development conversations. Examine your performance review cadence to ensure employees are receiving feedback at least twice a year.
Openly discuss and embrace diversity in working styles, including introducing work style and strengths assessments such as MBTI, StrengthsFinder, or similar. Encourage teams to review each member's preferences and identities, and create opportunities to take advantage of those differences.
Create opportunities—via AMA sessions or coordinated meetings—for leaders to meet with managers across departments they don't oversee. This will enable managers to create connections that unlock collaboration across the company for their teams. Not all managers are naturally successful in establishing relationships across the company.

### Self-efficacy

Establish an expectation that all employees have growth plans consisting of the skills and talents they want to develop. Ensure managers are actively tracking and that employees are updating progress.
Offer a stipend to pursue learning and development opportunities. Make sure managers actively encourage their reports to use it.
Encourage or train managers to provide their teams with constructive feedback in one-on-ones and ad-hoc. Employees can also request feedback from their peers. Growth comes from feedback.
Have weekly one-on-ones between managers and their teams. Here they can set expectations and check on progress.
Give employees clarity. Have them set goals that are specific and measurable. When things aren't going well, managers should be able to provide feedback along the way.
Implement competency frameworks and have managers discuss role expectations with individual employees, both when they start a new role, and periodically as work changes.
If a deep dive into comments reveals that employees require certain technology or tools to be more effective in their work, make a case for additional technology or operational budget, evaluate vendors, and make the purchase.
If a deep dive into comments reveals that employees are stretched thin, help the affected teams' managers identify ways to reduce or redistribute workload, or to make a case for additional headcount.
If a deep dive into comments reveals that employees are stretched thin, identify ways to reduce or redistribute workload or make a case for additional headcount.
Make it easier for employees to see how their work contributes to the bigger picture. OKRs help make this clear because of their tiered approach.
Encourage managers to celebrate employee wins in public channels and in all-hands meetings. Recognition fosters pride.
Ensure that your company's mission and values are representative, widely known, and lived by leadership Company mission statements and values can help employees find meaning in their work.
Have managers discuss obstacles in their recurring one-on-ones. Are there obstacles or inefficiencies preventing employees from doing their best work?
Train managers to check in with employees regarding their roles and responsibilities at least once a quarter, to identify how to best align their work with their strengths and desired areas of development
Set a “no meeting” day or days to allow employees time for deep focus and better opportunity for time management.
Check-in with employees regarding their roles and responsibilities at least once a quarter, to identify how to best align their work with their strengths and desired areas of development
Implement a program where managers give their reports the opportunity to pursue one independent project per quarter. These assignments give employees the chance to leverage their unique skills and learn new ones.
Have employees set at least one “stretch” goal per quarter that's aspirational in nature. This goal should ideally tie to the part of their job they are most enthusiastic about.
If a deep dive into comments reveals employees feel their work is a negative challenge, examine whether there are obstacles or inefficiencies preventing employees from enjoying their work.

### Team Culture

Give employees time to learn from their coworkers directly. Invite team members to lead peer-to-peer lunch-and-learn sessions on topics related to work or a personal hobby or interest.
Identify and appoint subject matter experts across the company that other employees can turn to for answers to common challenges. When it comes to building trust, giving ownership and credit goes a long way.
Openly discuss and embrace diversity inabilities. Conduct skill mapping exercises to identify which employees are knowledgeable in specific areas, and match those employees with coworkers who need support via mentorships or office hours.
Implement competency frameworks and have managers discuss role expectations with individual employees, both when they start a new role, and periodically as work changes.
Create more shared and team-oriented goals to encourage teammates to appreciate one another's efforts, help each other through challenges, and “like” and “comment” on goal updates.
Have managers discuss these in their recurring one-on-ones. Are there obstacles or inefficiencies preventing employees from doing their best work?
Celebrate individual wins across the company. These recognition moments will highlight team member accomplishments that may otherwise go unnoticed.
Create more shared and team-oriented goals to encourage teammates to appreciate one another's efforts, help each other through challenges, and “like” and “comment” on goal updates.

### Psychological Safety

Give employees a means of submitting questions or concerns anonymously if they don't feel comfortable speaking up. All-hands meetings can provide a forum for addressing company-wide concerns.
Institute a post mortem process, and in advance of the session, have organizers circulate a survey asking for feedback. Projects or initiatives should be followed by a post-mortem meeting.
Make asking for help a norm. As part of their regular status updates, ask employees to identify where they need additional support.
When projects fall short, encourage employees to single out where checks and processes, not people, fell short Make the “blameless” model part of your culture
Create a program that encourages employees to take on at least one experimental project per quarter. Celebrate the effort and creativity that goes into the projects, and the learnings that come out—while success is welcome, it's not the expectation.
Recognize employees for trying new things and taking risks—even when things don't go well. Lead by example and make it a cultural norm
Remind leaders of the golden rule of management: praise in public, criticize in private. Employees will be more comfortable taking risks without worrying about mistakes being broadcast across the team
Foster an environment where creative thinking is encouraged. Make this philosophy part of your culture, be it through hackathons or days dedicated to outside-the-box thinking.
When projects fall short, encourage employees to single out where checks and processes fell short, not people. Make the “blameless” model part of your culture.
Help underrepresented employees (i.e. culturally diverse, women, LGBTQ+, parents, etc.) feel supported by creating Employee Resource Groups (ERGs). Encourage employees to lead the ERGs, and leaders to sponsor them. A low score on the psychological safety question often means you need to pay closer attention to diversity and inclusion initiatives.
Openly discuss and embrace diversity in working styles, including introducing work style and strengths assessments such as MBTI, StrengthsFinder, or similar. Encourage teams to review each member's preferences and identities, and create opportunities to take advantage of those differences.
Revisit your onboarding process. How can you make new hires feel more included? Introduce new practices, such as having managers and peers take new hires out to coffee or lunch, or pairing new hires up with “onboarding buddies.”
Make asking for help a norm across teams. During recurring meetings, encourage managers to have direct reports share what they're working on and where they need help. Managers can lead by asking for help with their own initiatives.
Ensure that teams are aware how their goals contribute and work together to accomplish department and organizational goals. Employees are more inclined to collaborate when they're working toward the same end.
Encourage employees to expense coffee dates with colleagues or new hires to bond and get to know each other better. Work relationships improve morale and collaboration
Implement competency frameworks and have managers discuss role expectations with individual employees, both when they start a new role, and periodically as work changes. Lack of clarity surrounding roles and responsibilities can lead employees to reach beyond the scope of their role.
Incorporate company values into your feedback and reviews. Have managers make it clear that values like humility and integrity are just as important in measuring employee performance.
Break up politics and silos by organizing inter-departmental initiatives and social events. This helps team members build empathy for peers who they otherwise might not interact with

### Team Learning

Institute a post mortem process, and in advance of the session, have organizers circulate a survey asking for feedback. Projects or initiatives should be followed by a post-mortem meeting.
Challenge your processes regularly. Set the expectation that every team process is reviewed on a regular (try biannual to start) basis, and that feedback is collected from everyone involved.
Allocate budget for L&D, conferences, etc., and have managers set goals around usage of budget across the team. Add a question to one-on-ones and updates: “Where do you think we could be seeking out more information as a team?”
Encourage employees to expense coffee dates with colleagues or new hires to bond and get to know each other better. Work relationships improve morale and collaboration.
Form monthly manager working groups to connect high-performing managers with new or lower-performing managers. In groups of 4 or 5, each can share challenges they face and work together to come up with ideas and solutions. If a group session isn't available to you, consider simply pairing managers with different strengths together in order to share with and learn from one another.
Ensure that all teams have access to customer feedback and that there is an opportunity to review it, discuss it, and suggest changes to products or processes via appropriate channels.
Recommend managers host project retrospectives with key stakeholders across teams to gather learnings for future collaboration. Dedicating time for teams to reflect on projects together can unearth critical insights about team communication, creativity, progress tracking, and more.
Set aside time for regular team or department offsites that allow teams to brainstorm and learn together, particularly around important changes. To help teams to be more creative or innovative, you may have to get them out of their standard work routine.
Involve more team members in the planning process. By including more voices in the initial phases of planning (whether it be new processes, initiatives, or goals) you introduce new perspectives that might challenge long-standing norms.
As part of your project timelines, host a cross-functional review forum to allow a project team to review their progress, get feedback, and crowdsource solutions to problems or questions they have.
Add specific points in the agenda of your internal planning meetings to challenge the assumptions and decisions you have made. This helps ensure every decision considers all potential side effects
When projects fall short, encourage employees to single out where checks and processes fell short, not people Make the “blameless” model part of your culture.
Create and identify meetings or communication channels for brainstorming and bouncing ideas off of each other with no judgment. Innovation often comes out of speaking out and testing assumptions.
Foster an environment where creative thinking is encouraged Make this philosophy part of your culture, be it through hackathons or days dedicated to outside-the-box thinking.

### Work Relationships

Establish an expectation that all employees have growth plans consisting of the skills and talents they want to develop. Ensure managers are actively tracking and that employees are updating progress.
Starting a “buddy” or mentor program gives new hires someone to talk to on day one. Employees are especially susceptible to loneliness when starting a new role.
Bring remote employees into the fold by leveraging communication tools and organizing virtual social events. Remote employees often feel like they're on the outside looking in.
Group new hires into “classes” so they have someone to go through onboarding with. Shared experiences give employees a means of building connections from the start.
Create a program that sponsors clubs, sports leagues, and after-work activities. This program will foster relationships between peers who might not otherwise interact. These bonds can also result in greater collaboration overall.
Foster work friendships by implementing random, cross-departmental lunches or coffee dates. Encourage employees to talk about their personal interests and hobbies, not work.
Bring employees together in social situations that don't involve work. Field days, dinners, and other outings encourage team members to talk about more than their day-to-day.
Give employees the opportunity to lead a lunch and learn about a personal project that's near and dear to their heart. This can be a small session or in front of the whole company.
Foster work friendships by implementing random, cross-departmental lunches or coffee dates. Encourage employees to talk about their personal interests and hobbies, not work.
Encourage department heads to share company-wide updates on projects and initiatives. This gives everyone a clear view of progress and who the subject matter experts are.
Give new hires clarity early on. As part of your onboarding process, ask team members to present on their areas of expertise and the initiatives and processes they own.
Establish clear escalation paths so employees can properly get the support they need when they have a knowledge gap. Employees need to know where to go for help.
Make “shout-outs” a part of your meeting culture. Have departments recognize someone in each of their weekly meetings, for example.
Recognize accomplishments and milestones in front of the whole company. Encourage managers to celebrate employee wins in public channels and in all-hands meetings

### Diversity Climate

Revisit your job requirements and how you're evaluating resumes. Job descriptions have an impact on who you are sourcing. For example, data shows that women tend to apply when they meet all requirements, whereas men tend to take more risks.
Set clear diversity and inclusion goals and publicize them to the whole company. Partner with sourcing platforms that connect companies with diverse candidates. Check-in on progress at all-hands meetings like you would other business targets.
Use your employee referral program as a vehicle to drive diversity in recruiting. Encourage employees to think critically about the job descriptions and requirements, rather than simply referring people they have felt comfortable working with in the past.
Empower your people to start employee resource groups (ERGs). These help employees spread awareness of the issues facing BIPOC, LGBTQ employees, working parents, and other groups.
Create an employee-led diversity, equity & inclusion task force that is representative of the employee base and task them with sharing ideas, learnings, concerns, and ideas with the executive team
Revisit your hiring practices and partner with an executive search firm with a diverse recruiting pipeline. Your diversity and inclusion program will come under scrutiny if women and minorities aren't represented in leadership.
Implement reverse-mentorships, where employees advise leaders on how their actions are perceived by others. Employees can sometimes view leadership as out of touch.
Implement a company-wide goal to improve diversity at every level of the organization. Have leadership provide regular check-ins at all-hands meetings. Have them share these updates with the board as well.

### Fairness

Train managers on review-writing technique, including the importance of specific examples when writing reviews Updates tracked goals and ongoing feedback can make a big difference by providing managers with reminders about their team members' performance, and help ensure that employees aren't caught by surprise.
Make performance calibration meetings part of your review process to ensure scores are fair across departments. Each manager has their own rubric for rating employees.
Offer training on unconscious bias to all managers (and employees). When managers evaluate team members in performance reviews, there is often unconscious bias at work. Their fair evaluations ensure equity in ratings across the company.
Solicit peer reviews to provide a more complete picture of how employees contribute to the organization. Managers only see so much. If peer reviews aren't already part of your review process, introduce this practice in the next cycle.
Look at your promotion and pay equity data. Are certain groups more or less likely to be rewarded for their work? This can tell you more than demographics alone—use the data to make a case for adjusting promotion and pay guidelines.
Implement a formal process for raises and promotions. Tying competency frameworks to performance reviews ensures that every manager is grading their employees based on the same criteria. Force managers to provide qualitative evidence that an employee is or is not meeting the expectations required to move to the next level of their framework.
Before recruiting an external hire, post all roles—particularly leadership roles—for internal talent to apply first. This sends the message that you're committed to employees' career development. Consider setting a tangible number-based goal to commit to a specific volume of internal promotions.
Set clear diversity and inclusion goals and publicize them to the whole company. Partner with sourcing platforms that connect companies with diverse candidates. Check-in on progress at all-hands meetings like you would other business targets.
Offer training on unconscious bias to all managers (and employees). When managers evaluate team members in performance reviews, there is often unconscious bias at work. Their fair evaluations ensure equity in ratings across the company.

These suggested actions help managers build manager action plans. Below is a list of all suggest actions grouped by themes.

### Commitment to the Company

Recognize great work, accomplishments, and milestones. Celebrate employee wins in public channels and in team meetings.
Send regular emails (bi-weekly suggested), summarizing your team's progress, projects, and outcomes. This creates a sense of transparency and allows for wins and contributors to be celebrated globally.
Invest in initiatives that help improve team culture, including team-building exercises, offsite meetings, and shared celebrations.
Ensure that your team knows the company's mission and values, and knows how their work is contributing to, and aligned with, both. Company mission statements and values can help employees find meaning in their work.
Spend time during a team meeting reviewing how your team's goals and responsibilities tie back to the greater company goals. Give your team a chance to discuss and ask questions.
Connect with individuals on your team on their personal goals, and discuss how to support them. To care about the company, employees need to see that the company cares about them. Explore how they might benefit from company policies such as learning stipends.
Implement reverse-mentorships, where employees advise leaders on how their actions are perceived by others. Employees can sometimes view leadership as out of touch.
Connect your team members to department or company leaders to give them an opportunity to advise leaders on how their actions are perceived by others.
Make yourself available for questions. Instituting office hours and lunches give employees the opportunity for face-time and to ask questions.
Invest in greater transparency. Team meetings are a great venue for you to communicate the thinking behind company initiatives and business decisions.
Have an open and honest engagement survey results conversation with your team to uncover additional insights. Share these learnings with your leadership team

### Engagement

Help give a sense of purpose by helping your team members understand how their work positively impacts your customers
Create a celebratory spirit by creating public spaces to share praise for employee wins, like a recurring agenda item in team meetings or a space in a recurring team update email.
Create an SME (subject matter expert) program to ensure that employees have leadership opportunities that let them shine outside of their day-to-day jobs.
Use your one-on-ones to dig into whether your team members are feeling under-supported in some way, or disconnected from the company mission, and address those issues individually.
Promote work-life balance by encouraging your team to not work (send emails, messages, etc.) after hours and on weekends.
Use updates to track how employee sentiment changes over time, and ask your team what activities they are enthusiastic about in a given week.
Set a “no meeting” day or days to allow employees time for deep focus and better opportunity for time management.
Encourage mental health breaks during the day to do activities like a workout or to meditate in order to help prevent burnout

### Feeling Valued

Implement competency frameworks and have managers discuss role expectations with individual employees, both when they start a new role and periodically as work changes.
Implement a program where you give your reports the opportunity to pursue one independent project per quarter. These assignments give employees the chance to leverage their unique skills and learn new ones.
Create growth plans with your employees consisting of the skills and talents they want to develop. Actively track these plans to ensure that employees are updating progress.
Implement competency frameworks and discuss role expectations with individual employees, both when they start a new role, and periodically as work changes.
Consider offering incentives ad hoc or on a recurring basis. Rewards, incentives, and gifts are a great way to recognize and motivate employees.
Ask employees to provide a weekly update on what they've accomplished and what they're working on. They can share these updates with teammates, too. Not every role has a highly visible output.
Encourage employees to use Lattice's feedback tool weekly to help their coworkers develop. Managers should lead by example.
Consider a no-interruption rule to ensure every employee has an opportunity to share their thoughts.
Encourage your team to share what's on their mind in writing, verbally, or otherwise. Not all employees feel comfortable speaking up in meetings.
After creating your action plans, communicate them to your team and connect them back to survey results, so that employees know they are being heard.
Create a celebratory spirit by creating public spaces to share praise for employee wins, like a recurring agenda item in team meetings or a space in a recurring team update email.
Send regular emails (bi-weekly suggested), summarizing your team's progress, projects, and outcomes. This creates a sense of transparency and allows for wins and contributors to be celebrated globally.
Praise from peers helps empower belonging. Challenge your reports to recognize at least one peer a week, be it in writing or in person.

### Fit and Belonging

Openly discuss and embrace diversity in working styles, including introducing work style and strengths assessments such as MBTI, StrengthsFinder, or similar. Review your team member's preferences and identities, and create opportunities to take advantage of those differences.
Help underrepresented employees (e.g., culturally diverse, women, LGBTQ+, parents, etc.) feel supported by creating Employee Resource Groups (ERGs). Encourage employees to lead the ERGs, and leaders to sponsor them. A low score on the fit and belonging question often means you need to pay closer attention to diversity and inclusion initiatives.
Celebrate non-standard holidays and events (such as Black History Month, Equal Pay Day, Pride Month, etc.) by bringing in speakers, setting aside time in team meetings, or hosting a social event with your team and your company ERGs.
Ensure that your team embodies your company values by tying feedback to them, including them in team communications, and linking activities and rewards to them
Help give a sense of purpose by helping your team members understand how their work positively impacts your customers.
Recognize great work, accomplishments, and milestones. Celebrate employee wins in public channels and in team meetings.
Create an employee-led diversity, equity & inclusion task force that is representative of the employee base and task them with sharing ideas, learnings, concerns, and ideas with the executive team.
Have each team member create an “operating manual” on how to working with them—what their preferences are on communication, cadence, timing, tools, etc. Have each team member present their manual to the rest of the team and keep all manuals updated and accessible.
Lead internal meetings by asking team members to share a personal check-in teams can go around the room, while large teams can divide into groups of 3-4 to give everyone a chance to share.

### Job Satisfaction

Recognize great work, accomplishments, and milestones. Celebrate employee wins in public channels and in team meetings.
Create growth plans with your employees consisting of the skills and talents they want to develop. Actively track these plans to ensure that employees are updating progress.
Diagnose and address engagement issues through weekly one-on-one meetings. These meetings should be used to regularly check on how employees are doing.
If a deep dive into comments reveals a problem with communication, openly discuss and embrace diversity in working styles, including introducing work style and strengths assessments such as MBTI, StrengthsFinder, or similar. Review your team member's preferences and identities, and create opportunities to take advantage of those differences.
If a deep dive into comments reveals a lack of collaboration, consider running a team goals alignment exercise that helps your team recognize their shared direction and plan how to achieve their goals together.
If a deep dive into comments reveals a lack of personal connection, foster deeper bonds by bringing your team together outside of work. Field days, dinners, and team outings can help build relationships.
Ensure you have an effective framework to ensure you are setting appropriate expectations with your team. One of the most critical aspects of management is to set expectations around roles, responsibilities, and individual and team goals.
Use updates to capture roadblocks that team members are facing. Respond to those roadblocks directly, and bring them up in their next one-on-one
Create growth plans with your employees consisting of the skills and talents they want to develop. Actively track these plans to ensure that employees are updating progress.
Create opportunities for your team to meet with and learn from other teams in the company by hosting combined team meetings with another manager. Have team members present on their work such that both teams benefit from the updates.

### Management

Encourage employees to use Lattice's feedback tool weekly to help their coworkers develop Managers should lead by example.
Create growth plans with your employees consisting of the skills and talents they want to develop. Actively track these plans to ensure that employees are updating progress.
Diagnose and address engagement issues through weekly one-on-one meetings. These meetings should be used to should regularly check on how employees are doing.
If you don't already have a semiannual performance review cycle, consider adding a lighter-weight review between the annual cycle that currently exists Employee expectations are shifting to more frequent feedback and reviews.
Use Lattice's feedback tools, and create reminders for yourself to remember to give frequent feedback. Feedback is only useful if it's delivered often, and you need to follow up to track progress
Use updates as a way to stay informed on your team members' progress, and reserve one-on-ones for them to set the agenda and drive the conversation Encourage them to share how you can support them in achieving their goals.
Hire a coach or consultant to conduct a 360-degree assessment for managers that scored low, and to work with them on identifying and addressing areas of concern for their teams, peers, and leaders
Identify a senior manager whose style and results you admire and form a mentorship relationship with that person, asking for their input and coaching around challenges you are facing.
Review your method for setting team goals. Set a regular cadence to review team goals with your team and get their feedback to ensure they are up to date and accurate.
Share team goals out to every team member, put them into Lattice, and make them part of one-on-one meetings going forward. If OKRs and goals are front and center to your team's success, they'll be more clearly visible to everyone on the team.
Use recurring talking points in one-on-ones to regularly provide your team members with actionable feedback. One-on-ones are the most important meetings of the week.
Send regular emails (bi-weekly suggested) to your team, summarizing recent updates you have received from leadership. This establishes visibility into the progress and updates of the senior leaders in the company.
Make yourself available for questions. Instituting office hours and lunches give employees the opportunity for face-time and to ask questions.
Reference your competency framework to understand the technical expectations of your role and create a growth plan to address the gaps in your knowledge.
Openly discuss and embrace diversity in technical abilities. Conduct skill mapping exercises to identify where you and your team members spike in specific technical areas, and use those exercises to capture the gaps in your technical knowledge. Carve out time to learn these technical skills independently, or from your team members.
Seek out a coach through an on-demand coaching platform (if your company has access to one) or use your development budget (if you have one) on an independent coach.
Use your development budget (if you have one) on training sessions focused on decision making and prioritization.
Commit to giving your team members feedback on a regular basis (start with once per week for each individual) to show them you're invested in their development One of the best ways to support your team is to provide them with thoughtful feedback.
Have employees set at least one “stretch” goal per quarter that's aspirational in nature. This goal should ideally tie to the part of their job they are most enthusiastic about.
Encourage employees to pursue learning and development opportunities, particularly if your company offers a development stipend.
Check-in with employees regarding their roles and responsibilities at least once a quarter, to identify how to best align their work with their strengths and desired areas of development.
Use a consistent framework to ensure you are setting clear expectations with your team One of the most critical aspects of management is to set expectations around roles, responsibilities, and individual and team goals.
Ensure you are giving feedback in one-on-ones and ad-hoc. Encourage your team to also request feedback from their peers. Growth comes from feedback.
Once team OKRs are set, share them out to every team member, put them into Lattice, and make them part of 1:1 meetings going forward. If OKRs and goals are front and center to your team's success, they'll be more clearly visible to everyone on the team.
Set a “no meeting” day or days to allow employees time for deep focus and better opportunity for time management.
Openly discuss and embrace diversity in working styles, including introducing work style and strengths assessments such as MBTI, StrengthsFinder, or similar. Review your team member's preferences and identities, and create opportunities to take advantage of those differences.

### Self-Efficacy

Create growth plans with your employees consisting of the skills and talents they want to develop. Actively track these plans to ensure that employees are updating progress.
Encourage employees to pursue learning and development opportunities, particularly if your company offers a development stipend.
Ensure you are giving feedback in one-on-ones and ad-hoc. Encourage your team to also request feedback from their peers. Growth comes from feedback.
Use your one-on-ones to set expectations and check on progress. This is also a great opportunity to revisit job expectations and align on growth areas with your team.
Give employees clarity. Have them set goals that are specific and measurable. When things aren't going well, you should be able to provide feedback along the way.
Implement competency frameworks and discuss role expectations with individual employees, both when they start a new role, and periodically as work changes.
If a deep dive into comments reveals that employees require certain technology or tools to be more effective in their work, make a case for additional technology or operational budget, evaluate vendors, and make the purchase.
If a deep dive into comments reveals that employees are stretched thin, identify ways to reduce or redistribute workload or make a case for additional headcount.
Make it easier for employees to see how their work contributes to the bigger picture. OKRs help make this clear because of their tiered approach.
Ensure that your team knows the company's mission and values, and knows how their work is contributing to, and aligned with, both. Company mission statements and values can help employees find meaning in their work
Recognition fosters pride. Celebrate employee wins in public channels and in all-hands meetings.
Set a “no meeting” day or days to allow employees time for deep focus and better opportunity for time management.
Are there obstacles or inefficiencies preventing employees from doing their best work? Discuss these in your recurring one-on-ones.
Check-in with employees regarding their roles and responsibilities at least once a quarter, to identify how to best align their work with their strengths and desired areas of development.
Have employees set at least one “stretch” goal per quarter that's aspirational in nature. This goal should ideally tie to the part of their job they are most enthusiastic about.
If a deep dive into comments reveals employees feel their work is a negative challenge, examine whether there are obstacles or inefficiencies preventing employees from enjoying their work.
Implement a program where you give your reports the opportunity to pursue one independent project per quarter. These assignments give employees the chance to leverage their unique skills and learn new ones.

### Team Culture

Give employees time to learn from their coworkers directly. Invite team members to lead peer-to-peer lunch-and-learn sessions on topics related to work or a personal hobby or interest.
Openly discuss and embrace diversity inabilities. Conduct skill mapping exercises to identify which employees are knowledgeable in specific areas, and match those employees with coworkers who need support via mentorships or office hours.
Identify and appoint subject matter experts on your team that other team members can turn to for answers to common challenges. When it comes to building trust on a team, giving ownership and credit goes a long way.
Create more shared and team-oriented goals to encourage teammates to appreciate one another's efforts, help each other through challenges, and “like” and “comment” on goal updates.
Implement competency frameworks and discuss role expectations with individual employees, both when they start a new role, and periodically as work changes.
Are there obstacles or inefficiencies preventing employees from doing their best work? Discuss these in your recurring one-on-ones.
Celebrate wins within the team. These smaller-group recognition moments will highlight team member accomplishments that may otherwise go unnoticed.
Create more shared and team-oriented goals to encourage teammates to appreciate one another's efforts, help each other through challenges, and “like” and “comment” on goal updates.

### Psychological Safety

Institute a post mortem process, and in advance of the session, have organizers circulate a survey asking for feedback. Projects or initiatives should be followed by a post-mortem meeting.
Give employees a means of submitting questions or concerns anonymously if they don't feel comfortable speaking up. Team meetings can provide an opportunity to address these concerns.
Make asking for help part of your team norms. As part of their regular status updates, ask employees to identify where they need additional support.
When projects fall short, encourage employees to single out where checks and processes fell short, not people Make the “blameless” model part of your culture.
Recognize employees for trying new things and taking risks—even when things don't go well Lead by example and make it a cultural norm.
Encourage your direct reports to take on at least one experimental project per quarter. Celebrate the effort and creativity that goes into the projects, and the learnings that come out—while success is welcome, it's not the expectation.
Make sure you are following the golden rule of management: praise in public, criticize in private. Employees will be more comfortable taking risks without worrying about mistakes being broadcast across the team.
Foster an environment where creative thinking is encouraged. Make this philosophy part of your culture, be it through deliberate creative activities or time dedicated during team meetings to outside-the-box thinking.
Help underrepresented employees (i.e. culturally diverse, women, LGBTQ+, parents, etc.) feel supported by encouraging them to join or create Employee Resource Groups (ERGs). A low score on the psychological safety question often means you need to pay closer attention to diversity and inclusion initiatives.
Openly discuss and embrace diversity in working styles, including introducing work style and strengths assessments such as MBTI, StrengthsFinder, or similar. Review your team member's preferences and identities, and create opportunities to take advantage of those differences.
Revisit your onboarding process. How can you make new hires feel more included? Introduce new practices, such as having team members take new hires out to coffee or lunch, or pairing new hires up with “onboarding buddies.”
Encourage employees to expense coffee dates with colleagues or new hires to bond and get to know each other better. Work relationships improve morale and collaboration
Make asking for help a team norm. During weekly meetings, have direct reports share what they're working on and where they need help. Lead this exercise by asking for help with your own initiatives.
Ensure that team members are aware how their individual goals contribute and work together to accomplish team and organizational goals. Employees are more inclined to collaborate when they're working toward the same end.
Break up politics and silos by organizing team initiatives and social events. This helps team members build empathy for each other and collaborate better.
Incorporate company values into your feedback and reviews. Make it clear that values like humility and integrity are just as important in measuring employee performance.
Implement competency frameworks and discuss role expectations with individual employees, both when they start a new role, and periodically as work changes. Lack of clarity surrounding roles and responsibilities can lead employees to reach beyond the scope of their role.

### Team Learning

Institute a post mortem process, and in advance of the session, have organizers circulate a survey asking for feedback. Projects or initiatives should be followed by a post-mortem meeting.
Challenge your processes regularly. Set the expectation that every team process is reviewed on a regular (try biannual to start) basis, and that feedback is collected from everyone involved.
Allocate budget for L&D, conferences, etc., and set goals around usage of budget across the team. Add a question to one-on-ones and updates: “Where do you think we could be seeking out more information as a team?”
Encourage employees to expense coffee dates with colleagues or new hires to bond and get to know each other better. Work relationships improve morale and collaboration.
Identify a senior manager whose style and results you admire and form a mentorship relationship with that person, asking for their input and coaching around challenges you are facing.
Ensure your team has access to customer feedback and that there is an opportunity to review it, discuss it, and suggest changes to products or processes via appropriate channels.
Involve more team members in the planning process By including more voices in the initial phases of planning (whether it be new processes, initiatives, or goals) you introduce new perspectives that might challenge long-standing norms.
Host project retrospectives with key stakeholders across teams to gather learnings for future collaboration Dedicating time to reflect on projects together can unearth critical insights about team communication, creativity, progress tracking, and more
Set aside time for regular team or department offsites that allow your team to brainstorm and learn together, particularly around important changes. To help your team to be more creative or innovative, you may have to get them out of their standard work routine.
As part of your project timelines, host a cross-functional review forum to allow a project team to review their progress, get feedback, and crowdsource solutions to problems or questions they have
Add specific points in the agenda of your internal planning meetings to challenge the assumptions and decisions you have made. This helps ensure every decision considers all potential side effects
When projects fall short, encourage employees to single out where checks and processes fell short, not people Make the “blameless” model part of your culture.
Create and identify meetings or communication channels for brainstorming and bouncing ideas off of each other with no judgment. Innovation often comes out of speaking out and testing assumptions.
Foster an environment where creative thinking is encouraged Make this philosophy part of your culture, be it through deliberate creative activities or time dedicated during team meetings to outside-the-box thinking.

### Work Relationships

Starting a “buddy” or mentor program gives new hires someone to talk to on day one. Employees are especially susceptible to loneliness when starting a new role
Bring them into the fold by leveraging communication tools and organizing virtual social events. Remote employees often feel like they're on the outside looking in.
Create growth plans with your employees consisting of the skills and talents they want to develop. Actively track these plans to ensure that employees are updating progress.
Partner with other managers to make random, cross-departmental coffee dates part of your culture so employees can build connections at work. Make it taboo to “talk shop” during these informal meetings
Hold weekly one-on-one meetings as a way to diagnose and address engagement issues. These meetings should be used to regularly check on how employees are doing.
Bring employees together in social situations that don't involve work. Field days, dinners, and other outings encourage team members to talk about more than their day-to-day.
Give employees the opportunity to lead a lunch and learn about a personal project that's near and dear to their heart. This can be a small session or you can partner with other managers to share learnings across teams.
Lead internal meetings by asking team members to share a personal check-in teams can go around the room, while large teams can divide into groups of 3-4 to give everyone a chance to share.
Partner with other managers to make random, cross-departmental coffee dates part of your culture so employees can build connections at work. Make it taboo to “talk shop” during these informal meetings.
Share regular updates summarizing your team's projects and initiatives. This gives your team a clear view of progress and who the subject matter experts are.
Give new hires clarity early on. As part of your team onboarding process, ask other team members to present on their areas of expertise and the initiatives and processes they own.
Establish clear escalation paths so employees can properly get the support they need when they have a knowledge gap. Employees need to know where to go for help.
Make “shout-outs” a part of your team meeting culture. Have each team member recognize someone in each of your weekly meetings, for example.
Recognize accomplishments and milestones in front of the whole team. Celebrate employee wins in public channels and in team meetings.
Help employees build meaningful relationships with their peers through team-building offsites and activities. Make these inclusive so team members don't feel left out.

### Diversity Climate

Work with your HRBP to set clear diversity and inclusion goals and share them with your team. Partner with a sourcing platform that connects companies with diverse candidates Check-in on progress at team meetings like you would other business targets.
Empower your team by encouraging them to join or create Employee Resource Groups (ERGs). These help employees spread awareness of the issues facing BIPOC, LGBTQ employees, working parents, and other groups.
Connect your team members to department or company leaders to give them an opportunity to advise leaders on how their actions are perceived by others. Employees can sometimes view leadership as out of touch.
Educate yourself and your team on the company's commitment to diversity, inviting leaders to come to speak with your team about it, or requesting that it be brought up more frequently in company-wide communications and events

### Fairness

Sign up for a course on review-writing technique, including the importance of specific examples when writing reviews. Updates, tracked goals, and ongoing feedback can make a big difference by providing you with reminders about your team members' performance, and help ensure that employees aren't caught by surprise.
When evaluating your team members in performance reviews, recognize that unconscious bias may be at work. Consider getting trained on unconscious bias, or asking for such training from your company. Your fair evaluations ensure equity in ratings across the company.
In advance of performance conversations, ask your team members' peers for feedback to ensure you get a complete picture of their performance. You can only see and know so much about your team members' work life.
Work with your HRBP to set clear diversity and inclusion goals and share them with your team. Partner with a sourcing platform that connects companies with diverse candidates Check in on progress at team meetings like you would other business targets.

Once you have navigated to the Notification Center, there may be multiple options for how notifications can be sent when it comes to our surveys tool—e.g., through Slack and/or through email.

Note: Survey notifications will default to the employee time zone, then company time zone, and then PST time.

### Engagement Notification Surveys

Engagement survey notifications are sent as follows:
When you launch a survey (to all participants)
When you nudge a survey participant before the survey ends
As a reminder to participants that have not completed the survey two days before the deadline
When you nudge a survey participant before the survey ends (selected participants)
As a reminder to end a survey two days before the end date (email only to survey admins)
A reminder to complete the survey two days before the end date (email only to those who haven't completed the survey)
   Engagement survey notifications when replying to anonymous comments are as follows:
A conversation has been assigned to you
A comment assigned to you is awaiting a reply
A manager or survey admin has replied to your anonymous comment
   Engagement survey notifications for action plans are as follows:
When publishing a public company action plan, all employees will receive an email notification and task to view action plan
When publishing a private company action plan, all survey admins and action plan owners will receive an email notification and task to view action plan
When publishing a public manager action plan, all survey admins, direct reports, and any owners that are not direct reports will receive an email notification and task to view manager action plan
When publishing a private manager action plan, all survey admins and owners will receive an email notification and task to view manager action plan
When republishing an action plan, email notifications will follow the same logic as above
When posting an update to a published action plan, email notifications will be sent to everyone who has the ability to view the plan using the same logic as above
   Engagement survey action plan notifications are sent as follows:
When a company action plan is published
When a manager action plan is published
When updates are posted to published action plans

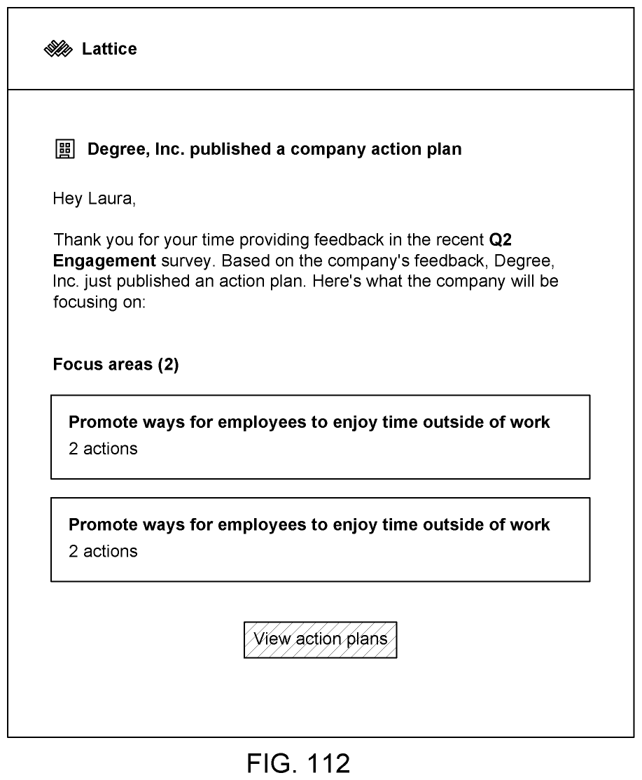

FIG. 112 is a screenshot of an example user interface for a notification of a publishing of a company action plan.

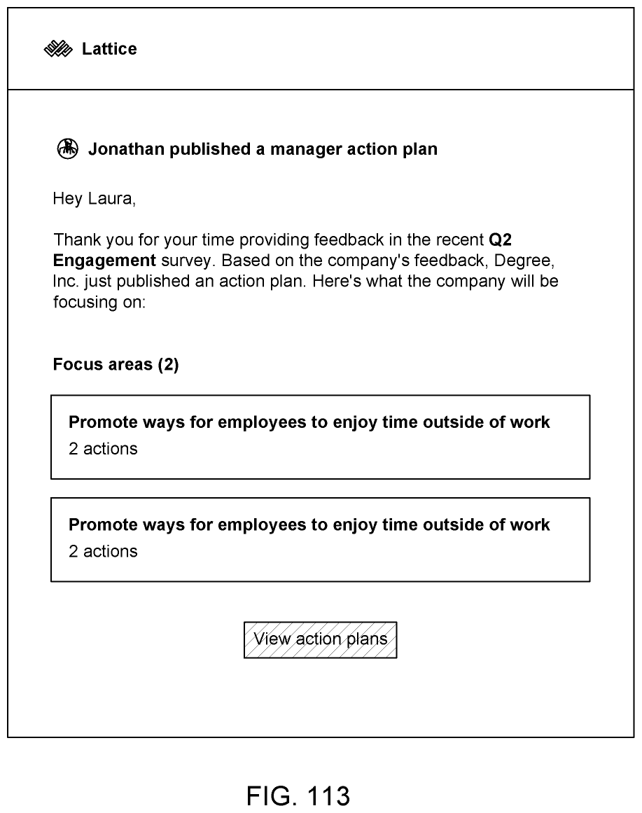

FIG. 113 is a screenshot of an example user interface for a notification of a publishing of a manager action plan.

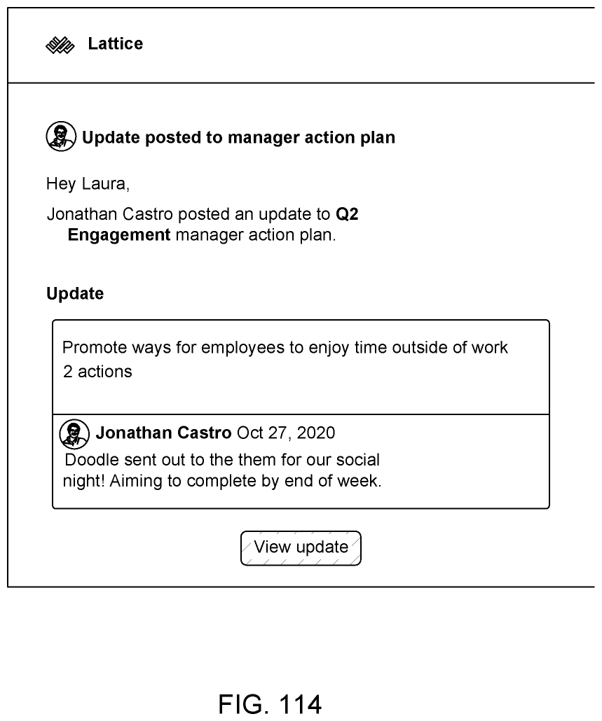

FIG. 114 is a screenshot of an example user interface for a notification of an update to a published action plan.

Note: All active AND invited users will receive email and Slack notifications to participate in surveys.

To send survey notifications through Slack or email, you can check on the boxes to the right of “Surveys.” Make sure to press the blue “Save changes” button when you're finished.

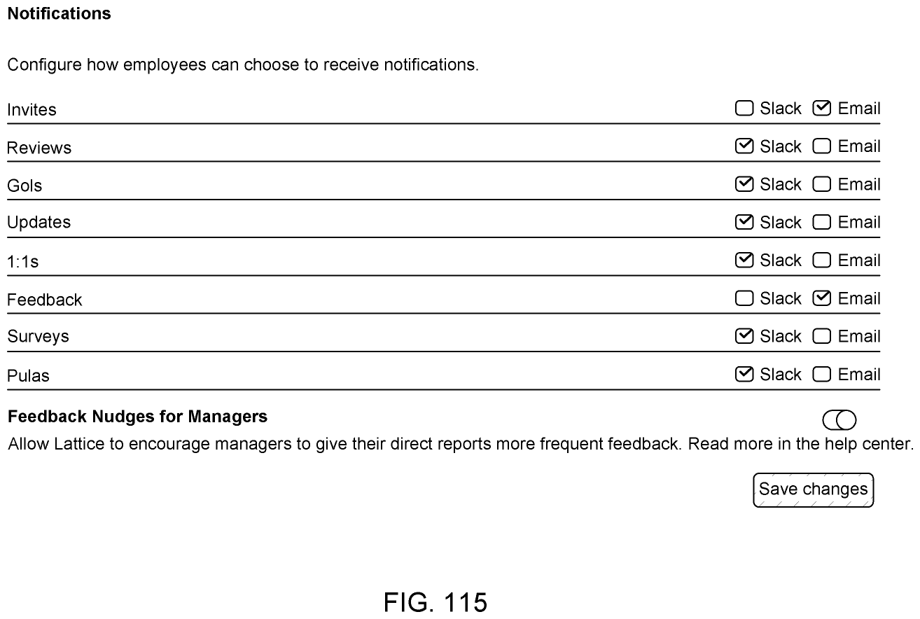

FIG. 115 is a screenshot of an example user interface for configuring notifications, including whether each of multiple types of notifications are sent via one or more particular channels (e.g., Slack or email).

Note: Slack notifications are sent via a mobile application (e.g., the Lattice app”).

Notifications users receive:
Launch of engagement survey: This is a custom message curated by the admin.
A reminder to complete the survey: This is a customizable message that will be sent out by the admin to remind users to complete the survey.
A reminder to end the survey (for admins only): Because engagement surveys do not automatically close, this notification will be sent out two days before the survey's due date to remind admins to end the survey.
A reminder to complete the survey two days before the end date (email only to those who haven't completed the survey).
   Once the survey has ended, you will be able to share views of the results with employees.

### More About Action Plans

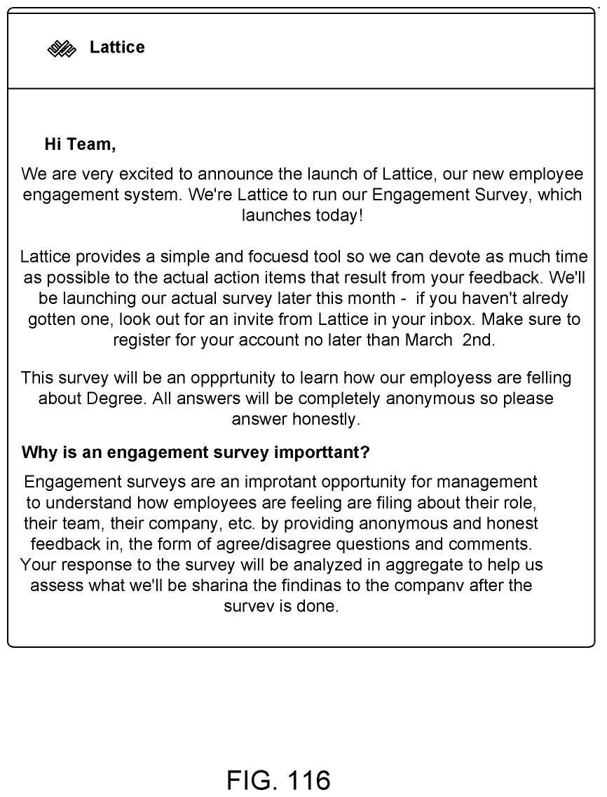

FIG. 116 is a screenshot of an example user interface for a notification of a launch of an engagement survey.

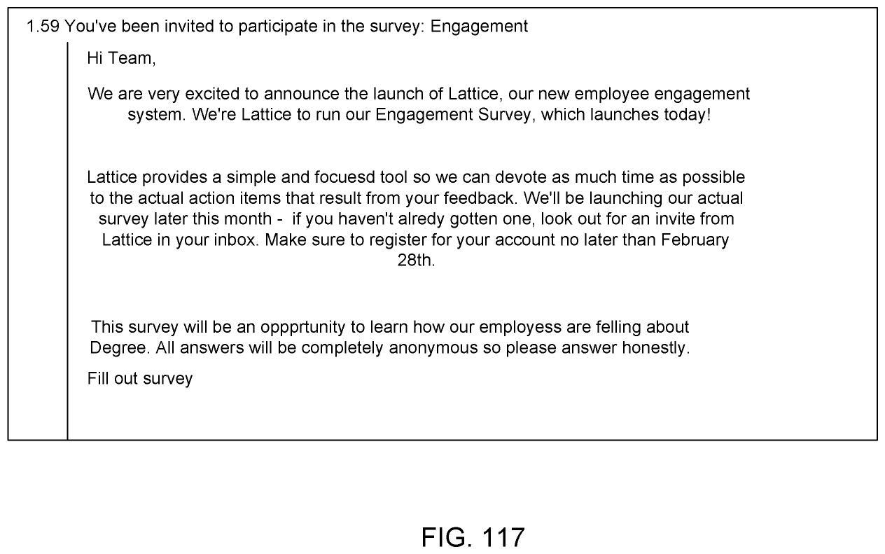

FIG. 117 is a screenshot of an additional example user interface for a notification of a launch of an engagement survey.

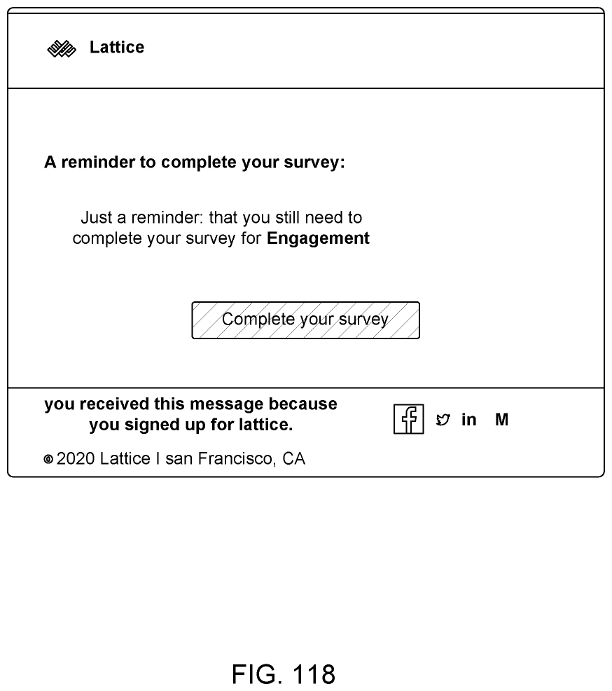

FIG. 118 is a screenshot of an example user interface for a notification of a reminder to complete a survey.

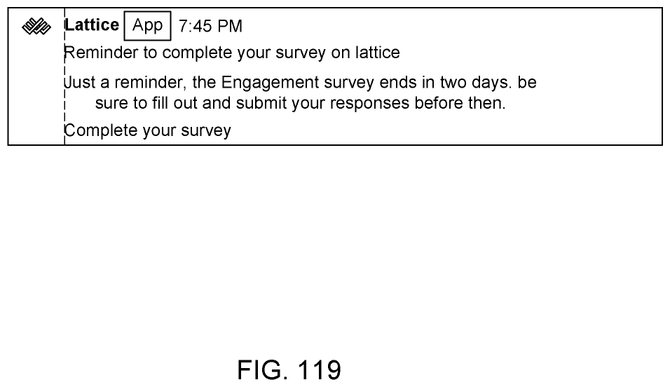

FIG. 119 is a screenshot of an additional example user interface for a notification of a reminder to complete a survey.

Once an engagement survey launches, any employees included in that survey will receive a task titled “Respond to a survey.” If clicked, it will take the employee into the survey in Lattice. Survey tasks are not dismissible-they will not leave your profile until you've completed the survey or the survey ends.

Once you've selected “Respond to survey,” it will bring you directly into the survey.

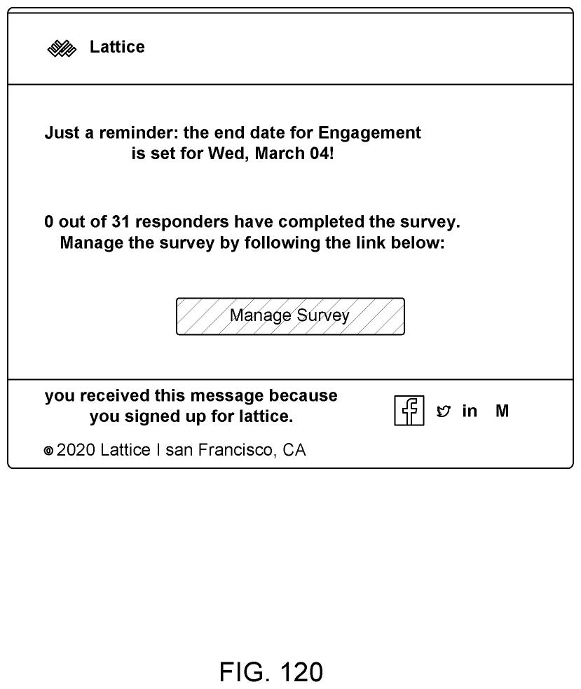

FIG. 120 is a screenshot of an example user interface for a notification for admins to manage a survey.

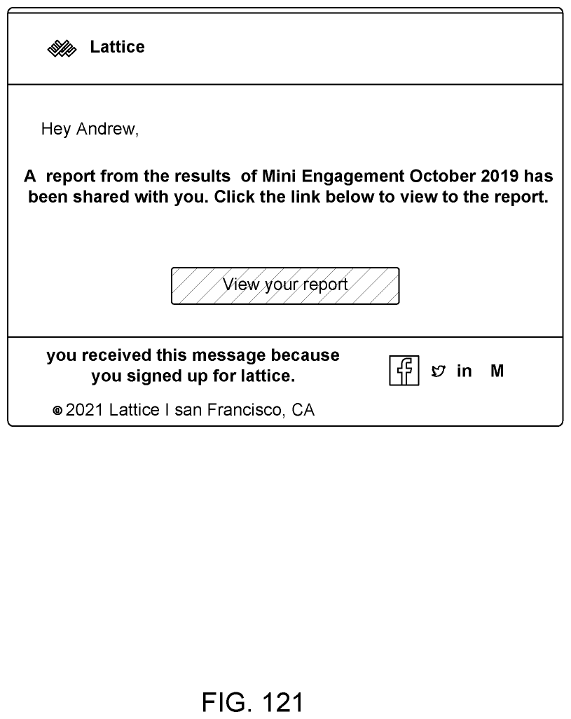

FIG. 121 is a screenshot of an example user interface for a notification of a notification that a report has been shared.

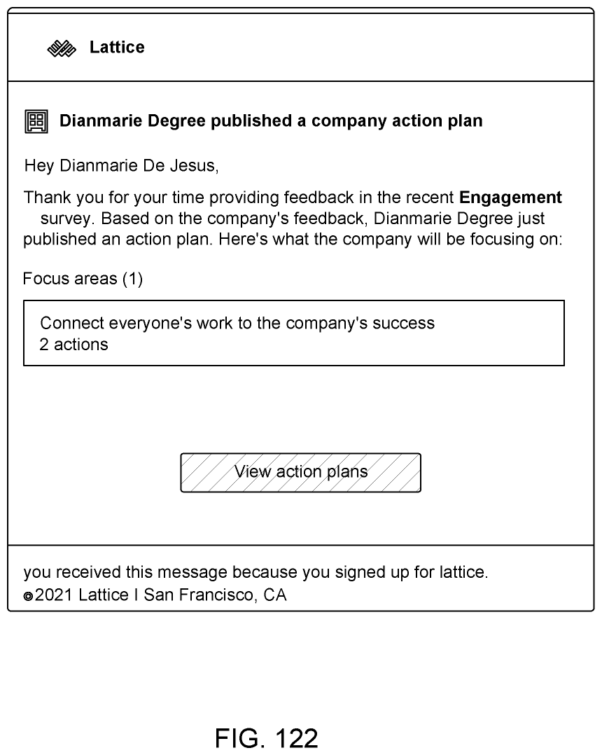

FIG. 122 is a screenshot of an example user interface for a notification for an action plan being published.

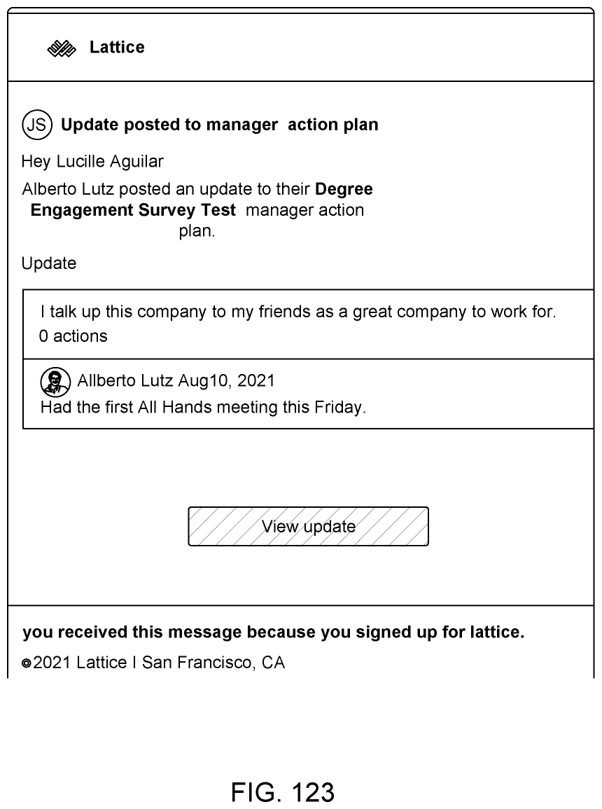

FIG. 123 is a screenshot of an example user interface for a notification for an action plan being updated.

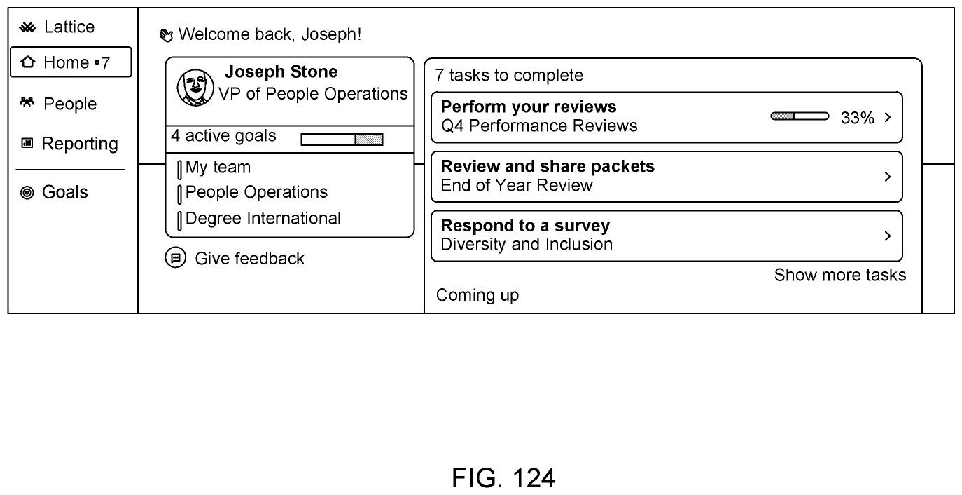

FIG. 124 is a screenshot of an example user interface for responding to a survey via a tasks list.

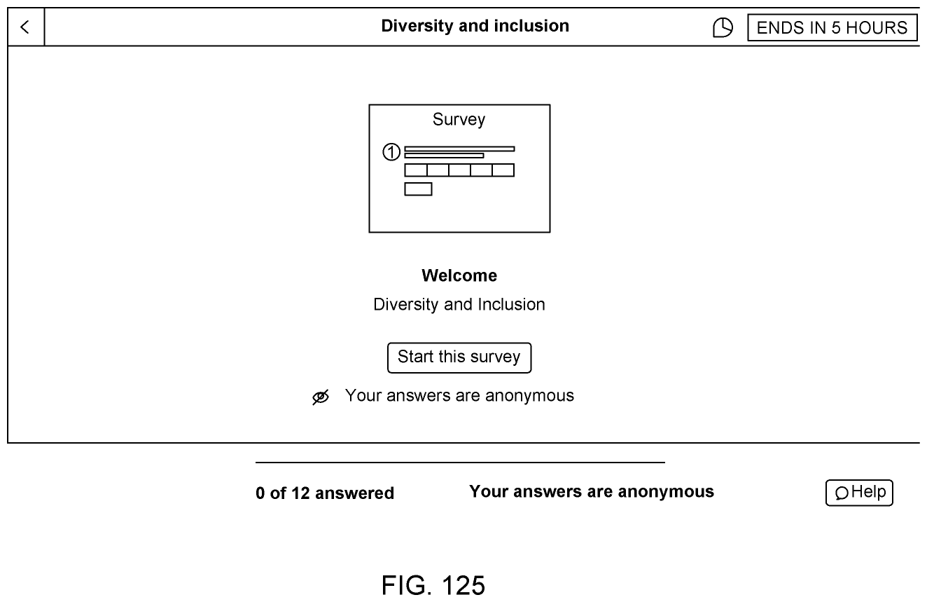

FIG. 125 is a screenshot of an example user interface for a welcome screen for a survey.

### Engagement Surveys

Engagement surveys may be traditionally performed annually, bi-annually, or quarterly and contain data that lacks a temporal dimension. Engagement surveys are a tool to measure how your whole (or a large portion) of workforces is feeling at a specific point in time.

### Pulse Surveys

The Pulse system (e.g., “Pulse”) is designed to capture employee engagement on a much shorter cadence. Similarly to how continuous feedback fills in the space between performance reviews, pulse fills in the space between long-form engagement surveys.

When configuring pulse surveys, you select the cadence with which your org will be pulsed. The cadence settings are composed of the question limit (how many questions are asked during each pulse) and the frequency (how often pulse surveys are distributed to employees).

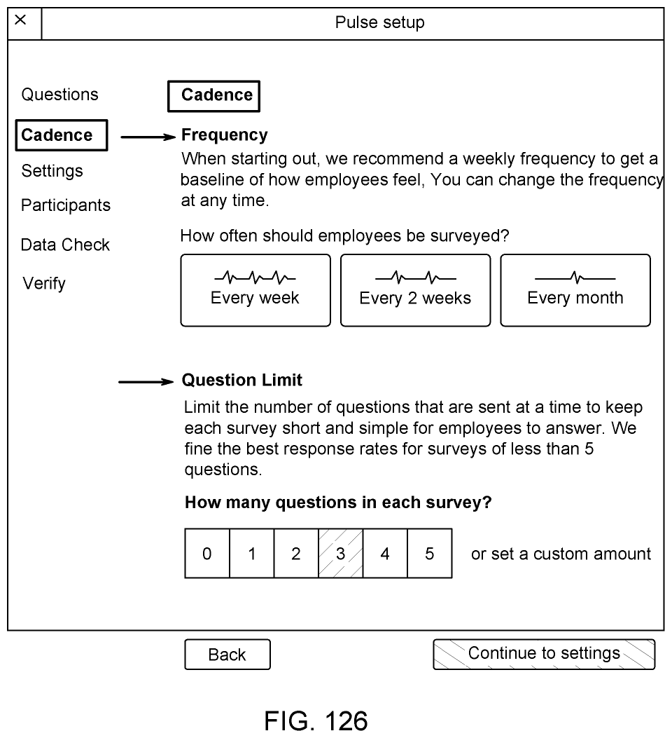

FIG. 126 is a screenshot of an example user interface for setting a cadence for a survey, such as a frequency and/or a question limit.

Once you determine your cadence settings and verify your pulse survey, Lattice's algorithm will select members of your org to pulse at random throughout the frequency period. Every employee should receive 1 pulse per frequency period.

For the initial survey, all employees will be pulsed the same set of questions at varying times during the selected frequency (sometime within the next week, 2 weeks, or month). All subsequent pulses will randomize the questions asked in addition to randomizing at what time they are received. Using the screenshot above, each employee would receive 3 questions chosen at random from the pool of questions you chose for pulse. This minimizes bias that could be introduced by the time of day or day of the week that employees are surveyed, and leads to more accurate results.

Pulse surveys will only be sent during regular business hours (9 am to 5 pm local time), Monday through Friday. Employees should not be pulsed on weekends or outside of their working hours (based on their individual time zone setting in Lattice, falling back on the company time zone if not set on the individual level).

### Question

How do questions cycle through pulse?

### Answer

Each employee sees every question at least once before they receive the same question again. Let's say you have a weekly cadence set with a 60 question survey and a 5 question limit. An employee would receive 5 random questions per week for 12 weeks, e.g., until they have seen each question once. Then it would cycle through the questions again.

Adding eNPS to Your Pulse Survey

Navigate to your pulse survey questions in Settings and click the toggle button at the top of the Questions page to enable eNPS.

This question is measured on a scale of 0 (Not very likely) to 10 (Very likely) and also includes an option to add a comment similar to other pulse survey questions.

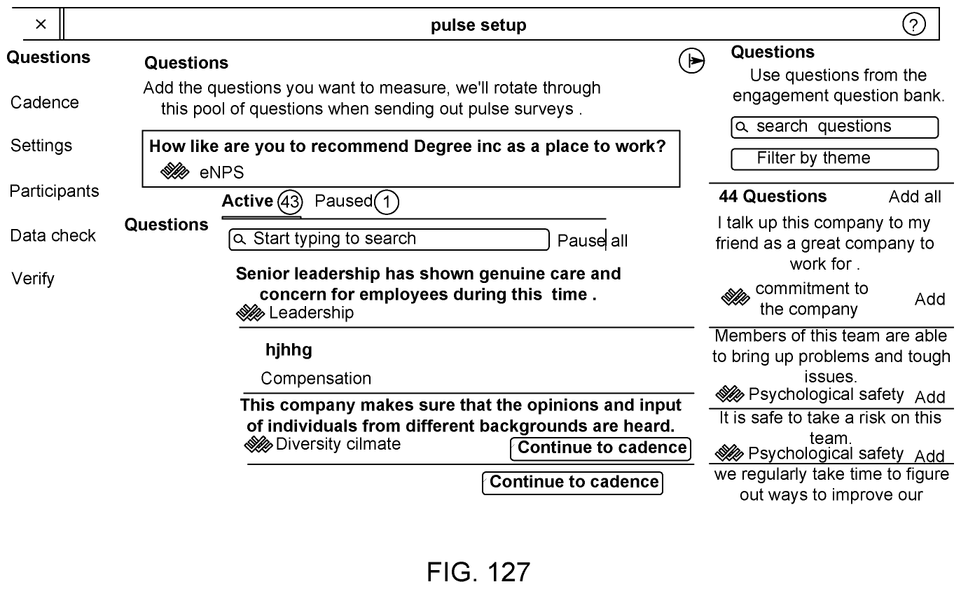

FIG. 127 is a screenshot of an example user interface for adding an eNPS question to a survey (e.g., a pulse survey).

How eNPS Appears to Pulse Respondents

When filling out an eNPS pulse, Lattice users will see the question displayed as in the screenshot below.

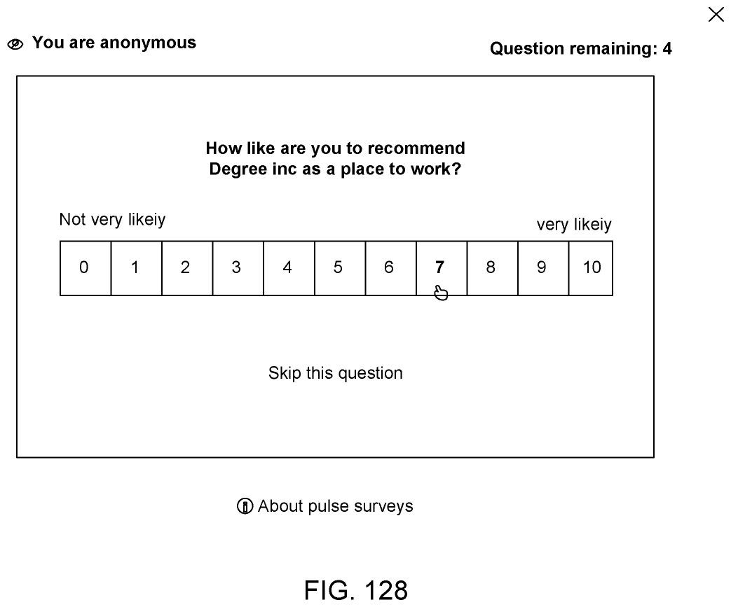

FIG. 128 is a screenshot of an example user interface for presenting an eNPS survey question to a user.

Please note: it is randomized when a user receives the eNPS question just like all other pulse questions, but when the question is included in a pulse, it will be the first question asked.

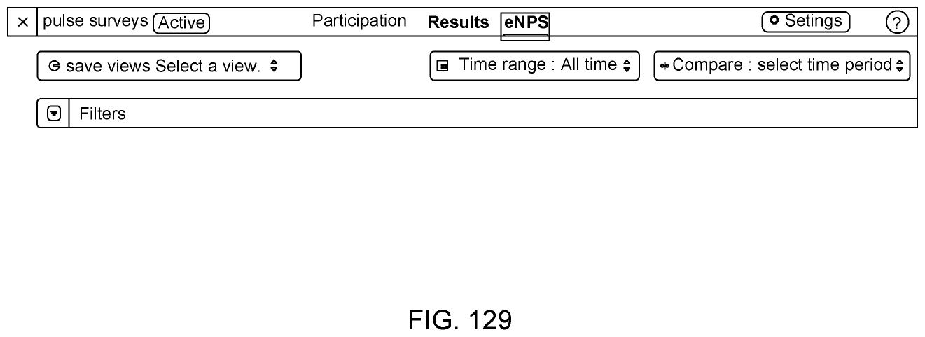

FIG. 129 is a screenshot of an example user interface for accessing eNPS reporting.

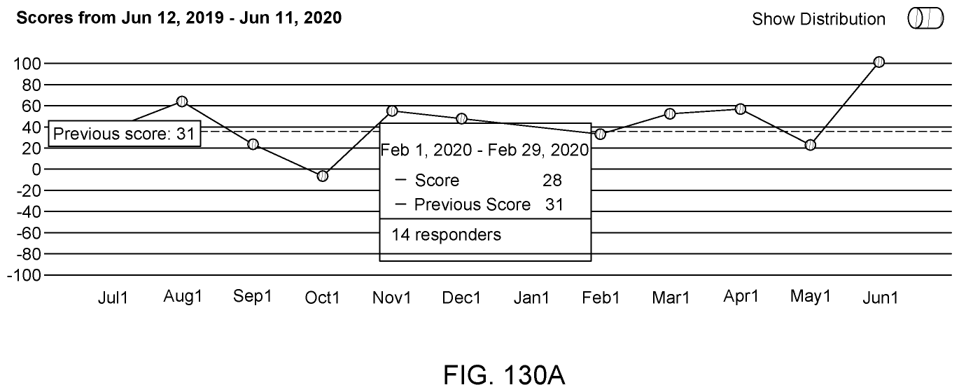

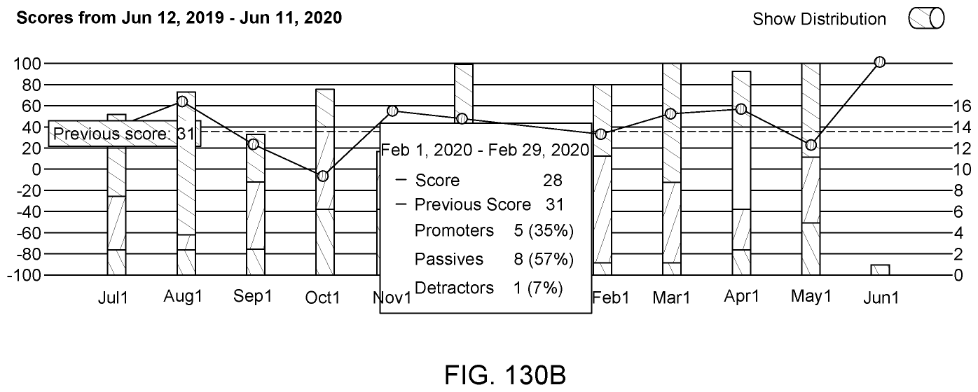

FIG. 130A is a screenshot of example user interfaces for accessing scores over a time period.

FIG. 130B is a screenshot of an example user interface for accessing scores over a time period with a distribution of promoters, passive, and/or detractors being toggled on to be shown.

### Setting Up Your Pulse

When creating your pulse you will be able to select the frequency. You will be able to select between pulsing your employees weekly, bi-weekly, and monthly (every 30 days)
This cadence is based on when you launched your pulse. There is not a quarterly cadence; however, if you want to survey your employees quarterly you can use our regular engagement surveys tool.
You may also select how many questions are asked for each pulse. The system may recommend no more than 3-5 questions per pulse to avoid survey fatigue. The system may recommend a smaller number of questions if your pulse frequency is more often.

### Employee Participation

### All Employees Participate

If you would like all your employees to be pulsed, select All employees in the Participants section of the pulse setup.

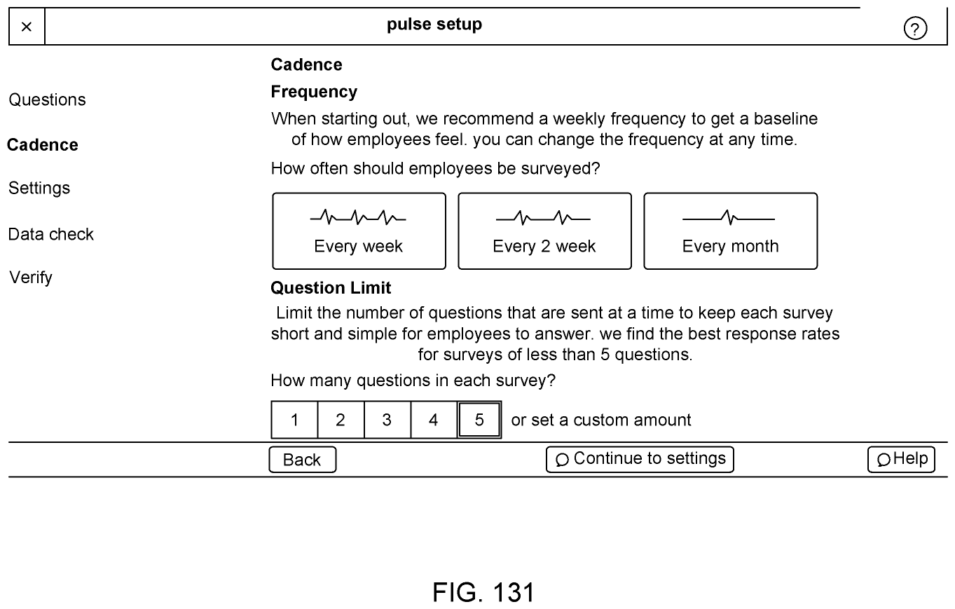

FIG. 131 is a screenshot of an example user interface for specifying a number of pulse survey questions from a recommended range (e.g., 3-5).

### Subset of Employees Participate

If you would like only a particular subset of your employees to be Pulsed, select Specific employees in the Participants section of the pulse setup. Then select the filter to select employees you'd like to pulse based on default and custom user attributes.

As an admin, once you have launched your pulse survey, you will get access to pulse reporting and analytics. This will allow you to get a real time view of your organization's participation and results.

### How to Configure Your Pulse Survey in Eight Simple Steps

### Setup Guide

Step 1: Navigate to the admin page on the discovery navigation and click on “pulse.”

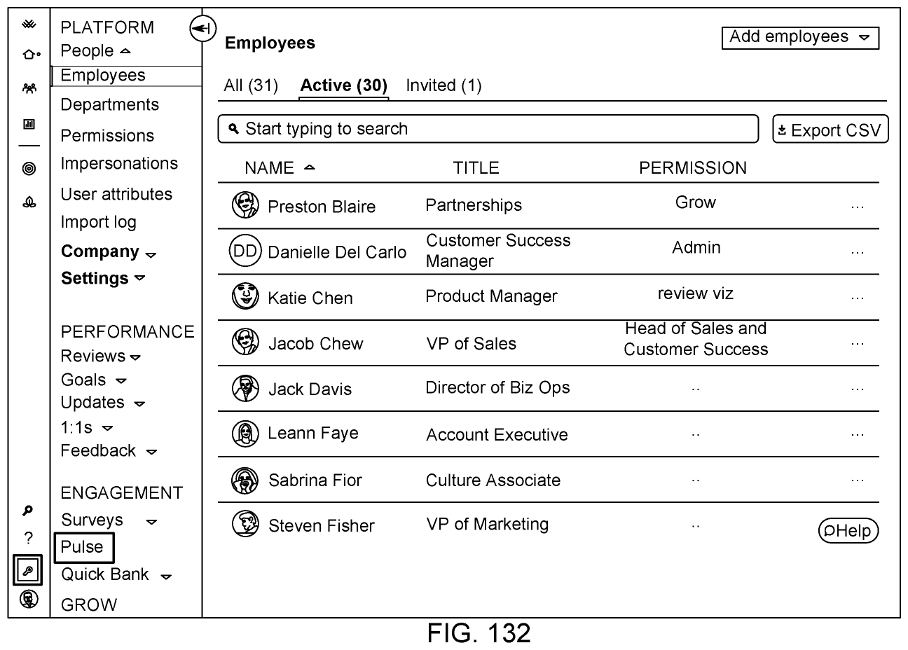

FIG. 132 is a screenshot of an example user interface for accessing a pulse survey setup screen.

Step 2: Set up your questions, we recommend the Lattice engagement questions, or you can create your own. Please note: only rating questions can be added to a pulse survey. Comment-type questions are not able to be included in pulse.

Step 3: Select the cadence for how your employees will be surveyed.
Choose the frequency
Set your question limit

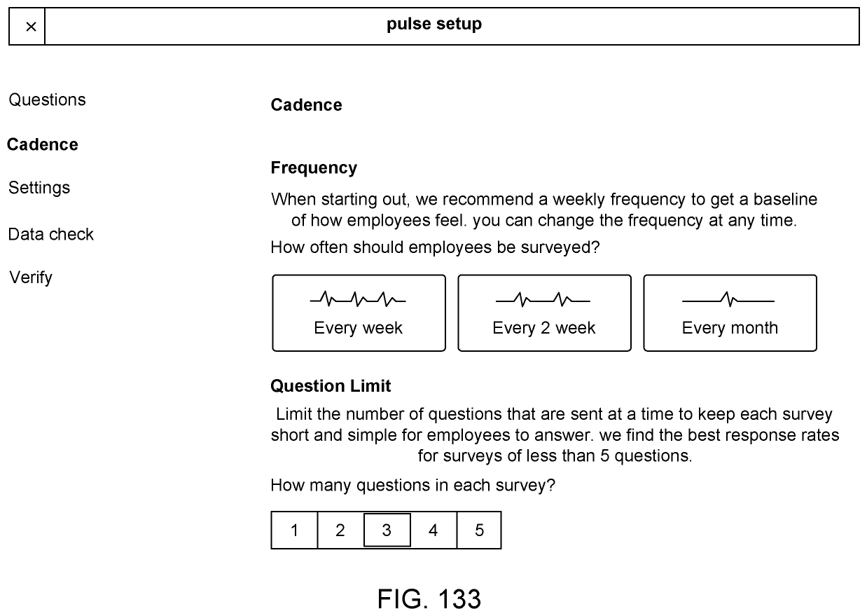

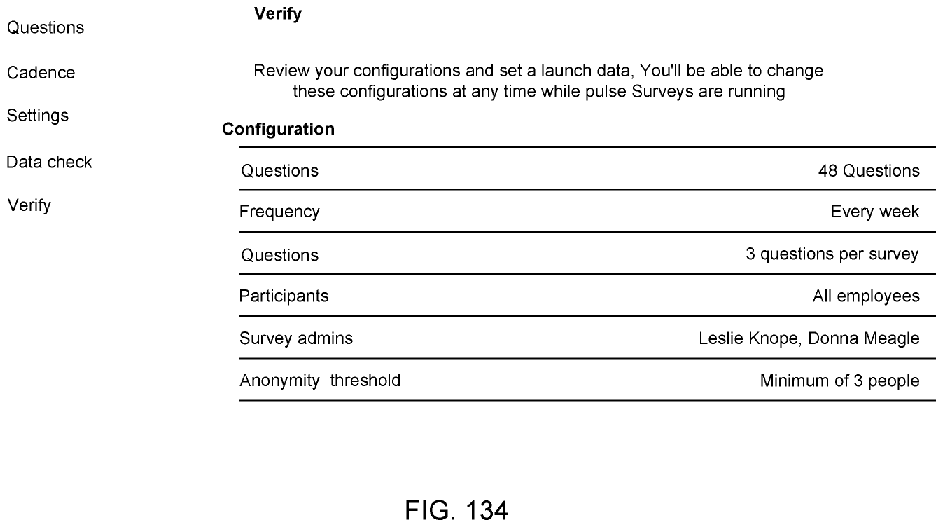

FIG. 133 is a screenshot of an example user interface for specifying a Cadence for a pulse survey during a setup flow.

Step 4: Select the proper channels to reach your employees. From this same screen, you will also be able to select notifications settings.

Step 5: Select the pulse survey admins, anonymity threshold, and launch date.

Step 6: “Data Check”—here you will be able to see user attributes and any information to separate your pulse survey.

Step 7: “Verify”—view a summary of the settings and configurations of your pulse. This will include the time when your pulse will launch. Select “Done” to launch.

FIG. 134 is a screenshot of an example user interface for verifying configurations and/or setting a launch date for a pulse survey.

Step 8: Once you have selected “Done,” you will see a confirmation screen with your pulse survey's launch date. Keep in mind that if you want to launch a pulse survey for the next business day, you will need to have your survey set up by 4 pm PST/7 pm EST.

### Launching a Pulse Survey

Once you have finished your pulse survey setup, you will be taken to the page shown below, confirming set up was successful and stating the first date your employees will be pulsed. Please note that not all of your employees will be pulsed on this day but rather will be pulsed at times distributed across the cadence you have selected.

Now that Your Pulse has Launched

Employees will receive a randomized selection of your active questions at a random time during the pulse frequency period (anywhere between 9 am-5 pm, Monday through Friday).

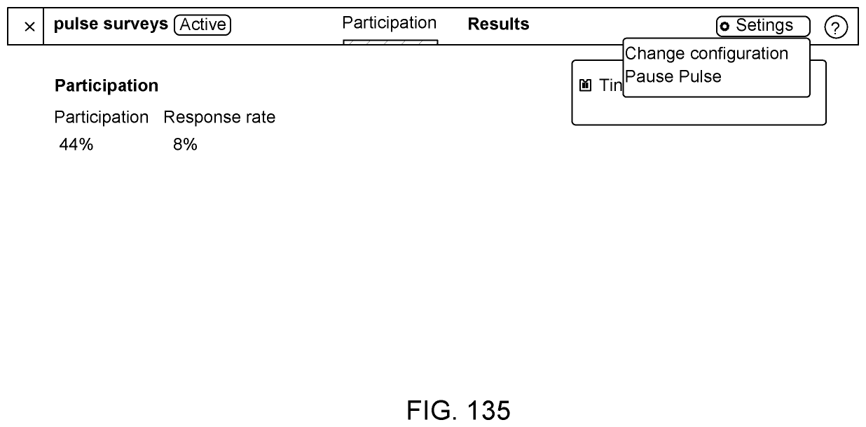

FIG. 135 is a screenshot of an example user interface for changing configuration settings for and/or pausing a pulse survey.

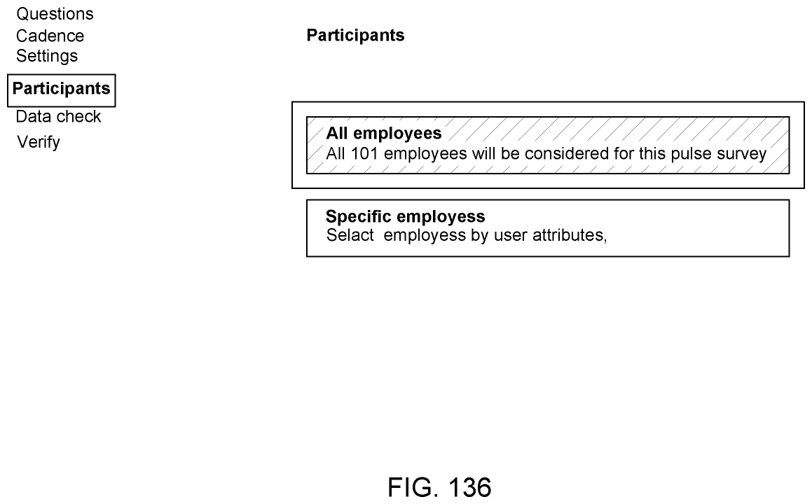

FIG. 136 is a screenshot of an example user interface for specifying one or more participants or groups of participants for a survey.

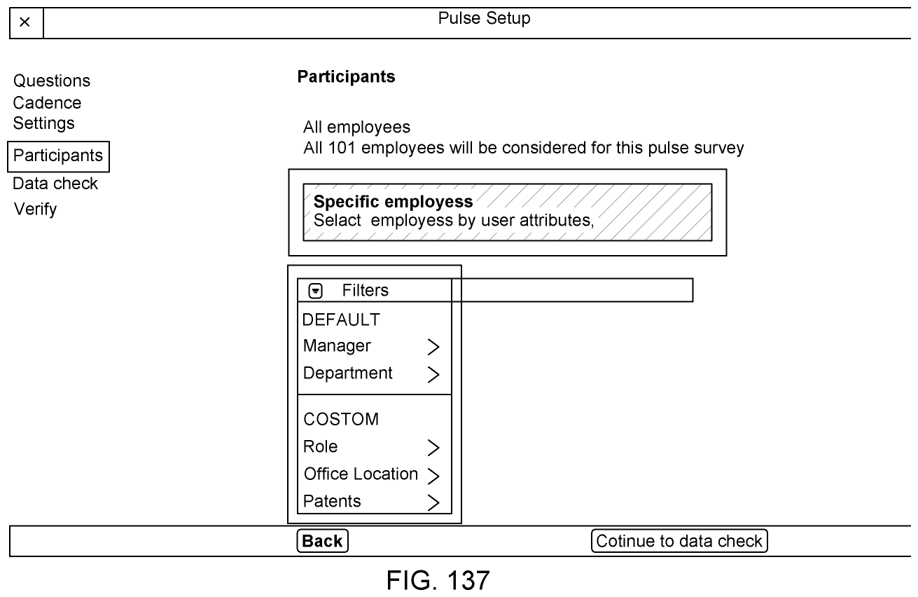

FIG. 137 is a screenshot of an example user interface for specifying one or more specific users (e.g., employees) as participants for a survey.

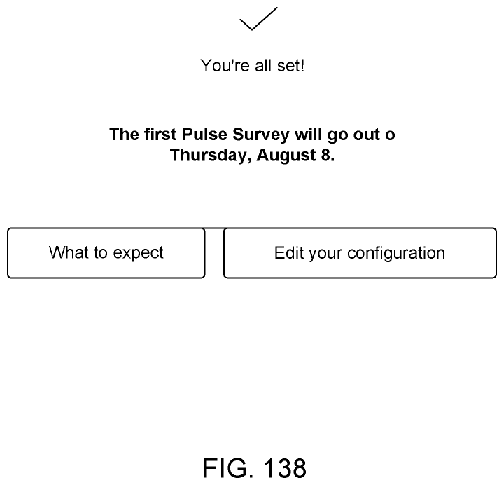

FIG. 138 is a screenshot of an example user interface for confirming and/or launching a pulse survey.

### Viewing Pulse Survey Analytics

Once your first pulse survey has been sent you will be able to access the pulse reporting and analytics.

### Viewing Your Participation and Response Rates

Under the participation tab, admins will be able to see the participation and response rate for the pulse survey. This will be visible to admins once one participant has completed a pulse survey.

Department Vs. Manager Participation

When viewing pulse participation you have the option to view under department-level participation or manager participation. Department participation provides the participation rate of the entire department, while under the manager view, you will see specifically the participation of direct reports pertaining to individual managers in the org.

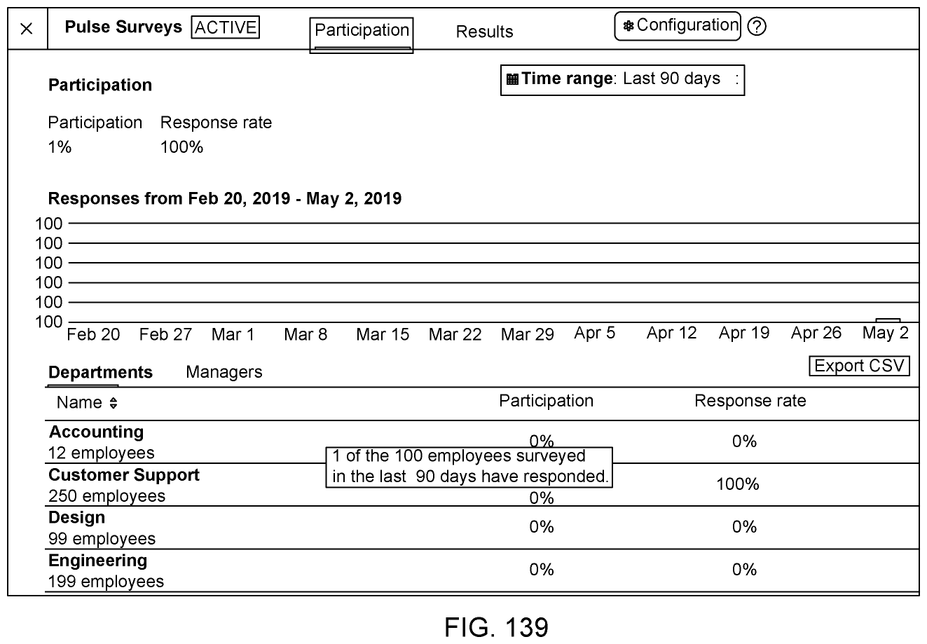

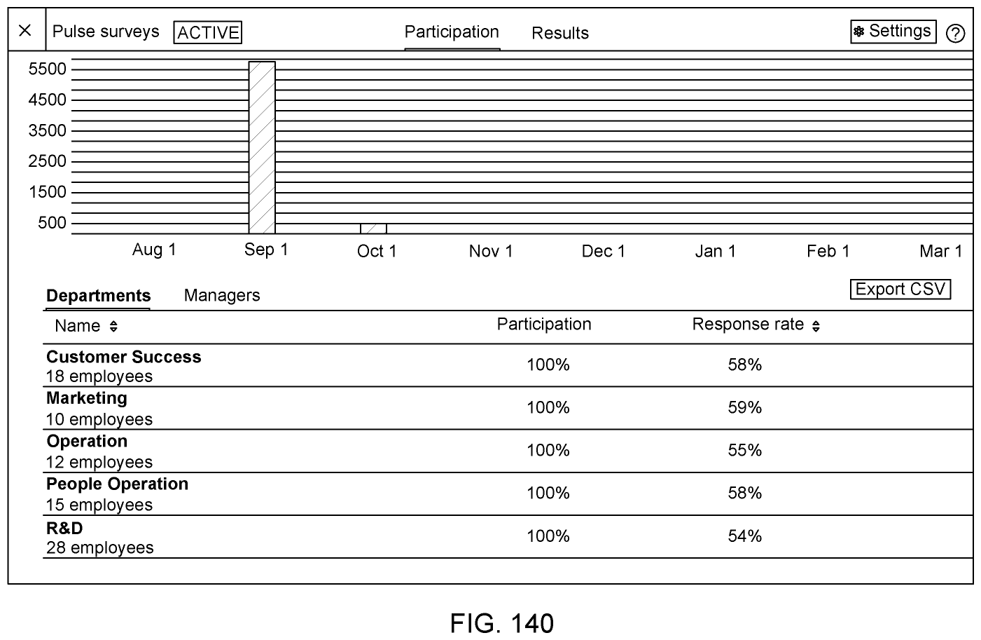

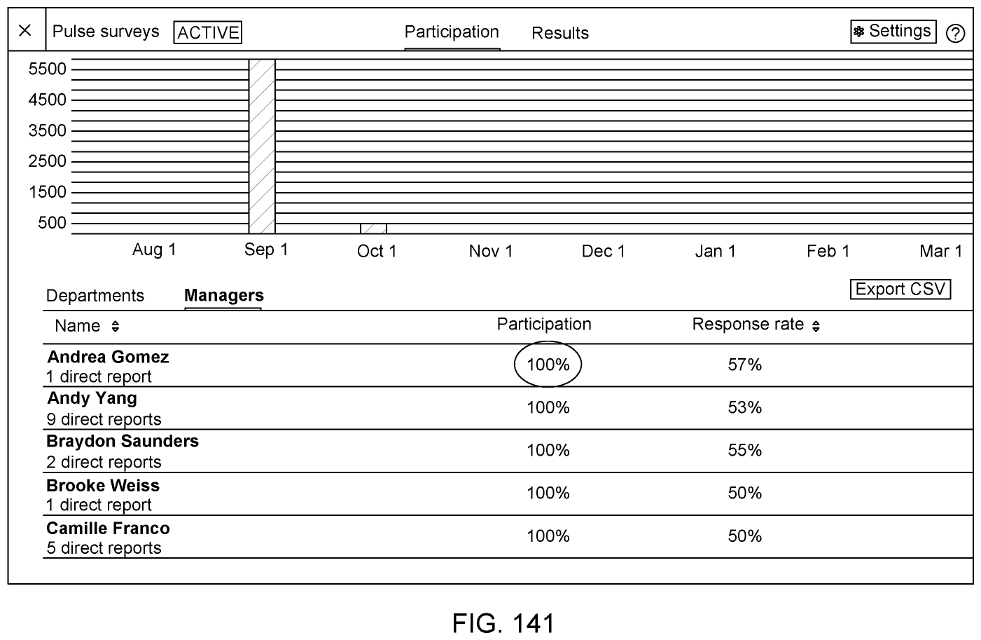

FIG. 139 is a screenshot of an example user interface for accessing participation and/or response rates for a survey.

FIG. 140 is a screenshot of an example user interface for accessing different options for response and/or participation rates for a survey.

FIG. 141 is a screenshot of an example user interface for viewing participation and/or response rates under a specific view (e.g., a manager view).

### Viewing Pulse Results

Under the Results tab, admins will be able to see and filter their pulse data. This will be available to admins once the anonymity threshold has been met.

Once people start submitting responses to their pulse survey, admins will be able to see analytics around the responses once the number of responses submitted satisfies our anonymity threshold. We offer several views to help you discover insights about your people and organization.

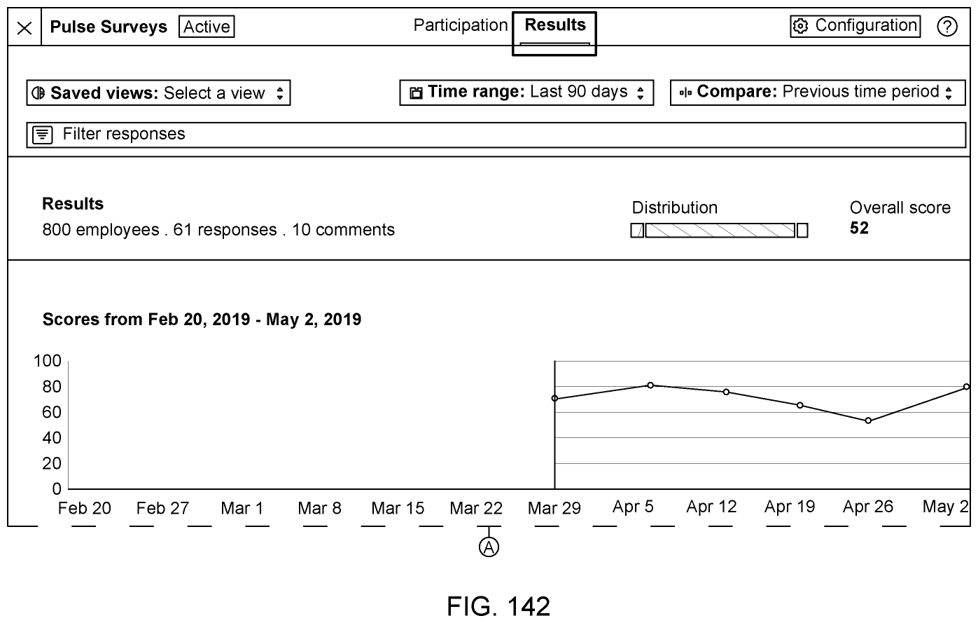

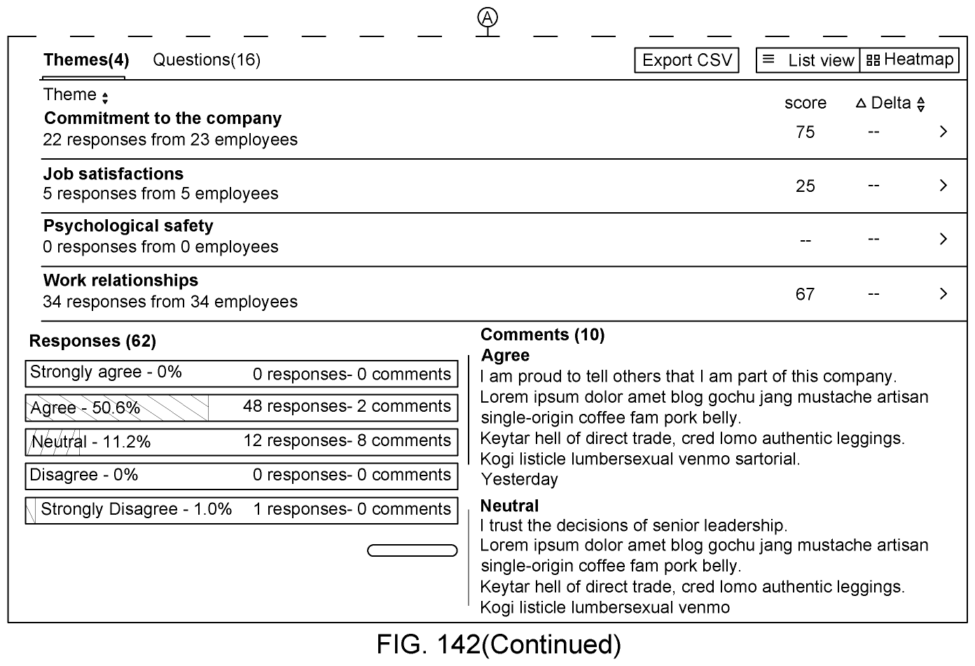

FIG. 142 is a screenshot of an example user interface for viewing and filtering pulse survey data (e.g., for administrators).

### Results

To view the results of a pulse, go to the admin tab and select pulse on your left navigation panel, then select Reporting. The overview panel provides a snapshot of the data that has been collected. Data regarding participation and response rate can be found here.

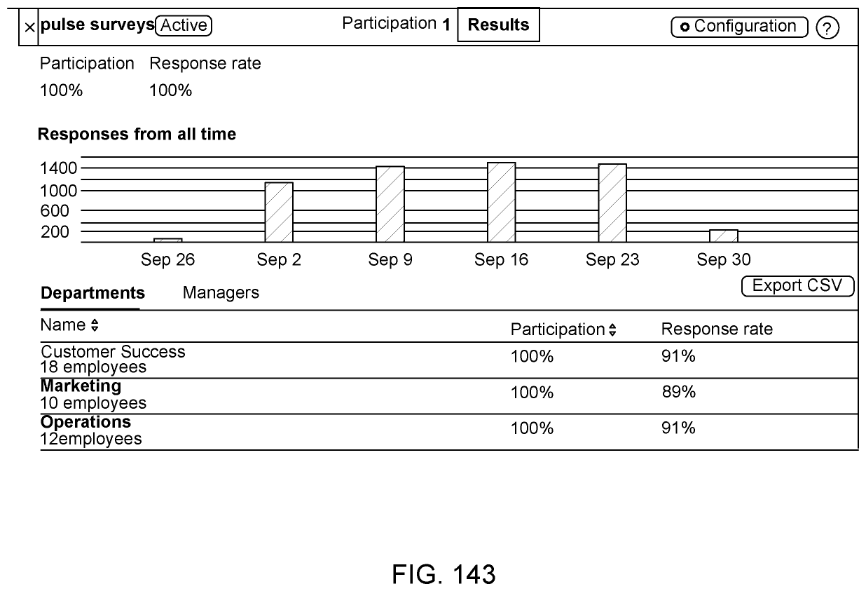

FIG. 143 is a screenshot of an example user interface for accessing results of a pulse survey.

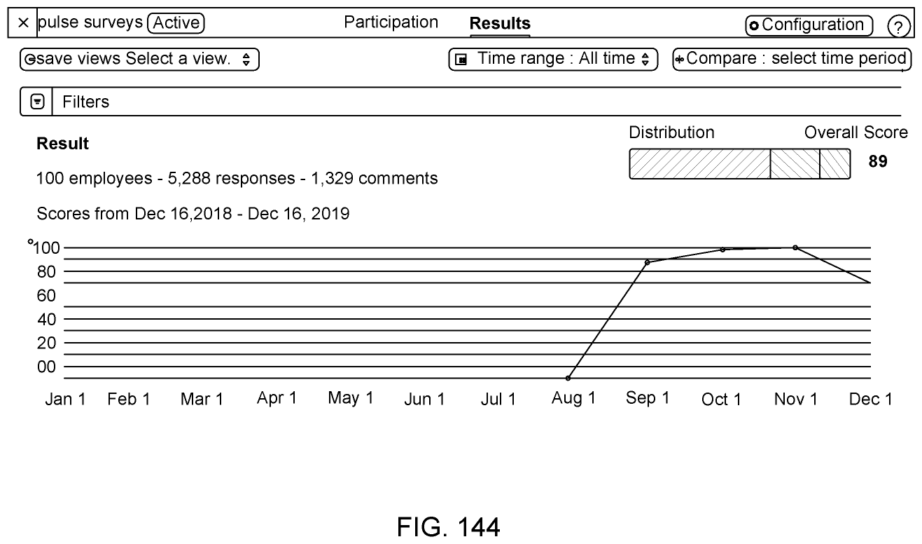

FIG. 144 is a screenshot of an example user interface for accessing participation and/or response rates for a pulse survey.

When you compare your select time period with the previous time period, it compares it to the previous time period to the date range you've selected. For example, if the time period is set to 90 days, the previous time period would be 90 days before that time range.

Lattice treats pulse ‘tenure’ buckets based on what the employee's tenure is today. For example, let's say an employee is set to hit their 1-year tenure on Nov. 24, 2020. This employee will be pulled into the filter “Tenure=1-2 years”. Now, let's say in the future, this employee has hit the 2-year mark. In this case, their data will only be shown if the “Tenure=2-4 years” is marked.

What is the difference between response rate and participation in a pulse survey?

You may be wondering what the difference is between response rate and participation in a pulse survey under the participation tab. We have outlined the differences below:

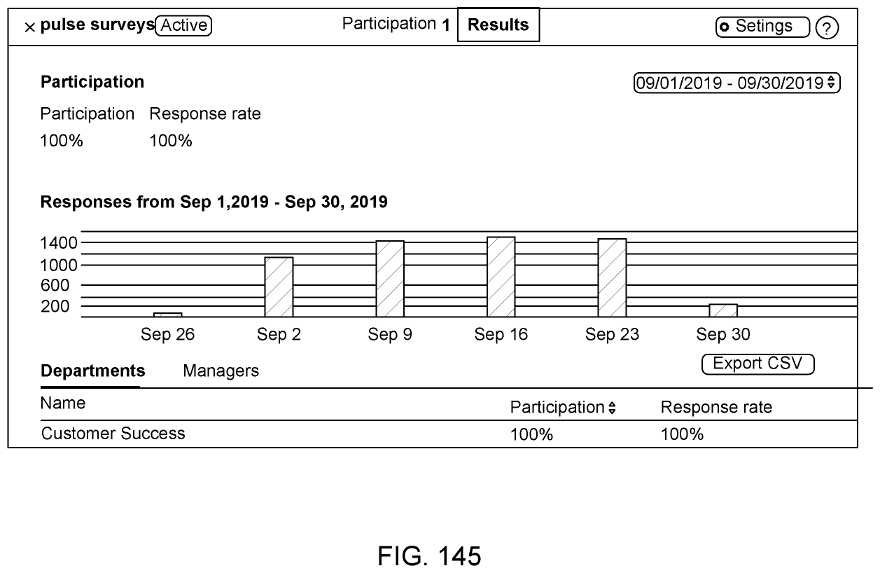

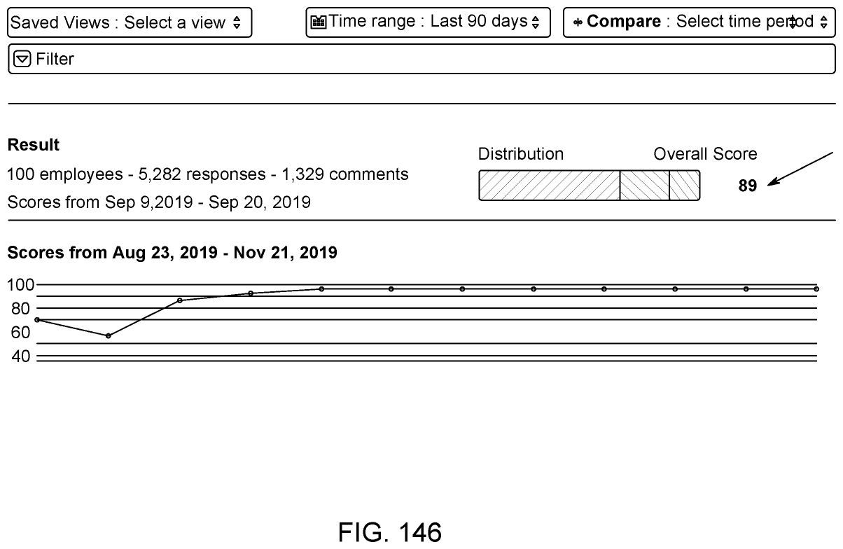

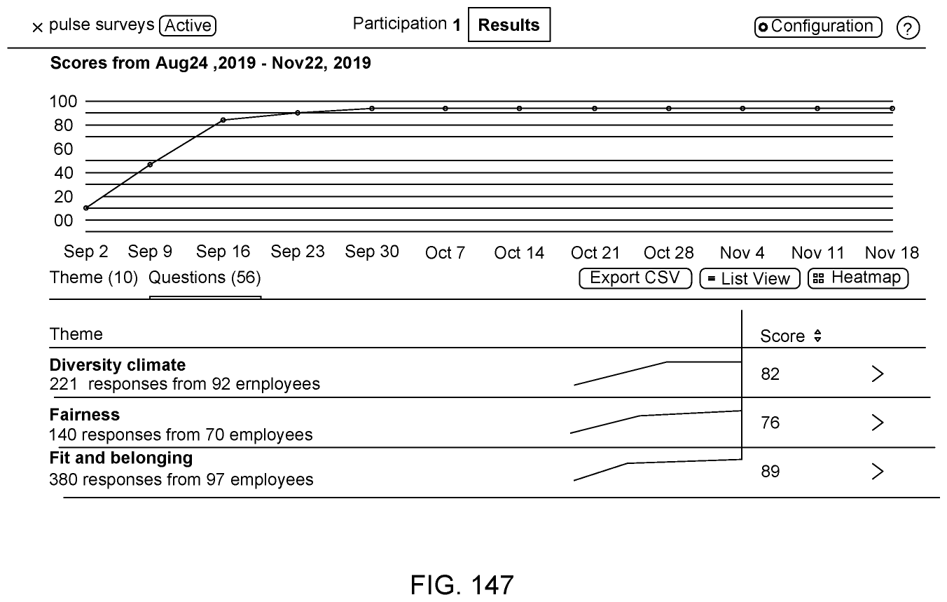

FIG. 145 is a screenshot of an additional example user interface for accessing participation and/or response rates for a pulse survey.

### What is Response Rate?

We calculate response rate as the number of responses submitted out of the total number of questions sent out. This information will be easily accessible from the admin tab under reporting.

### What is Participation Rate?

Participation is calculated by taking the number of people who have answered at least one question out of the total number of people who were sent a pulse survey.

Once you've pulsed employees and enough responses have been submitted, you will see three different scores: your overall pulse score, your theme scores, and your question scores.

### Overall Pulse Score

Your overall pulse score is shown at the top of your pulse results screen.

FIG. 146 is a screenshot of an example user interface for accessing an overall score for a pulse survey.

To calculate the overall score, Lattice uses the average of all theme scores within the time range. If theme scores are not visible because the anonymity threshold is not met, the overall score will still be calculated based on the data available in each theme.

### Theme Scores

FIG. 147 is a screenshot of an example user interface for accessing theme scores for a pulse survey.

Theme scores can be found next to each theme on the right-hand side. The theme is calculated by taking the average of all responses to that theme for each user (with the current filters and date range) and then compared to a threshold to determine if each user is a “positive” responder for that theme. The percentage of positive responders over total responders is the theme score.

### Question Scores

Question scores can be found next to each question on the right-hand side.

The overall question score finds the most recent response for each user for the given question. If that most recent response is either “Agree” or “Strongly Agree,” then their response is considered a positive response. We take the total number of positive responses and divide that by the total number of users that have responded to the question to get the percentage of positive responses from users who answered the question. The percentage is rounded to a full number between 0 and 100.

Please note: This shouldn't be considered an average of all responses, as we only count one response per user (the most recent response). This gives each employee's response equal weight in the question score.

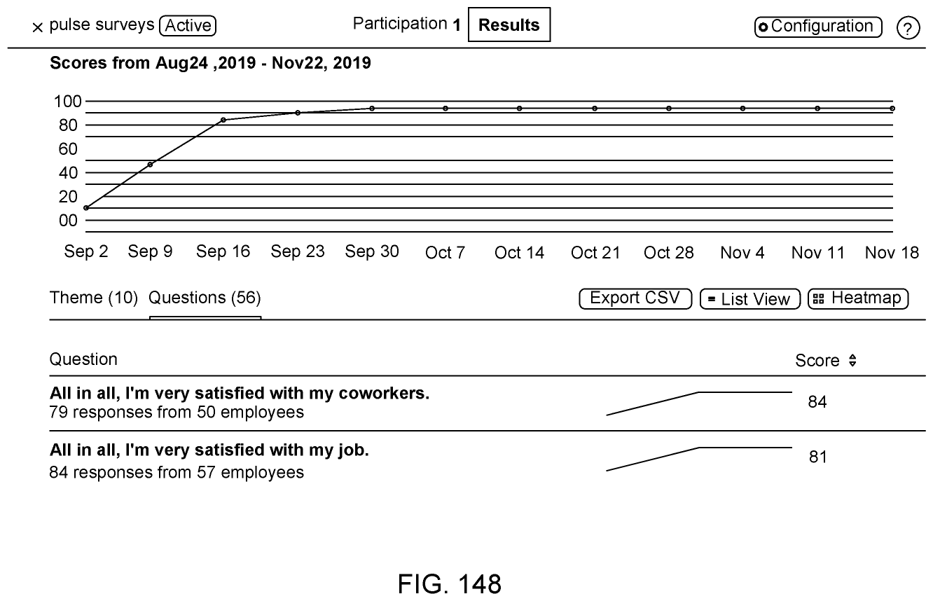

FIG. 148 is a screenshot of an example user interface for accessing theme scores over a specified time period.

### Response Trends

To the right of each question, you will find a trendline for the question's score. The color of each trend is categorized by the following score thresholds:
Red: 0-33
Yellow: 34-66
Green: 67-100

### Time Zones

When you get pulsed is based on your local time zone. If you do not have your local time zone configured the pulse will be sent according to your org's time zone.

### Best Practices

You will want to have a more frequent cadence (weekly, bi-weekly, monthly) for a “healthy and active” pulse survey.
The longer you run your pulse, the richer and deeper your data will be.

### After Your Survey

When viewing your pulse results, the eNPS reporting will appear at the top of the pulse surveys page to the right of Results.

Promoters are response scores 9-10.

Passives are response scores 7-8.

Detractors are response scores 0-6.

To calculate eNPS, we take the percentage of your employees who are Promoters and subtract the percentage of employees who are Detractors.

Your result is measured on a scale from −100 to 100.

After pulse surveys are turned on, they are meant to stay on to give you a constant monitor of employee happiness, like a heart monitor.

### Response Breakdown

The response breakdown can be found under “Distribution” next to the question score and under “Responses” next to comments. The response breakdown includes every response from your users. This differs from the question score because the question score takes just the most recent response from a user into account.

Once again, if a user's response is either “Agree” or “Strongly Agree,” their response is considered a positive response. If the user answered the question twice, once with a positive response and once with a negative or neutral response, both responses would be included in the response breakdown.

As an admin, you may want to view your pulse data grouped or filtered by different user attributes to discover insights about your people and organization. See the “Filtering through custom attributes” section below.

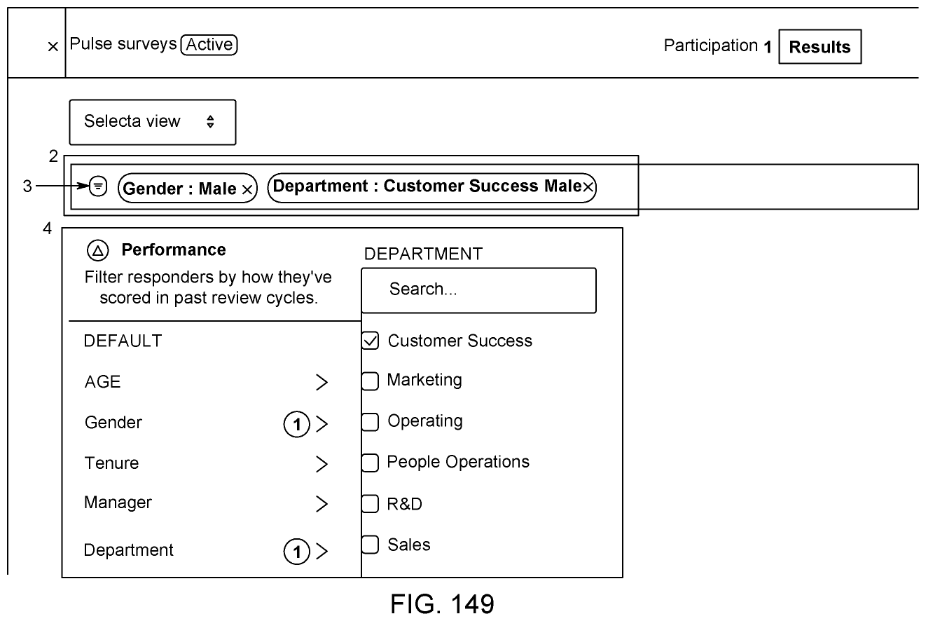

FIG. 149 is a screenshot of an example user interface for selecting one or more filter options and/or selecting one or more custom attributes.

### Filtering Pulse Survey Custom Attributes

On the Results page, you can filter your results by any user attribute that you have uploaded to Lattice before the survey was launched. This includes default fields (gender, age, department, etc.) as well as custom fields (that you have customized and uploaded into Lattice), and various performance metrics.

To filter through user attributes, follow the steps below:
Step 1: Navigate to the pulse Surveys Analytics, select the “Results” tab
Step 2: Locate the filter bar at the top of the page
Step 3: Click on the filter icon
Step 4: Select and apply the desired custom attributes

You can stack filters for different fields on top of each other to get to the exact cut of data that you want. For example, stacking Gender=>Male and Department=>Customer Success will show responses from all the men in the customer success department.

Within one field, selecting multiple options (like selecting both Engineering and Design from the Department field) will show people who are in Engineering OR Design.

### Filtering Through Performance Metrics

Similar to filtering by custom attributes, you can drill down into multiple different directions to unlock insights of how employee performance connects to employee engagement. By filtering through rating questions and scored attributes from a specific review cycle, you answer questions such as:
Do employees who rate their managers highly actually more engaged?
Are employees who are rated highly by peers more engaged or not?
Does a performance gap between the manager and reviewee (manager rated the employee lower than what the reviewee thought they were) have an impact on engagement?

To start uncovering these data insights, follow the steps below:
Step 1: Navigate to the pulse Surveys Analytics, select the “Results” tab
Step 2: Locate the filter bar at the top of the page
Step 3: Click on the filter icon
Step 4: Select “Review Cycles” and apply the desired performance metrics

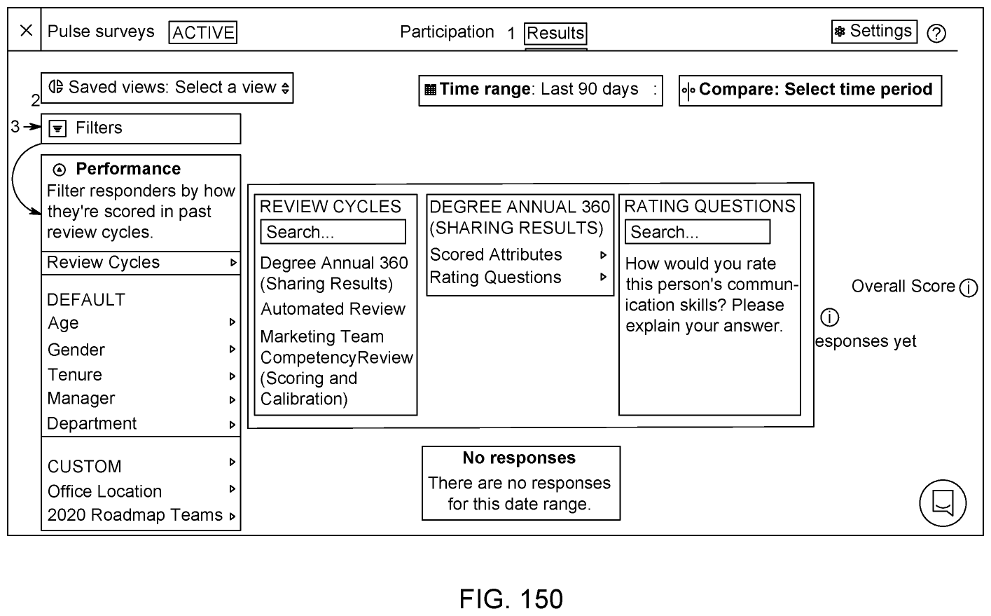

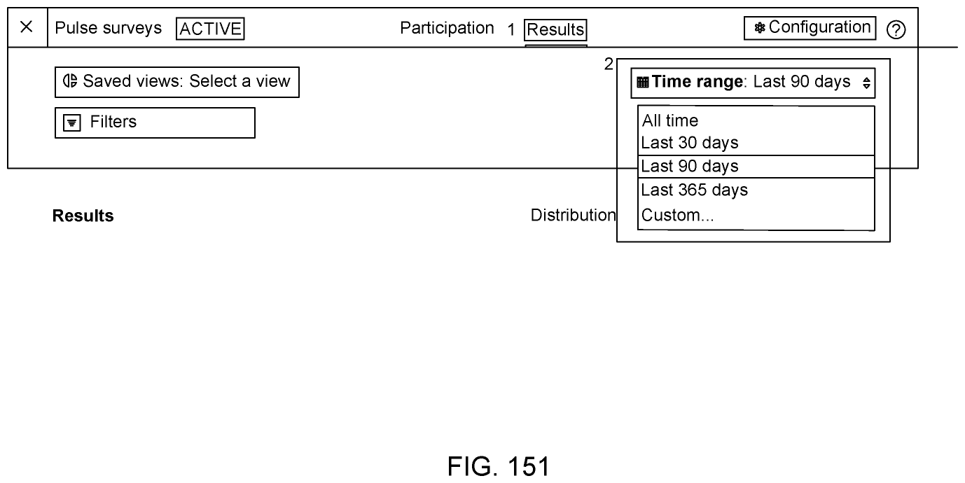

FIG. 150 is a screenshot of an example user interface for uncovering one or more data insights in search results.

### Filtering Through Time Ranges

Similar to the custom attributes filters, you can look at your results by filtering through a specific time range. You can select any of the preset time filters (30 days, 60 days, 365 days) or do you custom time range.

To filter through time ranges, follow the steps below:
Step 1: Navigate to the pulse Surveys Analytics, select the “Results” tab
Step 2: Locate and click on the Time Range bar
Step 3: Select and apply the desired time range

For a custom time range, select the start date and end date from the calendar. Ensure to hit the “Apply” button.

FIG. 151 is a screenshot of an example user interface for accessing a time range bar.

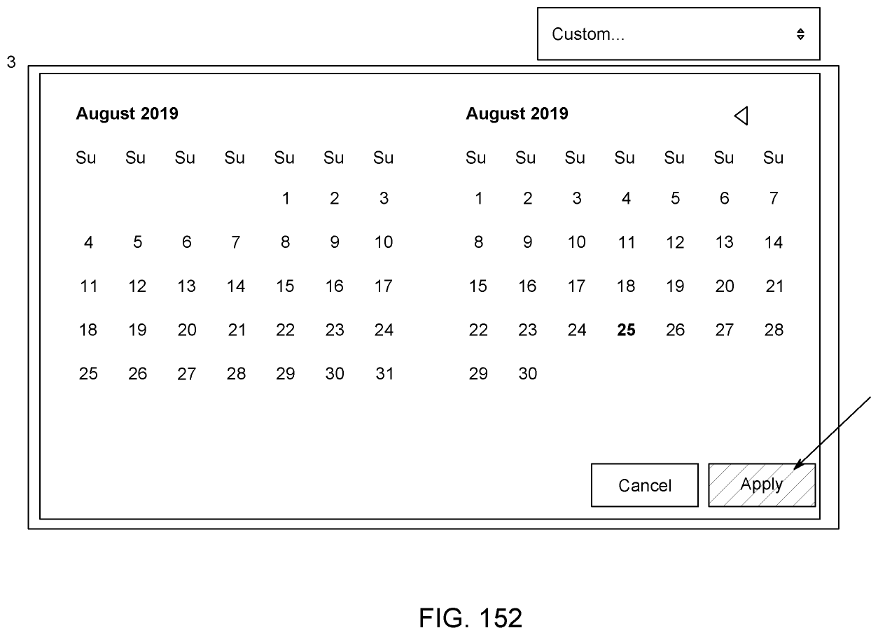

FIG. 152 is a screenshot of an example user interface for selecting and/or applying a desired time range.

### Using Time as a Filter

When it comes to using time as a filter, you can also compare leverage time to compare pulse Results from a specific time range to the previous time range. You can select any of the preset or custom time filters and then compare it to the previous time.

To compare to previous time period, follow the steps below:
Step 1: Navigate to the pulse Surveys Analytics, select the “Results” tab
Step 2: Locate and set your Time Range bar
Step 3: Click on Compare and select “Previous time period”
   For a specific pulse survey, select the start date and end for that specific calendar.

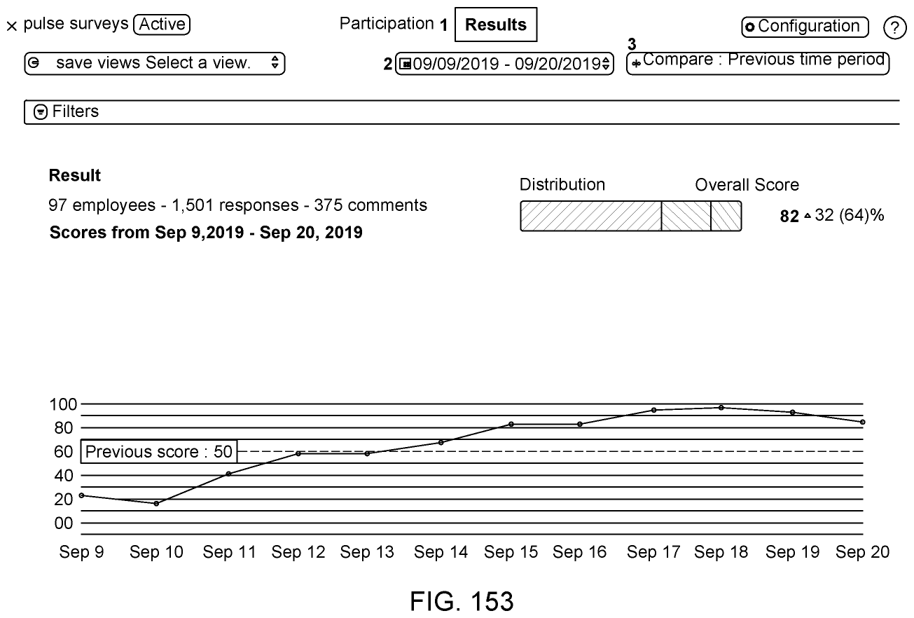

FIG. 153 is a screenshot of an example user interface for comparing pulse results for a specific time range to a previous time range.

### Exploring Your Results

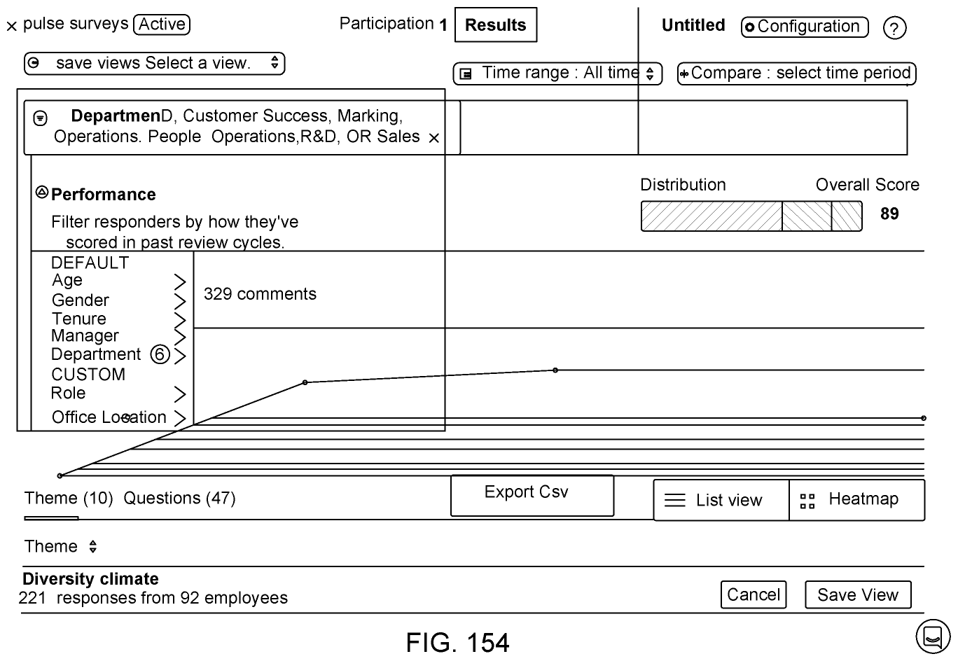

FIG. 154 is a screenshot of an example user interface for saving a view.

When setting your filters, you can stack custom attribute filters and time filters, to better explore your survey results. After you set your filters, you can examine your results by question or by theme, in either a list format or heatmap view. You are able to either share a specific filter view or export your survey results into a CSV.

Pulse survey admins can share survey results with others at the company. pulse Surveys results can either be shared in full or as a filtered set of data.

Once you share a saved view, the employee will have access to the saved view, until it is revoked. For example, if you were to share a view with the department head for the Marketing team, they would always have access to Marketing results until you remove them from that view.

If you are a survey admin, learn how to create a Saved View of your pulse survey results with anyone at your company by checking out Sharing pulse Survey Results.

Option 1: From your Home page
Step 1: On your Home page, click on View results from your profile card.
   Option 2: From your People page
Step 1: Click on the People page.
Step 2: Select your own profile page.
Step 3: Click View results next to pulse survey.

Saved Views can also be accessed from your initial email notification. Select View your report to be directly taken to your Saved View in Lattice.

### Sharing Pulse Survey Results

You can share the full pulse survey results with anyone. For example, you might want to send results to your executive team.

To do so, follow the steps below:
Step 1: Navigate to the Results tab of the survey.
Step 2: Choose the desired filter and select all (e.g., select departments and then select each department to share all data).
Step 3: Click on “Save this view”.

FIG. 154 is a screenshot of an example user interface for saving a view.
Step 4: In the saved views sidebar, name your view.
Step 5: List the users that you want to share this view with. You can share the survey results with multiple individuals at once.

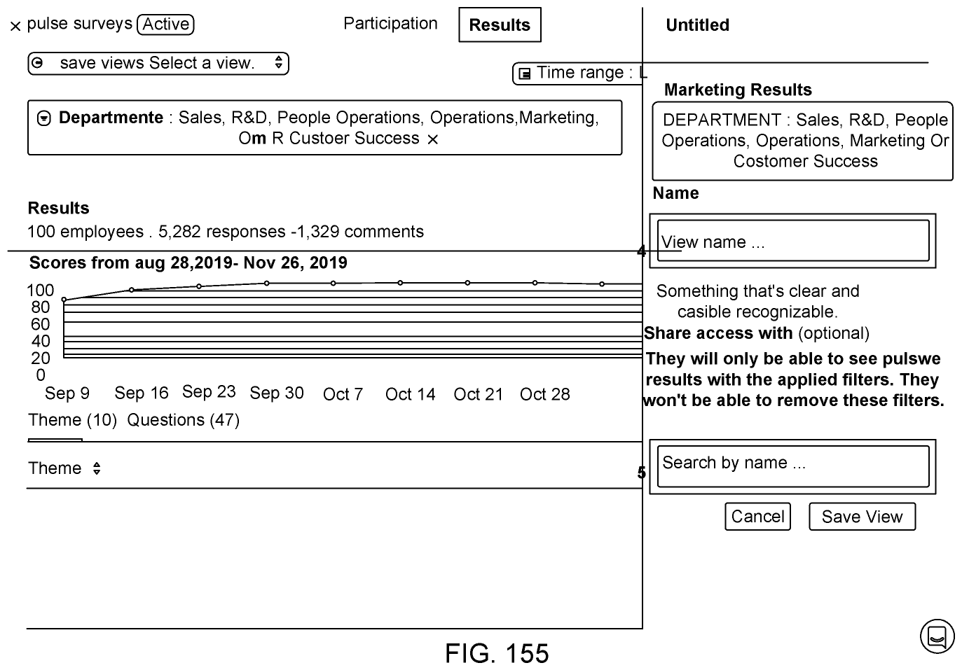

FIG. 155 is a screenshot of an example user interface for sharing a view with one or more groups of users and/or one or more individual users.

### Sharing Partial Results

You might only want to share a subset of the data with certain members of your organization; for example, a department head might need access to all results within their department or a manager might get access to everyone on their team.

To share partial results, please follow the steps outlined below:
Step 1: Filter appropriately (e.g., Department=Customer Success).
Step 2: Once the filter is set, click “Save this view”.
Step 3: In the saved views sidebar, name your view.
Step 4: List the users with whom you want to share this view.

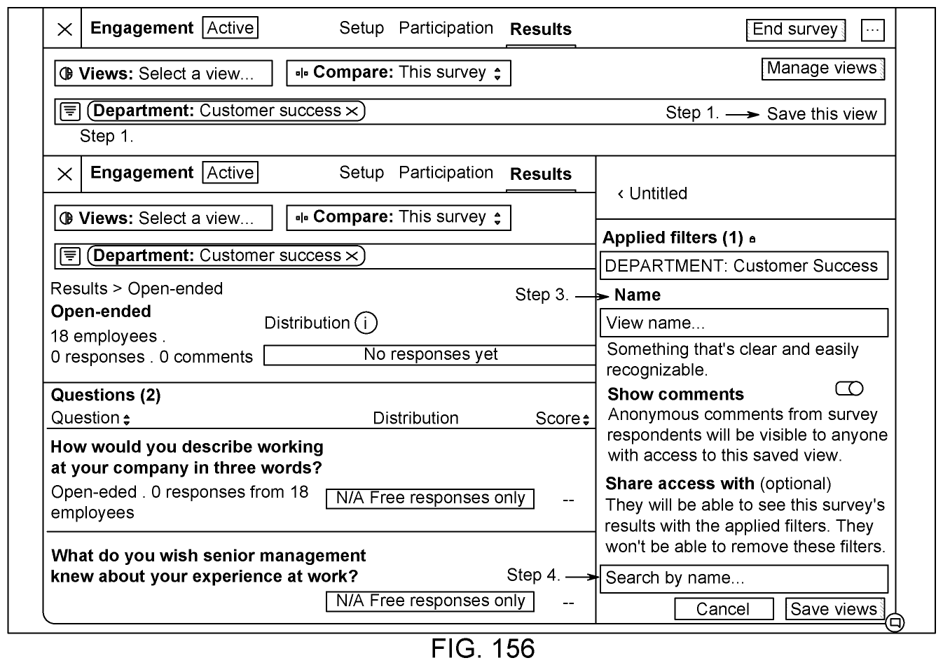

FIG. 156 is a screenshot of an example user interface for managing users with whom to share a view.

### Accessing Survey Results

Individuals who have access to shared views will get an email with a link to access the results tab or can also access the saved view from their You tab. The saved view will be locked with the specific filters you have selected, so only those filters will be available to the non-admin with whom you have shared the view. They will also have access to the list and heatmap views for their filtered group. This means that they cannot remove the preset filters for the saved view, but they are able to add additional filters when exploring the data. For example, if a department head has access to full department data, they can add additional filters such as filtering by manager or gender within that department.

### Managing Shared Surveys

If you were interested in deleting, additionally sharing, or revoking access to a saved review, you can manage those settings directly in your results panel.

To manage a survey's saved views, navigate to your results panel, and click on the “Manage” icon to open up the sidebar.

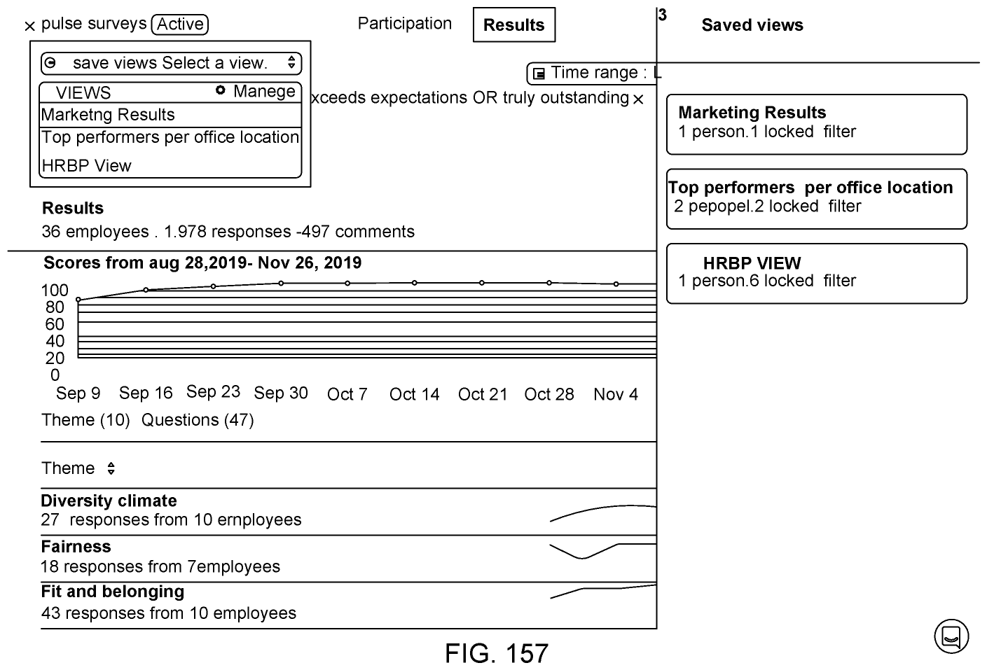

FIG. 157 is a screenshot of an example user interface for managing one or more saved views for a survey.

Here you can:
1. Delete the views
2. Share existing views with more people
3. Remove people's access to views

### Exporting a CSV

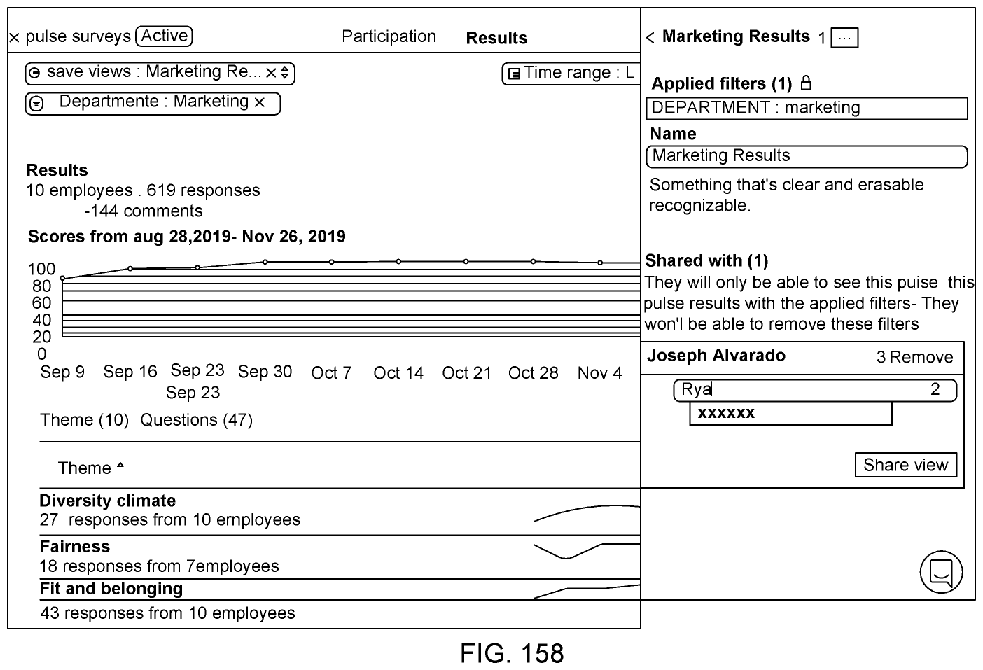

FIG. 158 is a screenshot of an example user interface for deleting a view, sharing a view, or removing access to a view.

As an admin, you can directly share save views of your pulse survey results with other members of your team, or you can export survey results as a CSV or a heatmap. Once the anonymity threshold has been reached for your questions or themes, survey admins can view and export a CSV and/or heatmap at any time after the pulse survey is launched.

To export a CSV of your survey results, follow the steps below:
Step 1: Navigate to the “admin” panel in the top navigation bar.
Step 2: Click on “pulse” under Engagement in the left panel
Step 3: Select the “Results” tab.
Step 4: Toggle and select to view your data by theme or by questions.

Ensure the “List” view is selected. Then choose how you want to group your data (gender, department, etc.), what filters you want to be applied, and whether you want to see absolute scores or deltas.
Step 5: Click “Export CSV.”

### Exporting a Heatmap

To export a heatmap, follow the steps below:
Step 1: Navigate to the “Admin” Panel in the top navigation bar.
Step 2: Click on “pulse” under Engagement in the left panel.
Step 3: Select Survey and click on either its name or “View results.”
Step 4: Toggle and select to view your data by theme or by questions.

Ensure the “Heatmap” view is selected. Then choose how you want to group your data (gender, department, or other custom attributes), what filters you want to be applied, and whether you want to see absolute scores or deltas. For example, we can look at how top performers are doing per office location.
Step 5: Click “Export Heatmap.”

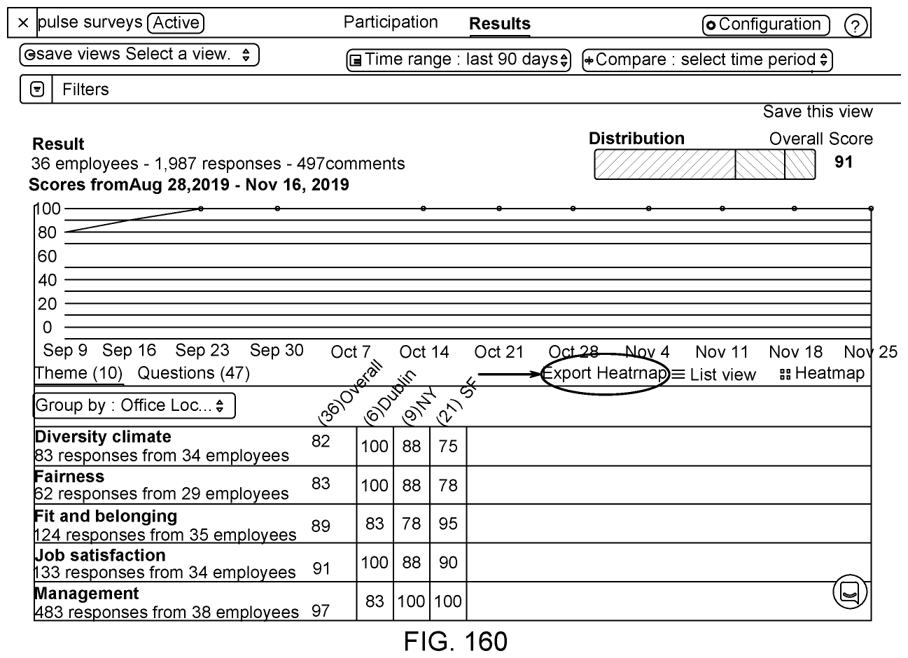

FIG. 160 is a screenshot of an example user interface for generating a heatmap export.

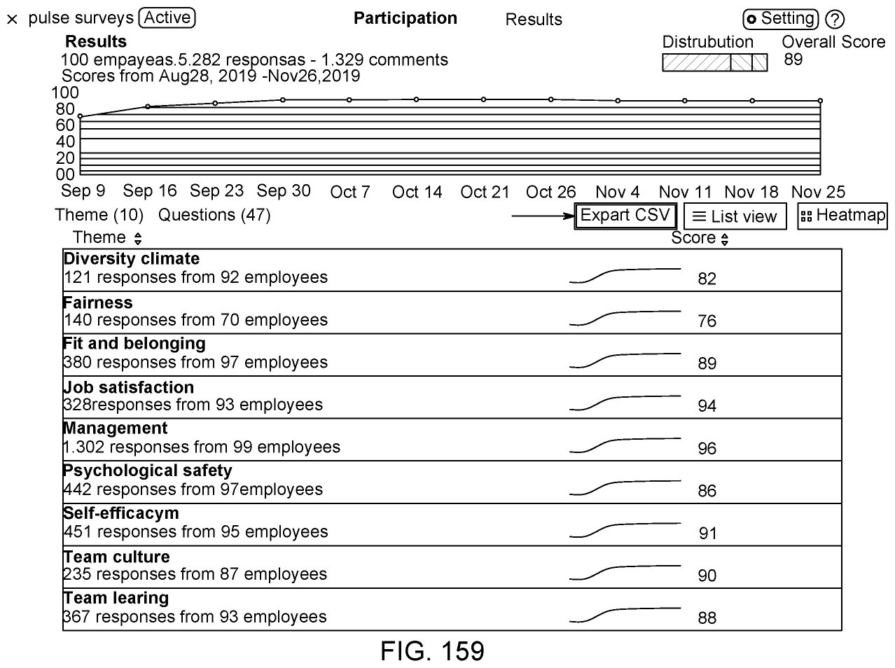

FIG. 159 is a screenshot of an example user interface for exporting a view for access by an external tool (e.g., to a file, such a CSV file, for access by a spreadsheet program).

This heatmap export will be an Excel file that looks the same as the heatmap in Lattice.

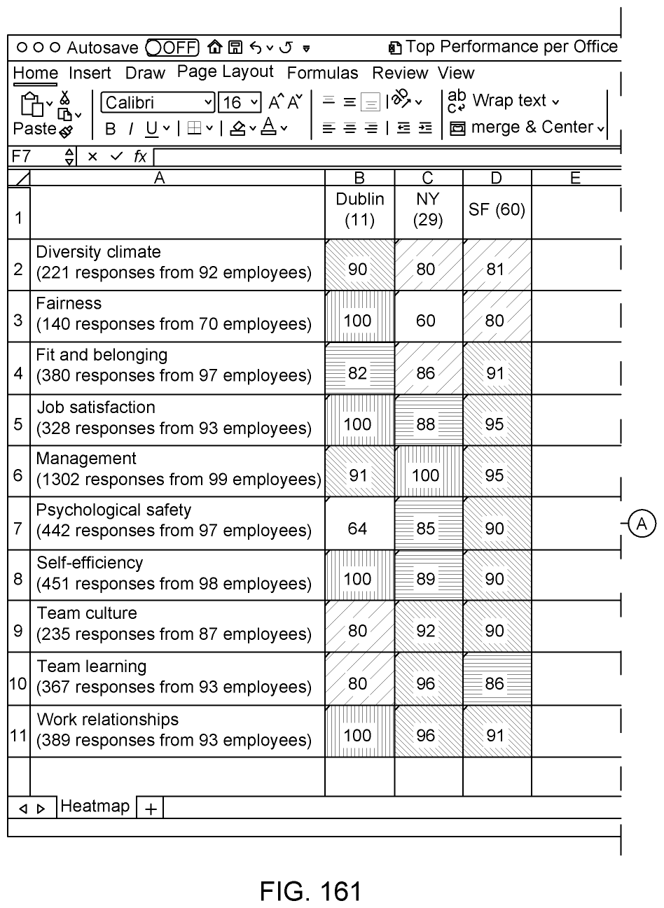

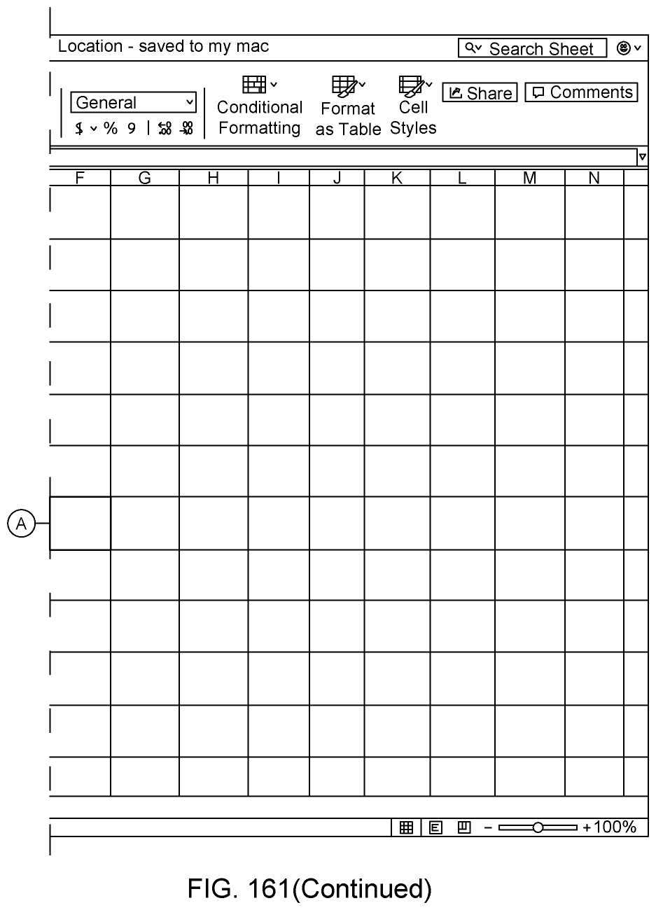

FIG. 161 is a screenshot of an example user interface for accessing a heatmap export in an external tool, such as a spreadsheet program (e.g., Excel).

You can export heatmaps for both themes and questions by toggling on the lefthand side and then clicking on “Export heatmap” on the right.

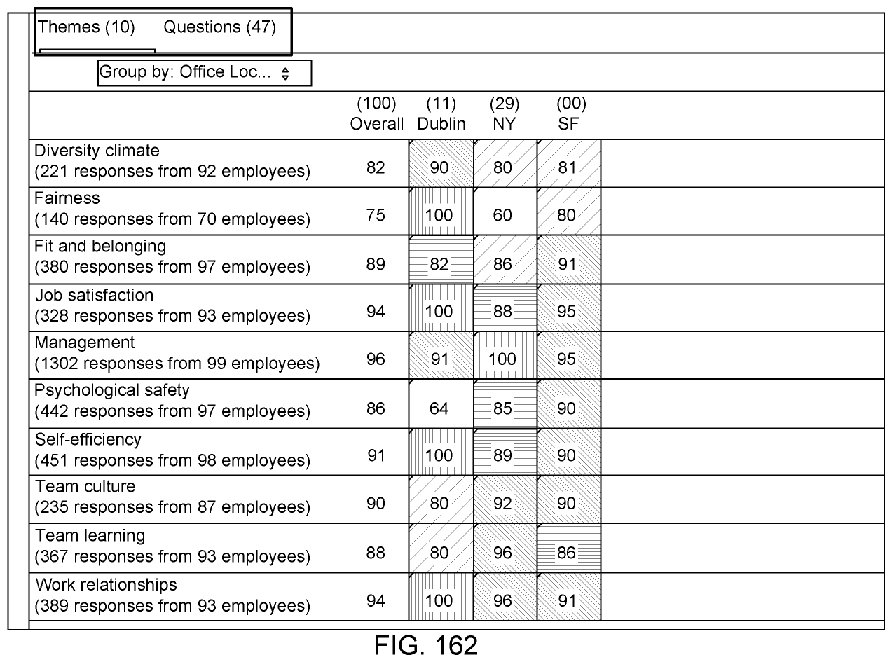

FIG. 162 is a screenshot of an example user interface for exporting heatmaps for themes and/or questions.

### The Different States of a Pulse Question

Active—Question is currently being sent to employees
Paused—Question is not being sent to employees, but the data remains
Removed—Question is not being asked to employees, and no data is available to view.

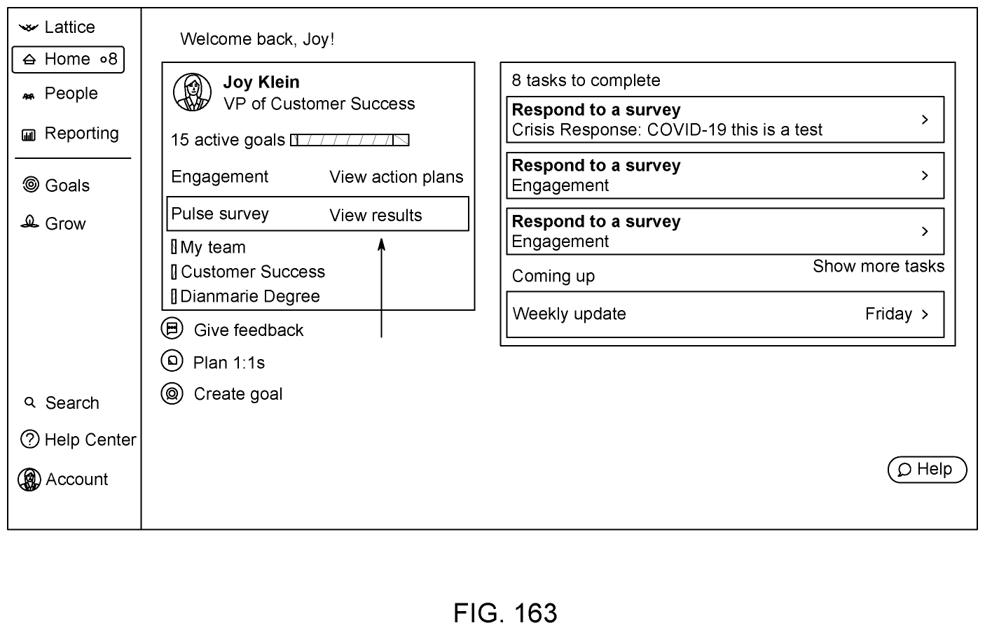

FIG. 163 is a screenshot of an example user interface for sharing survey results from a user profile page (e.g., a user having admin role with respect to the survey).

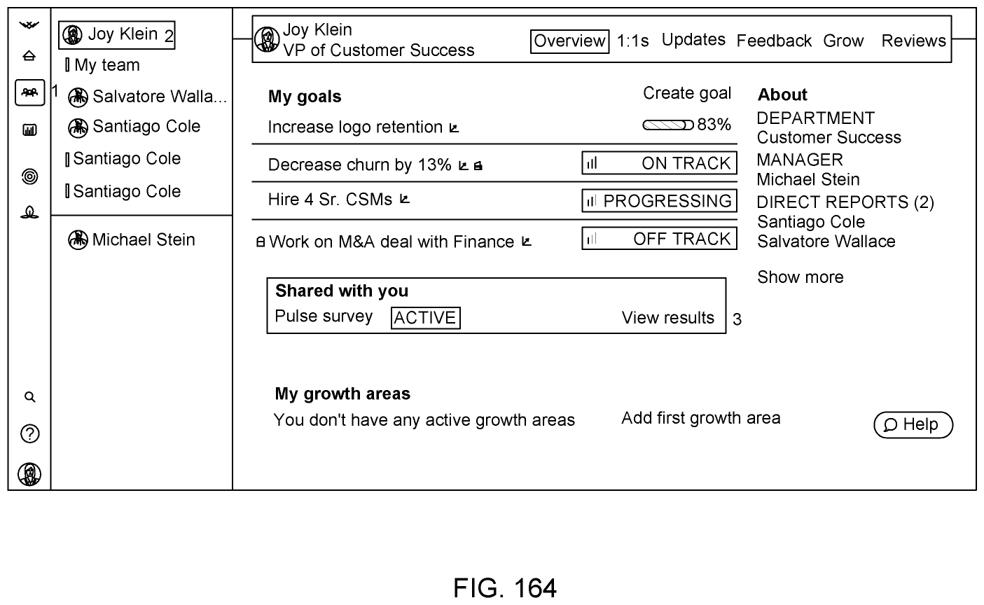

FIG. 164 is a screenshot of an example user interface for sharing survey results from a people page.

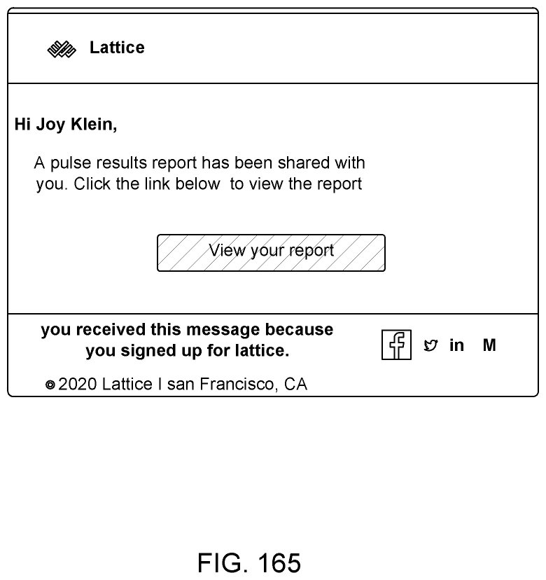

FIG. 165 is a screenshot of an example user interface for presenting a notification that a report has been shared with a user.

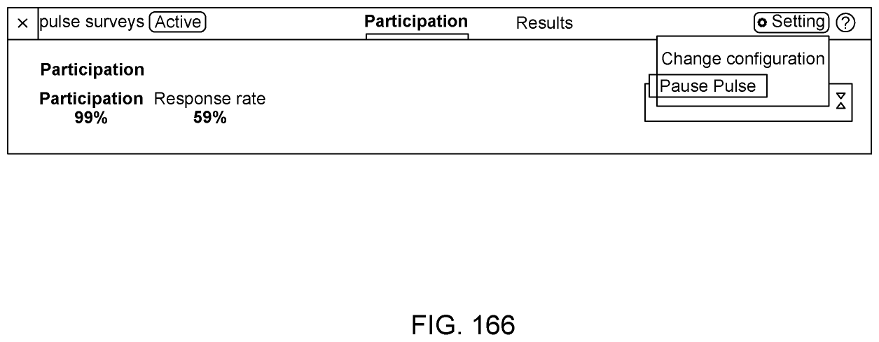

FIG. 166 is a screenshot of an example user interface for pausing a pulse survey.

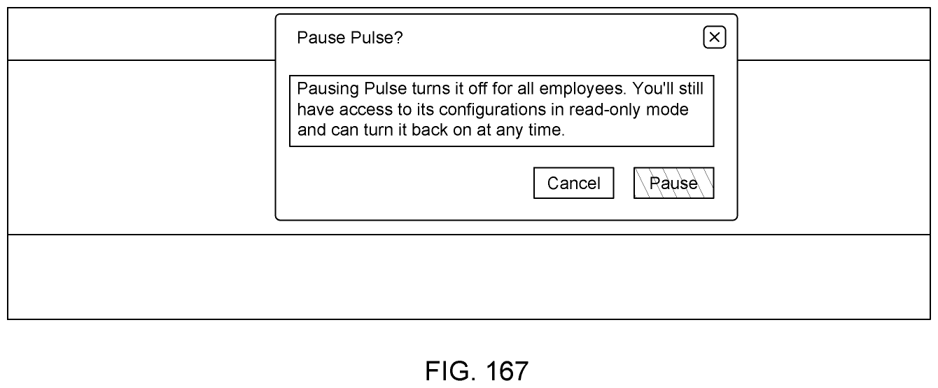

FIG. 167 is a screenshot of an example user interface for confirming that a pulse survey is to be paused.

Why pause or remove pulse survey questions?

### Pausing Pulse Questions

You are no longer interested in gathering data on a question, but you still want to access the data. Admins can always view data on questions no longer actively being asked in pulse Surveys by pausing particular questions.

### Removing Pulse Questions

You are no longer interested in gathering or reviewing data on a pulse question.

### How to Remove or Pause Pulse Survey Questions

Step 1: Select “Change configuration” in your pulse survey settings.

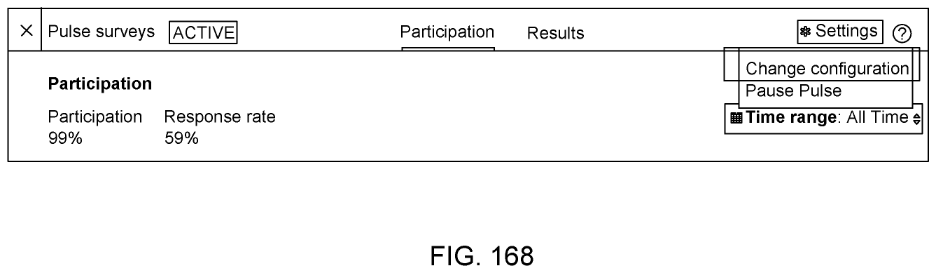

FIG. 168 is a screenshot of an example user interface for changing configuration settings for a pulse survey.

Step 2: Select the ellipsis to the right of the question and select either “Pause” or “Remove.”

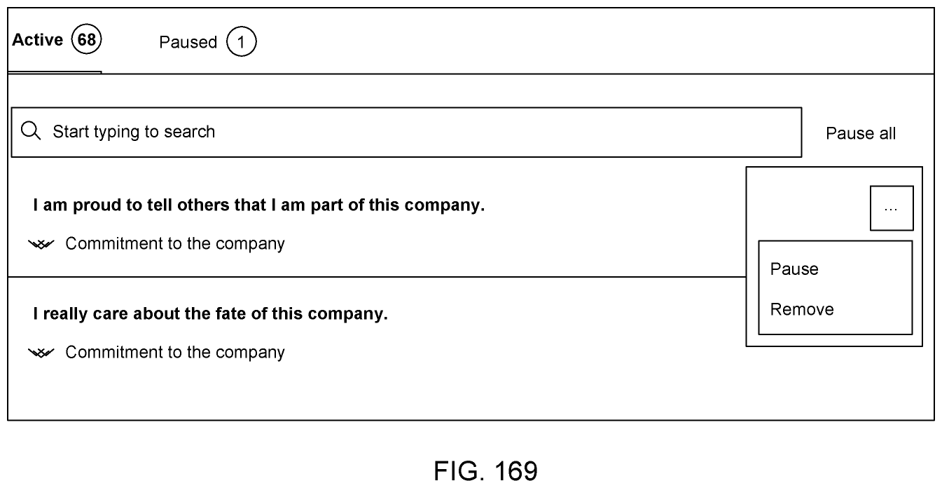

FIG. 169 is a screenshot of an example user interface for pausing or removing a question from a pulse survey.

Step 3: Select “Continue to cadence” to save your paused or removed questions before exiting.

Keep in mind, if you remove a question and then re-add it to a pulse survey, any previous data will return in the results section of pulse.

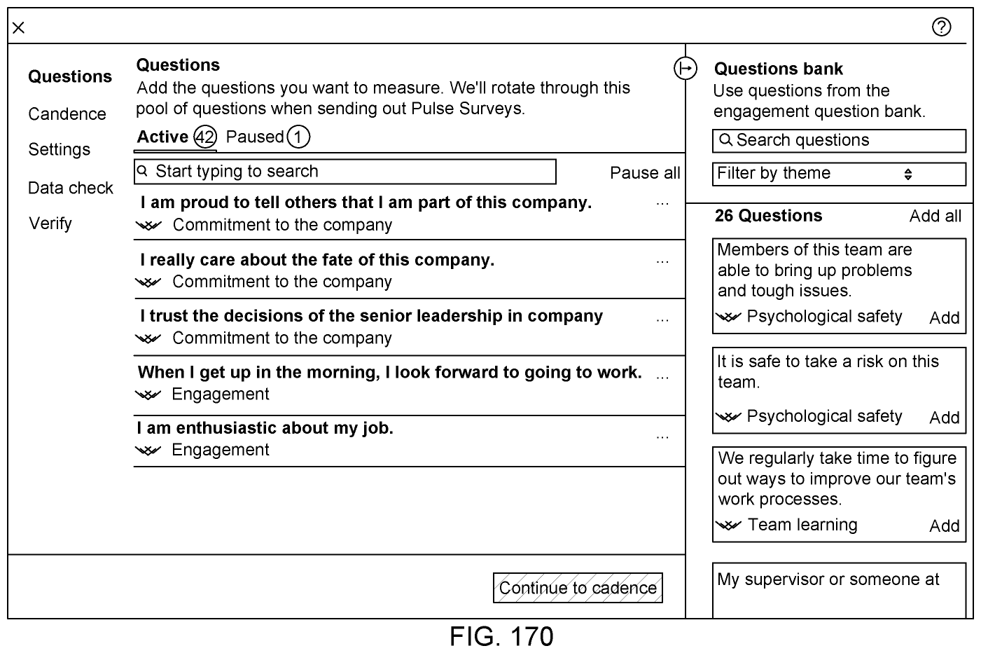

FIG. 170 is a screenshot of an example user interface for saving changes to questions for a pulse survey.

When a question is paused, it will be gray out the Results page of your pulse survey.

Once you have navigated to the Notification Center, there are three options for how notifications can be sent when it comes to our pulse surveys tool-through Slack or Microsoft Teams, and/or email.

Pulse survey notifications are sent as follows:
When you launch pulse
When it's time to complete the next pulse survey

Anonymous comment notifications are sent as follows.
When an admin replies to your anonymous comment
When an anonymous comment is assigned to you (admin only)
A comment assigned to you is awaiting a reply (admin only)
Pulse weekly digest (admin only)

Note: only active users will receive pulse notifications. Invited users will not receive email or Slack notifications to participate in pulse.

To send these through Slack or email, you can check on the boxes to the right of “pulse,” as shown below. Make sure to press the blue “Save changes” button at the bottom of the page when you're finished.

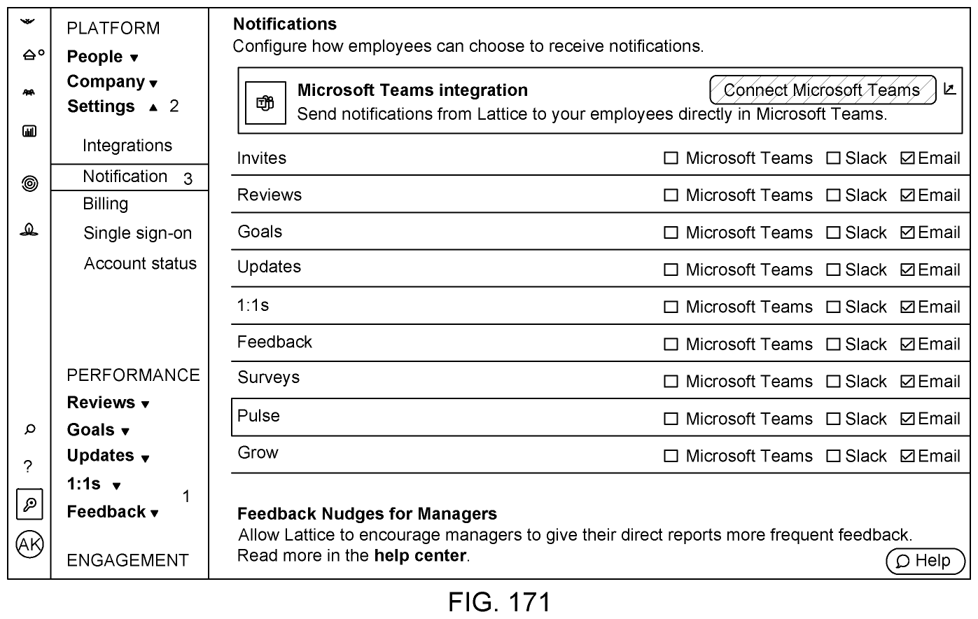

FIG. 171 is a screenshot of an example user interface for configuring notifications associated with pulse surveys.

Note: Slack notifications are sent via the Lattice app and appear as shown below.

Notifications users receive:
Launch of pulse survey
Reminder to complete next survey
   Anonymous comment notifications:
An admin has replied to your comment
An anonymous comment is assigned to you (admin only)

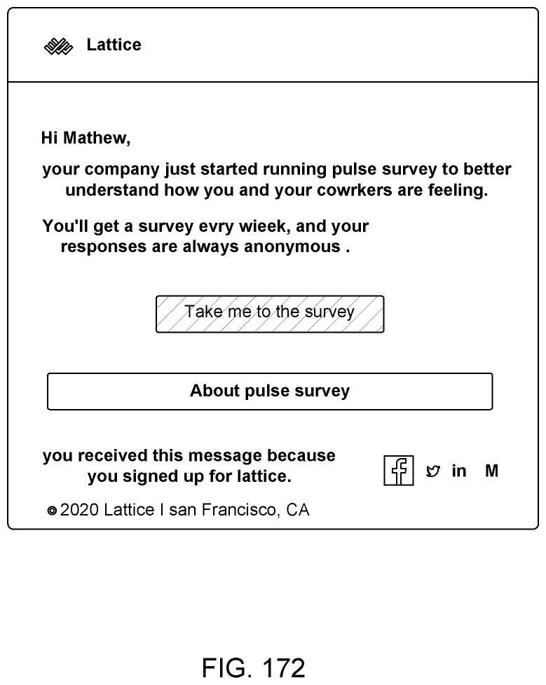

FIG. 172 is a screenshot of an example user interface for a notification for launching of a pulse survey

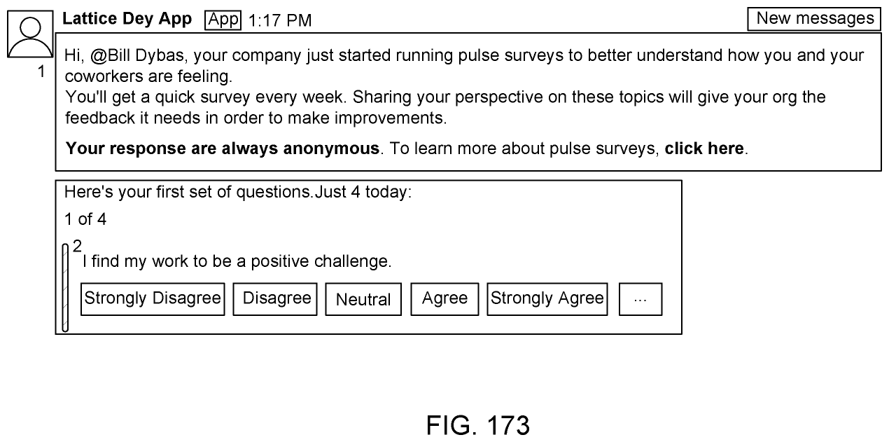

FIG. 173 is a screenshot of an additional example user interface for launching of a pulse survey.

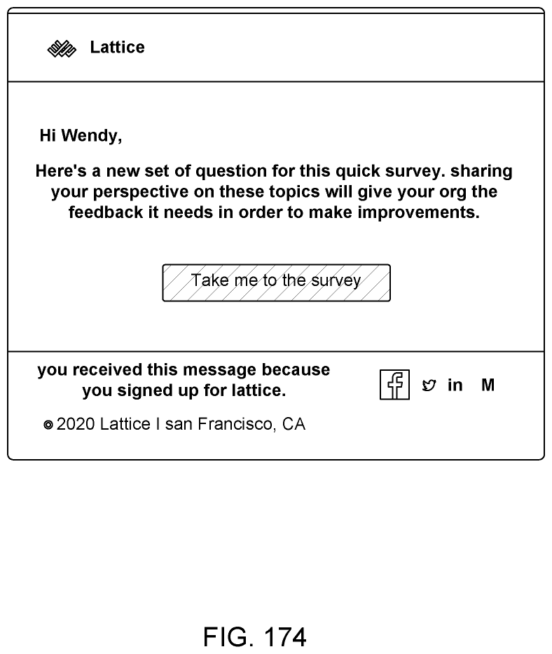

FIG. 174 is a screenshot of an example user interface for a presenting a reminder to complete a pulse survey.

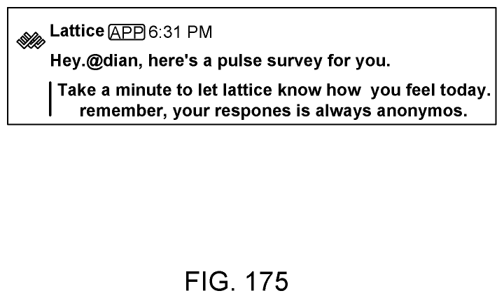

FIG. 175 is a screenshot of an additional example user interface for presenting a reminder to complete a pulse survey.

Pulse Weekly Digest

The pulse weekly digest will go out to all pulse admins at 9 am Fridays in your company's time zone. The digest will include:
New comments submitted for pulse
The number of comments awaiting reply (if anonymous comments are enabled)
Updated eNPS score (if eNPS is enabled)

A task is created within Lattice when it is time for you to complete a pulse survey. The task will be named “New pulse survey”.

It will let you know how many questions are in that pulse and when “Take survey” is selected it will take you directly into the pulse.

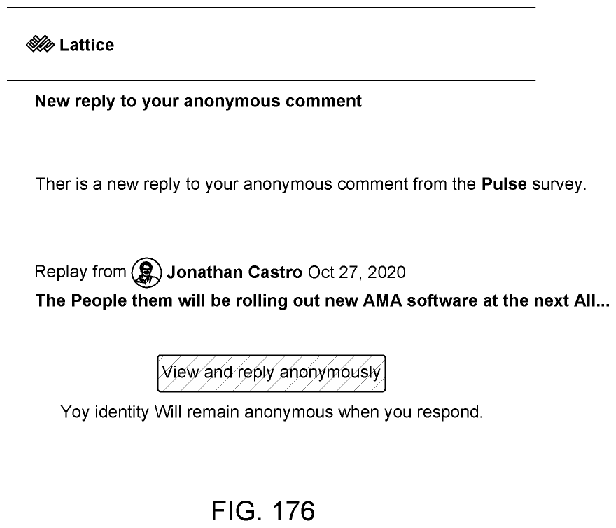

FIG. 176 is a screenshot of an example user interface for presenting a notification that an administrator has replied to a comment.

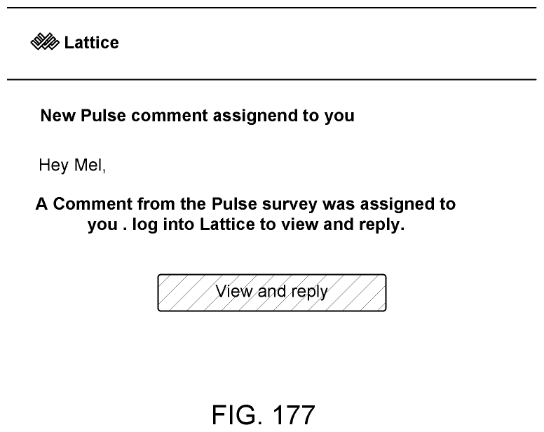

FIG. 177 is a screenshot of an example user interface for presenting a notification that an anonymous comment has been assigned to a user for handling.

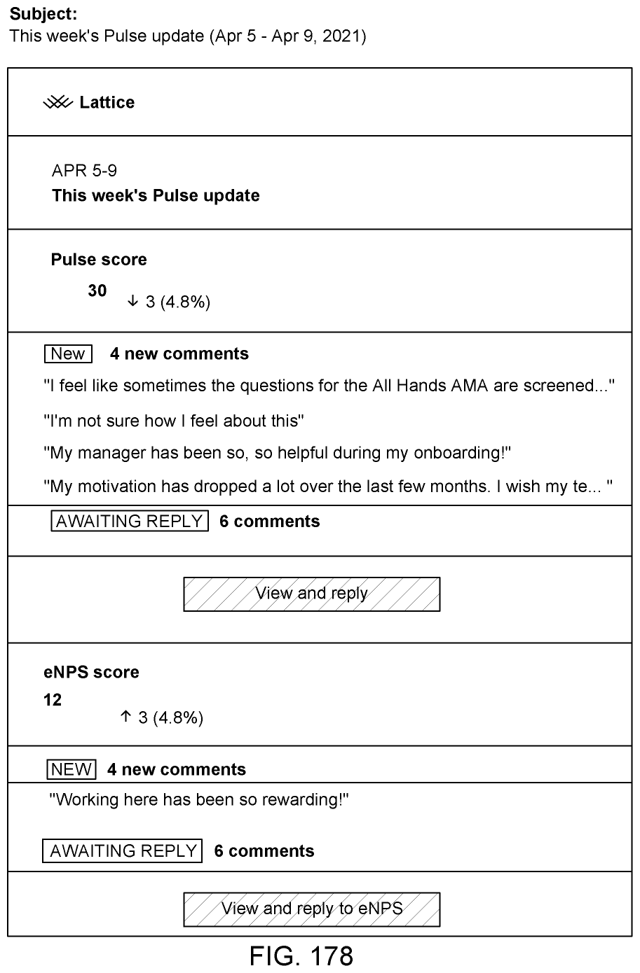

FIG. 178 is a screenshot of an example user interface for presenting a pulse update.

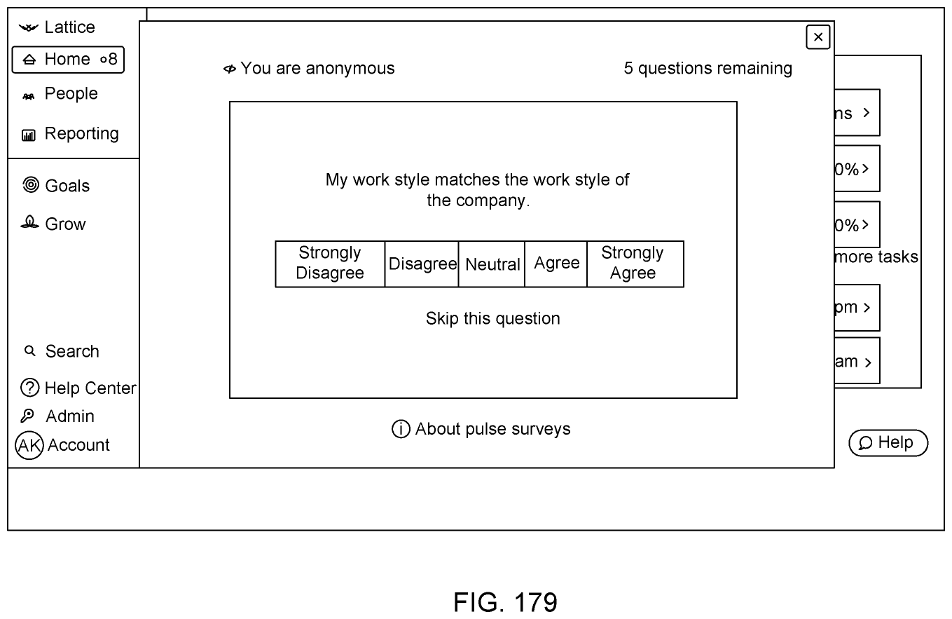

FIG. 179 is a screenshot of an example user interface for starting a pulse survey.

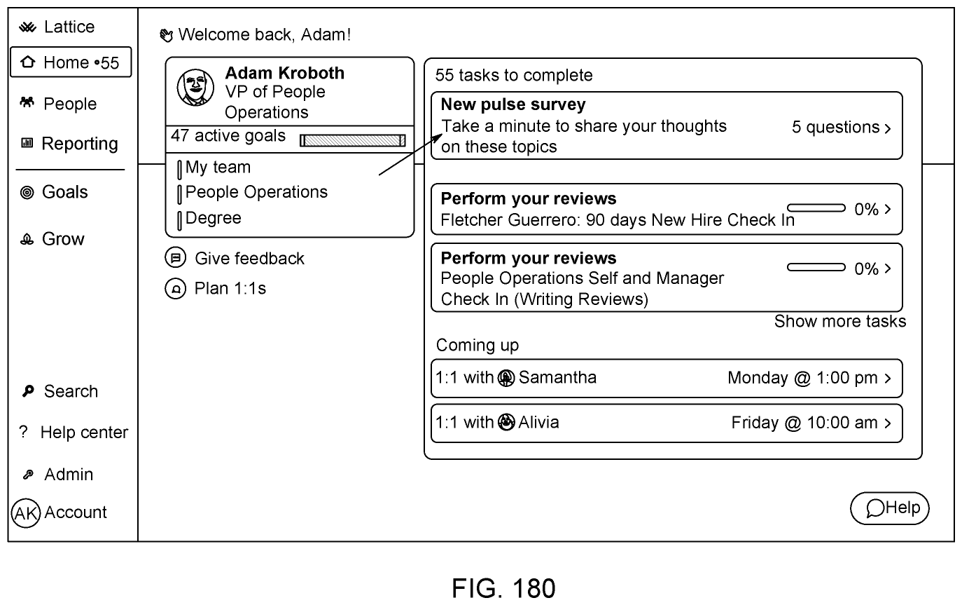

FIG. 180 is a screenshot of an example user interface for accessing new pulse survey from a profile page of a user.

### Pulse Survey Frequently Asked Questions

Q: How do questions cycle through pulse?

A: If your question bank has more questions than the set questions cadence, the algorithm will randomly select the questions asked. After the first pulse, the algorithm will do its best job to ensure that the next pulse questions are not duplicated. If your question bank is the same number of questions being asked on the set cadence, then the same questions will be asked on every pulse. If you have eNPS turned on, this question is considered part of the count, so if you have 5 questions on your question bank and a cadence of 5 questions, the eNPS question will be counted as one of those 5 questions, thus only choosing 4 questions from your question bank.

Q: Why did my team member receive different questions in their pulse?

A: Each pulse will be composed of a different set of randomized questions for each employee. The reason behind this is that, as with a heart monitor, pulse is meant to ask questions randomly to give you a constant and truthful monitor of employee happiness and engagement.

Q: When is my team receiving a pulse?

A: Our algorithm looks at time zone, among other factors, to be able to pulse employees at different times throughout the working hours of a day. Every 15 minutes, the algorithm will consider the number of employees and the set time cadence to decide when and which employees to pulse. If you have 100 employees and the cadence is set to monthly, then all employees will receive a pulse sometime throughout the month, but not all at the same time.

Q: What happens if someone's manager, department, or other employee data changes after I've launched a pulse survey?

A: Lattice captures demographic info (manager, department, etc.) a couple of times: first at the time of sending the pulse and again at the time of response. Please note, the second data check overrides the first. This means if an employee submits their response BEFORE their manager has changed, the results will reflect their old manager. If an employee submits their response AFTER their manager has changed, the results will reflect the new manager. The employee data will accurately reflect both the participation and results analytics.

When configuring your pulse survey, you have the option to have all your employees participate, or just a specific subset. This is done in the Participants section of pulse setup. If you have already launched your pulse, access your pulse setup by navigating to Settings and selecting Change configuration.

eNPS Explorations

The following figures show various user interface screens and flows for setting up and using eNPS via the administrative user interface.

In example embodiments, various user interface flows may depend on whether engagement surveys, pulse surveys, or both have been enabled.

As an admin with engagement surveys on, you can visit the engagement tab within the user interface to view your surveys. There, you will be notified of an option to add the eNPS metric to the engagement surveys and provided with a user interface element to turn on the eNPS feature. You can also start an engagement survey from scratch, where your question list is empty and you can see the eNPS question in the Question Bank panel, or you can have your question list populated automatically and, if eNPS is enabled, have the eNPS question added automatically (e.g., with the Question Bank panel collapsed). To complete setup, you can see the eNPS question in the engagement form and will be prompted to add an optional comment. Last, you can view the engagement survey results page, which includes a separate block for eNPS results.

As an admin with pulse surveys on, you can go through the pulse setup flow. You can start with engagement, eNPS only, or from scratch. When starting from scratch, your question list is empty and you have an option to turn on eNPS. Additionally, the Question Bank panel is open. On the cadence step, you can choose your frequency and question limit.

When starting with engagement, your question list is populated automatically, the eNPS question is turned on, and the Question Bank panel is collapsed. On the cadence step, you can choose your frequency and question limit for the survey. When eNPS is turned on, the eNPS frequency option is placed under the frequency setting as an exception. On the verify step, you can see the eNPS settings. In your pulse survey, employees get the eNPS question first. Additionally, a comment form is displayed to employees to optionally provide context for their response to the eNPS question. The employee takes the rest of the engagement questions in the pulse survey (e.g., within the question limit). You can view the engagement scores over time and show/hide distribution over time. You can see your eNPS score over time and filter comments by response type. You can show/hide the distribution over time.

When starting with eNPS only, your question list is empty, but there may be an option to add other questions. The eNPS question is turned on and the Question Bank panel is collapsed. On the cadence step, you can choose your eNPS frequency. There is no question limit setting because eNPS is the only question.

As an admin with both engagement survey and pulse surveys on, you can visit the engagement tab to view your surveys. Lattice tells you that you can add eNPS to your engagement surveys or your pulse survey. If you enable eNPS for your pulse survey, you go through a pulse configuration flow. You visit the Question page with eNPS turned on. You can select the eNPS frequency on the cadence step. You can view engagement scores over time and show/hide the distribution over time.

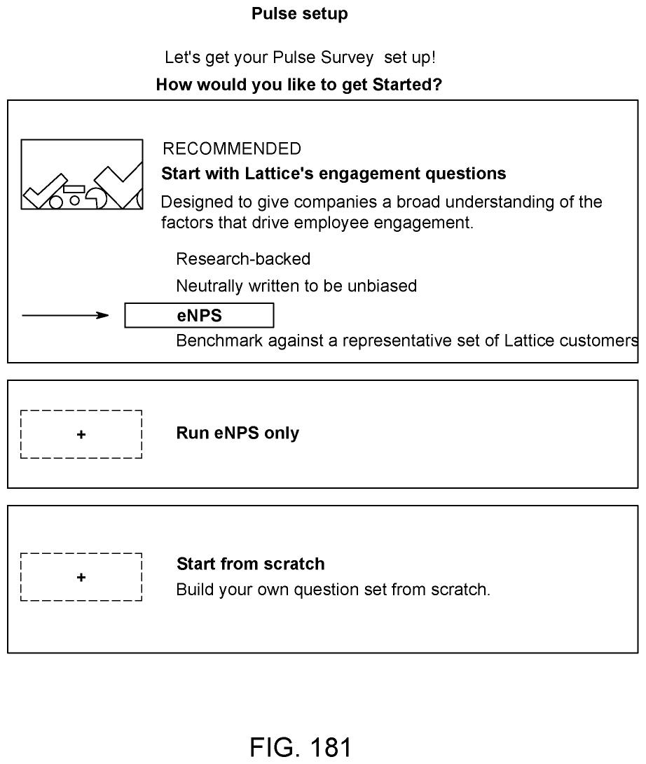

FIG. 181 is a screenshot of an example user interface for selecting to create a survey that incorporates an eNPS question.

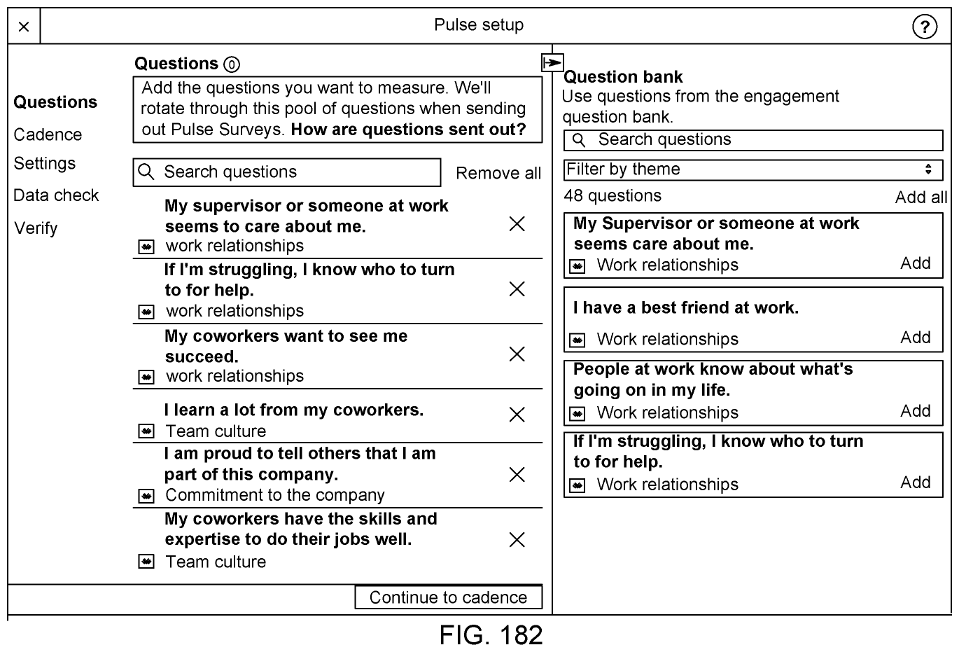

FIG. 182 is a screenshot of an example user interface for selecting questions for a survey (e.g., from a question bank).

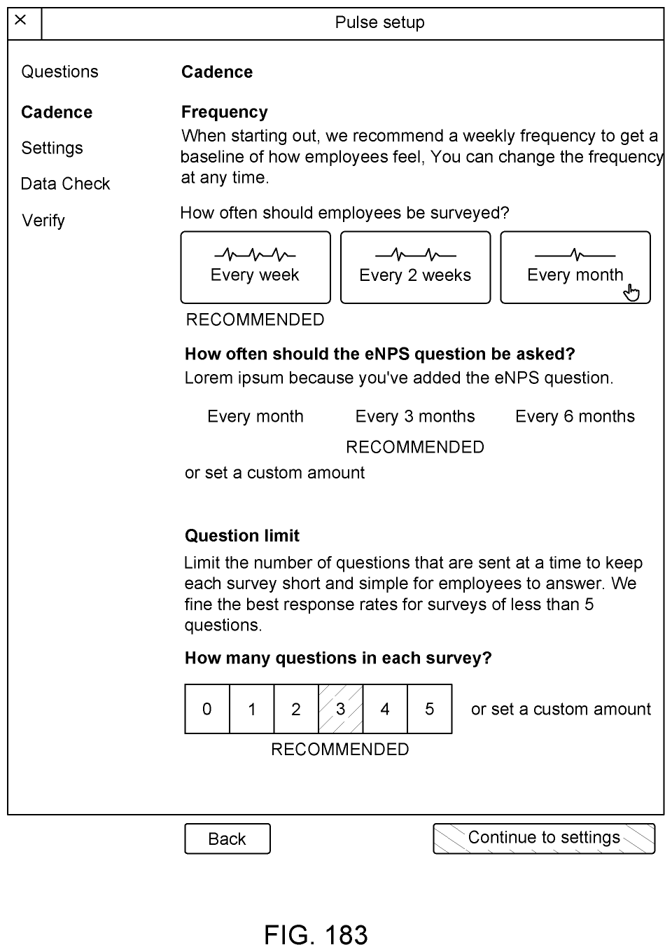

FIG. 183 is a screenshot of an example user interface for selecting a cadence for a survey and/or for an eNPS question within the survey.

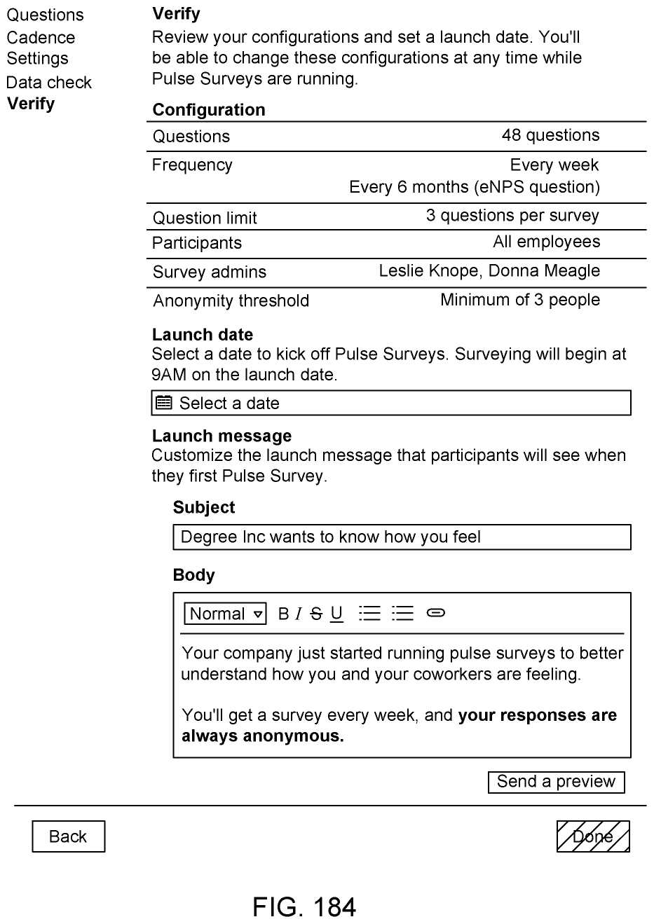

FIG. 184 is a screenshot of an example user interface for verifying a pulse survey configuration.

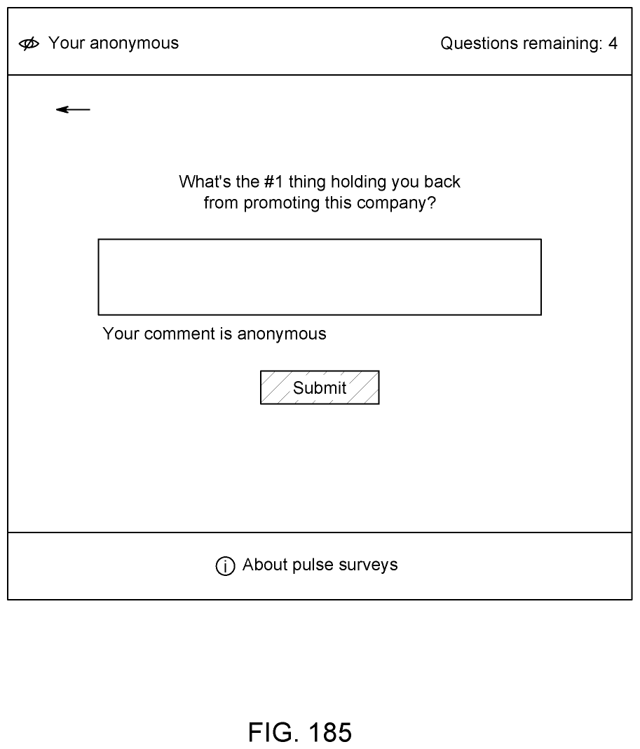

FIG. 185 is a screenshot of an example user interface for presenting an eNPS question within a pulse survey to a user.

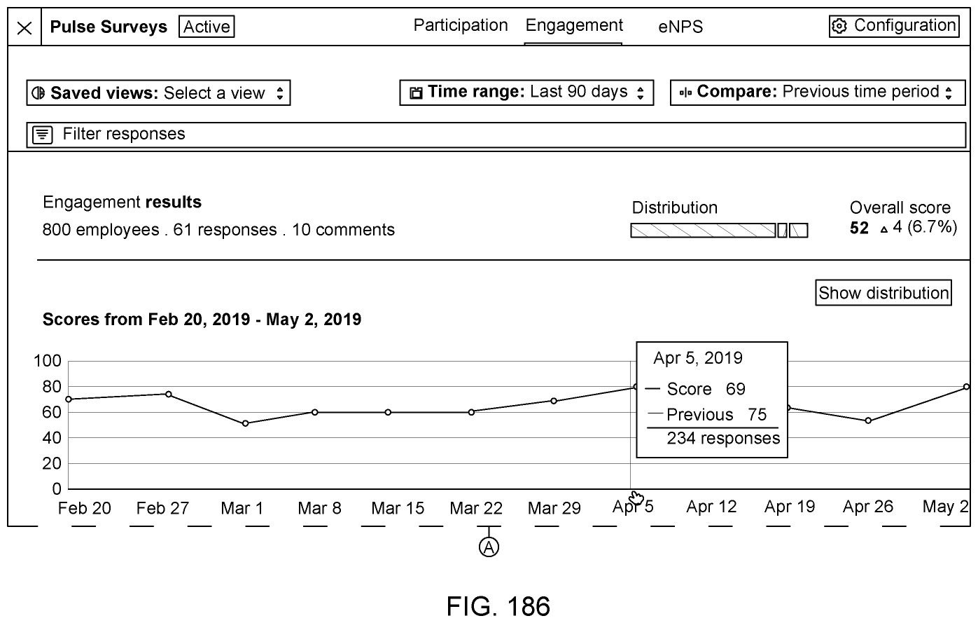

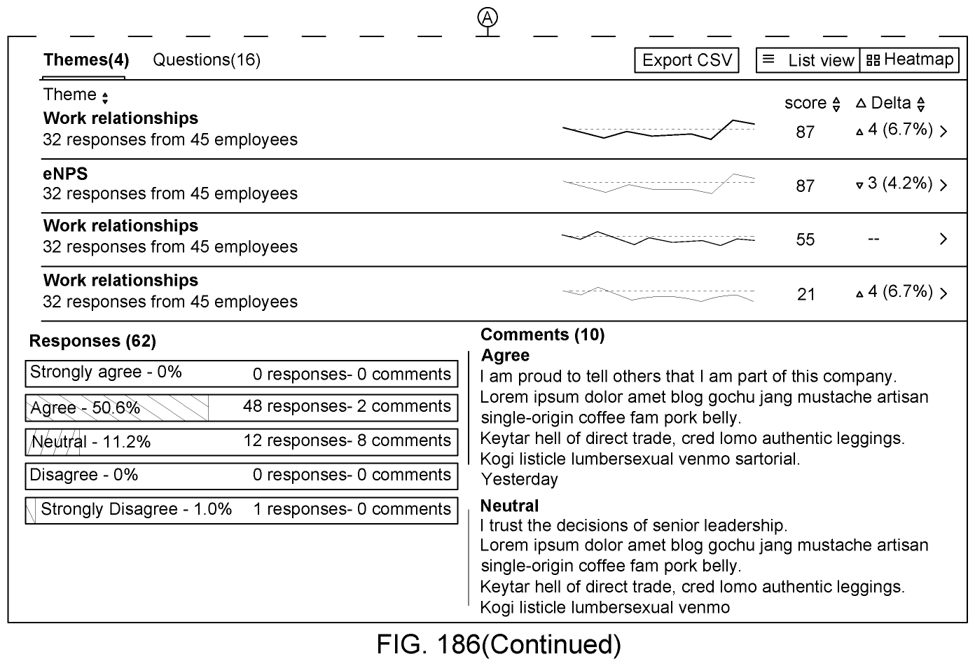

FIG. 186 is a screenshot of an example user interface for presenting results of an Engagement and/or pulse survey.

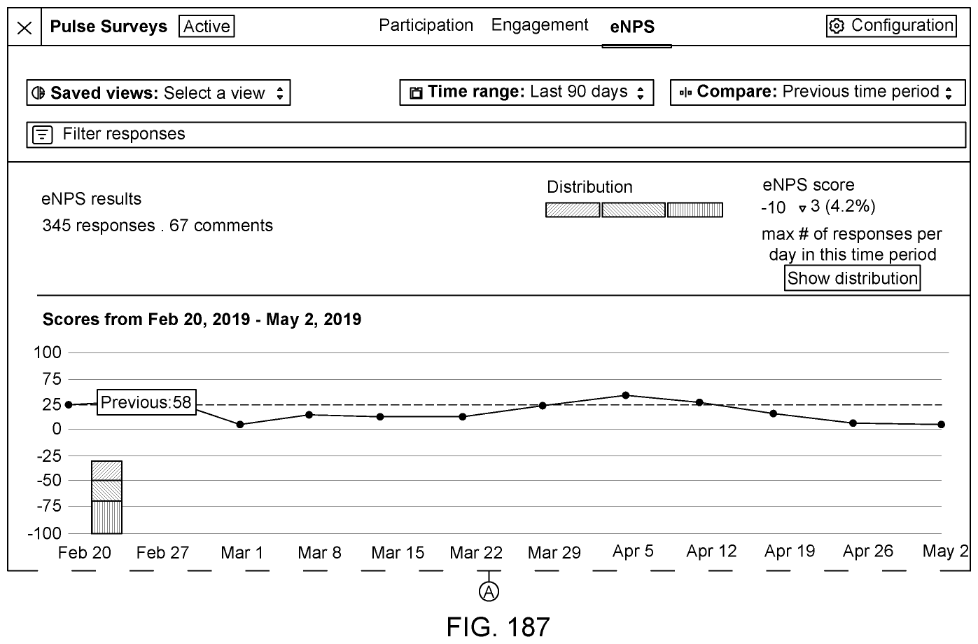

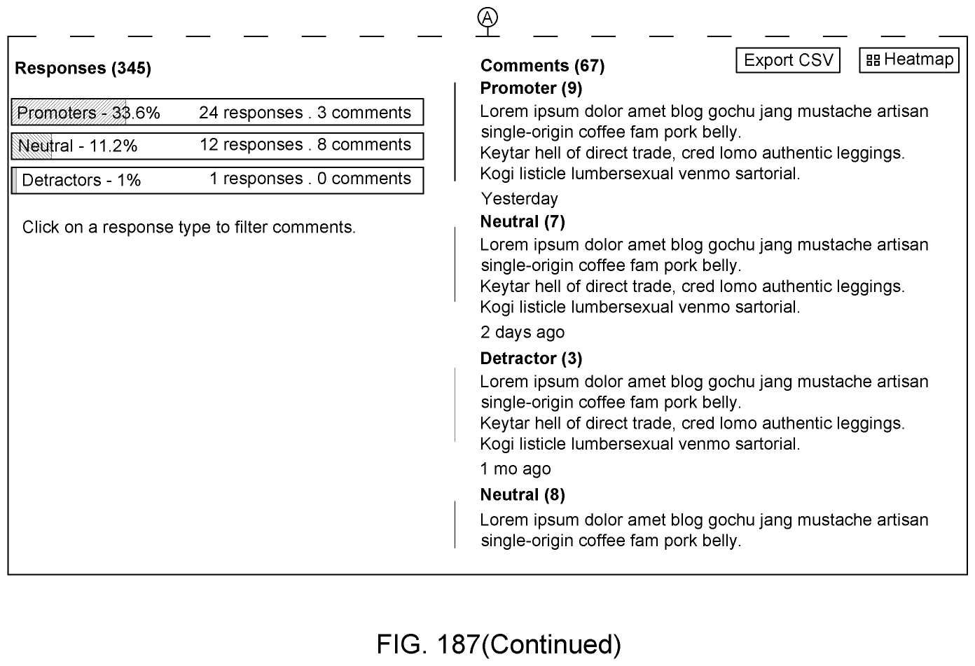

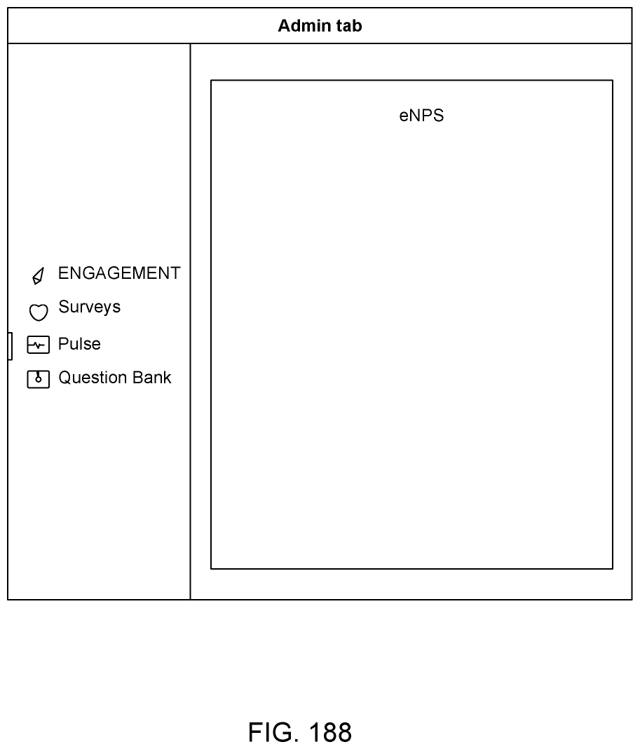

FIG. 187 is a screenshot of an example user interface for presenting eNPS results corresponding to a survey.

FIG. 188 is a screenshot of an example user interface for an administration tab for a pulse survey.

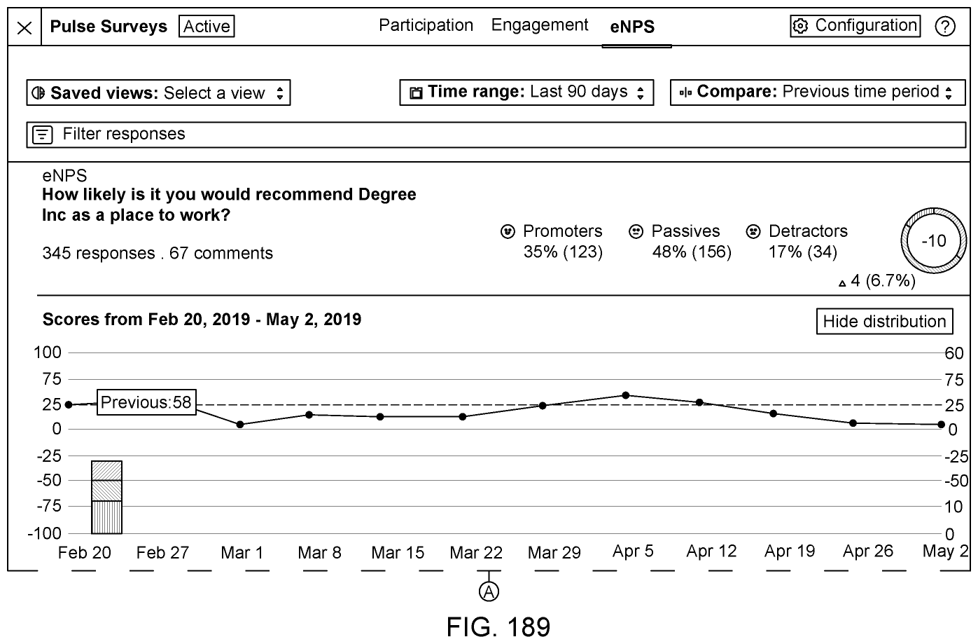

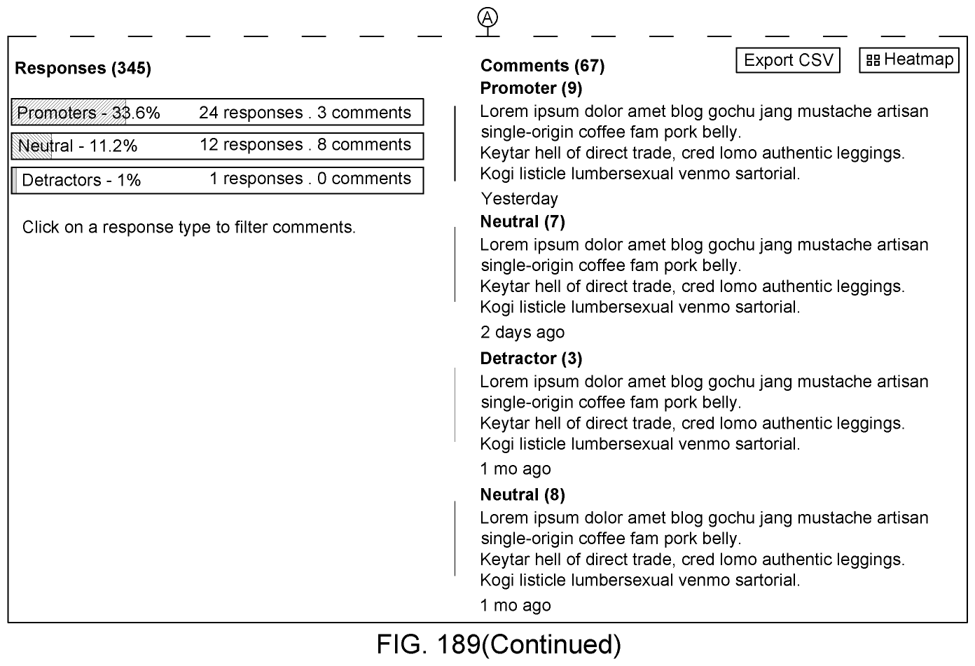

FIG. 189 is a screenshot of an example user interface for displaying a distribution of scores corresponding to eNPS question over a configurable time period.

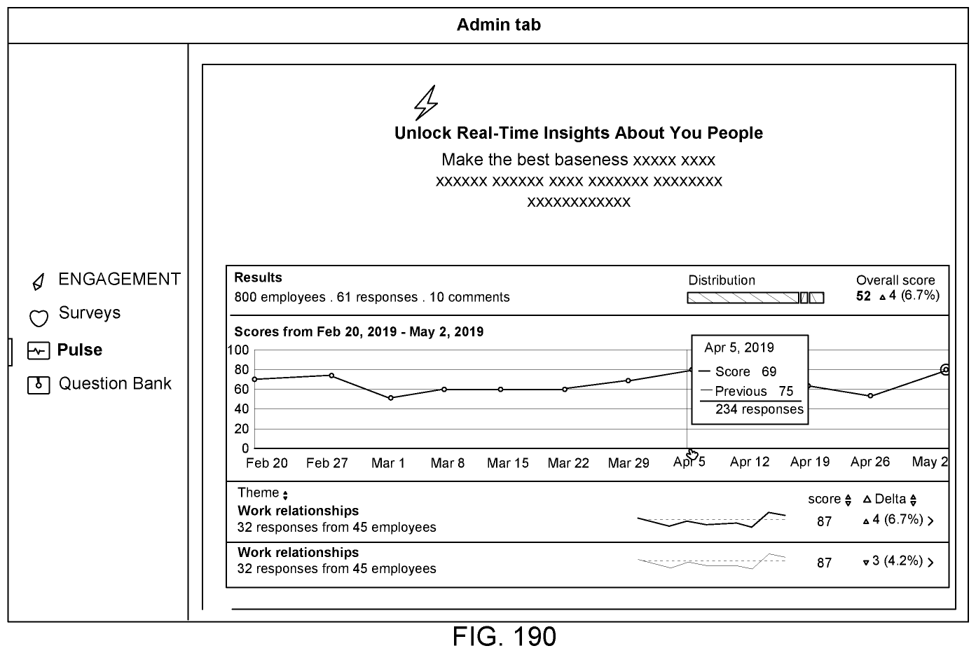

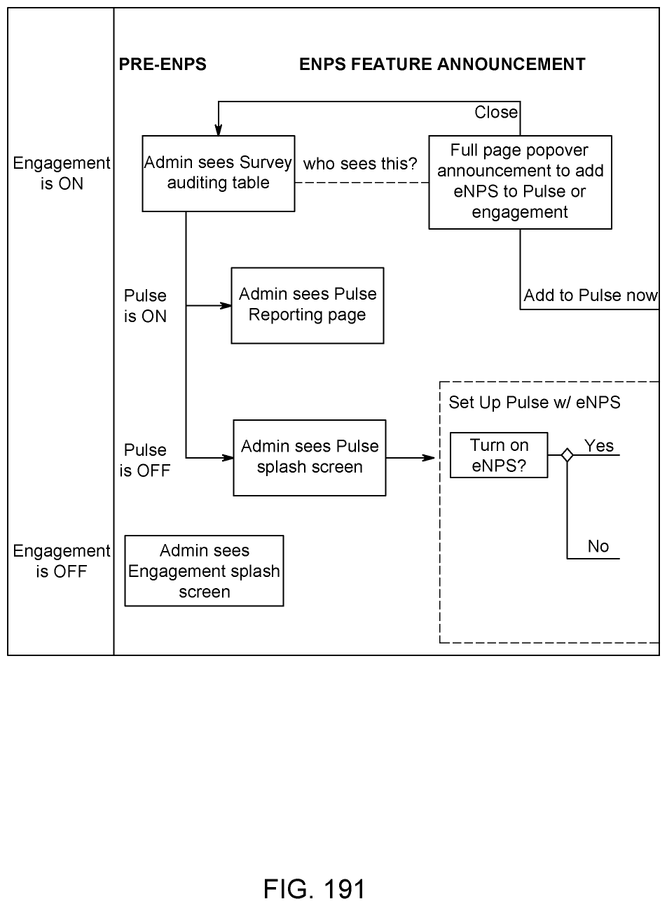

FIG. 190 is a screenshot of an example user interface for unlocking real-time insights about people.

FIG. 191 is a block diagram of example operations for incorporating eNPS into a survey generation workflow.

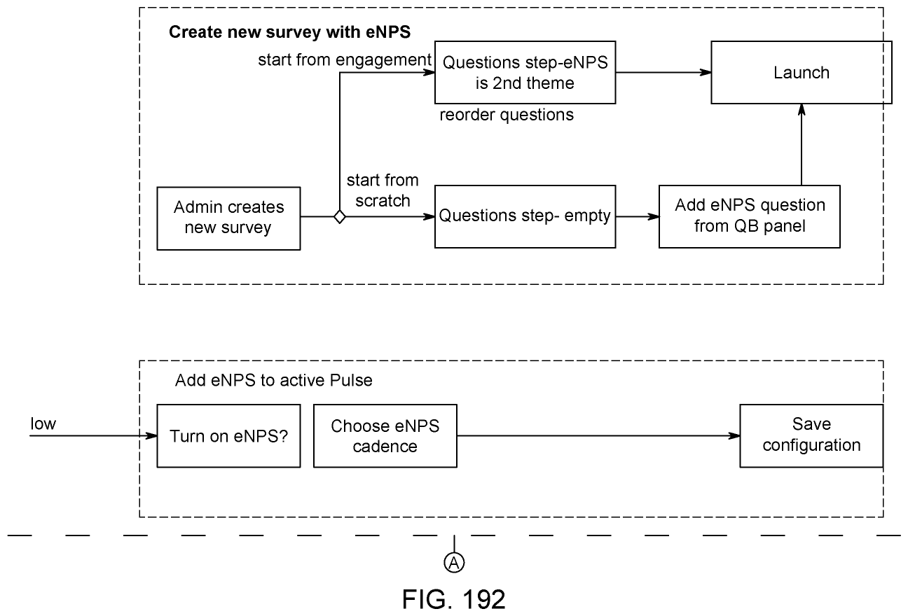

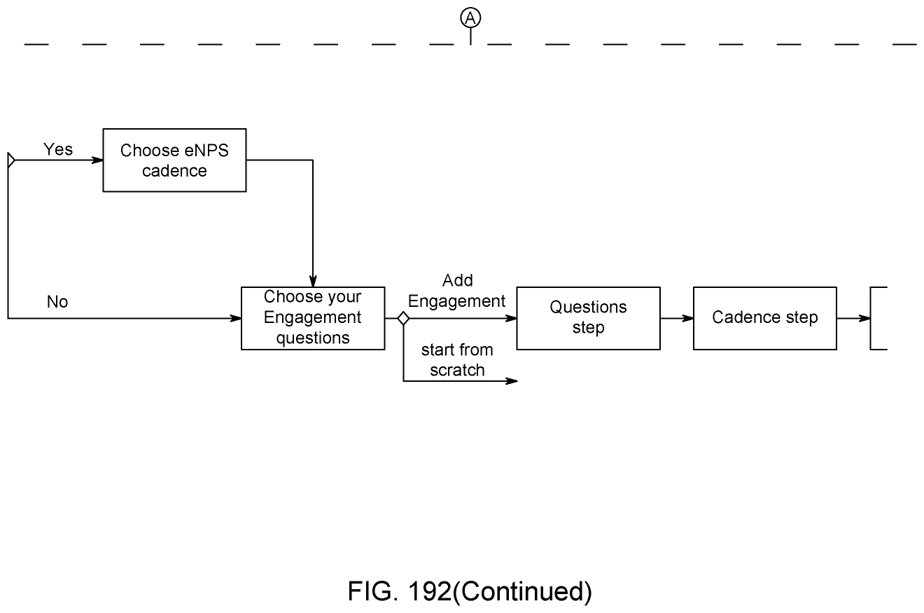

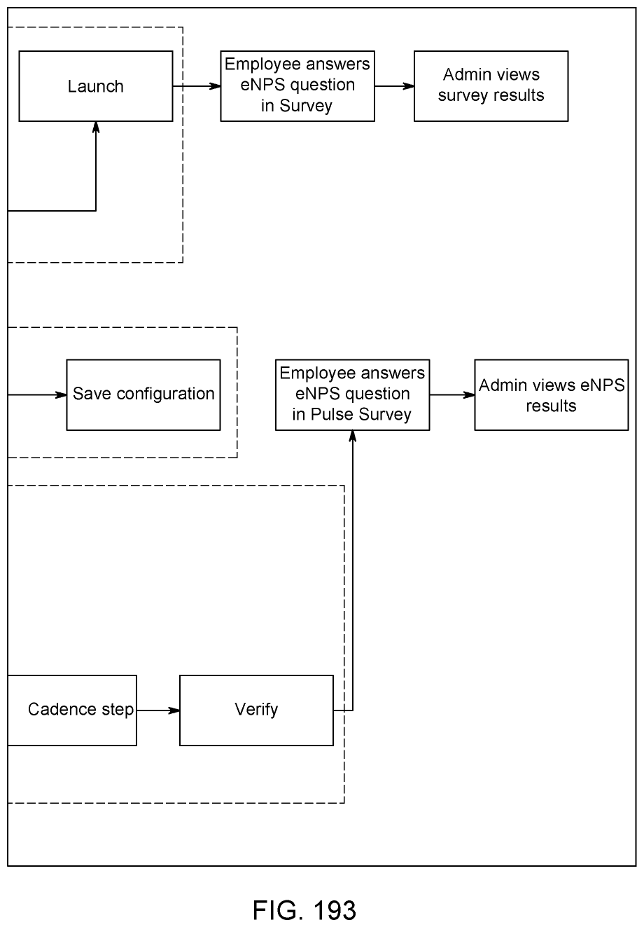

FIG. 192 is a block diagram of additional example operations for incorporating eNPS into a survey generation workflow.

FIG. 193 is a block diagram of additional example operations for incorporating eNPS into a survey generation workflow.

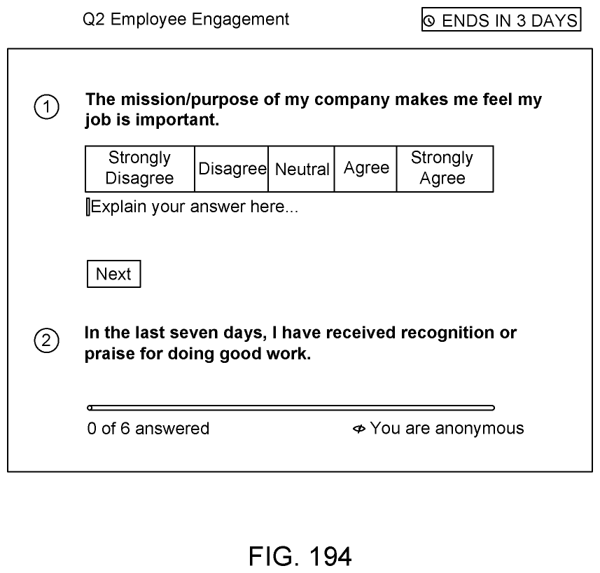

FIG. 194 is a screenshot of an example user interface for presenting an eNPS question to a user and for collecting an explanation for the selected answer.

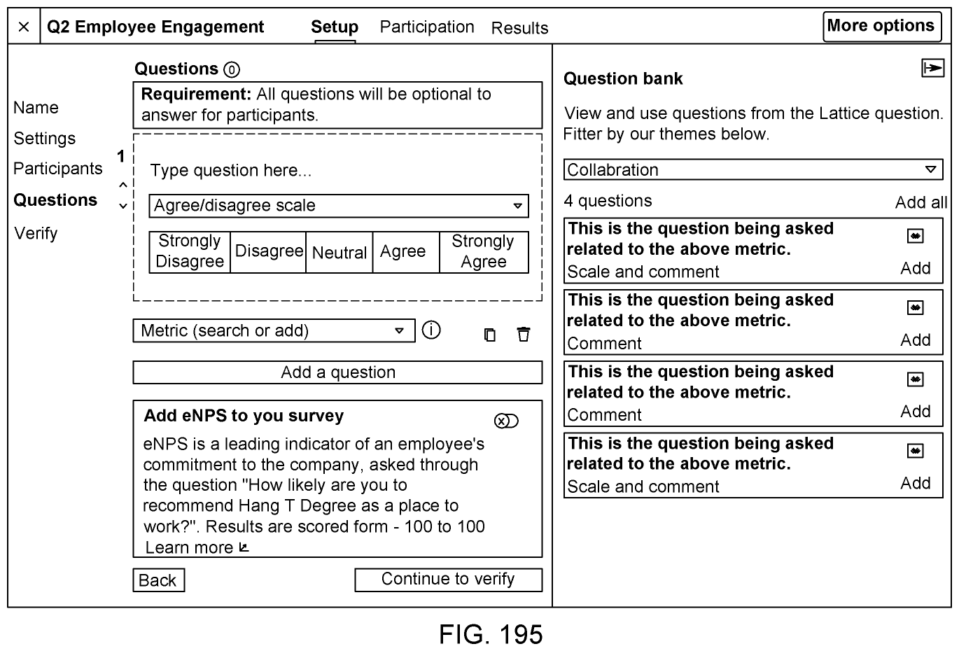

FIG. 195 is a screenshot of an example user interface for specifying a question in a survey.

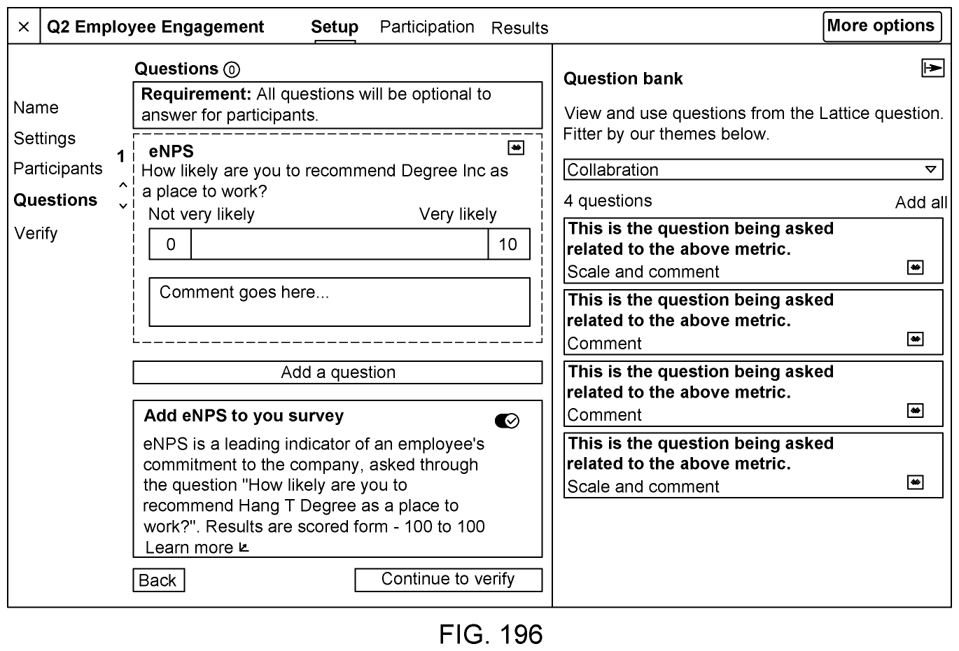

FIG. 196 is a screenshot of an example user interface for specifying that an eNPS question is to be added to a survey.

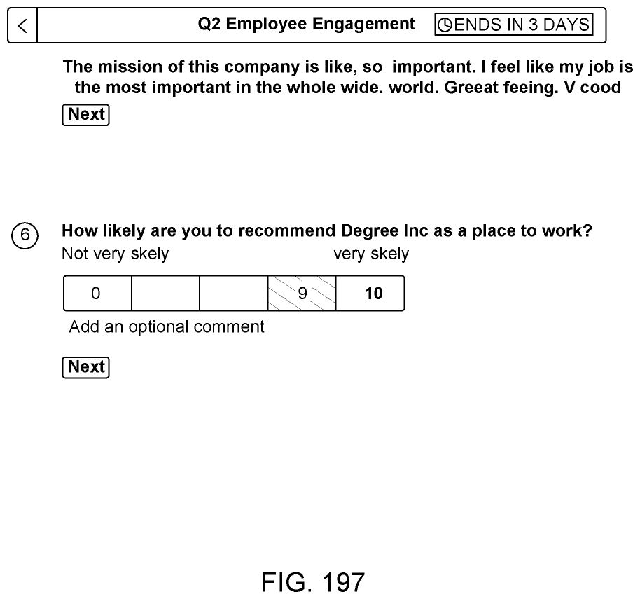

FIG. 197 is a screenshot of an example user interface for recording an answer to an eNPS question.

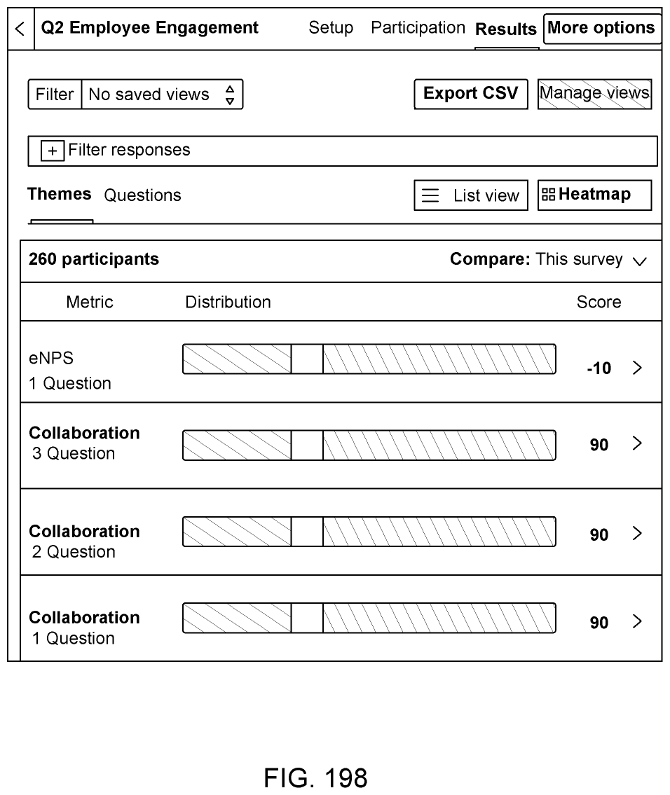

FIG. 198 is a screenshot of an example user interface for accessing survey results based on themes.

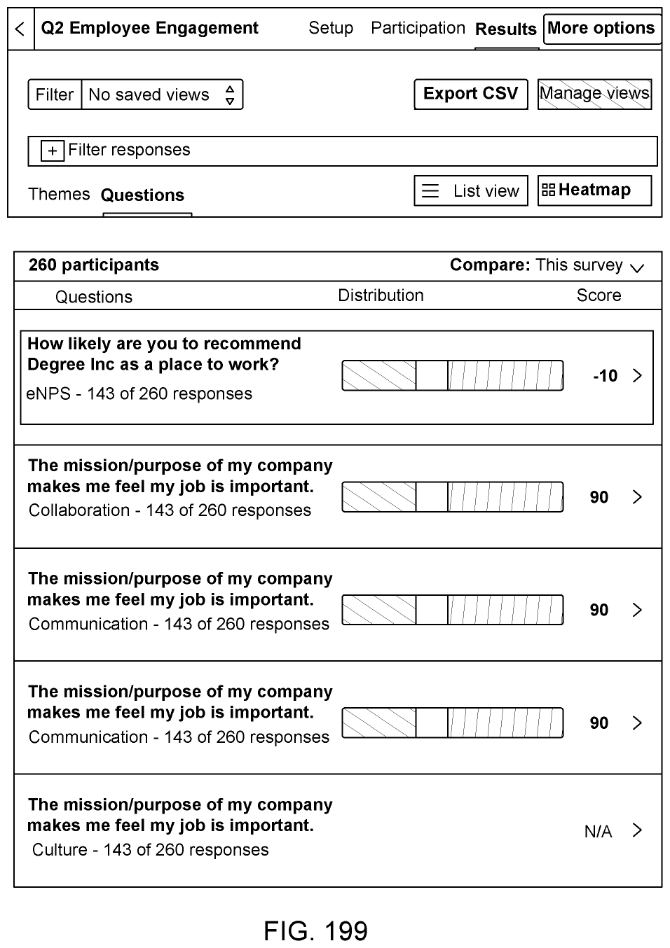

FIG. 199 is a screenshot of an example user interface for accessing survey results based on questions.

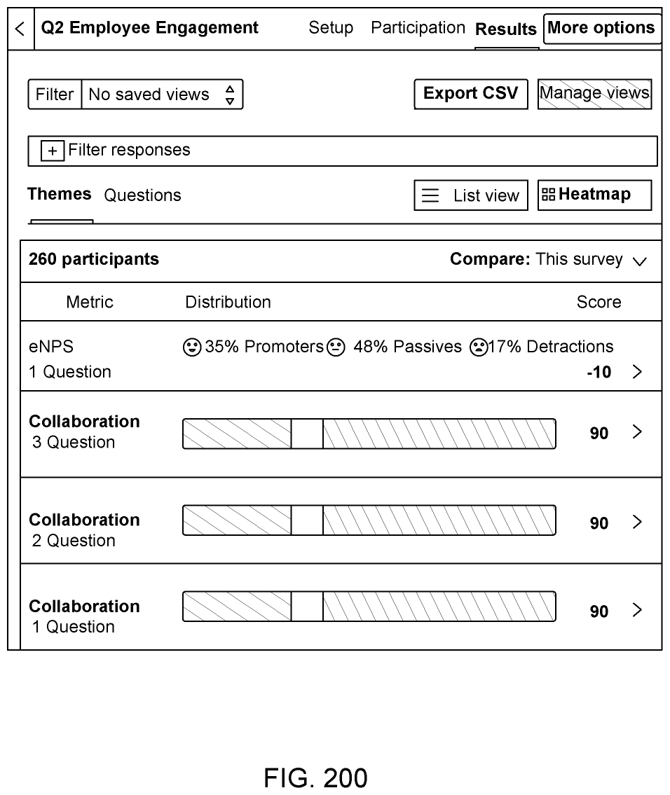

FIG. 200 is a screenshot of an example user interface for interacting with a result in a user interface in order to view a distribution of promoters, passives, and detractors with respect to an eNPS question.

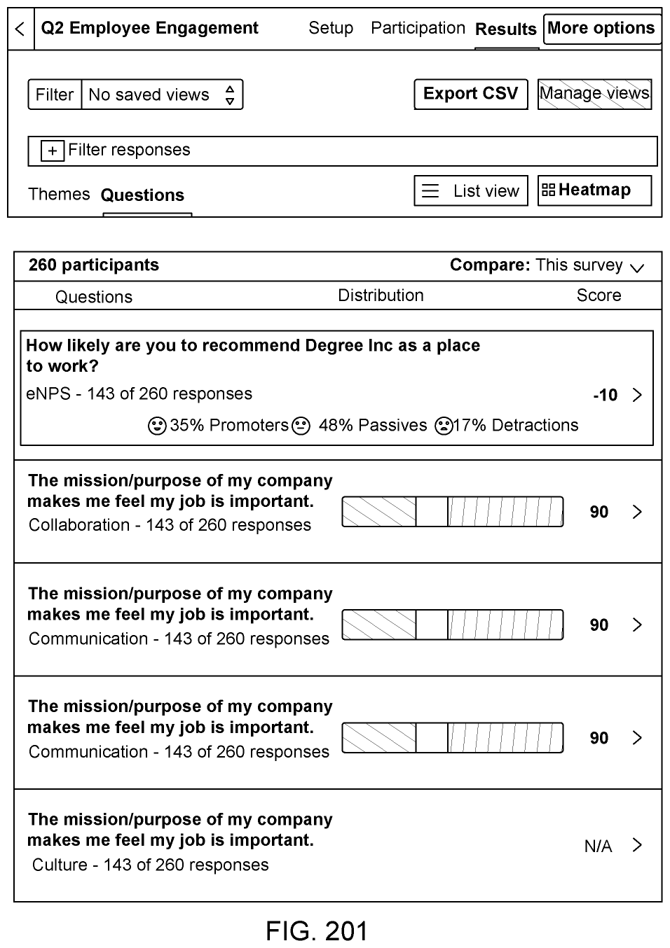

FIG. 201 is a screenshot of an additional example user interface for interacting with a result in a user interface in order to view a distribution of promoters, passives, and detractors with respect to an eNPS question.

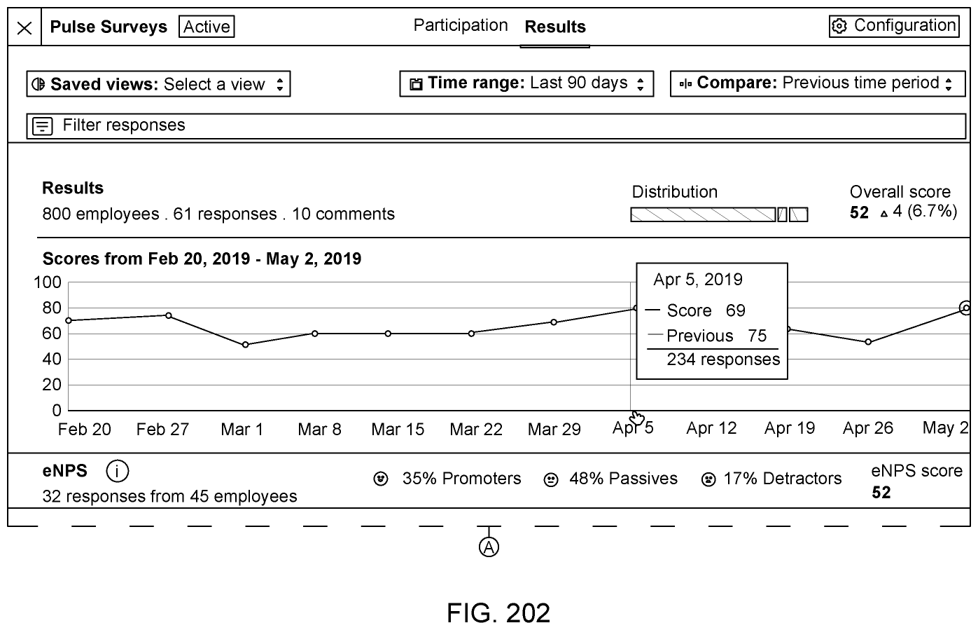

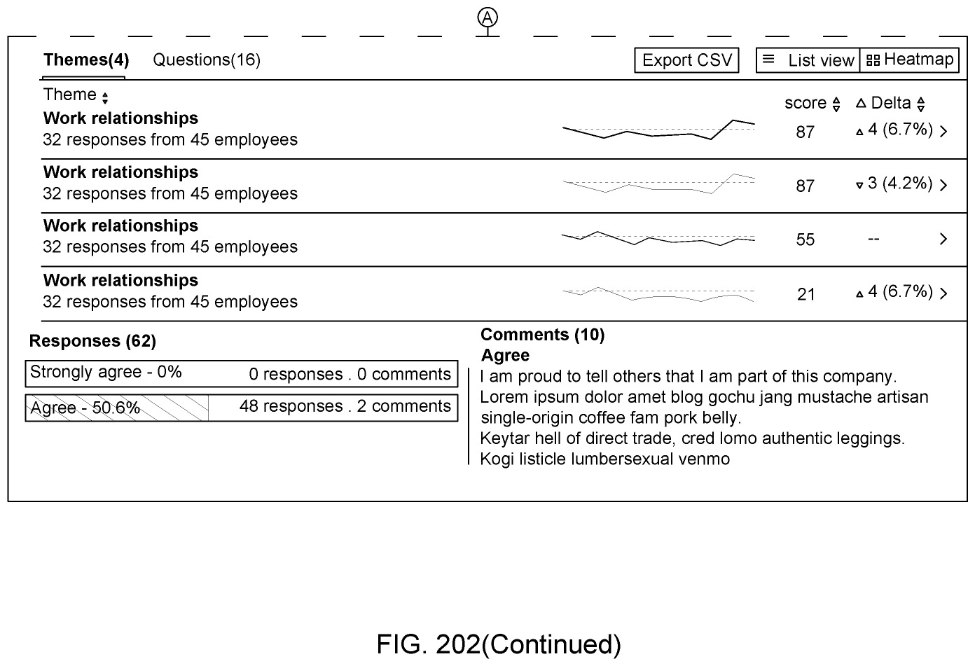

FIG. 202 is a screenshot of an example user interface for viewing eNPS scores over a configurable period of time, including by theme.

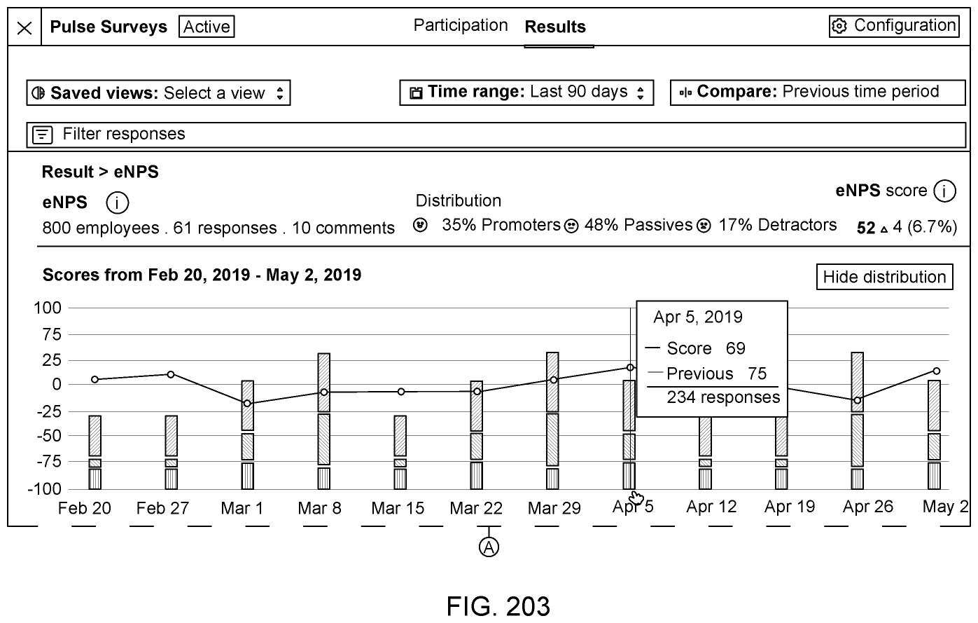

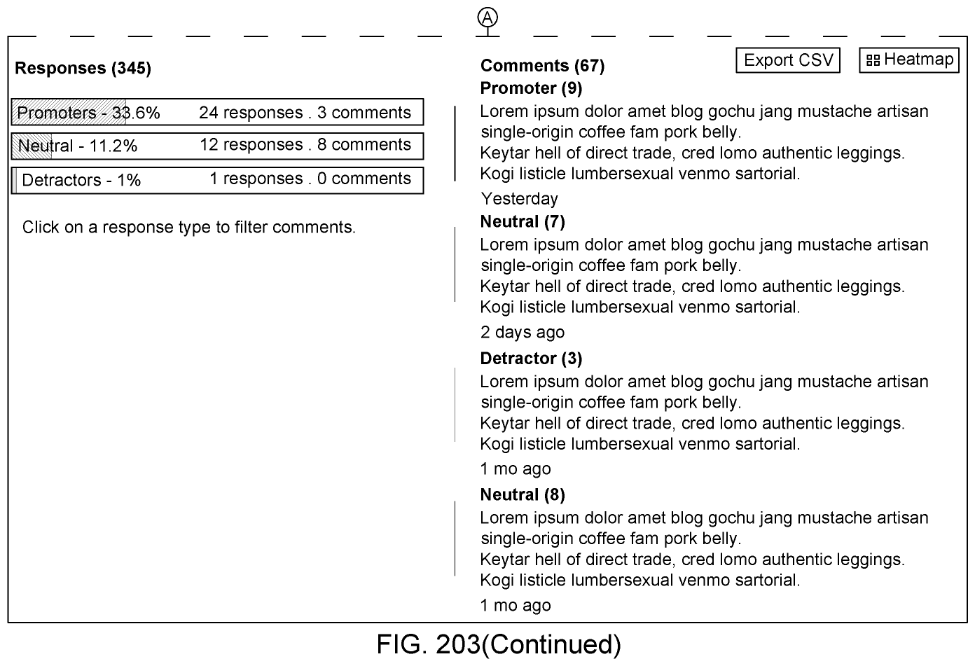

FIG. 203 is a screenshot of an example user interface for viewing eNPS distributions over a configurable period of time.

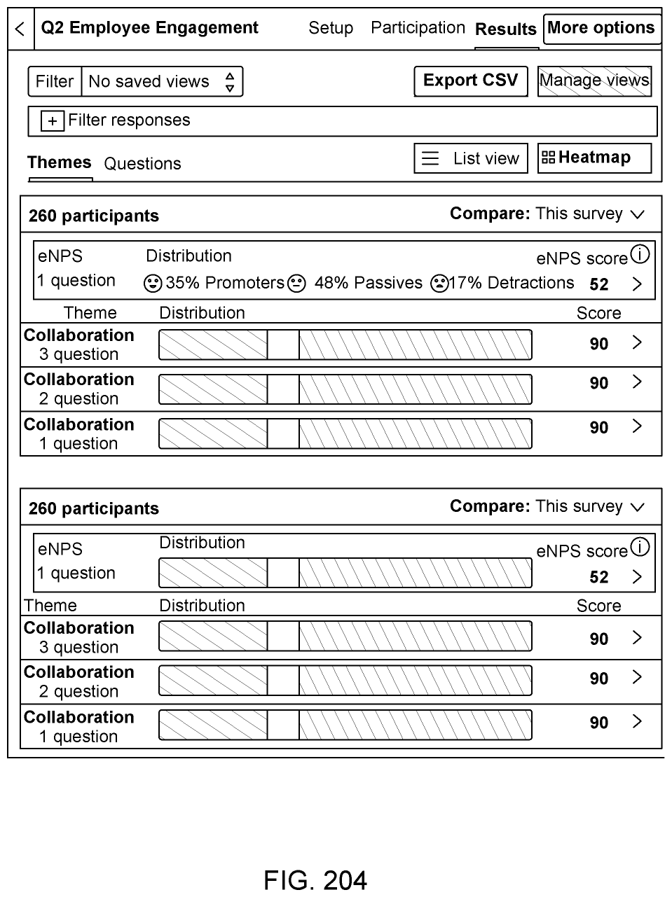

FIG. 204 is a screenshot of an example user interface for accessing survey results for multiple surveys and optionally comparing one or more of the multiple surveys.

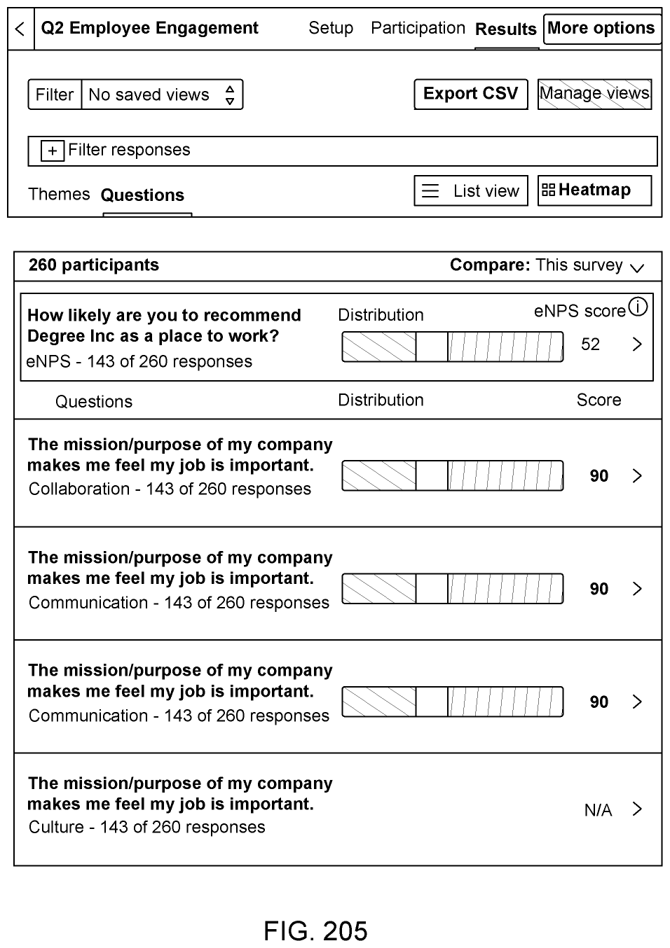

FIG. 205 is a screenshot of an example user interface for viewing results of an eNPS survey question and/or one or more results of other survey questions.

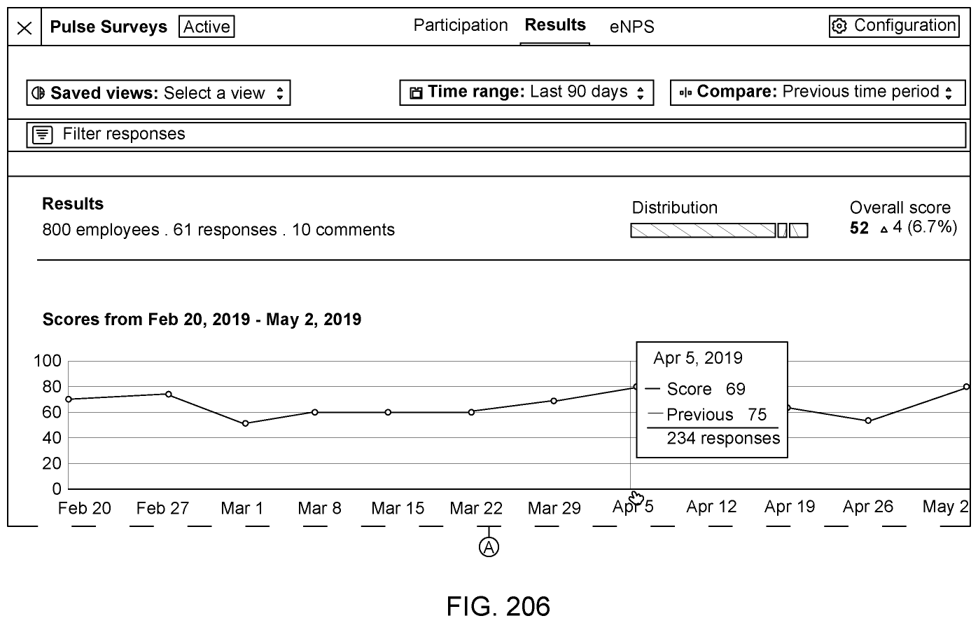

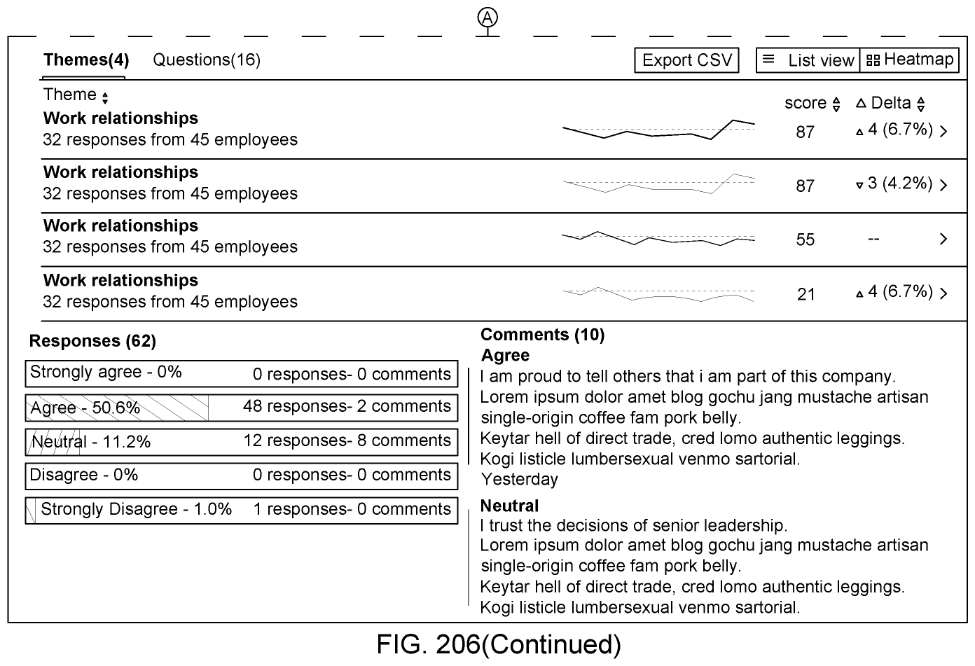

FIG. 206 is a screenshot of an example user interface for interactively drilling down into a specific survey result included in a graph of scores over a configurable period of time.

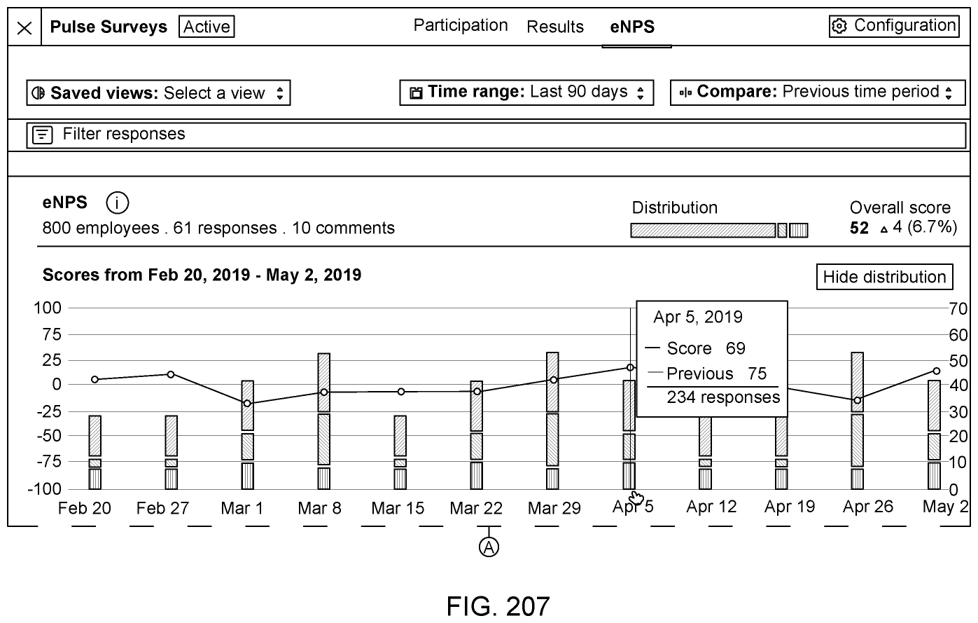

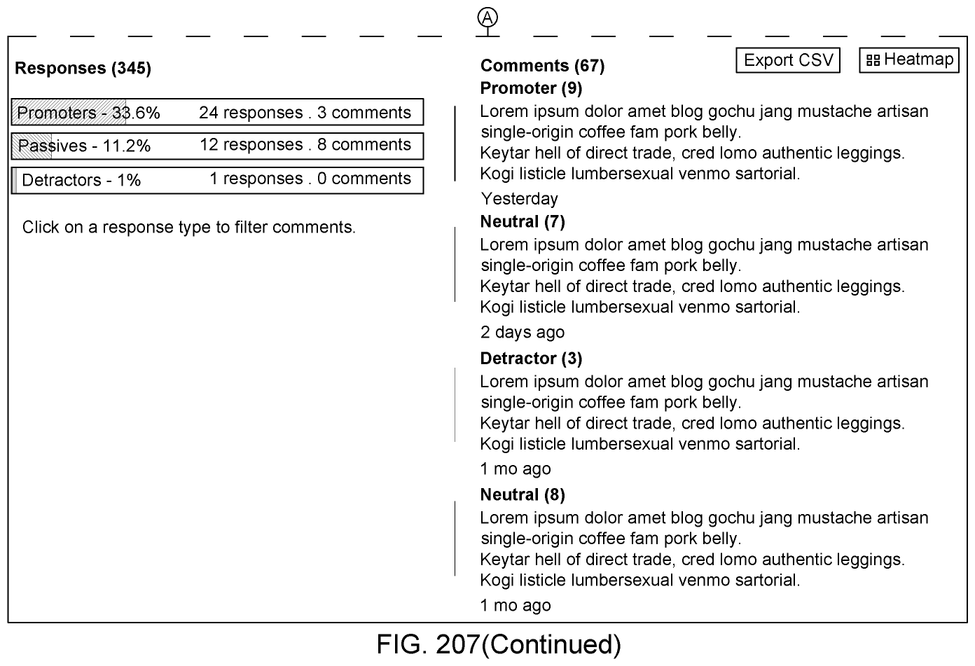

FIG. 207 is a screenshot of an additional example user interface for interactively drilling down into a specific survey result.

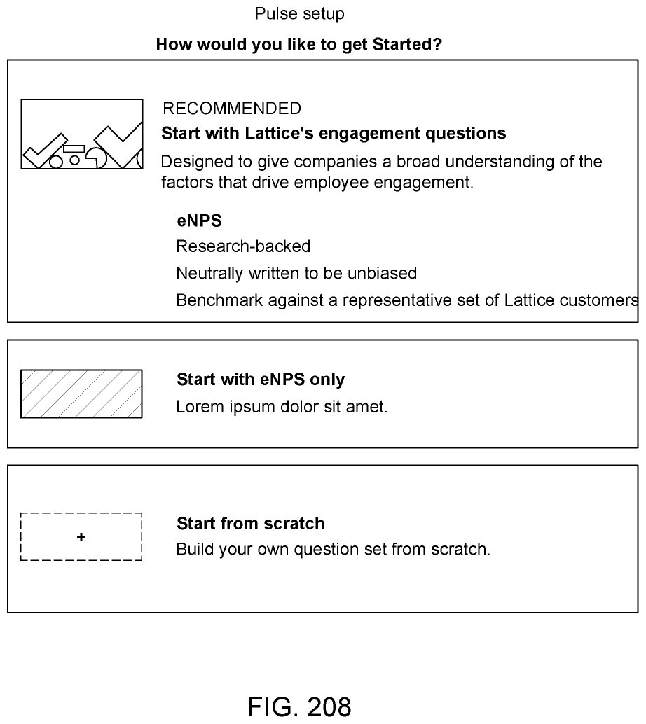

FIG. 208 is a screenshot of an example user interface for starting generation of a survey.

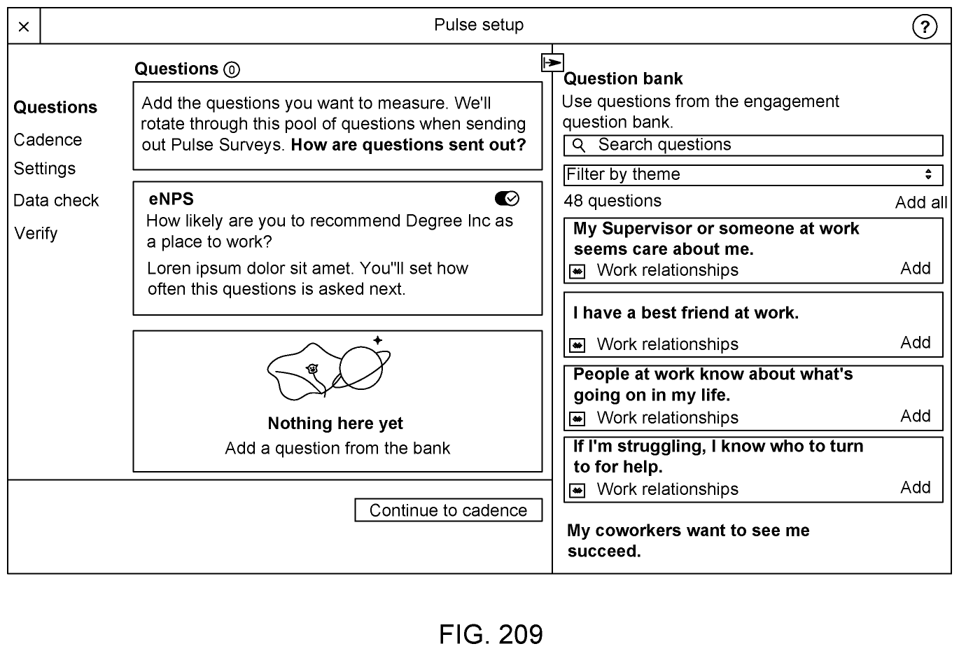

FIG. 209 is a screenshot of an example user interface for adding a eNPS question to a survey and/or toggling the eNPS question on or off.

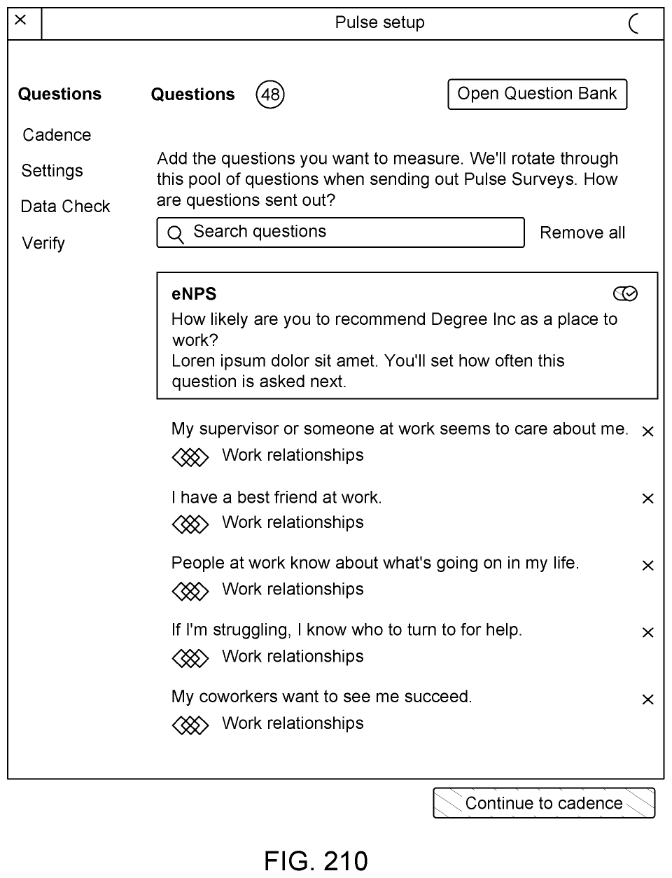

FIG. 210 is a screenshot of an example user interface for adding and/or removing one or more survey questions to a survey.

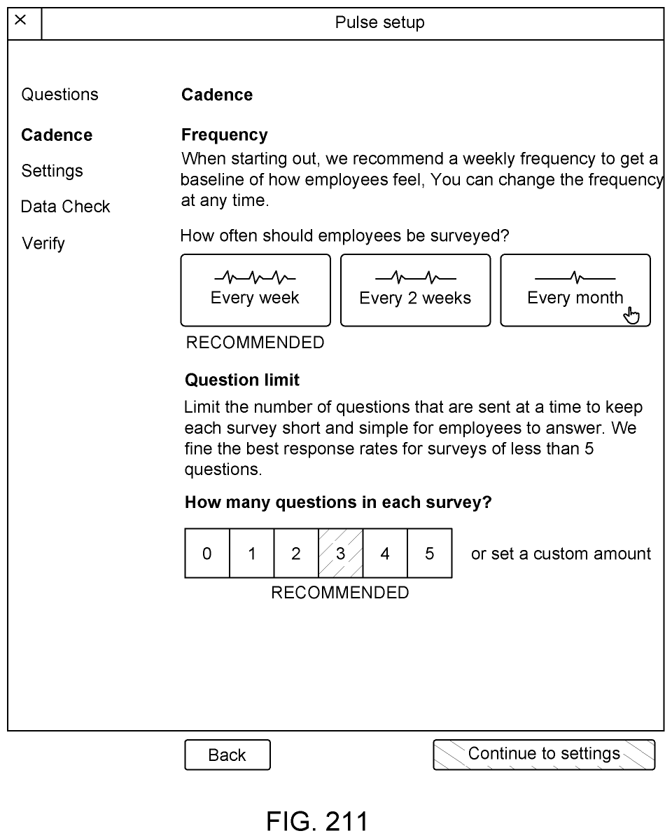

FIG. 211 is a screenshot of an example user interface for specifying a cadence for a survey.

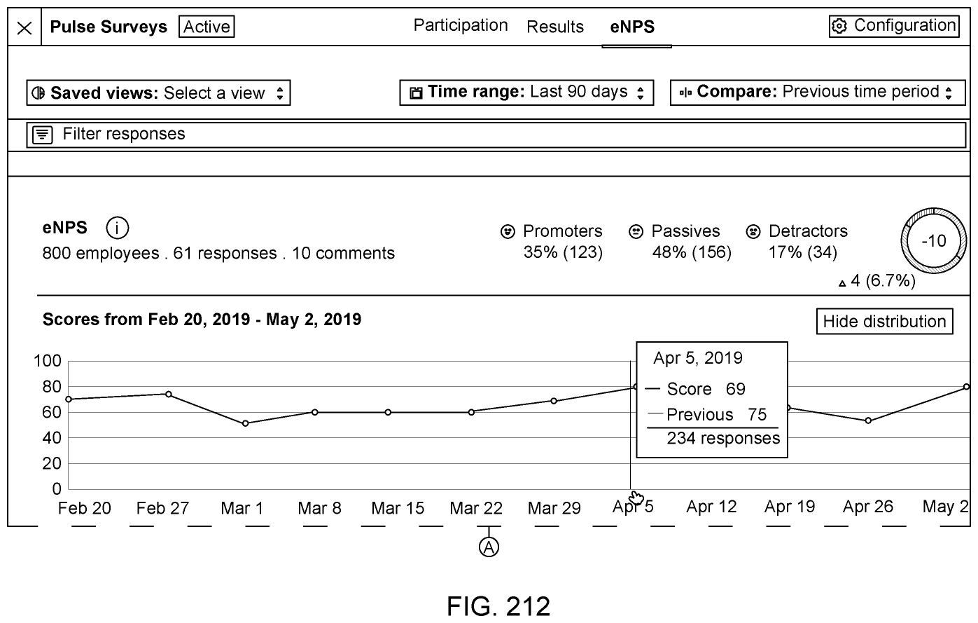

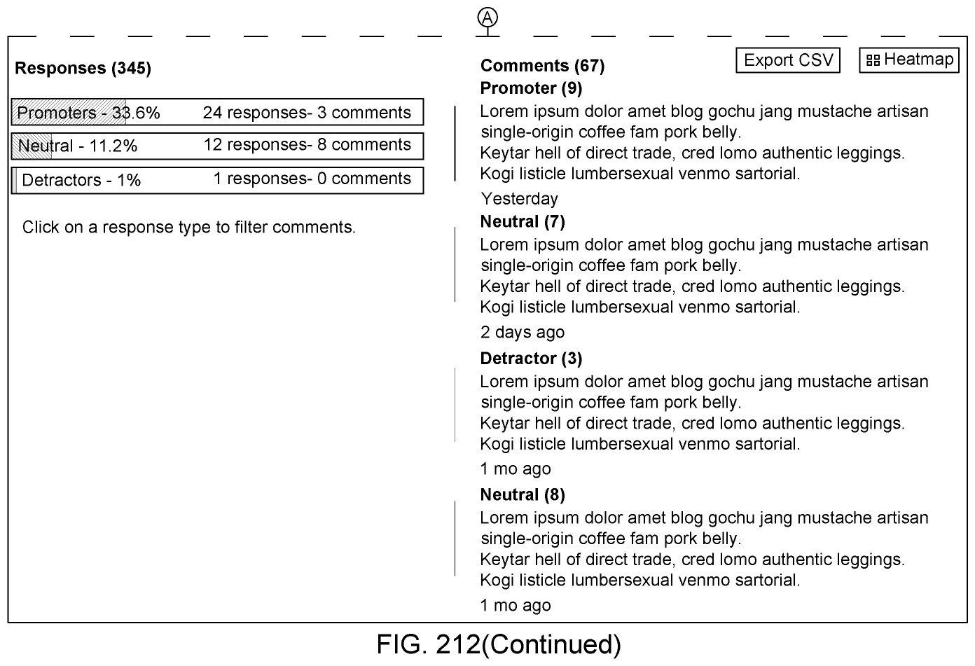

FIG. 212 is a screenshot of an example user interface for viewing eNPS results corresponding to a survey.

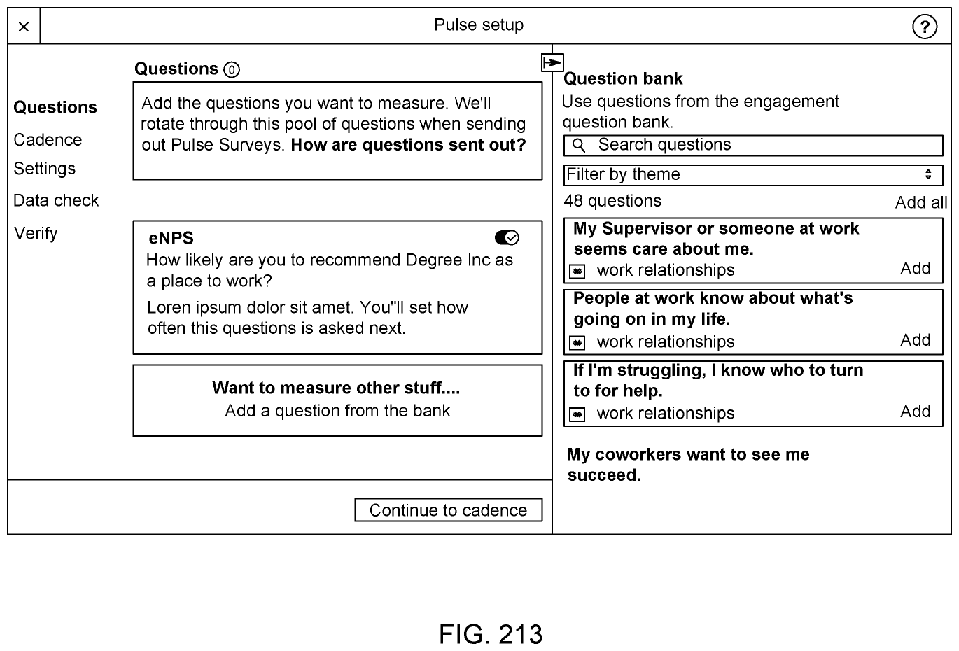

FIG. 213 is a screenshot of an example user interface for optionally adding one or more questions to a survey from a question bank.

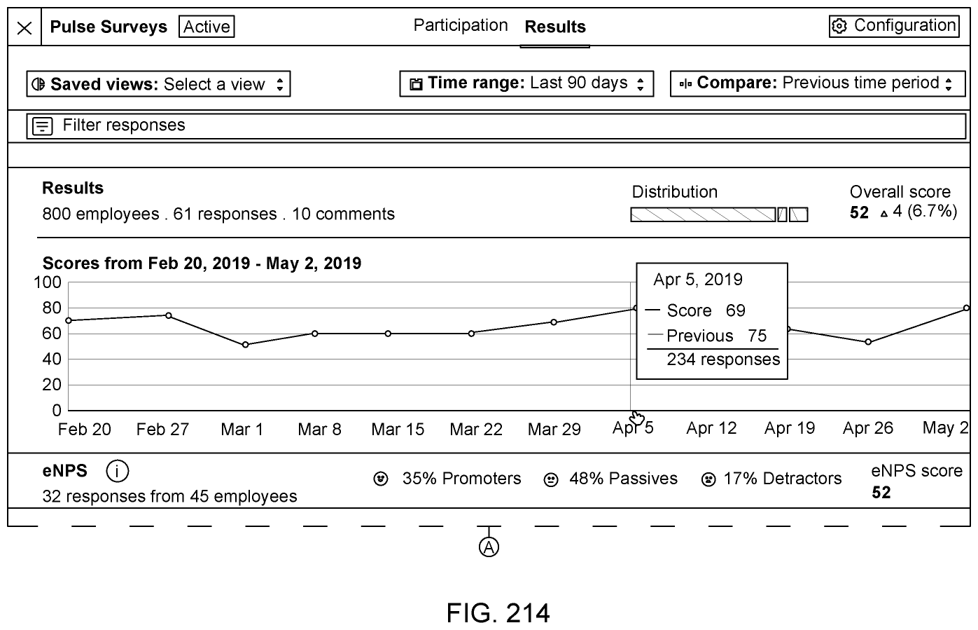

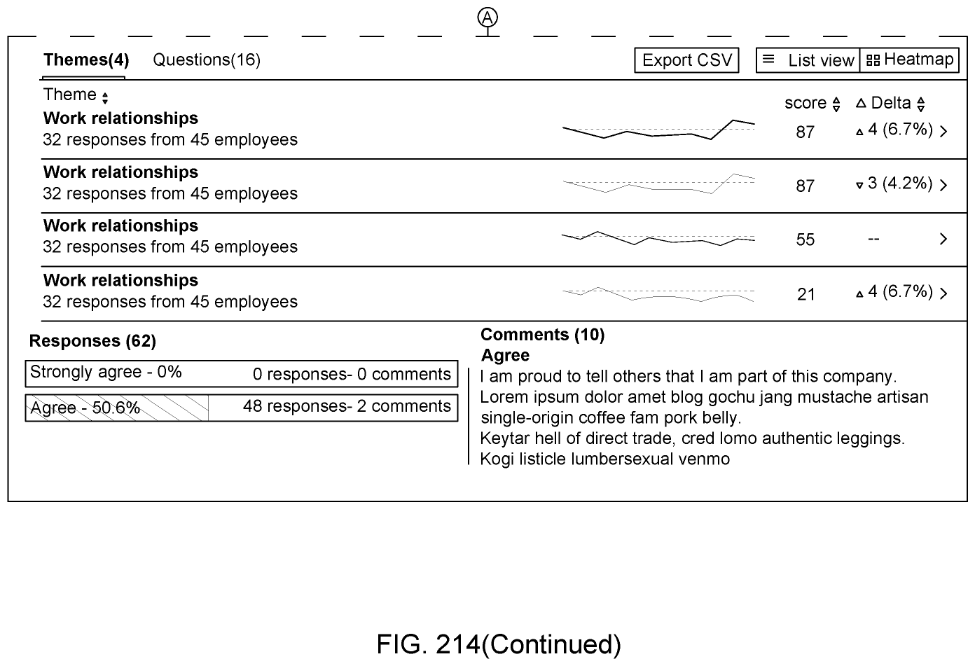

FIG. 214 is a screenshot of an example user interface for viewing survey results over a configurable period of time.

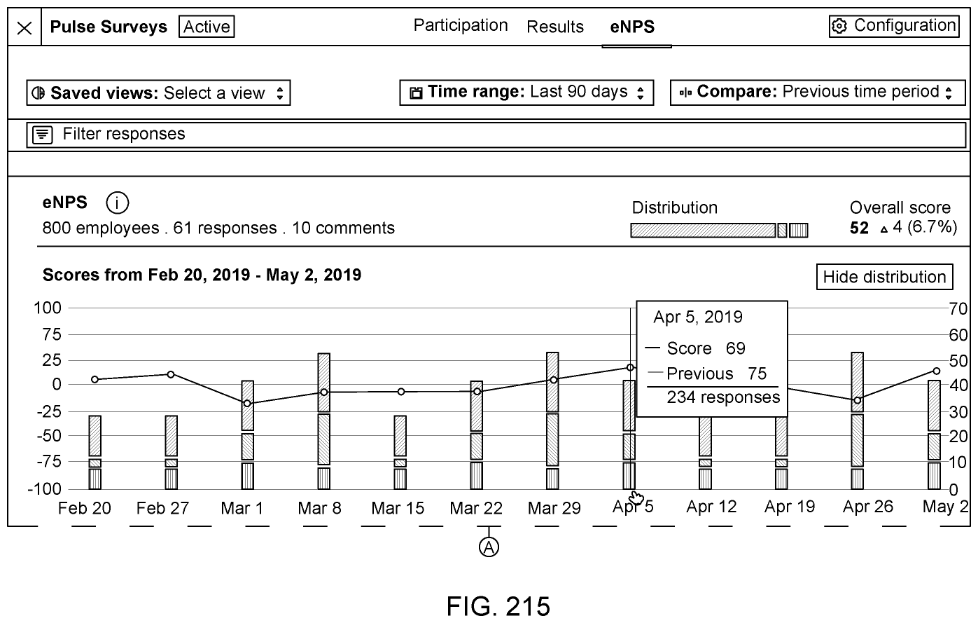

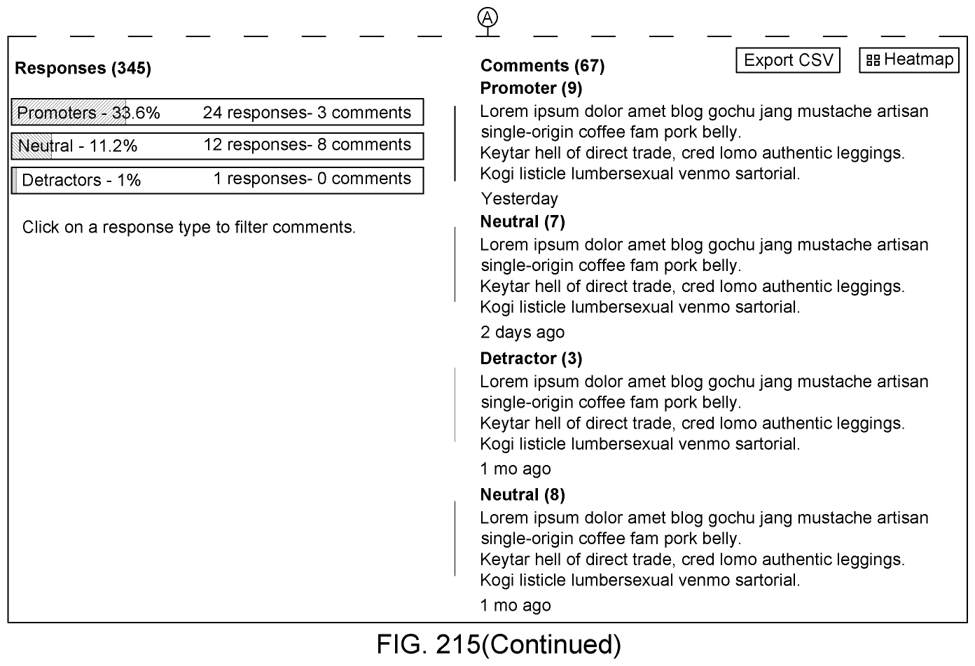

FIG. 215 is a screenshot of an example user interface for viewing eNPS survey question results, including distributions, over a configurable period of time.

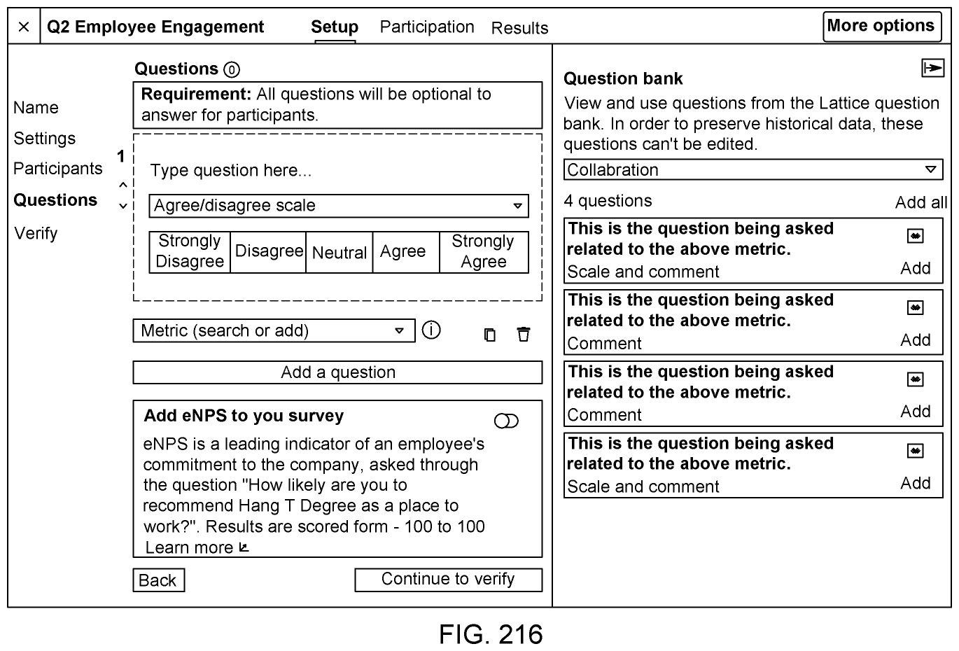

FIG. 216 is a screenshot of an example user interface for specifying a type of a question as well as possible answers to the question for including in a survey.

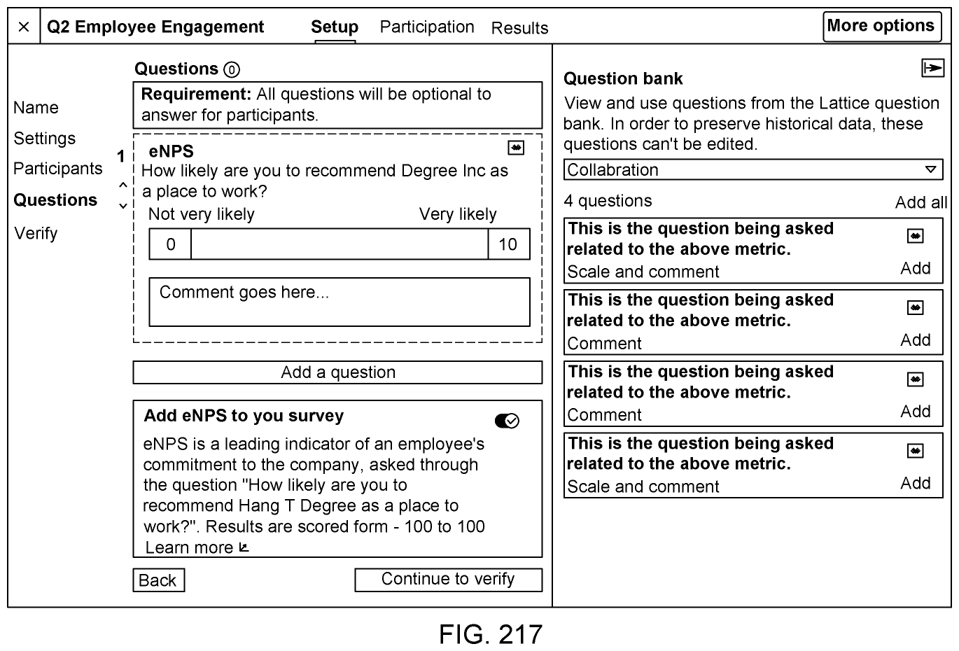

FIG. 217 is a screenshot of an example user interface for specifying a theme in order to filter questions in the question bank for optional selection.

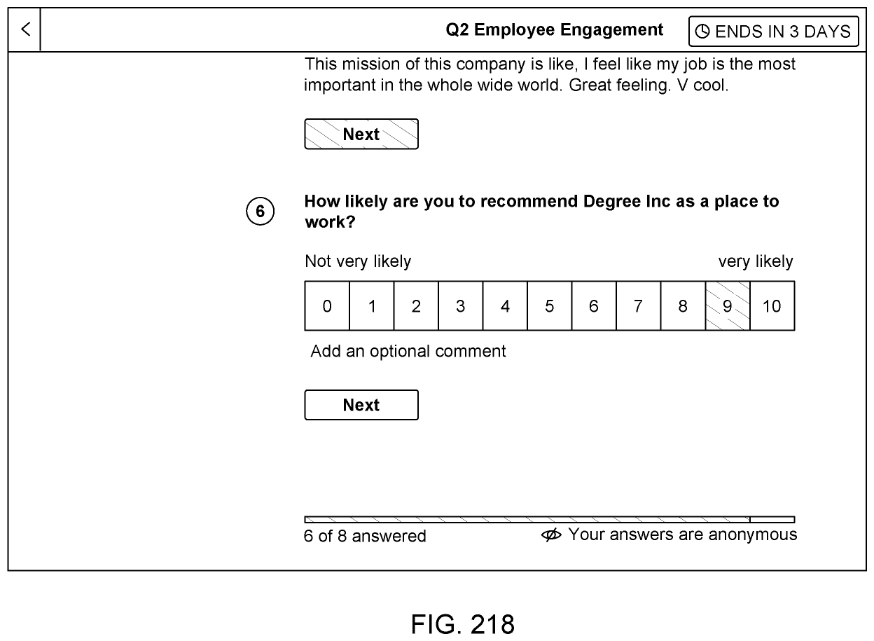

FIG. 218 is a screenshot of an example user interface for presenting an eNPS question to a user.

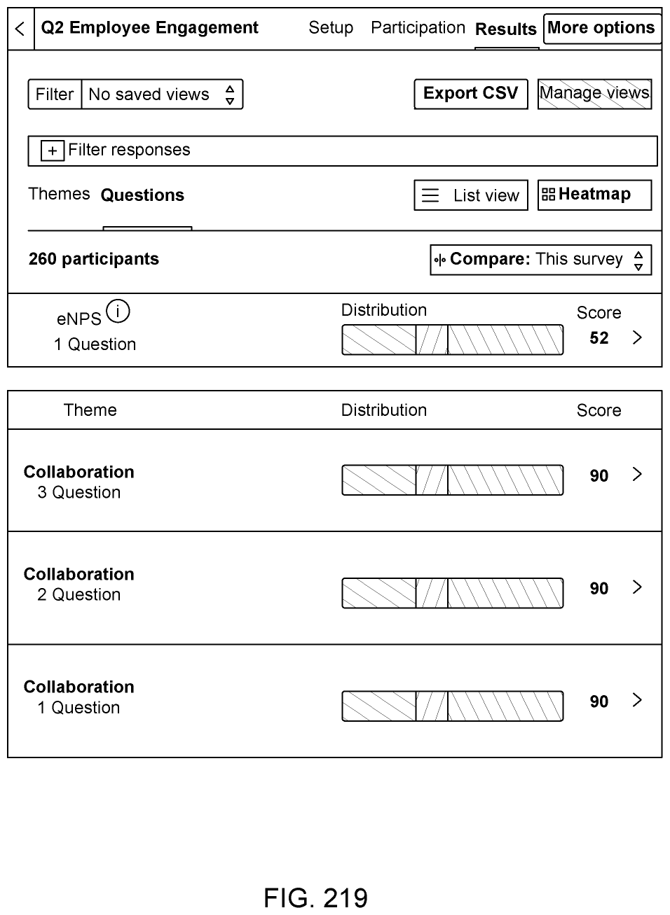

FIG. 219 is a screenshot of an example user interface for managing views associated with survey results by question.

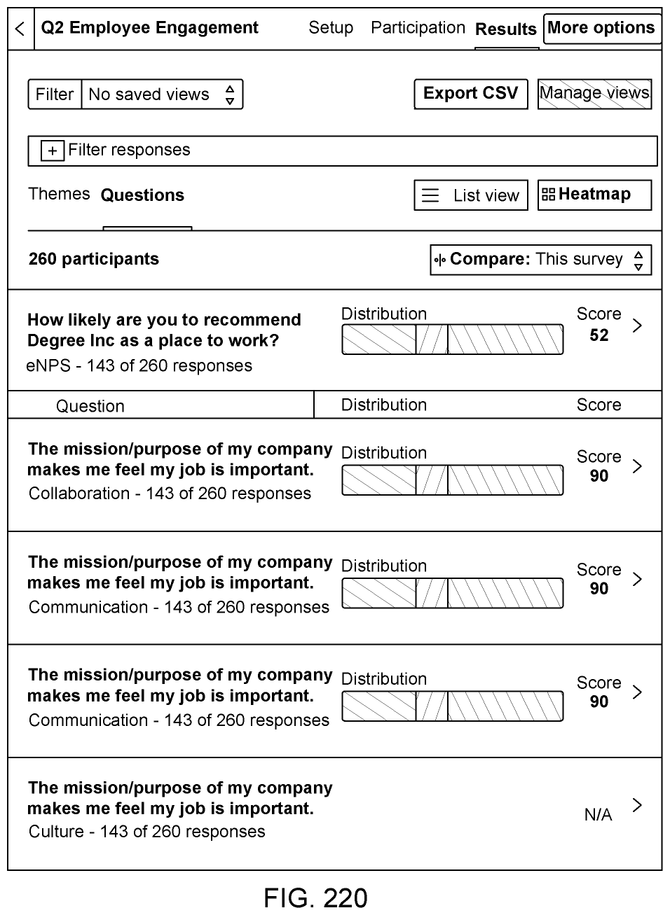

FIG. 220 is a screenshot of an example user interface for managing views associated with survey results by theme.

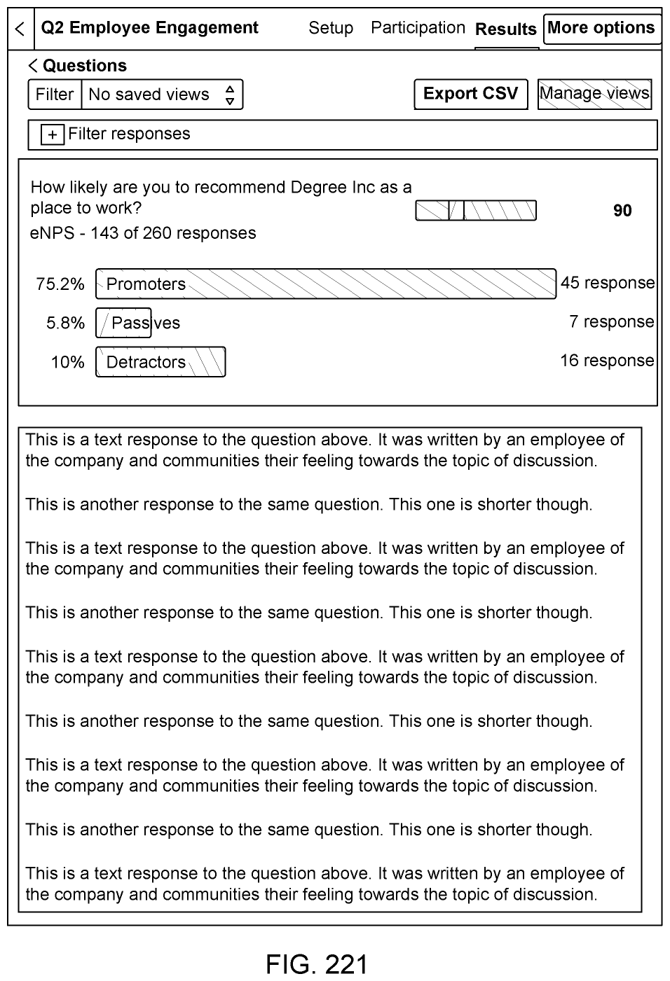

FIG. 221 is a screenshot of an example user interface for presenting detailed view of eNPS results.

### Example Mobile Device

The mobile device 1100 can include a processor 1602. The processor 1602 can be any of a variety of different types of commercially available processors suitable for mobile devices 1100 (for example, an XScale architecture microprocessor, a Microprocessor without Interlocked Pipeline Stages (MIPS) architecture processor, or another type of processor). A memory 1604, such as a random access memory (RAM), a Flash memory, or other type of memory, is typically accessible to the processor 1602. The memory 1604 can be adapted to store an operating system (OS) 1606, as well as application programs 1608, such as a mobile location-enabled application that can provide location-based services (LBSs) to a user. The processor 1602 can be coupled, either directly or via appropriate intermediary hardware, to a display 1610 and to one or more input/output (I/O) devices 1612, such as a keypad, a touch panel sensor, a microphone, and the like. Similarly, in some embodiments, the processor 1602 can be coupled to a transceiver 1614 that interfaces with an antenna 1616. The transceiver 1614 can be configured to both transmit and receive cellular network signals, wireless data signals, or other types of signals via the antenna 1616, depending on the nature of the mobile device 1100. Further, in some configurations, a GPS receiver 1618 can also make use of the antenna 1616 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1702 (e.g., a central processing unit (CPU), a graphics processing unit (GPU) or both), a main memory 1704 and a static memory 1706, which communicate with each other via a bus 1708. The computer system 1200 may further include a graphics display unit 1710 (e.g., a liquid crystal display (LCD) or a cathode ray tube (CRT)). The computer system 1200 also includes an alphanumeric input device 1712 (e.g., a keyboard or a touch-sensitive display screen), a user interface (UI) navigation device 1714 (e.g., a mouse), a storage unit 1716, a signal generation device 1718 (e.g., a speaker) and a network interface device 1720.

### Machine-Readable Medium

The storage unit 1716 includes a machine-readable medium 1722 on which is stored one or more sets of instructions and data structures (e.g., software) 1724 embodying or utilized by any one or more of the methodologies or functions described herein. The instructions 1724 may also reside, completely or at least partially, within the main memory 1704 and/or within the processor 1702 during execution thereof by the computer system 1200, the main memory 1704 and the processor 1702 also constituting machine-readable media.

While the machine-readable medium 1722 is shown in an example embodiment to be a single medium, the term “machine-readable medium” may include a single medium or multiple media (e.g., a centralized or distributed database, and/or associated caches and servers) that store the one or more instructions 1724 or data structures. The term “machine-readable medium” shall also be taken to include any tangible medium that is capable of storing, encoding or carrying instructions (e.g., instructions 1724) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1724 may further be transmitted or received over a communications network 1726 using a transmission medium. The instructions 1724 may be transmitted using the network interface device 1720 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more computer processors;
one or more computer memories;
a set of instructions incorporated into the one or more computer memories, the set of instructions configuring the one or more computer processors to perform operations comprising:
based on an enablement of an employee Net Promoter Score (eNPS) feature in an administrative user interface, adding an eNPS survey question to one or more question banks associated with one or more surveys;
collecting anonymous answers to the eNPS survey question from a plurality of employees of an entity;
calculating an eNPS score for the entity, the calculating of the eNPS score including subtracting a percentage of detractors from a percentage of promoters;
based on the eNPS score, generating one or more suggested actions for improving the eNPS score for the entity; and
causing user interface elements pertaining to the one or more suggested actions to be surfaced in the administrative user interface to allow one or more users to signal one or more intentions to implement the one or more suggested actions.

2. The system of claim 1, wherein the calculating of the eNPS score further includes determining the percentage of detractors based on a percentage of employees who submitted a value in response to the eNPS survey question that was at or below a detractor threshold value.

3. The system of claim 1, wherein the calculating of the eNPS score further includes determining the percentage of promoters based on a percentage of employees who submitted a value in response to the eNPS survey question that was at or above a promoter threshold value.

4. The system of claim 1, wherein the calculating of the eNPS score further includes determining a percentage of passives based on a percentage of employees who submitted a value in response to the survey question that was above a detractor threshold value and below a promoter threshold value.

5. The system of claim 1, wherein the one or more suggested actions include one or more machine-learned actions that previously improved the eNPS score for the entity or another entity.

6. The system of claim 5, wherein the one or more surveys include one or more pulse surveys, the one or more pulse surveys configured to update the eNPS score at a selected cadence or selected frequency.

7. The system of claim 6, further comprising:
receiving an anonymity threshold value via the administrative user interface; and
surfacing the eNPS score for the entity in the administrative user interface based on the anonymity threshold value being transgressed.

8. A method comprising:
based on an enablement of an eNPS (employee Net Promoter Score) feature in an administrative user interface, adding an eNPS survey question to one or more question banks associated with one or more surveys;
collecting anonymous answers to the eNPS survey question from a plurality of employees of an entity;
calculating an eNPS score for the entity, the calculating of the eNPS score including subtracting a percentage of detractors from a percentage of promoters;
based on the eNPS score, generating one or more suggested actions for improving the eNPS score for the entity; and
causing user interface elements pertaining to the one or more suggested actions to be surfaced in the administrative user interface to allow one or more users to signal one or more intentions to implement the one or more suggested actions.

9. The method of claim 8, wherein the calculating of the eNPS score further includes determining the percentage of detractors based on a percentage of employees who submitted a value in response to the eNPS survey question that was at or below a detractor threshold value.

10. The method of claim 8, wherein the calculating of the eNPS score further includes determining the percentage of promoters based on a percentage of employees who submitted a value in response to the eNPS survey question that was at or above a promoter threshold value.

11. The method of claim 8, wherein the calculating of the eNPS score further includes determining a percentage of passives based on a percentage of employees who submitted a value in response to the survey question that was above a detractor threshold value and below a promoter threshold value.

12. The method of claim 8, wherein the one or more suggested actions include one or more machine-learned actions that previously improved the eNPS score for the entity or another entity.

13. The method of claim 12, wherein the one or more surveys include one or more pulse surveys, the one or more pulse surveys configured to update the eNPS score at a selected cadence or selected frequency.

14. The method of claim 6, further comprising:
receiving an anonymity threshold value via the administrative user interface; and
surfacing the eNPS score for the entity in the administrative user interface based on the anonymity threshold value being transgressed.

15. A non-transitory computer-readable storage medium storing instructions thereon, which, when executed by one or more processors, cause one or more processors to perform operations, the operations comprising:
based on an enablement of an eNPS (employee Net Promoter Score) feature in an administrative user interface, adding an eNPS survey question to one or more question banks associated with one or more surveys;
collecting anonymous answers to the eNPS survey question from a plurality of employees of an entity;
calculating an eNPS score for the entity, the calculating of the eNPS score including subtracting a percentage of detractors from a percentage of promoters;
based on the eNPS score, generating one or more suggested actions for improving the eNPS score for the entity; and
causing user interface elements pertaining to the one or more suggested actions to be surfaced in the administrative user interface to allow one or more users to signal one or more intentions to implement the one or more suggested actions.

16. The non-transitory computer-readable storage medium of claim 15, wherein the calculating of the eNPS score further includes determining the percentage of detractors based on a percentage of employees who submitted a value in response to the eNPS survey question that was at or below a detractor threshold value.

17. The non-transitory computer-readable storage medium of claim 15, wherein the calculating of the eNPS score further includes determining the percentage of promoters based on a percentage of employees who submitted a value in response to the eNPS survey question that was at or above a promoter threshold value.

18. The non-transitory computer-readable storage medium of claim 15, wherein the calculating of the eNPS score further includes determining a percentage of passives based on a percentage of employees who submitted a value in response to the survey question that was above a detractor threshold value and below a promoter threshold value.

19. The non-transitory computer-readable storage medium of claim 15, wherein the one or more suggested actions include one or more machine-learned actions that previously improved the eNPS score for the entity or another entity.

20. The non-transitory computer-readable storage medium of claim 19, wherein the one or more surveys include one or more pulse surveys, the one or more pulse surveys configured to update the eNPS score at a selected cadence or selected frequency.
